(19) United States
(12) Patent Application Publication
(10) Pub. No.: US 2025/0117750 A1
(43) Pub. Date: Apr. 10, 2025

(54) Methods and Apparatus for Métier Specifications Creation and Utilization

(71) Applicant: Metier Intellectual Properties, LLC, Fort Collins, CO (US)

(72) Inventors: T. Thomas Metier, Fort Collins, CO (US); Jack Metier, Denver, CO (US); Christopher Matney, Lyons, CO (US)

(21) Appl. No.: 18/417,924

(22) Filed: Jan. 19, 2024

Related U.S. Application Data
(60) Provisional application No. 63/542,696, filed on Oct. 5, 2023.

(51) Int. Cl. G06Q 10/1053

(52) U.S. Cl. CPC G06Q 10/1053

(57) ABSTRACT

Métier-methodized selection, sequencing, and ranking of individuals for particular métier applications may be disclosed. Embodiments may involve obtaining métier-relevant psychological data of an individual, obtaining métier-relevant objective data of an individual, numericizing such data to create métier-relevant numerical input data, applicatively revaluing such métier-relevant numerical input data to create métier-applied revalued numerical data, applicatively ranking the individual using such métier-applied revalued numerical data to create a métier-applied individual rank score for the individual, applying the individual rank score for the individual to create a métier-applied recommendation for the individual useful for a particular métier application, and fulfilling a vacant métier role with said individual using said métier-applied recommendation.

This application is a U.S. Non-Provisional Patent application claiming priority to and the benefit of U.S. Provisional Patent Application No. 63/542,696, filed Oct. 5, 2023, hereby incorporated herein by reference in its entirety.

### BACKGROUND OF THE INVENTION

The present inventive technology may generally relate to and include embodiments directed to methods and apparatus to create and utilize various kinds of métier specifications. The inventive technology may have applicability for métier-methodized selection, sequencing, and ranking of individuals for particular métier applications and fulfilling of vacant métier roles with métier-methodized recommended individuals.

A métier generally may be a field of work or other activity in which an individual may have a special ability or training. Métiers may include fields of work, occupations, trades, professions, or the like, but need not be so limited-métiers also may encompass amateur endeavors such as hobbies, avocations, or other non-professional pursuits that may require individuals engaged in them to have the special ability or training required for the métier.

Métiers often may bring together or involve individuals having in common the special training or ability applicable to the métier. As but one example, the legal profession may be a métier bringing together individuals trained as lawyers. This, of course, is just one example of a métier and the individuals having the special ability or training required for it. Even within the legal profession métier, for example, such individuals may include non-lawyers such as paralegals, vendors of legal services and products, and so forth. Other professional métiers may analogously bring together individuals in a like fashion, such as the medical profession métier bringing together doctors, nurses, and vendors of medical services and products, the engineering profession métier bringing together engineers, tradespeople, and vendors of engineering services and products, and so forth. And of course, the manner in which a métier may bring together individuals similarly may extend into the many non-professional métiers that may bring together persons having the special ability or training for the métier.

While it may seem that a métier would provide a common link facilitating the bringing together of individuals participating in the métier, in practice it may be difficult to bring together the best qualified, most complementary, or otherwise most effective individuals for a métier undertaking. The simple commonality of the métier often may be insufficient to bring together individuals in such a manner, particularly where the métier is complex, multifaceted, or otherwise may involve a large number of variables affecting the success or failure of a métier undertaking. In this manner, it may be appreciated that existing attempts to bring together the best qualified, most complementary, or otherwise most effective individuals for a métier may be lacking.

For example, existing attempts may fail to identify and quantify characteristics of individuals affecting their effectiveness for a métier undertaking in a way that is measurable and calculable beyond merely existing at the gross level of the métier. In the legal profession métier, for example, existing attempts may be sufficient at the gross level of the métier to identify individuals as lawyers, or perhaps even as lawyers admitted to a particular state bar, having a certain practice area, or the like, but may fail to account for temperament, disposition, or other psychological aspects pertinent to successful lawyering as may vary for different kinds of legal tasks, and may be unable to measure and calculate those psychological aspects in such a way as to evaluate them for different or varied kinds of legal tasks. Appropriate information may not even exist as needed for such particular tasks, and attempts at computer-implementation may heretofore have been simple automation of conventional techniques in the manner by which they otherwise could or would have been executed by a human.

Further, existing attempts may fail to operate from critically-thought and reasoned bases as to what characteristics make individuals successful in particular métier undertakings, and to develop foundational premises upon which measurements or calculations implementing such foundational premises may be made. In the legal profession métier, for example, it may be desirable to critically think and reason the bases for what temperaments, dispositions, or other psychological aspects make individual lawyers more suitable for some kinds of legal tasks and less so for others, and to formulate such critically-thought and reasoned bases into one or more premises, hypotheses, axioms, or the like that may be used to generate appropriate information and that may be implemented in a manner that allows measurement and calculation of the individual lawyer's psychological qualities in a manner that reflects the premise, hypothesis, or axiom as applied to the specific legal tasks in question. Again, appropriate information may not even exist as needed for such particular tasks, and attempts at computer-implementation may heretofore have been simple automation of conventional techniques in the manner by which they otherwise could or would have been executed by a human.

Moreover, existing attempts and information may fail to account for the large number of variables that may affect the effectiveness of an individual for a given métier undertaking, particularly where the métier is complex or multifaceted. In the legal profession métier, for example, a given legal task may have dozens or even hundreds of variables drawn from psychological aspects of the individual lawyer, objective aspects of the individual lawyer, and aspects specific to the legal task in question, all of which may dynamically interact to affect the success or failure of the legal task, and all of which may be affected by one or more premise-, hypothesis-, or axiom-implemented measurements or calculations drawn from the temperaments, dispositions, or other psychological aspects of the individual lawyers involved. As before, appropriate information may not even exist as needed for such particular tasks, and attempts at computer-implementation may heretofore have been simple automation of conventional techniques in the manner by which they otherwise could or would have been executed by a human.

Existing attempts also may fail to have independently operative computational formulas, principles, information, data, or procedures utilizing such premise-, hypothesis-, or axiom-implemented measurements or calculations for and specific to each of the large number of variables that may affect the effectiveness of an individual for a given métier undertaking. In the legal profession métier, for example, an individual lawyer may have a plurality of discrete psychological characteristics, separate and distinct from one another, that may benefit from individual measurement and calculation using dedicated formulas, principles, or procedures specifically applicable to each such individual psychological characteristic and as may be separately measured and calculated distinct from each other such individual psychological characteristic. Once again, appropriate information may not even exist as needed for such particular tasks, and attempts at computer-implementation may heretofore have been simple automation of conventional techniques in the manner by which they otherwise could or would have been executed by a human.

Existing attempts to bring together the best qualified, most complementary, or otherwise most effective individuals for a métier undertaking that is complex or multifaceted therefore may be largely ineffective or otherwise lacking. Accordingly, a need may exist to create métier specifications that may identify and quantify characteristics of individuals affecting their effectiveness for a métier undertaking in a way that is measurable, calculable, or otherwise utilizable beyond merely existing at the gross level of the métier, that may implement critically-thought and reasoned bases as to what characteristics make individuals successful in particular métier undertakings, that may address the large number of variables for complex or multifaceted métiers that may affect the effectiveness of an individual for a given métier undertaking, and that may have independently operative computational formulas, principles, or procedures utilizing such premise-, hypothesis-, or axiom-implemented measurements or calculations for and specific to each métier specification, particularly where multiple métier specifications may be useful to evaluate an individual in connection with his or her suitability for a métier undertaking.

### SUMMARY OF THE INVENTION

The present application includes a variety of aspects, which may be selected in different combinations based upon the particular application or needs to be addressed.

In some embodiments, it is an object of the application to provide a method of métier-methodized ranking of individuals for a particular métier application involving obtaining métier-relevant psychological data of an individual with a métier-methodized capture of individual psychological information of such individual, obtaining métier-relevant objective data of such individual with a métier-methodized capture of objective information of such individual, numericizing such métier-relevant psychological data of such individual and such métier-relevant objective data of such individual to create métier-relevant numerical input data for such individual, applicatively revaluing such métier-relevant numerical input data for such individual by inputting such métier-relevant numerical input data for such individual into a métier-applied data valuation framework to create métier-applied revalued numerical data for such individual, applicatively ranking such individual by using such métier-applied revalued numerical data for such individual to create a métier-applied individual rank score for such individual, and applying such métier-applied individual rank score for such individual to create a métier-applied recommendation for such individual useful for such particular métier application.

In some embodiments, it is an object of the application to provide a métier-methodized ranking system of individuals for a particular métier application having a métier-methodized individual psychological information capture element configured to obtain métier-relevant psychological data of such individual, a métier-methodized individual objective information capture element configured to obtain métier-relevant objective data of such individual, a data numeration processing element configured to create métier-relevant numerical input data for such individual from such métier-relevant psychological data of such individual and such métier-relevant objective data of such individual, a métier-applied data valuation framework processing element configured to create métier-applied revalued numerical data for such individual by applicatively revaluing such métier-relevant numerical input data for such individual with a métier-applied data valuation framework, an applicative data rank processing element configured to create a métier-applied individual rank score for such individual using such métier-applied revalued numerical data for such individual, and an individual rank score data application processing element configured to apply such métier-applied individual rank score for such individual to create a métier-applied recommendation for such individual useful for such particular métier application.

In some embodiments, it is an object of the application to fulfill a vacant métier role for a particular métier application with an individual based on a computer-generated métier-applied recommendation for such individual.

Naturally, other goals and objects of the present inventive technology are disclosed throughout the text, clauses, and claims.

### BRIEF DESCRIPTION OF THE DRAWINGS

FIG. 1 is a schematic representation of a métier-methodized ranking system in one exemplary and non-limiting embodiment.

FIG. 2 is a schematic representation of a feedback point utilized in a métier-methodized ranking system in one exemplary and non-limiting embodiment.

FIG. 3 is a schematic representation of an automated processing element configuration data update processing element utilized in a métier-methodized ranking system in one exemplary and non-limiting embodiment.

FIG. 4 is a schematic representation of a display processing element utilized in a métier-methodized ranking system in one exemplary and non-limiting embodiment.

FIG. 5 is an illustration of a two-axis score in one exemplary and non-limiting embodiment.

FIG. 6 is a schematic representation of iteratively developed reference data utilized in a métier-methodized ranking system in one exemplary and non-limiting embodiment.

FIG. 7 is a schematic representation of a métier-applied data valuation framework processing element in one exemplary embodiment.

FIG. 8 is a schematic representation of métier-relevant numerical input data in one exemplary embodiment.

FIG. 9 is a schematic representation of a plurality of métier-trait-metric parameters in one exemplary embodiment.

### DETAILED DESCRIPTIONS OF THE INVENTIONS

It should be understood that embodiments include a variety of aspects, which may be combined in different ways. The following descriptions are provided to list elements and describe some of the embodiments of the application. These elements are listed with initial embodiments; however, it should be understood that they may be combined in any manner and in any number to create additional embodiments. The variously described examples and preferred embodiments should not be construed to limit the embodiments of the application to only the explicitly described systems, techniques, and applications. The specific embodiment or embodiments shown are examples only. The specification should be understood and is intended as supporting broad claims as well as each embodiment, and even claims where other embodiments may be excluded.

Importantly, disclosure of merely exemplary embodiments is not meant to limit the breadth of other more encompassing claims that may be made where such may be only one of several methods or embodiments which could be employed in a broader claim or the like. Further, this description should be understood to support and encompass descriptions and claims of all the various embodiments, systems, techniques, methods, devices, and applications with any number of the disclosed elements, with each element alone, and also with any and all various permutations and combinations of all elements in this or any subsequent application.

The inventive technology described herein requires computers and computer-implementation to achieve the full realization of the methods and systems described. The methods and systems described herein are not simply an abstract idea or ideas, not simply a mathematical concept or concepts, not simply a mental process or processes, not simply a method or methods of organizing human activity, or the like. They are a practical application and improvement to the functioning of a computer and the technologies for making the described métier rankings, métier recommendations, fulfilling of vacant métier roles, and other such technologies discussed herein.

The inventive technology seeks to improve the métier-relevant,-specific, and -applied approaches and outcomes described herein by using expanded data sets, novel and varied calculational logic, iterative techniques, multi-dimensional analysis, and the other such techniques described herein. The resulting practical applications of the inventive technology are not simply automating conventional activity, because humans have not previously employed these techniques either at all or to the degree of sophistication described herein, and the methods and systems described herein achieve their results in fundamentally different ways than what a human could or would have done if they had tried. Moreover, the computer implementation of the described methods and systems improves speed and accuracy of outcomes in a way that humans have not done before and that would be unachievable as a practical matter without such computer implementation. The result is a practical application of achieving the described métier rankings, recommendations, fulfilling of vacant métier roles, and other practical applications described herein in a manner that is an unconventional solution to a technological problem.

The use of computers and computer-implementation of the methods and systems described herein are intended to be manifested in physical and tangible forms, including via the various processors, hardware, and computer implementations described. As to computer aspects and each aspect amenable to programming or other electronic automation, it should be understood that in characterizing these and all other aspects of the various embodiments of the inventive technology—whether characterized as a device, a capability, an element, or otherwise, because all of these can be implemented via software, hardware, or even firmware structures as set up for a general purpose computer, a programmed chip or chipset, an ASIC, application specific controller, subroutine, logic, or other known programmable or circuit specific structure—it should be understood that all such aspects are at least defined by structures including, as a person of ordinary skill in the art would well recognize: hardware circuitry, firmware, programmed application specific components, and even a general purpose computer programmed to accomplish the identified aspect. For such items implemented by programmable features, the inventive technology should be understand to encompass processes performed with the aid of or on a computer, machine, or computing machine, a programmable apparatus, a computer readable memory encoded with data to direct a computer comprising means or elements which function as described herein, a computer, machine, or computing machine configured as herein disclosed and described, individual or combined subroutines, processor logic, and/or programs as herein disclosed and described, a carrier medium carrying computer readable code for control of a computer to carry out separately each and every individual and combined method described herein, a computer program to perform separately each and every individual and combined method disclosed, a computer program containing all and each combination of means for performing each and every individual and combined step disclosed, a storage medium storing each computer program disclosed, a signal carrying a computer program disclosed, a processor executing instructions that act to achieve the steps and activities detailed, circuitry configurations (including configurations of transistors, gates, and the like) that act to sequence and/or cause actions as detailed, computer readable medium(s) storing instructions to execute the steps and cause activities detailed, the related methods disclosed and described, similar, equivalent, and even implicit variations of each of these systems and methods, those alternative designs which accomplish each of the functions shown as are disclosed and described, those alternative designs and methods which accomplish each of the functions shown as are implicit to accomplish that which is disclosed and described, each feature, component, and step shown as separate and independent inventions, and the various combinations of each of the above and of any aspect, all without limiting other aspects in addition. Computer implementation generally may involve fulfilling, performing, or carrying out a thing or function with a computer. Computer generation generally may involve producing, bringing into existence, or causing to be a thing or function with a computer. The methods and systems described herein should be understood as being amenable to and capable of computer implementation and computer generation even where such may not be explicitly stated.

While the figures may be discussed herein primarily in an apparatus context, it should be understood that they also depict the processes and methods involved and so each figure and even their elements should also be understood as depicting steps in the methods and processes described herein as well.

Embodiments of the present inventive technology may relate to a method of métier-methodized selection, sequencing, and ranking of individuals for a particular métier application. Embodiments of the present inventive technology also may relate to a métier-methodized selection, sequencing, and ranking system (1) of individuals for such a particular métier application.

A métier application generally may be a thing, action, event, or the like having the quality of being usable for a particular purpose or in a special way that is specific to the métier. In a legal profession métier, for example, métier applications may include lawyer networking, lawyer team-building, lawyer referrals, lawyer memberships in lawyer associations, lawyer mentorships, and the like. However, the scope of particular métier applications may be as wide or as narrow as circumstances may require so long as retaining the particular purpose or special way specific to the given métier in question, and of course need not be limited to the illustrative networking, team-building, referrals, associations memberships, and mentorships examples set forth, and indeed need not be limited to the legal profession métier.

The method and system embodiments described and disclosed herein generally may involve métier-methodized selection, sequencing, and ranking of individuals for such métier applications. Such métier-methodized selection, sequencing, and ranking generally may apply métier-methodization to some or all aspects of some or all considerations used in the selection, sequencing, and ranking. This can involve implementing such considerations arranged or executed in a manner according to the needs or requirements of a particular métier or métier application in question. As will be discussed herein, such métier-methodization may be achieved with a very high level of specificity and precision, for example to identify and quantify characteristics of individuals affecting their effectiveness for a métier undertaking in a way that is measurable and calculable beyond merely existing at the gross level of the métier, to operate from critically-thought and reasoned bases as to what characteristics make individuals successful in particular métier undertakings, to account for the large number of variables that may affect the effectiveness of an individual for a given métier undertaking where the métier is complex or multifaceted, and to have independently operative computational formulas, principles, or procedures utilizing premise-, hypothesis-, or axiom-implemented measurements or calculations for and specific to each of the large number of variables that may affect the effectiveness of an individual for a given métier undertaking.

The selection, sequencing, and ranking of individuals in such métier-methodized manners, as set forth in the method and system embodiments described herein, can allow for the creation of métier-applied recommendations for individuals useful for particular métier applications with very high specificity and precision-again, using the legal profession métier as an example, not just a lawyer for an individual's networking, team-building, referral, associations membership, or mentorship needs, but rather perhaps exactly the right lawyer for that particular individual's highly specific and precise needs as measured, quantified, and computed by the métier-methodized system and method embodiments described and disclosed herein.

It is noted that various embodiments of the system described and disclosed herein may utilize data processors for various kinds of complex computational processes. The configuration of such data processors for such various kinds of complex computational processes may be accomplished in any suitable fashion consistent with the inventive principles discussed herein, and in various embodiments may be done such as by programming, a subroutine, firmware, hardware, or the like.

It also is noted that the descriptions and disclosures set forth herein may use the legal profession métier or other kinds of métiers as illustrative examples of various aspects, characteristics, or applications of the inventive technology. Such use of the legal profession métier specifically or other kinds of métiers specifically as such kinds of illustrative examples does not limit the applicability of the illustrated and exemplified aspects, characteristics, or applications from being applied to other métiers, métier applications, métier-relevant things, métier-applied things, and métier-methodized things generally. This should be understood to include (but not be limited to) the description and disclosure herein of specific networking métier applications, specific referrals métier applications, specific team-building métier applications, specific associations membership métier applications, specific leadership development métier applications, specific mentorship métier applications, specific vendor métier applications, specific behavioral tendencies, assertiveness specifically as a behavior tendency, compassion specifically as a behavior tendency, creativity specifically as a behavior tendency, dependability specifically as a behavior tendency, ethicalness specifically as a behavior tendency, open-mindedness specifically as a behavior tendency, passion specifically as a behavior tendency, perseverance specifically as a behavior tendency, pragmatism specifically as a behavior tendency, resilience specifically as a behavior tendency, trust specifically as a behavior tendency, wisdom specifically as a behavior tendency, specific self-assessment queries, specific slider pairs as a self-assessment query, specific either/or questions as a self-assessment query, specific ranking questions as a self-assessment query, specifically disclosed user interfaces, specifically disclosed networking user interfaces, specifically disclosed referrals user interfaces, specifically disclosed team-building interfaces, specifically disclosed associations membership interfaces, specifically disclosed mentorship interfaces, specifically disclosed leadership development interfaces, specifically disclosed vendor interfaces, specifically disclosed types, implementations, or uses of feedback, and specifically disclosed types, implementations, or uses of two-axis scoring, each and all of which may be capable of utilization exactly, substantially, or analogously as disclosed in, for, or with other métiers, métier applications, métier-relevant things, métier-applied things, and métier-methodized things other than the legal profession métier or other specific métier for which they may be described and disclosed herein as illustrative examples.

Referring to the figures, in some embodiments, the method may involve obtaining métier-relevant psychological data (2) of an individual with a métier methodized capture of individual psychological information of that individual. Psychological information may be information pertaining to the mind or mental state of the individual, as perhaps may be manifested by an individual's temperament, disposition, or tendency towards action in a given situation. Capture of such psychological information may be accomplished in any suitable manner consistent with the inventive principles herein disclosed. In some embodiments, capture may be a métier-methodized capture, which may involve capture configured in a manner to arrange such captured psychological information according to the needs or requirements of a particular métier or métier application in question.

In various embodiments, the métier-methodized capture of individual psychological information allows for the obtaining of métier-relevant psychological data (2) of the individual. It may be appreciated that while psychological information may describe a qualitative state, characteristic, or attribute of the individual, psychological data (2) may be information that has been translated into a form that is usable for computationally complex data processing, such as by a computer or the like. The method can allow for the obtaining of métier-relevant psychological data (2) of an individual, which may be psychological data (2) tending to affect the individual's effectiveness for a given particular métier application.

Embodiments of the system may involve a métier-methodized individual psychological information capture element (3) configured to obtain such métier-relevant psychological data of an individual. The capture element (3) may be any as may be suitable to capture psychological information of the individual consistent with the inventive principles discussed herein, and in various embodiments may include keyboards, screens, microphones, displays, touch interfaces, data entry devices, data recording devices, and the like.

In various embodiments of the method, obtaining métier-relevant psychological data (2) may involve obtaining métier-specific psychological data (2). This may be psychological data (2) of an individual specific for a given métier in which the individual may be involved. Naturally, such métier-specific psychological data (2) may take a great many varieties or forms as may be suitable to reflect the given métier in question. In some embodiments, métier-specific psychological data (2) may be behavioral tendency data, and obtaining métier-specific psychological data (2) may involve obtaining behavioral tendency data. Behavioral tendency data may be data regarding an individual's tendencies toward certain behaviors, actions, or the like for a given métier undertaking or situation in which the individual may be involved. Again, behavioral tendency data may take a great many varieties of kinds and forms. For example, in some embodiments, a métier may comprise the legal profession, and obtaining behavioral tenancy data may involve obtaining behavioral tendency data pertaining to the trait of assertiveness, behavioral tendency data pertaining to the trait of compassion, behavioral tendency data pertaining to the trait of creativity, behavioral tendency data pertaining to the trait of dependability, behavioral tendency data pertaining to the trait of ethicalness, behavioral tendency data pertaining to the trait of open-mindedness, behavioral tendency data pertaining to the trait of passion, behavioral tendency data pertaining to the trait of perseverance, behavioral tendency data pertaining to the trait of pragmatism, behavioral tendency data pertaining to the trait of resilience, behavioral tendency data pertaining to the trait of trust, behavioral tendency data pertaining to the trait of wisdom, or any combination of the foregoing. In various embodiments of the system, a métier-methodized individual psychological information capture element (3) may be an element configured to obtain such métier-specific psychological data (2).

In some embodiments of the method, obtaining métier-relevant psychological data (2) of an individual with a métier-methodized capture of individual psychological information of the individual may involve prompting the individual with a métier-methodized self-assessment query (69). This may be a métier-methodized query prompting the individual to conduct a self-assessment of his or her own psychological information as such may be relevant for a given métier in which the individual may be involved. In embodiments of the system, a métier-methodized individual psychological information capture element (3) may be a métier-methodized self-assessment query (69) prompt.

A métier-methodized self-assessment query may be of any suitable type or kind consistent with the inventive principles discussed herein.

In some embodiments, a métier-methodized self-assessment query may involve slider pairs. Slider pairs may involve a user-positionable slider having a characteristic or quality at each end of the slider, thereby perhaps allowing a user to self-assess himself or herself with respect to such characteristics or qualities. In some embodiments, slider pairs may be behavioral tendency metric slider pairs, as wherein such characteristics or qualities may be behavioral tendencies and the slider may be a metric for the same. Any suitable behavioral tendencies may be utilized consistent with the inventive principles discussed herein. For example, in some embodiments a métier may be the legal profession, and slider pairs may be assertiveness versus modesty, compassion versus cruelty, creativity versus unimaginativeness, dependability versus unreliability, ethicalness versus corruption, open-mindedness versus unreceptiveness, passion versus indifference, perseverance versus procrastination, pragmatism versus irrationality, trust versus skepticism, wisdom versus ignorance, and the like. In system embodiments, a métier-methodized self-assessment query prompt may be slider pairs.

In some embodiments, a métier-methodized self-assessment query may involve either/or questions. A user may self-assess a characteristic or quality by providing an answer to an either/or question testing for such characteristic or quality. In some embodiments, either/or questions may be behavioral tendency metric either/or questions, as wherein such characteristics or qualities may be behavioral tendencies and the either/or question may test for the same. Any suitable behavioral tendencies may be utilized consistent with the inventive principles discussed herein. For example, in some embodiments a métier may be the legal profession, and either/or questions may test for creativity versus pragmatism, trust versus assertiveness, ethics versus perseverance, open-mindedness versus wisdom, passion versus compassion, resilience versus dependability, and the like. In system embodiments, a métier-methodized self-assessment query prompt may be either/or questions.

In some embodiments, a métier-methodized self-assessment query may involve ranking questions. A user may self-assess a characteristic or quality by ranking one or more items or things that may test for or correspond to such characteristic or quality. In some embodiments, ranking questions may be behavioral tendency ranking questions, as wherein such characteristics or qualities may be behavioral tendencies. Any suitable behavioral tendencies may be utilized consistent with the inventive principles discussed herein. For example, in some embodiments a métier may be the legal profession, and ranking questions may involve ranking dependability, perseverance, and open-mindedness, ranking compassion, assertiveness, pragmatism, and trustworthiness, ranking resilience, ethics, passion, and wisdom, and the like. In system embodiments, a métier-methodized self-assessment query prompt may be ranking questions.

In some embodiments, the method may involve obtaining métier-relevant objective data (42) of an individual with a métier-methodized capture of objective information of the individual. Objective information may be information pertaining to things external to the mind rather than the psychological state, characteristic, or attribute of an individual. Capture of such objective information may be accomplished in any suitable manner consistent with the inventive principles herein disclosed. In some embodiments, capture may be a métier-methodized capture, which may involve capture configured in a manner to arrange such captured objective information according to the needs or requirements of a particular métier application in question.

In various embodiments, the métier-methodized capture of individual objective information may allow for the obtaining of métier-relevant objective data (42) of the individual. It may be appreciated that while objective information may describe a qualitative state, characteristic, or attribute of the individual, objective data (42) may be information that has been translated into a form that is usable for data processing, such as via a computer or the like. The method may allow for the obtaining of métier-relevant objective data (42) of an individual, which may be objective data (42) tending to affect the individual's effectiveness for a given particular métier application.

Embodiments of the system may involve a métier-methodized individual objective information capture element (4) configured to obtain métier-relevant objective data of an individual. The capture element (4) may be any as may be suitable to capture objective information of the individual consistent with inventive principles discussed herein, and in various embodiments may include keyboards, screens, microphones, displays, touch interfaces, data entry devices, data recording devices, and the like.

Objective data (42) may be of any type or kind consistent with the inventive principles discussed herein. For example, in some embodiments, objective data (42) may include first name data, last name data, nickname data, vocation data, avocation data, location data, personal photo data, pronouns data, birthdate data, race data, ethnicity data, skills data, certifications data, training data, endorsements data, recommendations data, mentorship roles data, and the like. In another example, a métier may be the legal profession, and objective data (42) may include law firm data, field of law data, legal specialty area data, state licensing data, practice geography data, law school data, legal education data, year of bar admission data, desired case type data, recent case overview data, recent case results data, and the like.

In some embodiments of the method, obtaining métier-relevant objective data (42) of an individual with a métier-methodized capture of objective information of the individual may involve prompting the individual with a métier-methodized self-assessment query (69). This may be a métier-methodized query prompting the individual to conduct a self-assessment of his or her own objective information as such may be relevant for a given métier in which the individual may be involved. In embodiments of the system, a métier-methodized individual objective information capture element (3) may be a métier-methodized self-assessment query (69) prompt.

Moreover, métier-relevant objective data (42) in some embodiments may be data of or about an individual himself or herself, and in some embodiments may be information about another person, thing, event, or the like that simply may be relevant to the individual, for example as may be relevant to, for, or in connection with evaluating such individual for a métier undertaking, and which may be or involve métier-relevant numerical input data of such individual in various embodiments.

Embodiments of the method may involve numericizing obtained métier-relevant psychological data (2) of the individual and métier-relevant objective data (42) of the individual to create métier-relevant numerical input data (5) for the individual. Numericizing may facilitate the complex computational processes necessary to apply various embodiments of the methods and systems discussed herein and may be accomplished in any suitable manner consistent with the inventive principles described herein. Numericizing as described herein also may be seen to be an example of a practical application and an improvement to the functioning of a computer as being achieved in a way fundamentally different than what a human could or would do as well as improving speed and accuracy of the same in a way that would be unachievable as a practical matter without computer implementation.

In some embodiments of the system, the system may utilize a data numeration processing element (6) configured to create such métier-relevant numerical input data (5) for the individual from such métier-relevant psychological data (2) and such métier-relevant objective data (42). A data numeration processing element (6) may be any as may be suitable consistent with the inventive principles described herein to transform métier-relevant psychological data (2) and métier-relevant objective data (42) into numerical values, and in some embodiments may include a programmed computer processor, a microprocessor, an embedded processor, an integrated circuit, a programmable CPU, a microcontroller, an ASIC, or the like.

Métier-relevant numerical input data (5) may be understood to be the psychological data (2) and objective data (42) previously discussed, wherein such data has been transformed into one or more numerical values. In various embodiments, such transforming may not change the values of such data, but may merely transform its form into numerals or other forms that are computationally useable. Naturally, such métier-relevant numerical input data (5) may maintain its relevance to the particular métier application in question as being a product of the métier-relevant psychological data (2) and métier-relevant objective data (42) underlying it.

In various embodiments, numericizing métier-relevant psychological data (2) of an individual may involve assigning a numerical value to at least one métier-methodized self-assessment query response. As may be discussed herein, a métier-methodized self-assessment query (69) may be utilized to obtain métier-relevant psychological data (2) of an individual. The responses to such métier-methodized self-assessment queries accordingly may be seen to provide data pertaining to psychological information of the individual, and assigning a numerical value to such responses may serve to numericize such psychological data. In various embodiments of the system, a data numeration processing element (6) may be a data numeration processing element (6) configured to assign a numerical value to at least one métier-methodized self-assessment query response. Assigning a numerical value may involve assigning a numerical value between 0 and 1 inclusive, which in various embodiments may facilitate normalizing or allowing for normalized used of such numerical values in various kinds of data processing, and a data numeration processing element (6) in various embodiments may be a data numeration processing element (6) configured to assign a numerical value between 0 and 1 inclusive.

In some embodiments of the method, at least one métier-methodized self-assessment query response may be a métier trait metric. A métier trait may be a trait of an individual, such as a psychological trait or objective trait of an individual in various embodiments, that may be relevant to the effectiveness or suitability of the individual for a given métier undertaking. A métier trait metric may be a metric, such as a value, numeral, or other measure, tending to measure such a trait of the individual. In some embodiments, métier-relevant numerical input data (5) for an individual may be métier-relevant numerical input data (5) for at least one métier trait metric for the individual.

In some embodiments of the method, a métier trait metric may be a behavioral tendency metric, such as wherein the metric provides a measure of a behavioral tendency of the individual with respect to a métier. For example, in various embodiments the métier may be the legal profession, and numericizing may involve creating a set of numerical values for behavioral tendencies. In embodiments, a data numeration processing element (6) may be configured to create a set of numerical values for behavioral tendencies.

Embodiments of the method may involve equalizing the number of métier-methodized self-assessment queries for a given métier trait metric or metrics, and embodiments of the system may involve an equal number of métier-methodized self-assessment queries for a given métier trait metric or metrics. Using or apportioning equal numbers of such queries per metric in this manner may, for example, promote or contribute to the standardization, normalization, or the like of the resulting data from such queries.

In various embodiments of the method, numericizing may involve assigning a plurality of numerical values to an n-dimensional space. An n-dimensional space may be a conceptual space in which concepts such as values, calculations, measures, and the like may be individually and separately represented in multiple dimensions noted by the “n” value. For example, in some embodiments each dimension of an n-dimensional space may represent a métier trait metric, perhaps as each may be represented by a numerical value, in n dimensions. An n-dimensional space may be specific for a given métier. For example, in some embodiments the métier may comprise the legal profession and the n-dimensional space may have a plurality of behavioral tendency dimensions. In embodiments of the system, a data numeration processing element (6) may be a data numeration processing element (6) configured to assign a plurality of numerical values to an n-dimensional space.

An n-dimensional space in various embodiments may have any number of dimensions “n” suitable consistent with the inventive principles discussed herein for which the n-dimensional space may be utilized. In various embodiments, the number of dimensions may be greater than 10, greater than 20, greater than 50, greater than 75, or greater than 100. In some embodiments, an n-dimensional space may be a 95-dimensional space. Moreover, the implementation of an n-dimensional space in various embodiments may be as a matrix, an array, or the like, such as a matrix of mathematical elements or numerical values, an array of mathematical elements or numerical values, or the like. Further, the utilization of an n-dimensional space as described herein may be an example of a practical application and an improvement to the functioning of a computer as being achieved in a way fundamentally different than what a human could or would do as well as improving speed and accuracy of the same in a way that would be unachievable as a practical matter without computer implementation.

In embodiments, numericizing métier-relevant psychological data (2) of an individual and/or métier-relevant objective data (42) of an individual to create métier-relevant numerical input data (5) for an individual may involve normalizing such métier-relevant psychological data (2) and such métier-relevant objective data (42) to create métier-relevant normalized numerical input data for said individual. Such normalization may involve mathematically transforming or adjusting such data so that the data fits a standard measure or scale, for example in some embodiments by making numerical values fall between 0 and 1 inclusive. In some embodiments, métier-relevant normalized numerical input data for an individual may be scalable input data, symmetrical input data, or the like. In system embodiments, a data numeration processing element (6) may be configured to create such métier-relevant normalized numerical input data for an individual.

In some embodiments, numericizing métier-relevant psychological data (2) of an individual and/or métier-relevant objective data (42) of an individual to create métier-relevant numerical input data (5) for an individual may involve creating a numerical matrix of or for such data. Such a matrix may involve a rectangular, spatial, or other dimensional array of numbers, algebraic symbols, mathematical functions, or the like that may be added, multiplied, or be the subject of various kinds of mathematical operations and/or calculations. In system embodiments, a data numeration processing element (6) may be configured to create a numerical matrix. Moreover, a matrix or matrices as described herein may be an example of a practical application and an improvement to the functioning of a computer as being achieved in a way fundamentally different than what a human could or would do as well as improving speed and accuracy of the same in a way that would be unachievable as a practical matter without computer implementation.

The system in various embodiments may include a métier-applied data valuation framework (7) into which such métier-relevant numerical input data (5) may be input. Such a data valuation framework (7) may utilize one, several, or perhaps even a métier-methodized collection of processes or ways in which to change one or more numerical values of the métier-relevant numerical input data (5) that is put therein. The processes or ways in which such numerical values may be changed may be any as may be suitable consistent with the inventive principles described herein, and in various embodiments may involve mathematical weightings, functions, computations, rules, matrices, numerical value lookups, and the like, and in embodiments a data valuation framework (7) may be a métier-applied weighting data valuation framework (7), a métier-applied function data valuation framework (7), a métier-applied computation data valuation framework (7), a métier-applied data rule valuation framework (7), a métier-applied data matrix valuation framework (7), and the like. The data valuation framework (7) may be métier-applied in as much as it may revalue the métier-relevant numerical input data (5) according to the requirements, needs, or purposes of a given métier application. Utilization of the data valuation framework (7) may serve to create métier-applied revalued numerical data (9), in as much as the métier-relevant numerical input data (5) is revalued by the framework (7) and in as much as the framework (7) itself is métier-applied. In some embodiments, such revaluing may involve generating, creating, or otherwise bringing into existence new or even new kinds of data, information, or the like that may not have existed before, for example, in some embodiments perhaps métier-applied data, information or the like that may provide new or even new kinds of métier-applied capabilities or utilities that may not have been possible prior to the inventive technology disclosed herein. A data valuation framework (7) in embodiments may be a computer-implemented data valuation framework (7), such as a computer-implemented métier-applied data valuation framework (7). Moreover, a métier-applied data valuation framework (7) as described herein may be an example of a practical application and an improvement to the functioning of a computer as being achieved in a way fundamentally different than what a human could or would do as well as improving speed and accuracy of the same in a way that would be unachievable as a practical matter without computer implementation.

The system may utilize a métier-applied data valuation framework processing element (8) configured to create métier-applied revalued numerical data (9) for an individual by applicatively revaluing métier-relevant numerical input data (5) for the individual with a métier-applied data valuation framework (7). The processing element (8) may be any as may be suitable consistent with the inventive principles discussed herein to process or change numerical values as described for the data valuation framework (7), and in some embodiments may include a programmed computer processor, a microprocessor, an embedded processor, an integrated circuit, a programmable CPU, a microcontroller, an ASIC, and the like.

In this manner, the method in various embodiments may involve applicatively revaluing métier-relevant numerical input data (5) for an individual by inputting the métier-relevant numerical input data (5) for the individual into a métier-applied data valuation framework (7) to create métier-applied revalued numerical data (9) for the individual. Inputting may involve supplying one or more numerical values of the métier-relevant numerical input data (5) as input for the processes or ways in which the numerical values may be changed by the data valuation framework (7), and applicatively revaluing the métier-relevant numerical input data (5) may involve changing numerical values of such numerical input data to meet the needs or requirements of a particular métier application. In some embodiments, applicatively revaluing may be computer-implemented applicatively revaluing.

In some embodiments of the method, applicatively revaluing the métier-relevant numerical input data (5) for an individual may involve applicatively revaluing the métier-relevant numerical input data (5) in an n-dimensional space. In various embodiments, each dimension of such an n-dimensional space may represent a métier trait metric, and in some embodiments, the métier may be the legal profession and the n-dimensional space may have a plurality of behavioral tendency dimensions. Examples of such behavioral tendency dimensions in some embodiments may include dimensions for assertiveness, compassion, creativity, dependability, ethicalness, open-mindedness, passion, perseverance, pragmatism, resilience, trust, wisdom, and the like. In embodiments of the system, a métier-applied data valuation framework processing element (8) may be a n-dimensional space métier-applied data valuation framework processing element (8). Applicatively revaluing in an n-dimensional space again may be an example of a practical application and an improvement to the functioning of a computer as being achieved in a way fundamentally different than what a human could or would do as well as improving speed and accuracy of the same in a way that would be unachievable as a practical matter without computer implementation.

In various embodiments of the method and the system, a métier-applied data valuation framework (7) may implement one or more axioms. Such axioms may be premises, contentions, observations, rules, tenets, theorems, principles, or the like that may provide predictive information on whether an individual may be effective or suitable for a given métier undertaking. For example, in some embodiments, the métier may be the legal profession, and the axioms may relate to métier applications such as networking, team-building, referrals, associations membership, and mentorship. In various embodiments, a métier-applied data valuation framework (7) may be a métier-applied networking data valuation framework (7) that may include, utilize, or otherwise have or incorporate at least one networking axiom, a métier-applied team-building data valuation framework (7) that may include, utilize, or otherwise have or incorporate at least one team-building axiom, a métier-applied referrals data valuation framework (7) that may include, utilize, or otherwise have or incorporate at least one referrals axiom, a métier-applied associations membership data valuation framework (7) that may include, utilize, or otherwise have or incorporate at least one associations membership axiom, and a métier-applied mentorship data valuation framework (7) that may include, utilize, or otherwise have or incorporate at least one mentorship axiom.

The nature of the axioms may be any as may be suitable consistent with the inventive principles discussed herein by which the properties of the data valuation framework (7) may be built. For example, where the métier is the legal profession and the métier application may be team-building, a team-building axiom may be selected from a local practice area axiom, a fields of law axiom, a specialty area axiom, a trial threat axiom, a complementary personalities axiom, a case outcomes axiom, a diversity axiom, a feedback axiom, a degrees of separation axiom, a case example axiom, and a skills and certifications axiom. Such implementations of axioms as described herein further may be an example of a practical application and an improvement to the functioning of a computer as being achieved in a way fundamentally different than what a human could or would do as well as improving speed and accuracy of the same in a way that would be unachievable as a practical matter without computer implementation.

The method in various embodiments may involve applicatively ranking an individual by using the métier-applied revalued numerical data (9) for the individual to create a métier-applied individual rank score (10) for the individual. A rank score (10) for an individual may computationally measure or quantify, often from a complex combination of disparate and perhaps even non-analogous factors, the individual's effectiveness, suitability, or the like for a given purpose, and in various embodiments may be a numerical value rank score (10). Applicatively ranking may involve creating such a rank score (10) for an individual for a particular métier application, and the rank score (10) may be seen as being métier-applied in this fashion.

Applicatively ranking as described herein may be another example of a practical application and an improvement to the functioning of a computer as being achieved in a way fundamentally different than what a human could or would do as well as improving speed and accuracy of the same in a way that would be unachievable as a practical matter without computer implementation.

In some embodiments, métier-applied revalued numerical data (9) may be a plurality of revalued numerical values. The action of applicatively ranking in such situations may involve transforming such plurality of revalued numerical values into a numerical value rank score (10), which in embodiments may be a single value. Such situations may arise, for example, where métier-relevant numerical input data (5) comprises multiple numerical values for valuation with a métier-applied data valuation framework (7). In some embodiments, for example, a plurality of revalued numerical values may be a plurality of revalued numerical values in an n-dimensional space, such as wherein each dimension of such n-dimensional space may represent a métier trait metric. In some embodiments, a métier may be the legal profession, and an n-dimensional space may be a plurality of behavioral tendency dimensions. In system embodiments, a métier-applied data valuation framework processing element (8) may be configured to transform such a plurality of revalued numerical values into one or more numerical value rank scores (10).

The system in various embodiments may have an applicative data rank processing element (11) configured to create such a métier-applied individual rank score (10) for the individual using the métier-applied revalued numerical data (9) for the individual, such as may have been created with the métier-applied data valuation framework (7). The applicative data rank processing element (11) may be any as may be suitable consistent with the inventive principles discussed herein to create a métier-applied individual rank score (10), and in some embodiments may include a programmed computer processor, a microprocessor, an embedded processor, an integrated circuit, a programmable CPU, a microcontroller, an ASIC, or the like. Creating the rank score (10) in some embodiments may involve changing one or more numerical values of the métier-applied revalued numerical data (9), such as with the applicative data rank processing element (11). The processes or ways in which such numerical values may be changed may be any as may be suitable consistent with the inventive principles described herein, and in various embodiments may involve mathematical weightings, functions, computations, rules, numerical value lookups, and the like. Using the métier-applied revalued numerical data (9) may involve supplying such data as input for the applicative data rank processing element (11). The data rank processing element (11) may be seen to be applicative in as much as it may create a rank score (10) for a particular métier application.

In some embodiments, applicatively ranking an individual may involve comparing said métier-applied individual rank score (10) for the individual to at least one métier-applied individual rank score (10) for another individual, and an applicative data rank processing element (11) may be an applicative data rank processing element (11) configured to compare a métier-applied individual rank score (10) for an individual to at least one métier-applied individual rank score (10) for another individual.

The method in various embodiments may involve applying the métier-applied individual rank score (10) for the individual to create a métier-applied recommendation (12) for the individual useful for a particular métier application. Creating such a métier-applied recommendation (12) may be done in any manner suitable consistent with the inventive principles discussed herein. For example, in various embodiments, creating such a métier-applied recommendation (12) may involve comparing the rank score (10) for the individual with rank scores (10) for other individuals, comparing the rank score for the individual against a threshold or minimum rank score (10) required for a particular métier application, and the like. A métier-applied recommendation (12) in embodiments may be computer-generated métier-applied recommendation (12). Métier-applied recommendations (12) as described herein may be another example of a practical application and an improvement to the functioning of a computer as being achieved in a way fundamentally different than what a human could or would do as well as improving speed and accuracy of the same in a way that would be unachievable as a practical matter without computer implementation.

The métier-applied recommendation (12) also may be any as may be suitable consistent with the inventive principles discussed herein that may be useful for a particular métier application. Generally speaking, the usefulness of such a métier-applied recommendation (12) may be to reflect the effectiveness, suitability, or the like of the individual for a given particular métier application.

Some embodiments may involve fulfilling a vacant métier role for a particular métier application with a métier-methodized recommended individual. Such a métier role may be or involve a given métier position, function, or the like assumed by an individual in a given métier, métier application, métier undertaking, or the like. For example, in a networking métier application, fulfilling a métier role may involve adding a métier-methodized recommended individual to another individual's network. In another example, in a team-building métier application, fulfilling a métier role may involve adding a recommended métier-methodized individual to a team. In another example, in a referrals métier application, fulfilling a métier role may involve referring a person, thing, matter, or the like from or to a métier-methodized recommended individual. In another example, in a mentorship métier application, fulfilling a métier role may involve providing a métier-methodized recommended individual as a mentor or a mentee for another individual. In another example, in an associations membership or associations subgroup métier application, fulfilling a métier role may involve providing a métier-methodized recommended individual as a member for an association or association subgroup. While the foregoing provide some examples, naturally fulfilling a vacant métier role for a particular métier application with a métier-methodized recommended individual may take any form or be of any kind suitable consistent with the inventive principles discussed herein. Fulfilling a vacant métier role as described herein may be another example of a practical application and an improvement to the functioning of a computer as being achieved in a way fundamentally different than what a human could or would do as well as improving speed and accuracy of the same in a way that would be unachievable as a practical matter without computer implementation.

In various embodiments, the recommendation naturally may be for a given métier application, such as a métier-applied networking recommendation for the individual useful for a métier networking application, a métier-applied team-building recommendation for the individual useful for a métier team-building application, a métier-applied referrals recommendation for the individual useful for a métier referrals application, métier-applied associations membership recommendation for the individual useful for a métier associations membership application, a métier-applied mentorship recommendation for the individual useful for a métier mentorship application, a métier-applied leadership recommendation for the individual useful for a métier leadership application, a métier-applied vendor recommendation for the individual useful for a métier vendor application, and the like. In some embodiments, applying a métier-applied individual rank score (10) for an individual to create a métier-applied recommendation (12) for the individual useful for a particular métier application may involve applying the highest métier-applied individual rank score (10) among a plurality of individuals to make such recommendation.

The system in various embodiments may involve an individual rank score data application processing element (13) configured to apply the métier-applied individual rank score (10) for the individual to create the métier-applied recommendation (12) for the individual useful for a particular métier application. The individual rank score data application processing element (13) may be any as may be suitable consistent with the inventive principles discussed herein to create the métier-applied recommendation (12) through application of the métier-applied individual rank score (10), and in some embodiments may include a programmed computer processor, a microprocessor, an embedded processor, an integrated circuit, a programmable CPU, a microcontroller, an ASIC, and the like.

Embodiments may be provided with a métier-applied user interface (122) or interfaces (122). Such a user interface (122) may involve hardware or software enabling the communication of information between hardware, software, devices, programs, and the like and a user or users. Examples of user interfaces (122) may include keyboards, screens, microphones, displays, touch interfaces, data entry devices, data recording devices, speakers, visual interfaces, audio interfaces, and the like. The user interface (122) may be métier-applied in as much as allowing one or more individuals to interact, participate in, or otherwise benefit from the methods and systems described herein according to the requirements, needs, or purposes of a given métier application.

For example, in some embodiments a métier application may be networking, and embodiments may involve providing a métier-applied networking user interface (122). The interface may allow a user or users to interact, participate in, or otherwise benefit from the methods and systems described herein according to networking requirements, needs, or purposes. In some embodiments a métier may be the legal profession, and a métier-applied networking user interface (122) may involve a map or maps of fields of law, a referrals sorting interface, a feedback sorting interface, a profession sorting interface, and the like. In system embodiments, a métier-applied networking user interface (122) may be responsive to at least one processing element.

In another example, in some embodiments a métier application may be team-building, and embodiments may involve providing a métier-applied team-building user interface (122). The interface may allow a user or users to interact, participate in, or otherwise benefit from the methods and systems described herein according to team-building requirements, needs, or purposes. In system embodiments, a métier-applied team-building user interface (122) may be responsive to at least one processing element.

In another example, in some embodiments a métier application may be referrals, and embodiments may involve providing a métier-applied referrals user interface (122). The interface may allow a user or users to interact, participate in, or otherwise benefit from the methods and systems described herein according to referrals requirements, needs, or purposes. In some embodiments a métier may be the legal profession, and a métier-applied referrals user interface (122) may involve a referrals sending interface, a referrals tracking interface, a reciprocity tracking interface, and the like. In system embodiments, a métier-applied referrals user interface (122) may be responsive to at least one processing element.

In another example, in some embodiments a métier application may be associations membership, and embodiments may involve providing a métier-applied associations membership user interface (122). The interface may allow a user or users to interact, participate in, or otherwise benefit from the methods and systems described herein according to associations membership requirements, needs, or purposes. In some embodiments a métier may be the legal profession, and a métier-applied associations membership user interface (122) may involve a chat interface, a dues interface, a purchasing interface, and the like. In system embodiments, a métier-applied associations membership user interface (122) may be responsive to at least one processing element.

In another example, in some embodiments a métier application may be mentorship, and embodiments may involve providing a métier-applied mentorship user interface (122). The interface may allow a user or users to interact, participate in, or otherwise benefit from the methods and systems described herein according to mentorship requirements, needs, or purposes. In system embodiments, a métier-applied mentorship user interface (122) may be responsive to at least one processing element.

In some embodiments, a métier-applied user interface (122) may have, utilize, or otherwise involve a filter (123). Such a filter may categorize, sort, prioritize, block, or similarly act on data, such as through rule-based protocols or the like. For example, in some embodiments a métier-applied referrals user interface (122) may have a referrals filter (123), such as a geographic filter, a field of law filter, and the like.

Various embodiments of the system and the method may utilize reference data. Reference data may be used in conjunction with the métier-applied data valuation framework (7). For example, where embodiments of the method may involve applicatively revaluing métier-relevant numerical input data (5) for an individual with a métier-applied data valuation framework (7), reference data may provide reference values against which métier-relevant numerical input data (5) for the individual may be revalued against. The reference values may represent data or information external of the individual in question for whom métier-relevant numerical input data (5) has been created, but that nevertheless may be relevant for evaluating that individual's effectiveness or suitability for a given métier undertaking. The utilization of reference data as described herein may be another example of a practical application and an improvement to the functioning of a computer as being achieved in a way fundamentally different than what a human could or would do as well as improving speed and accuracy of the same in a way that would be unachievable as a practical matter without computer implementation.

For example, embodiments of the method may involve utilizing historical reference data (14). Such historical reference data (14) may provide data pertaining to historical events or information that may be relevant in evaluating the effectiveness or suitability of the individual for a given métier undertaking. In some embodiments, historical reference data (14) may be feedback data, such as user feedback data or the like. Naturally, in various embodiments historical reference data (14) may be one or more numerical values, perhaps in some embodiments such as may have been assigned a value or values between zero and one inclusive. In system embodiments, a métier-applied data valuation framework processing element (8) may be a métier-applied data valuation framework processing element (8) configured to utilize historical reference data (14).

In embodiments where applicatively revaluing métier-relevant numerical input data (5) for an individual involves utilizing historical reference data (14), such utilizing may involve adjusting at least one numerical value of métier-relevant numerical input data (5) in response to such historical reference data (14), for example increasing a value of an historically effective variable, decreasing a value of an historically ineffective variable, or the like. In this manner, applicatively revaluing métier-relevant numerical input data (5) for an individual may take into account historical information represented by such historical reference data (14) that may tend to influence, affect, or otherwise be relevant to the effectiveness or suitability of the individual for a métier undertaking. Moreover, embodiments may involve discounting aged historical reference data (14), which may tend to devalue the weight, relevance, or the like of historical reference data (14), such as wherein older historical reference data (14) may have less weight, relevance, or the like as compared to newer historical reference data (14). In system embodiments, a métier-applied data valuation framework processing element (8) may be configured to adjust at least one numerical value of métier-relevant numerical input data (5) in response to historical reference data (14), such as configured to increase a value of an historically effective variable, configured to decrease a value of a historically ineffective variable, and the like, and system embodiments may involve an age-of-data historical reference data discount processing element (121).

Embodiments of the method also may involve utilizing group reference data (15). Where a plurality of individuals may work together in a group, group reference data (15) may be data pertaining to the effectiveness or suitability of the group, or perhaps the effectiveness or suitability of individuals in the group, for the métier undertaking in which the group may be involved. Examples of groups of individuals engaged in a métier undertaking may include building a team of individuals for a métier task, individuals seeking networking opportunities within the métier, individuals seeking mentorship opportunities within the métier, individuals seeking to refer métier business to other individuals within the métier, individuals seeking membership opportunities in métier associations, and the like. In embodiments of the method, applicatively revaluing métier-relevant numerical input data (5) for an individual may involve utilizing group reference data (15) where the effectiveness or the suitability of the individual is being evaluated in connection with a group métier undertaking, and applicatively ranking an individual by using the métier-applied revalued numerical data (9) for the individual may involve maximizing the aggregate effectiveness of the group of individuals, such as wherein group reference data (15) may be utilized to rank the individual as, for example, contributing to or weakening the effectiveness of the group. System embodiments may have an applicative data rank processing element (11) configured to maximize the aggregate effectiveness of the group of individuals and a métier-applied data valuation framework processing element (8) configured to utilize group reference data. In some embodiments, maximizing the aggregate effectiveness of a group of individuals may involve prompting a user to maximize the aggregate effectiveness of such a group of individuals, and a métier-applied data valuation framework processing element (8) configured to utilize group reference data (15) may be a métier-applied data valuation framework processing element (8) responsive to a user prompt.

In some embodiments, maximizing the aggregate effectiveness of a group of individuals may involve taking the sum of the highest métier-applied individual rank scores (10) for a plurality of individuals. For example, such a plurality of individuals may be a pool of candidates that composition of the group of individuals may be drawn from. Drawing such individuals from such plurality may be accomplished by using the highest métier-applied individual rank scores (10) for the needs of the group, which in some cases perhaps may be a simple sum of the highest métier-applied individual rank scores (10) from the plurality of individuals, or in other cases may be the sum of the highest such métier-applied individual rank scores (10) according to a more involved methodology. In some embodiments, applicatively ranking an individual may involve iteratively recasting a métier-applied individual rank score (10) for the individual to create a métier-applied iteratively recast individual rank score (10) for the individual, which may involve computer-implemented iteratively recasting a computer-generated métier-applied individual rank score (10). This may occur, for example, where individuals may be added to a group, the needs of the group may change accordingly, and further candidate individuals may be re-ranked in light of the same, the whole process perhaps occurring iteratively upon each addition of an individual to the group.

Maximizing the aggregate effectiveness of a group of individuals in some embodiments may involve utilizing the highest métier-applied iteratively recast individual rank score (10) among a plurality of individuals. In system embodiments, a métier-applied data valuation framework processing element (8) may be configured to take the sum of the highest métier-applied individual rank scores (10) for a plurality of individuals, an applicative data rank processing element (11) may be configured to iteratively recast one or more métier-applied individual rank scores (10) for one or more individuals to create one or more métier-applied iteratively recast individual rank scores (10) for such individual or individuals, and an applicative data rank processing element (11) may be configured to utilize the highest métier-applied iteratively recast individual rank score (10) or scores (10) among a plurality of individuals.

Embodiments of the method may involve iteratively developed reference data (16), which in embodiments may be computer-implemented iteratively developed reference data (16). Iteratively developed reference data (16) may be data generated by repeating a process, step, calculation, or the like as may be set forth, for example, in the method embodiments described herein. In some embodiments, data generated as output from such repetition may become the input for a subsequent iteration of such a repeated process, step, calculation, or the like.

For example, in various embodiments of the method, applicatively ranking an individual may involve iteratively recasting a métier-applied individual rank score (10) for the individual. Such a step of iteratively recasting may become necessary or desirable, for example, where reference data is newly generated that may make a prior rank score (10) for an individual obsolete. One example of this may occur in team-building métier applications, where the addition of individuals to a team may change the effectiveness or suitability of the previously ranked individual for the team, necessitating re-ranking of the individual. This, of course, should be understood as one illustrative and non-limiting example giving rise to a situation where iteratively developed reference data (16) may become necessary or desirable.

More generally, such situations may arise in a variety of métier applications such as networking métier applications, team-building métier applications, referrals métier applications, associations membership métier applications, mentorship métier applications, and the like. Various embodiments of the method accordingly may involve iteratively recasting a métier-applied individual rank score (10) for an individual in response to iteratively developed networking reference data, iteratively recasting a métier-applied individual rank score (10) for an individual in response to iteratively developed team-building reference data, iteratively recasting a métier-applied individual rank score (10) for an individual in response to iteratively developed referrals reference data, iteratively recasting a métier-applied individual rank score (10) for an individual in response to iteratively developed membership associations reference data, iteratively recasting a métier-applied individual rank score (10) for an individual in response to iteratively developed mentorship reference data, and the like.

In various embodiments, the method may involve generating antecedent iterative reference data (17) (which may involve computer-generating antecedent iterative reference data (17)), utilizing the antecedent iterative reference data (17) in a step of the method (which may involve utilizing computer-generated antecedent iterative reference data (17) in a computer-implemented step), and generating subsequent iterative reference data (18) as a result of using the antecedent iterative reference data (17) in such step in the method (which may involve computer-generating subsequent iterative reference data (18) as a result of a computer-implemented step). For example, iteratively recasting in various embodiments of the method may involve generating antecedent iterative reference data (17), utilizing the antecedent iterative reference data (17) in a step of applicatively revaluing, and generating subsequent iterative reference data (18) as a result of the step of applicatively revaluing. In some embodiments, utilizing antecedent iterative reference data (17) in a step of applicatively revaluing may involve adjusting at least one numerical value of métier-relevant numerical input data (5) in response to the antecedent iterative reference data (17). In various embodiments, it may be appreciated that subsequent iterative reference data (18) may be antecedent iterative reference data (17) for a next succeeding iteration.

In system embodiments, iteratively developed reference data (16) may be utilized by appropriate processing elements. For example, a métier-applied data valuation framework processing element (8) may be configured to iteratively recast a métier-applied individual rank score (10) for an individual and may be configured to utilize iteratively developed reference data (16) for the same, which in various embodiments may include iteratively developed networking reference data (16), iteratively developed team-building reference data (16), iteratively developed referrals reference data (16), iteratively developed associations membership reference data (16), iteratively developed mentorship reference data (16), and the like. In some embodiments, a métier-applied data valuation framework processing element (8) configured to utilize antecedent iterative reference data (18) with a métier-applied data valuation framework (7) may be a métier-applied data valuation framework processing element (8) configured to adjust at least one numerical value of métier-relevant numerical input data (5) in response to such antecedent iterative reference data (18).

Moreover, the iterative reference data as described herein may be another example of a practical application and an improvement to the functioning of a computer as being achieved in a way fundamentally different than what a human could or would do as well as improving speed and accuracy of the same in a way that would be unachievable as a practical matter without computer implementation.

Various embodiments of the method may involve utilizing at least one feedback point (19) in connection with any step of any method embodiment, such as may be described herein for the method, and which in embodiments may be a computer-implemented feedback point (19). A feedback point (19) may be a point in such a method at which feedback may be provided. For example, embodiments may involve providing feedback for use in conjunction with a step of obtaining métier-relevant psychological data (2) of an individual, obtaining métier-relevant objective data (42) of the individual, numericizing such data, applicatively revaluing numerical input data (5), applicatively ranking the individual, applying a métier-applied individual rank score (10) for the individual, and the like.

Feedback in various embodiments may be a reaction or response to a particular process or activity, for example as such processes or activities may be described for the method and system embodiments described herein, and may include evaluative information derived from such a reaction or response. The nature of feedback may be any as may be métier-relevant, métier-applied, or métier-methodized consistent with the inventive principles described herein.

A feedback point (19) in various embodiments may be at least one feedback point (19), multiple feedback points (19), multiple feedback points (19) from multiple users, multiple feedback points (19) from multiple automatic generation, multiple iterative feedback points (19), any of the foregoing in any combination, and the like. It also may be appreciated that feedback may be user generated feedback, such as provided by an individual using a method or system as may be described herein in any of its various embodiments, or may be automatically generated feedback, such as generated automatically by a system as may be described herein in any embodiment, or again, naturally any combination of the foregoing. Examples of user generated feedback in various embodiments may include a relationship statement, a user reported interaction outcome, a user reported behavioral tendency evaluation, a user reported peer value added evaluation, and the like. Examples of automatically generated feedback in various embodiments may include historical data feedback, data trend feedback, and the like. Embodiments may involve milestone feedback, which may be feedback solicited and/or obtained at milestone events, times, or the like, and which in embodiments may include periodic interval feedback, event milestone feedback, case milestone feedback, outcome feedback, and the like.

System embodiments may involve a feedback point (19) configured for utilization by at least one processing element, such as may have been previously described herein.

Embodiments of the method also may involve discounting aged feedback. This may involve reducing the weight, worth, relevance, and the like of feedback based on how old the feedback is. In some embodiments, such discounting may involve changing the value, such as a numerical value embodying the feedback, to reflect its decreased weight, worth, relevance, and the like due to its age. System embodiments may include an age-of-data feedback discount processing element (20) responsive to at least one feedback point (19).

Embodiments of the method also may involve utilizing feedback reference data (21), which in embodiments may be computer-implemented feedback reference data (21). Feedback reference data (21) may involve feedback information pertaining to the effectiveness or suitability of an individual, a group, or the like for a métier undertaking in which the individual, group, or the like may be involved. Such feedback reference data (21) may be utilized at any step of a method as perhaps described in various embodiments herein. For example, applicatively revaluing métier-relevant numerical input data (5) for an individual in some embodiments may involve utilizing feedback reference data (21). System embodiments may involve one or more processing elements configured to utilize feedback reference data (21), for example, a métier-applied data valuation framework processing element (8) may be configured to utilize feedback reference data (21). In some embodiments, at least one feedback point (19) may be multiple feedback points (19) and feedback reference data (21) may be a plurality of feedback reference data (21).

In some embodiments, utilizing feedback reference data (21) may involve the step of adjusting at least one numerical value of métier-relevant numerical input data (5) in response to such feedback reference data (21), and system embodiments may involve a métier-applied data valuation framework processing element (8) configured to adjust at least one numerical value of métier-relevant numerical input data (5) in response to such feedback reference data (21).

Embodiments of the method also may involve discounting aged feedback reference data (21). This may involve reducing the weight, worth, relevance, and the like of feedback reference data (21) based on how old the feedback reference data (21) is. In some embodiments, such discounting may involve changing the value, such as a numerical value embodying the feedback reference data (21), to reflect its decreased weight, worth, relevance, and the like due to its age. System embodiments may include an age-of-data feedback reference data discount processing element (124) responsive to at least one feedback point (19).

In some embodiments, a plurality of feedback reference data (21) may be iterative feedback reference data (21). Iterative feedback reference data (21) may be feedback reference data (21) generated by repeating a feedback process, feedback step, feedback calculation, or the like. Applicatively revaluing métier-relevant numerical input data (5) utilizing feedback reference data (21) in some embodiments may involve iteratively applicatively revaluing métier-relevant numerical input data (5) utilizing iterative feedback reference data (21) to create métier-applied iteratively revalued numerical data for an individual. System embodiments may involve a métier-applied data valuation framework processing element (8) configured to iteratively create métier-applied revalued numerical data (9) for an individual by applicatively revaluing métier-relevant numerical input data (5) for an individual with a métier-applied data valuation framework (7) utilizing such a plurality of iterative feedback reference data (21).

In some embodiments, iteratively applicatively revaluing métier-relevant numerical input data (5) may involve generating antecedent iterative feedback reference data (21), utilizing such antecedent iterative feedback reference data (21) in such step of applicatively revaluing, and generating subsequent iterative feedback reference data (21) as a result of such step of applicatively revaluing. System embodiments may involve a métier-applied data valuation framework processing element (8) configured to generate antecedent iterative feedback reference data (21), utilize such antecedent iterative feedback reference data (21) with a métier-applied data valuation framework (7), and generate subsequent iterative feedback reference data (21) with such métier-applied data valuation framework (7). In various embodiments, subsequent iterative feedback reference data (21) may be antecedent iterative feedback reference data (21) for a next succeeding iteration.

Moreover, such uses of feedback as described herein may be another example of a practical application and an improvement to the functioning of a computer as being achieved in a way fundamentally different than what a human could or would do as well as improving speed and accuracy of the same in a way that would be unachievable as a practical matter without computer implementation.

In various embodiments, feedback may be a two-axis score (22). A two-axis score (22) may be a form of feedback wherein the feedback value is reflected in two components capable of measure on two axes. For example, a two-axis score (22) may have a user-generated outcome score axis, as wherein a user may generate an outcome evaluation of a task or event capable of being plotted as a point along a first axis, and a user-generated difficulty score axis, as wherein a user may generate an evaluation of the difficulty of the task or event capable of being plotted as a point along a second axis.

Moreover, a two-axis score (22) may be for any kind of feedback or other information consistent with the inventive principles discussed herein capable of such measure on two axes, and in various embodiments may be for métier-related outcomes of any suitable kinds, such as métier-related case outcomes, métier-related project outcomes, métier-related effort outcomes, métier-related task outcomes, métier-related objective outcomes, métier-related activity outcomes, métier-related transaction outcomes, métier-related merger outcomes, métier-related purchase outcomes, métier-related sale outcomes, métier-related contract outcomes, métier-related team pursuit outcomes, métier-related negotiation outcomes, and the like. For example, where the métier is the legal profession, a two-axis score (22) may measure a legal case outcome, a legal project outcome, a legal effort outcome, a legal task outcome, a legal objective outcome, a legal activity outcome, a legal transaction outcome, a legal merger outcome, a legal purchase outcome, a legal sale outcome, a legal contract outcome, a legal team pursuit outcome, a legal negotiation outcome, and the like.

Method embodiments may involve displaying at least one two-axis score (22) as a data point (23) on a two-axis plot (24), and system embodiments may have a display processing element (25) configured to display at least one two-axis score (22) as a data point (23) on a two-axis plot (24).

In some embodiments, a data point (23) on a two-axis plot (24) may be a two-axis score (22) provided by a user, a two-axis score (22) averaged from multiple users, a two-axis score (22) averaged from multiple users that comprise a team, a two-axis score (22) averaged from multiple users that comprise multiple teams, and the like.

In some embodiments, a data point (23) may be a data point (23) selectable to view underlying constituent information of the data point (23). Such underlying constituent information generally may be any information about or relevant to or for the data point (23). For example, in embodiments underlying constituent information may be data used to generate the data point (23), metadata for the data point (23), relational aspects of the data point (23) to other data, and the like.

In some embodiments, displaying may involve displaying a plurality of two-axis scores (22) as a plurality of data points (23) on a two-axis plot (24). Any suitable grouping, selection, or organization of such data points (23) may be utilized consistent with the inventive principles discussed herein. For example, in a legal profession métier, such a plurality of data points (23) may be a plurality of data points (23) organized by attorney, a plurality of data points organized by case (23), and the like. System embodiments may involve a display processing element (25) configured to display a plurality of two-axis scores (22) as a plurality of data points (23) on a two-axis plot (24).

Embodiments may involve data analyzing a plurality of data points (23). Any such data analysis may be utilized consistent with the inventive principles described herein. For example, embodiments may involve analyzing a data trend, discounting aged data, temporally sorting data, and the like. System embodiments may involve a data analysis processing element (125) configured to data analyze a plurality of data points (23).

Naturally, it may be seen that the great variety of métiers and métier applications contemplated by the inventive technology discussed herein may give rise to a large number of possible embodiments for the use of two-axis scores (22), data points (23), two-axis plots (24), and related data analysis that may naturally follow from the needs, requirements, or implementations dictated by such métiers and métier applications.

The method in various embodiments may involve automatically updating at least one of any aspect of a method or system embodiment disclosed herein using self-generated métier-methodized data (41). Self-generated métier-methodized data (41) may be data generated in whole or in part by any method or system embodiment herein described. Updating may involve using such self-generated métier-methodized data (41) to improve, extend, or otherwise beneficially modify any such method or system embodiment. System embodiments may include an automated processing element configuration data update processing element (40) configured to use self-generated métier-methodized data (41) to update the configuration of at least one processing element. In various embodiments, self-generated métier-methodized data (41) may include historical reference data (14), feedback reference data (21), and the like including alone or in any combination. In various embodiments, automatically updating may involve utilizing artificial intelligence, expert systems, machine learning, neural networks, or the like. In conjunction with the high precision and specificity afforded by the métier-methodized methods and systems herein described and disclosed, such utilization may serve to dramatically enhance the efficacy of the métier-applied recommendations (12) useful for various kinds of particular métier applications as have been discussed herein.

As may be seen from the foregoing discussion, the methodologies and system elements utilized to reach the métier-applied recommendations (12) for the individual may be highly targeted to the needs or requirements of the particular métier application in question, in as much as they may reflect métier-relevant characteristics of the individual and métier-aspects specific to particular métier applications. They also naturally may be effectuated or implemented in any manner consistent with the inventive principles discussed herein.

One illustrative and non-limiting embodiment for such effectuation and implementation may involve the following. The illustrative and non-limiting example described as follows may be another example of a practical application and an improvement to the functioning of a computer as being achieved in a way fundamentally different than what a human could or would do as well as improving speed and accuracy of the same in a way that would be unachievable as a practical matter without computer implementation.

A métier-applied data valuation framework (7) may have at least one métier-trait-metric parameter (26). Such a parameter in some embodiments may have or consist of instruction information permitting manipulation of the métier trait metric for a given purpose, for example, the purpose for which the métier-applied data valuation framework (7) may revalue métier-relevant numerical input data (5), and in some embodiments such instruction information may involve generating, creating, or otherwise bringing into existence new or even new kinds of data, information, or the like that may not have existed before, for example, in some embodiments perhaps métier-applied data, information or the like that may provide new or even new kinds of métier-applied capabilities or utilities that may not have been possible prior to the inventive technology disclosed herein. Examples of such instruction information may include mathematical weighting, mathematical attenuation, one or more mathematical functions, numerical value lookups, and the like. It may be appreciated that the métier-applied data valuation framework (7) may have a plurality of such métier-trait-metric parameters (26), which may enable the data valuation framework (7) to revalue numerical input data (5) for multiple métier traits. A métier-trait-metric parameter (26) in embodiments may be a computer-implemented métier-trait-metric parameter (26).

Métier-relevant numerical input data (5) may be data paired métier-relevant numerical input data (5). A data pair may represent a data point or other unit of data as a pair of numerical values. For example, in various implementations of the illustrative embodiment a data pair may have a measured métier-metric numerical value and a corresponding time stamp numerical value.

Applicatively revaluing métier-relevant numerical input data (5) may involve performing a métier-trait-metric-parameter-specific mathematical operation (98) on at least one numerical value of the data paired métier-relevant numerical input data (5) to create an interim numerical data set (27). A métier-trait-metric-parameter-specific mathematical operation (98) in embodiments may be a computer-implemented métier-trait-metric-parameter-specific mathematical operation (98), and an interim numerical data set (27) in embodiments may be a computer-generated interim numerical data set (27). Illustrative embodiments of a system may include a métier-applied data valuation framework processing element (8) configured to give effect to such performing.

With attention to the métier-trait-metric-parameter-specific mathematical operation (98), such may be any as may be consistent with the inventive principles discussed herein suitable to accomplish the purpose of the data valuation framework (7), and in various implementations of the illustrative embodiment may include eliminating one or more data pairs of the data paired métier-relevant numerical input data (5), time-based eliminating one or more data pairs of the data paired métier-relevant numerical input data (5), age-of-data eliminating one or more data pairs of the data paired métier-relevant numerical input data (5), individually differentiated data pair weighting of the data paired métier-relevant numerical input data (5), and any combination of the foregoing.

Applicatively revaluing métier-relevant numerical input data (5) further may involve applying a métier-trait-metric-parameter-specific mathematical calculation (71) to the interim numerical data set (27) to create an interim métier-trait-metric parameter value (28). A métier-trait-metric-parameter-specific mathematical calculation (71) in embodiments may be a computer-implemented métier-trait-metric-parameter-specific mathematical calculation (71), and an interim métier-trait-metric parameter value (28) may be a computer-generated interim métier-trait-metric parameter value (28). Illustrative embodiments of a system may include a métier-applied data valuation framework processing element (8) configured to give effect to such applying.

With attention to the métier-trait-metric-parameter-specific mathematical calculation (71), such may be any as may be consistent with the inventive principles discussed herein suitable to accomplish the purpose of the data valuation framework (7), and in various implementations of the illustrative embodiment may include averaging at least some numerical values of said data paired métier-relevant numerical input data (5), averaging at least some measured métier-metric numerical values of said data paired métier-relevant numerical input data (5), finding a maximum of said measured métier-metric numerical values of said data paired métier-relevant numerical input data (5), and any combination of the foregoing.

Applicatively revaluing métier-relevant numerical input data (5) further may involve multiplying the interim métier-trait-metric parameter value (28) by a métier-trait-metric parameter weight (29) to create a weighted métier-trait-metric parameter value (30). A métier-trait-metric parameter weight (29) in embodiments may be a computer-generated métier-trait-metric parameter weight (29), and a weighted métier-trait-metric parameter value (30) in embodiments may be a computer-generated weighted métier-trait-metric parameter value (30). Illustrative embodiments of a system may include a métier-applied data valuation framework processing element (8) configured to give effect to such multiplying.

With further respect to the métier-trait-metric parameter weight (29), this may be established as a métier-trait-metric-parameter-specific relative parameter weight value (31) for the métier-trait-metric parameter (26) divided by the sum of the métier-trait-metric-parameter-specific relative parameter weight values (31) for each of all other métier-trait-metric parameters (26) of the métier-applied data valuation framework (7). A métier-trait-metric-parameter-specific relative parameter weight value (31) in embodiments may be a computer-implemented métier-trait-metric-parameter-specific relative parameter weight value (31). Illustrative embodiments of a system may include a métier-applied data valuation framework processing element (8) configured to give effect to such establishing. Moreover, the value for the métier-trait-metric-parameter-specific relative parameter weight value (31) may vary according to the purpose for which the data valuation framework (7) may revalue numerical input data (5). For example, the data valuation framework (7) may revalue numerical input data (5) for different kinds of métier applications, such as a networking métier application, a team-building métier application, a referrals métier application, a membership associations métier application, a mentorship métier application, and the like. The value for the métier-trait-metric-parameter-specific relative parameter weight value (31) may vary from one métier application to another, and may in this fashion reflect the importance of the métier trait for a given métier application.

Applicatively ranking may involve taking the sum of the weighted métier-trait-metric parameter values (30) for all of the métier-trait-metric parameters (26) of the métier-applied data valuation framework (7) divided by the sum of the métier-trait-metric parameter weights (29) for all of the métier-trait-metric parameters (26) of the métier-applied data valuation framework (7) to create a métier-applied individual rank score (10) for the individual. A métier-applied individual rank score (10) in embodiments may be a computer-generated métier-applied individual rank score (10). Illustrative embodiments of a system may include an applicative data rank processing element (11) configured to give effect to the same.

The illustrative embodiment in various implementations may be applicable to pluralities of individuals. For example, applicatively revaluing may involve applicatively revaluing for a plurality of such individuals, and applicatively ranking may involve applicatively ranking for a plurality of such individuals and may further involve métier-applied ordering a plurality of métier-applied individual rank scores (10) for a plurality of such individuals. Métier-applied ordering may involve ordering according to the needs or requirements of a particular métier application. Illustrative embodiments of a system may include a métier-applied data valuation framework processing element (8), an applicative data rank processing element (11), and a métier-applied data ordering processing element (39), each configured to give effect to the same.

The illustrative embodiment in various implementations may involve one or more kinds of reference data. Such reference data may include networking reference data (32), team-building reference data (33), referrals reference data (34), associations membership reference data (35), mentorship reference data (36), feedback reference data (21), historical reference data (14), group reference data (15), iteratively developed reference data (16), and the like, such as may be described herein. Such kinds of reference data may be métier-relevant numerical input reference data for various implementations of the illustrative embodiment, and applicatively revaluing in the illustrative embodiment may involve performing a métier-trait-metric-parameter-specific mathematical operation (98) on at least one numerical value of the métier-relevant numerical input reference data to create the interim numerical data set (27). Illustrative embodiments of a system may include a métier-applied data valuation framework processing element (8) configured to perform a métier-trait-metric-parameter-specific mathematical operation (98) on at least one numerical value of some or all of métier-relevant numerical input reference data (39) to create the interim numerical data set (27).

In various implementations of the illustrative embodiment, various aspects, processes, or steps of the illustrative embodiment may be axiom-implementing, as such may be described herein. For example, a métier-trait-metric-parameter-specific mathematical operation (98) may be an axiom-implementing métier-trait-metric-parameter-specific mathematical operation (98), a métier-trait-metric-parameter-specific mathematical calculation (71) may be an axiom-implementing métier-trait-metric-parameter-specific mathematical calculation (71), and the like.

In various implementations of the illustrative embodiment, various steps of the illustrative embodiment may be capable of update using self-generated métier-methodized data, as such may be described herein. For example, implementations of the illustrative embodiment may involve updating the métier-trait-metric-parameter-specific mathematical operation (98) using self-generated métier-methodized data, updating the métier-trait-metric-parameter-specific mathematical calculation (71) using self-generated métier-methodized data, and the like, which may include the utilization of artificial intelligence, expert systems, machine learning, neural networks, or the like. Illustrative embodiments of the system may include a métier-trait-metric-parameter-specific mathematical operation update data processing element (37) and a métier-trait-metric-parameter-specific mathematical calculation update data processing element (38) configured to give effect to such updating.

In the illustrative embodiment, it may be appreciated that each weighted métier-trait-metric parameter value (30) for each of all of the métier-trait-metric parameters (26) of the métier-applied data valuation framework (7) and each métier-trait-metric parameter weight (29) for each of all of the métier-trait-metric parameters (26) of the métier-applied data valuation framework (7) may be métier-applied revalued numerical data (9) for the individual.

At least one métier-trait-metric parameter (26) in embodiments may be a behavioral-tendency-similarity parameter (43). This may be a parameter tending to measure, quantify, or otherwise provide information pertaining to the similarity or dissimilarity two or more individuals may have for a given behavioral tendency. In some embodiments, a behavioral-tendency-similarity parameter (43) may tend to promote the association of individuals who are similar to one another for a given behavioral tendency. Any behavioral tendency may be made the subject of a behavioral-tendency-similarity parameter (43) consistent with the inventive principles discussed herein. For example, embodiments may involve a behavioral-tendency-similarity-for-assertiveness parameter (44), a behavioral-tendency-similarity-for-compassion parameter (45), a behavioral-tendency-similarity-for-creativity parameter (46), a behavioral-tendency-similarity-for-deliberation parameter (47), a behavioral-tendency-similarity-for-ethics parameter (48), a behavioral-tendency-similarity-for-open-mindedness parameter (49), a behavioral-tendency-similarity-for-passion parameter (50), a behavioral-tendency-similarity-for-perseverance parameter (51), a behavioral-tendency-similarity-for-pragmatism parameter (52), a behavioral-tendency-similarity-for-skepticism parameter (53), a behavioral-tendency-similarity-for-urgency parameter (54), a behavioral-tendency-similarity-for-wisdom parameter (55), and the like.

A behavioral-tendency-similarity parameter (43) may have a relative parameter weight (31) that may be a numerical value. The numerical value may be any as may be suitable for a given métier application. In some métier applications, the relative parameter weight (31) may be the numerical value 1.

Métier-relevant numerical input data (5) for a behavioral-tendency-similarity parameter (43) in embodiments may be a behavioral tendency score (56) or scores (56) for an individual or individuals. A behavioral tendency score (56) may be a value tending to measure, quantify, or otherwise provide information pertaining to a behavioral tendency for a given individual. Embodiments may involve a behavioral tendency score (56) or scores (56) being a numerical value or values, which in embodiments may be one or more numerical values between 0 and 1 inclusive. Embodiments also may involve such numerical values as representing minimum and maximum measures of a behavioral tendency score (56), which in some embodiments may be the numerical values 0 and 1 as such minimum and maximum, but for which any suitable numerical values may be used in embodiments to represent such minimum and maximum measures. Moreover, any behavioral tendency of an individual may be scored consistent with the inventive principles discussed herein. For example, embodiments may involve an assertiveness behavioral tendency score (57), a compassion behavioral tendency score (58), a creativity behavioral tendency score (59), a deliberation behavioral tendency score (60), an ethics behavioral tendency score (61), an open-mindedness behavioral tendency score (62), a passion behavioral tendency score (63), a perseverance behavioral tendency score (64), a pragmatism behavioral tendency score (65), a skepticism behavioral tendency score (66), an urgency behavioral tendency score (67), a wisdom behavioral tendency score (68), and the like.

A behavioral tendency score (56) may be calculated, determined, or otherwise obtained in any manner suitable consistent with the inventive principles discussed herein. Various embodiments may involve using a métier-methodized self-assessment query (69) for an individual. The métier-methodized self-assessment query (69) may inquire of or about one or more behavioral tendencies of the individual, and the individual may provide one or more métier-methodized self-assessment query responses (70). The responses may be or may be converted into one or more numerical values. Such numerical values may be or may be used to calculate, determine, or otherwise obtain a behavioral tendency score (56). For example, in some embodiments a behavioral tendency score (56) for an individual may be the quotient of a numerical value for all métier-methodized self-assessment query responses (70) of a métier-methodized self-assessment query (69) for the individual pertaining to a given behavioral tendency divided by a numerical value for all métier-methodized self-assessment query responses (70) for all behavioral tendencies inquired of by the métier-methodized self-assessment query (69) for the individual.

A behavioral tendency score (56) or scores (56) may be used in one or more métier-trait-metric-parameter specific mathematical operations or in one or more métier-trait-metric-parameter specific mathematical calculations. For example, in some embodiments a métier-trait-metric-parameter-specific mathematical calculation (71) may include subtracting a behavioral tendency score (56) for one individual from a behavioral tendency score (56) for another individual and taking the absolute value of the result. A métier-applied data valuation framework processing element (8) configured to apply a métier-trait-metric-parameter-specific mathematical calculation (71) in embodiments may include a métier-applied data valuation framework processing element (8) configured to subtract a behavioral tendency score (56) for one individual from a behavioral tendency score (56) for another individual and take the absolute value of the result.

At least one métier-trait-metric parameter (26) in embodiments may be a personality-harmony parameter (72). This may be a parameter tending to measure, quantify, or otherwise provide information on the aggregate behavioral tendencies of a plurality of individuals. In some embodiments, the parameter may promote a harmony of personalities among such plurality of individuals, such as wherein the aggregate behavioral tendencies of the plurality of individuals may not skew heavily or unduly towards one or another behavioral tendency or extreme of a behavioral tendency. Moreover, a personality-harmony parameter (72) in embodiments may have a relative parameter weight (31) that may be a numerical value. The numerical value may be any as may be suitable for a given métier or métier application. For example, the relative parameter weight (31) in various embodiments may be the numerical value 1.

Métier-relevant numerical input data (5) for a personality-harmony parameter (72) in embodiments may include a numerical value for each behavioral tendency inquired of by a métier-methodized self-assessment query (69) for a team-member candidate individual, and embodiments further may involve, for each member individual of a team or other plurality of individuals, a numerical value for each behavioral tendency inquired of by a métier-methodized self-assessment query (69) for such member individual of such team or other plurality of individuals.

A métier-trait-metric-parameter-specific mathematical calculation (71) may include taking the sum of all such numerical values for each such behavioral tendency for all such individuals to create a first set of numerical value sums, and taking the standard deviation of such first set of numerical value sums to obtain a first standard deviation value. A métier-applied data valuation framework processing element (8) configured to apply a métier-trait-metric-parameter-specific mathematical calculation (71) in embodiments may include a métier-applied data valuation framework processing element (8) configured to obtain a first standard deviation value in this manner.

A métier-trait-metric-parameter-specific mathematical calculation (71) further may include taking the sum of all such numerical values for each such behavioral tendency for all such member individuals of such team or other plurality of individuals to create a second set of numerical value sums, and taking the standard deviation of such second set of numerical value sums to obtain a second standard deviation value. A métier-applied data valuation framework processing element (8) configured to apply a métier-trait-metric-parameter-specific mathematical calculation (71) in embodiments may include a métier-applied data valuation framework processing element (8) configured to obtain a second standard deviation value in this manner.

A métier-trait-metric-parameter-specific mathematical calculation (71) further may include setting an interim métier-trait-metric parameter value (28) to a numerical value of 0 if such first standard deviation value is greater than such second standard deviation value and setting such interim métier-trait-metric parameter value in all other cases to a numerical value equal to the numerical value for the quotient of such first standard deviation value divided by such second standard deviation value, such quotient subtracted from the numerical value 1. A métier-applied data valuation framework processing element (8) configured to apply a métier-trait-metric-parameter-specific mathematical calculation (71) in embodiments may include a métier-applied data valuation framework processing element (8) configured to set an interim métier-trait-metric parameter value (28) to a numerical value in this manner.

While a personality-harmony parameter (72) may be described herein with respect to a team-member candidate individual and the individual members of a team, it may be appreciated that such description may be applied to any single individual with respect to any plurality of other individuals using the methods, principles, and techniques set forth in such description.

At least one métier-trait-metric parameter (26) in embodiments may be a network-composition parameter (73). This may be a parameter tending to measure, quantify, or otherwise provide information pertaining to aspects, characteristics, or other qualities of the other individuals in a given individual's network.

At least one métier-trait-metric parameter (26) in embodiments may be a team-composition parameter (74). This may be a parameter tending to measure, quantify, or otherwise provide information pertaining to aspects, characteristics, or other qualities of individuals on an existing, past, or prospective team.

Any such network composition or team composition aspects, characteristics, or other qualities may be made the subject of a network-composition parameter (73) or team-composition parameter (74) consistent with the inventive principles discussed herein.

For example, embodiments may involve a network-identity-composition parameter (75) or a team-identity composition parameter (76). A network-identity-composition parameter (75) may tend to measure, quantify, or otherwise provide information concerning identity groups in an individual's network, and a team-identity composition parameter (76) may tend to measure, quantify, or otherwise provide information concerning identity groups on a team. Such identity groups may be groups of individuals having a common identity, such as racial groups, ethnic groups, and the like. In some embodiments, a network-identity-composition parameter (75) or a team-identity-composition parameter (76) may tend to promote expanding an individual's network or the members on a team to include individuals from identity groups that may be underrepresented according to a given metric, such as for example an aspirational distribution for the identity group.

In another example, embodiments may involve a network-pronouns-composition parameter (77) or a team-pronouns-composition parameter (78). A network-pronouns-composition parameter (77) may tend to measure, quantify, or otherwise provide information concerning the distribution of individuals in an individual's network utilizing given pronouns, and a team-pronouns-composition parameter (78) may tend to measure, quantify, or otherwise provide information concerning the distribution of individuals on a team utilizing given pronouns. In some embodiments, a network-pronouns-composition parameter (77) or a team-pronouns-composition parameter (78) may tend to promote expanding an individual's network or the members on a team to include individuals using pronouns that may be underrepresented according to a given metric, such as for example an aspirational distribution for individuals using such pronouns.

For another example, embodiments may involve a network-age-composition parameter (79) or a team-age-composition parameter (80). A network-age-composition parameter (79) may tend to measure, quantify, or otherwise provide information concerning age groups of individuals in an individual's network, and a team-age-composition parameter (80) may tend to measure, quantify, or otherwise provide information concerning age groups of individuals on a team. In some embodiments, a network-age-composition parameter (79) or a team-age-composition parameter (80) may tend to promote expanding an individual's network or the members on a team to include individuals from age groups that may be underrepresented according to a given metric, such as for example an aspirational distribution for individuals having such ages. Age groups may be set into any suitable bins, ranges, or categories consistent with the inventive principles described herein.

A network-composition parameter (73) or a team-composition parameter (74) may have a relative parameter weight (31) that may be a numerical value. The numerical value may be any as may be suitable for a given métier application. For example, in a networking métier application, a relative parameter weight (31) may be the numerical value 3, and in a team-building métier application, the relative parameter weight (31) may be the numerical value 1.

Métier-relevant numerical input data (5) for a network-composition parameter (73) or a team-composition parameter (74) in embodiments may be a network composition match value (81) or a team composition match value (82). A network composition match value (81) or a team composition match value (82) may be a value corresponding to an aspect, characteristic, or other quality of an individual by which a network composition or team composition of such individuals may be described. For example, in various embodiments a network composition match value (81) or a team composition match value (82) may be an identity match value (83) for an individual (such as corresponding to a particular race, ethnicity, or like of the individual), may be a pronoun match value (84) for an individual (such as corresponding to particular pronouns an individual may utilize), may be an age match value (85) for an individual (such as corresponding to an age of an individual or a bin of ages or an age range within which the individual may fall), and the like.

Match values (99) may indicate a match or a disparity among individuals with respect to the aspect, characteristic, or other quality represented by the value. For example, in some embodiments match values (99) may be for specific identities, pronouns, ages, or the like. Individuals having the same identity, pronoun, age, or the like may have the same match value for such identity, pronoun, age, or the like, and individuals having disparate identities, pronouns, ages or the like may have different match values (99) for such identities, pronouns, ages, or the like. In this manner, match values (99) may be seen as capable of distinguishing matches and disparities for such aspects, characteristics, or other qualities among a pool such individuals.

A network composition match value (81) or values or a team composition match value (82) or values may be used in one or more métier-trait-metric-parameter specific mathematical operations or in one or more métier-trait-metric-parameter specific mathematical calculations. For example, in some embodiments network composition match values or team composition match values may be used to obtain the percentage of individuals in a given individual's network or on a team having the same network composition match value (81) or team composition match value (82) as the individual, such as the same identity match value, the same pronoun match value, the same age match value, or the like. A métier-trait-metric-parameter-specific mathematical calculation (71) may include setting an interim métier-trait-metric parameter value (28) to the numerical value of the difference obtained by subtracting the percentage of individuals in an individual's network or of a team having the same network composition match value (81) or team composition match value (82) from the percentage of individuals in a pool of individuals having the same network composition match value (81) or team composition match value (82) if such numerical value of such difference is greater than 0, and setting an interim métier-trait-metric parameter value (28) to a numerical value of 0 in all other cases. Any suitable pool of individuals may be used in connection with such a calculation. For example, in embodiments where a métier is the legal profession, such a pool of individuals may be a pool of lawyers in given geography or other kind of field or area, such as lawyers in the United States. A métier-applied data valuation framework processing element (8) configured to apply a métier-trait-metric-parameter-specific mathematical calculation (71) in embodiments may include a métier-applied data valuation framework processing element (8) configured to set an interim métier-trait-metric parameter value (28) to the numerical value of the difference obtained by subtracting the percentage of individuals in an individual's network or of a team having the same network composition match value (81) or team composition match value (82) from the percentage of individuals in a pool of individuals having the same network composition match value (81) or team composition match value (82) if such numerical value of such difference is greater than 0, and to set an interim métier-trait-metric parameter value (28) to a numerical value of 0 in all other cases.

It further may be appreciated that network-composition parameters (73) and team-composition parameters (74) herein described both may be examples pertaining to the compositions of a plurality or pluralities of individuals. The same principles, methodologies and techniques may be applicable to a plurality or pluralities of individuals of other kinds, and may be applicable to the utilization of a plurality-of-individuals-composition parameter.

At least one métier-trait-metric parameter (26) in embodiments may be a feedback parameter (86) or a feedback-scores parameter (87). These may be parameters tending to measure, quantify, or otherwise provide information pertaining to feedback for a given individual or plurality of individuals. In some embodiments, feedback parameters (86) or feedback-score parameters (87) may be utilized to promote individuals who are more highly rated by other individuals, to promote individuals more highly rated by a given individual, and the like, for example as may be relevant for a given métier, métier application, or the like. Any kinds of feedback for any kinds of individuals or pluralities of individuals may be utilized consistent with the inventive principles described herein. For example, embodiments may involve a feedback parameter (86), a networking-aspirant-for-networking-candidate-feedback-scores parameter (88), a networking-candidate-for-networking-aspirant-feedback-scores parameter (89), a team-member-candidate-feedback parameter (90), a referring-individual-for-referral-candidate-feedback-scores parameter (91), a referral-candidate-for-referring-individual-feedback-scores parameter (92), a mentee-aspirant-for-mentor-candidate-feedback-scores-parameter (93), a mentor-candidate-for-mentee-aspirant-feedback-scores parameter (94), a mentor-aspirant-for-mentee-candidate-feedback-scores parameter (95), a mentee-candidate-for-mentor-aspirant-feedback-scores parameter (96), and the like.

A feedback parameter (86) or feedback-scores parameter (87) may have a relative parameter weight (31) that may be a numerical value. The numerical value may be any as may be suitable for a given métier application. For example, the relative parameter weight (31) for a feedback parameter (86) or feedback scores parameter may be the numerical value 1. Métier-relevant numerical input data (5) for a feedback parameter (86) in embodiments may be a feedback score (97) or scores (97) for an individual or individuals. A feedback score (97) may be a value tending to measure, quantify, or otherwise provide information pertaining to feedback for a given individual. Embodiments may involve a feedback score (97) or scores (97) being a numerical value or values, which in embodiments may be one or more numerical values between 0 and 1 inclusive. Moreover, any kind of feedback of an individual may be scored consistent with the inventive principles discussed herein. For example, embodiments may involve a feedback score (97) or scores (97) for a networking candidate individual, a feedback score (97) or scores (97) given by a networking aspirant individual to a networking candidate individual, a feedback score (97) or scores (97) given by a networking candidate individual to a networking aspirant individual, a feedback score (97) or scores (97) for a team-member candidate individual, a feedback score (97) or scores (97) for a referral candidate individual, a feedback score (97) or scores (97) given by a referring individual to a referral candidate individual, a feedback score (97) or scores (97) given by a referral candidate individual to a referring individual, a feedback score (97) or scores (97) for a mentor candidate individual, a feedback score (97) or scores (97) given by a mentee aspirant individual to a mentor candidate individual, a feedback score (97) or scores (97) given by a mentor candidate individual to a mentee aspirant individual, a feedback score (97) or scores (97) for a mentee candidate individual, a feedback score (97) or scores (97) given by a mentor aspirant individual to a mentee candidate individual, a feedback score (97) or scores (97) given by a mentee candidate individual to a mentor aspirant individual, and the like.

A feedback score (97) or scores (97) in embodiments may be used in one or more métier-trait-metric-parameter specific mathematical operations or in one or more métier-trait-metric-parameter specific mathematical calculations.

For example, in some embodiments a métier-trait-metric-parameter-specific mathematical operation (98) may include creating an interim numerical data set (27) from or by using one or more feedback scores. Examples may include eliminating one or more feedback scores (97) older than a threshold age value and/or eliminating a feedback score (97) or scores (97) outside of a threshold interquartile range value. Such threshold age values and threshold interquartile range values may be any as may be suitable consistent with the inventive principles discussed herein and may, for example, be tailored for the needs or requirements of a métier application in connection with which the mathematical operation may be performed. For example, in some embodiments a threshold age value may be three months, one year, or the like, and in some embodiments a threshold interquartile range value may be +/−1.5 interquartile range for a given set of feedback scores (97). A métier-applied data valuation framework processing element (8) configured to perform a métier-trait-metric-parameter-specific mathematical operation (98) in embodiments may include a métier-applied data valuation framework processing element (8) configured to create said interim numerical data set (27) by eliminating any feedback score (97) older than a threshold age value, by eliminating any feedback score (97) outside of a threshold interquartile range value for said feedback scores (97), and the like.

In another example, some embodiments of a métier-trait-metric-parameter-specific mathematical calculation (71) may include taking the average of a set of feedback scores (97), such as feedback scores (97) of an interim numerical data set (27). A métier-applied data valuation framework processing element (8) configured to apply a métier-trait-metric-parameter-specific mathematical calculation (71) in embodiments may include a métier-applied data valuation framework processing element (8) configured to take the average of feedback scores (97) of an interim numerical data set (27).

Métier-trait-metric parameters (26) in embodiments may utilize match values (99). Match values (99) may correspond to an aspect, characteristic, or other quality of an individual by which comparison may be made to another individual to assess if such other individual has the same aspect, characteristic, or other such quality. In this manner, match values (99) may indicate a match or a disparity among individuals with respect to such aspect, characteristic, or other quality represented by the value. A match value (99) in some embodiments may be a tag, character, numerical value or the like coding for or otherwise indicating the presence or absence of such aspect, characteristic, or other quality.

At least one métier-trait-metric parameter (26) in embodiments may be a degrees-of-separation-parameter (126). This may be a parameter tending to measure, quantify, or otherwise provide information on whether one individual may know another individual through one or more colleagues. In some embodiments, such a parameter may be utilized to promote bringing together individuals who know, have familiarity with, or otherwise may have personal relationship connections with one another in a manner to beneficially advantage the contributions made by each individual to a collective métier undertaking. Degrees-of-separation parameters (126) may utilize colleague match values (127), such as wherein the match value may indicate whether or not given individuals have one or more colleagues in common. For example, in a networking métier application, métier-relevant numerical input data (5) may be a colleague match value (127) for a networking aspirant individual, and a networking candidate individual may have a colleague match value (127). In another example, in a referrals métier application, métier-relevant numerical input data (5) may be a colleague match value (127) for a referring individual, and a referral candidate individual may have a colleague match value (127). In another example, in a mentorship métier application, métier-relevant numerical input data (5) may be a colleague match value (127) for a mentee aspirant individual, and a mentor candidate individual may have a colleague match value (127). In another example, in a mentorship métier application, métier-relevant numerical input data (5) may be a colleague match value (127) for a mentor aspirant individual, and a mentee candidate individual may have a colleague match value (127). A métier-trait-metric-parameter-specific mathematical calculation (71) may include setting an interim métier-trait-metric parameter value (28) to a numerical value of 1 for colleague match values that indicate a colleague match and setting the interim métier-trait-metric parameter value (28) to a numerical value of 0 in all other cases. A colleague match may be indicated by colleague match values (127) in any suitable manner consistent with the inventive principles discussed herein, for example, as wherein specific values may code for, indicate, or otherwise identify specific persons as colleagues of individuals, and a colleague match may be indicated if two or more individuals have such specific values in common. In this manner, the parameter may be seen to promote associations of individuals having one or more colleagues in common. Moreover, a degrees-of-separation parameter (126) in embodiments may have a relative parameter weight (31) that may be a numerical value. The numerical value may be any as may be suitable for a given métier or métier application. For example, the relative parameter weight (31) in various embodiments may be the numerical value 1. A métier-applied data valuation framework processing element (8) configured to apply a métier-trait-metric-parameter-specific mathematical calculation (71) in embodiments may include a métier-applied data valuation framework processing element (8) configured to set an interim métier-trait-metric parameter value (28) to a numerical value of 1 for colleague match values that indicate a colleague match and to set the interim métier-trait-metric parameter value (28) to a numerical value of 0 in all other cases.

At least one métier-trait-metric parameter (26) in embodiments may be an average-degrees-of-separation-parameter (128). This may be a parameter tending to measure, quantify, or otherwise provide information on whether one individual may have one or more colleagues in common with a plurality of other individuals. In some embodiments, such a parameter may be utilized to promote bringing together an individual with a plurality of other individuals who know, have familiarity with, or otherwise may have personal relationship connections with one another in a manner to beneficially advantage the contributions made by each individual to a collective métier undertaking. Average-degrees-of-separation parameters (128) may utilize colleague match values (127), such as wherein the match value may indicate whether or not given individuals have one or more colleagues in common. For example, in a team-building métier application, métier-relevant numerical input data (5) may be colleague match values (127) for a team-member candidate individual for each individual member of a team. A métier-trait-metric-parameter-specific mathematical calculation (71) may include assigning a numerical value of 1 for colleague match values that indicate a colleague match and assigning a numerical value of 0 for colleague match values that do not indicate a colleague match and taking the average of said assigned numerical values. A colleague match may be indicated by colleague match values (127) in any suitable manner consistent with the inventive principles discussed herein, for example, as wherein specific values may code for, indicate, or otherwise identify specific persons as colleagues of individuals, and a colleague match may be indicated if two or more individuals have such specific values in common. In this manner, the parameter may be seen to promote bringing together an individual with a plurality of other individuals who may know, have familiarity with, or otherwise may have personal relationship connections in common with one another. Moreover, an average-degrees-of-separation parameter (128) in embodiments may have a relative parameter weight (31) that may be a numerical value. The numerical value may be any as may be suitable for a given métier or métier application. For example, the relative parameter weight (31) in various embodiments may be the numerical value 1. A métier-applied data valuation framework processing element (8) configured to apply a métier-trait-metric-parameter-specific mathematical calculation (71) in embodiments may include a métier-applied data valuation framework processing element (8) configured to assign a numerical value of 1 for colleague match values that indicate a colleague match and assign a numerical value of 0 for colleague match values that do not indicate a colleague match and take the average of said assigned numerical values.

At least one métier-trait-metric parameter (26) in embodiments may be a profession/field/specialty-coverage parameter (119). This may be a parameter tending to measure, quantify, or otherwise provide information on matches and disparities among individuals with respect to their professions, fields, and specialties for or relevant to a given métier or métier application. In some embodiments, this parameter may be utilized to promote bringing together individuals with diverse, varied, or complementary professions, fields, and specialties in a manner to beneficially advantage the contributions made by each individual to a collective métier undertaking. For example, in a networking métier application, métier-relevant numerical input data (5) may be a colleague profession/field/specialty match value (100) for a networking aspirant individual, and a networking candidate individual may have a profession/field/specialty match value (100). A métier-trait-metric-parameter-specific mathematical calculation (71) may include setting an interim métier-trait-metric parameter value (28) to a numerical value of 1 if the profession/field/specialty match values indicate a profession match and a field/specialty disparity and setting the interim métier-trait-metric parameter value (28) to a numerical value of 0 in all other cases. In this manner, the parameter may be seen to promote associations of individuals in the same profession but having different fields and/or specialties, thereby potentially promoting a network of individual professionals having diverse, varied, and complementary fields and specialties. Moreover, a profession/field/specialty-coverage parameter (119) in embodiments may have a relative parameter weight (31) that may be a numerical value. The numerical value may be any as may be suitable for a given métier or métier application. For example, the relative parameter weight (31) in various embodiments may be the numerical value 1. A métier-applied data valuation framework processing element (8) configured to apply a métier-trait-metric-parameter-specific mathematical calculation (71) in embodiments may include a métier-applied data valuation framework processing element (8) configured to set an interim métier-trait-metric parameter value (28) to a numerical value of 1 if profession/field/specialty match values indicate a profession match and a field/specialty disparity and to set an interim métier-trait-metric parameter value (28) to a numerical value of 0 in all other cases.

At least one métier-trait-metric parameter (26) in embodiments may be a team-field/specialty-complementarity parameter (101). This may be a parameter tending to measure, quantify, or otherwise provide information on matches and disparities among individuals on or for an existing, past, or prospective team with respect to their professions, fields, and specialties for or relevant to a given métier or métier application. In some embodiments, this parameter may be utilized to promote building a team having diverse, varied, or complementary professions, fields, and specialties in a manner to beneficially advantage the contributions made by each team member to the team. For example, in a team-building métier application, métier-relevant numerical input data (5) may be a profession/field/specialty match value (100) for a team-member candidate individual, and a team may have a profession/field/specialty match value (100). A métier-trait-metric-parameter-specific mathematical calculation (71) may include setting an interim métier-trait-metric parameter value (28) to a numerical value of 1 if the profession/field/specialty match values indicate a field/specialty match and a profession disparity and setting the interim métier-trait-metric parameter value (28) to a numerical value of 0 in all other cases. In this manner, the parameter may be seen to promote teams having members with common fields and specialties but differing professions, thereby potentially promoting a team having diverse, varied, and complementary professions for given fields and specialties. Moreover, a team-field/specialty-complementarity parameter (101) in embodiments may have a relative parameter weight (31) that may be a numerical value. The numerical value may be any as may be suitable for a given métier or métier application. For example, the relative parameter weight (31) in various embodiments may be the numerical value 1. A métier-applied data valuation framework processing element (8) configured to apply a métier-trait-metric-parameter-specific mathematical calculation (71) in embodiments may include a métier-applied data valuation framework processing element (8) configured to set an interim métier-trait-metric parameter value (28) to a numerical value of 1 if profession/field/specialty match values indicate a field/specialty match and a profession disparity and to set an interim métier-trait-metric parameter value (28) to a numerical value of 0 in all other cases.

At least one métier-trait-metric parameter (26) in embodiments may be an own-profession-coverage parameter (102). This may be a parameter tending to measure, quantify, or otherwise provide information on matches and disparities among individuals with respect to their professions, fields, and specialties for or relevant to a given métier or métier application. In some embodiments, this parameter may be utilized to promote bringing together individuals within the same profession having diverse, varied, or complementary fields and specialties in a manner to beneficially advantage the contributions made by such individuals to a collective métier undertaking. For example, in a networking métier application, métier-relevant numerical input data (5) may be a profession/field/specialty match value (100) for a networking aspirant individual, and a networking candidate individual may have a profession/field/specialty match value (100).

A métier-trait-metric-parameter-specific mathematical calculation (71) may include setting an interim métier-trait-metric parameter value (28) to a numerical value of 1 if the profession/field/specialty match values indicate a profession/field match and a specialty disparity and setting the interim métier-trait-metric parameter value (28) to a numerical value of 0 in all other cases. In this manner, the parameter may be seen to promote associations of individuals in the same profession and/or field but having different specialties, thereby potentially promoting a network of individual professionals having diverse, varied, and complementary specialties for given professions and/or fields. Moreover, an own-profession-coverage parameter (102) in embodiments may have a relative parameter weight (31) that may be a numerical value. The numerical value may be any as may be suitable for a given métier or métier application. For example, the relative parameter weight (31) in various embodiments may be the numerical value 1. A métier-applied data valuation framework processing element (8) configured to apply a métier-trait-metric-parameter-specific mathematical calculation (71) in embodiments may include a métier-applied data valuation framework processing element (8) configured to set an interim métier-trait-metric parameter value (28) to a numerical value of 1 if profession/field/specialty match values indicate a profession/field match and a specialty disparity and to set an interim métier-trait-metric parameter value (28) to a numerical value of 0 in all other cases.

At least one métier-trait-metric parameter (26) in embodiments may be a profession/region parameter (120). This may be a parameter tending to measure, quantify, or otherwise provide information on matches and disparities among individuals with respect to their professions and geographic locations for or relevant to a given métier or métier application. In some embodiments, this parameter may be utilized to promote bringing together individuals with diverse, varied, or complementary geographic regions in a manner to beneficially advantage the contributions made by each individual to a collective métier undertaking. For example, in a networking métier application, métier-relevant numerical input data (5) may be a profession/region match value (103) for a networking aspirant individual, and a networking candidate individual may have a profession/region match value (103). A métier-trait-metric-parameter-specific mathematical calculation (71) may include setting an interim métier-trait-metric parameter value (28) to a numerical value of 1 if the profession/region match values indicate a profession match and a region disparity and setting the interim métier-trait-metric parameter value (28) to a numerical value of 0 in all other cases. In this manner, the parameter may be seen to promote associations of individuals in the same profession but having different geographic locations, thereby potentially promoting a network of individual professionals having diverse, varied, and complementary geographies. Moreover, a profession/region parameter (120) in embodiments may have a relative parameter weight (31) that may be a numerical value. The numerical value may be any as may be suitable for a given métier or métier application. For example, the relative parameter weight (31) in various embodiments may be the numerical value 1. A métier-applied data valuation framework processing element (8) configured to apply a métier-trait-metric-parameter-specific mathematical calculation (71) in embodiments may include a métier-applied data valuation framework processing element (8) configured to set an interim métier-trait-metric parameter value (28) to a numerical value of 1 if profession/region match values indicate a profession match and a region disparity and to set an interim métier-trait-metric parameter value (28) to a numerical value of 0 in all other cases.

At least one métier-trait-metric parameter (26) in embodiments may be a years-of-practice parameter (104). This may be a parameter tending to measure, quantify, or otherwise provide information on matches and disparities among individuals with respect to their professions, fields, and years of practice within a profession, that may be for or relevant to a given métier or métier application. In some embodiments, this parameter may be utilized to promote bringing together individuals with diverse, varied, or complementary levels of experience within a field and/or profession in a manner to beneficially advantage the contributions made by each individual to a collective métier undertaking. For example, in a networking métier application, métier-relevant numerical input data (5) may be a profession/field/years-of-practice match value (105) for a networking aspirant individual, and a networking candidate individual may have a profession/field/years-of-practice match value (105). A métier-trait-metric-parameter-specific mathematical calculation (71) may include setting an interim métier-trait-metric parameter value (28) to a numerical value of 1 if the profession/field/years-of-practice match values indicate a profession/field match and a years-of-practice disparity and setting the interim métier-trait-metric parameter value (28) to a numerical value of 0 in all other cases. In this manner, the parameter may be seen to promote associations of individuals in the same profession and/or field but having different years of practice therein, thereby potentially promoting a network of individual professionals having diverse, varied, and complementary years of practice for a profession and/or field. Moreover, a years-of-practice parameter (104) in embodiments may have a relative parameter weight (31) that may be a numerical value. The numerical value may be any as may be suitable for a given métier or métier application. For example, the relative parameter weight (31) in various embodiments may be the numerical value 1. A métier-applied data valuation framework processing element (8) configured to apply a métier-trait-metric-parameter-specific mathematical calculation (71) in embodiments may include a métier-applied data valuation framework processing element (8) configured to set an interim métier-trait-metric parameter value (28) to a numerical value of 1 if profession/field/years-of-practice match values indicate a profession/field match and a years-of-practice disparity and to set an interim métier-trait-metric parameter value (28) to a numerical value of 0 in all other cases.

At least one métier-trait-metric parameter (26) in embodiments may be a team-years-of-practice parameter (106). This may be a parameter tending to measure, quantify, or otherwise provide information on matches and disparities among individuals on or for an existing, past, or prospective team with respect to their professions and years of practice therein that may be for or relevant to a given métier or métier application. In some embodiments, this parameter may be utilized to promote building a team having diverse, varied, or complementary levels of experience within a profession in a manner to beneficially advantage the contributions made by each team member to the team. For example, in a team-building métier application, métier-relevant numerical input data (5) may be a profession/years-of-practice match value (107) for a team-member candidate individual, and a team may have a profession/years-of-practice match value (107). A métier-trait-metric-parameter-specific mathematical calculation (71) may include setting an interim métier-trait-metric parameter value (28) to a numerical value of 1 if the profession/years-of-practice match values indicate a profession match and a years-of-practice disparity and setting the interim métier-trait-metric parameter value (28) to a numerical value of 0 in all other cases. In this manner, the parameter may be seen to promote teams having members with common professions but having different years of practice therein, thereby potentially promoting a team having diverse, varied, and complementary years of practice for a profession.

Moreover, a team-years-of-practice parameter (106) in embodiments may have a relative parameter weight (31) that may be a numerical value. The numerical value may be any as may be suitable for a given métier or métier application. For example, the relative parameter weight (31) in various embodiments may be the numerical value 1. A métier-applied data valuation framework processing element (8) configured to apply a métier-trait-metric-parameter-specific mathematical calculation (71) in embodiments may include a métier-applied data valuation framework processing element (8) configured to set an interim métier-trait-metric parameter value (28) to a numerical value of 1 if profession/years-of-practice match values indicate a profession match and a years-of-practice disparity and to set an interim métier-trait-metric parameter value (28) to a numerical value of 0 in all other cases.

At least one métier-trait-metric parameter (26) in embodiments may be a referral-field/specialty-complementarity parameter (108). This may be a parameter tending to measure, quantify, or otherwise provide information on matches and disparities among individuals with respect to their professions, fields, and specialties for or relevant to a given referral métier application. In some embodiments, this parameter may be utilized to promote bringing together individuals that match more referral requirements than other individuals. For example, in a referrals métier application, métier-relevant numerical input data (5) may be a profession/field/specialty match value (100) for a referring individual, and a referral candidate individual may have a profession/field/specialty match value (100). A métier-trait-metric-parameter-specific mathematical calculation (71) may include setting an interim métier-trait-metric parameter value (28) to a numerical value of 1 if the profession/field/specialty match values indicate a field/specialty match and setting the interim métier-trait-metric parameter value (28) to a numerical value of 0 in all other cases. In this manner, the parameter may be seen to promote associations of individuals in the same field and/or specialty, thereby potentially promoting referrals meeting referral requirements. Moreover, a referral-field/specialty-complementarity parameter (108) in embodiments may have a relative parameter weight (31) that may be a numerical value. The numerical value may be any as may be suitable for a given métier or métier application. For example, the relative parameter weight (31) in various embodiments may be the numerical value 1. A métier-applied data valuation framework processing element (8) configured to apply a métier-trait-metric-parameter-specific mathematical calculation (71) in embodiments may include a métier-applied data valuation framework processing element (8) configured to set an interim métier-trait-metric parameter value (28) to a numerical value of 1 if profession/field/specialty match values indicate a field/specialty match and to set an interim métier-trait-metric parameter value (28) to a numerical value of 0 in all other cases.

At least one métier-trait-metric parameter (26) in embodiments may be an association parameter (109). This may be a parameter tending to measure, quantify, or otherwise provide information on matches and disparities among individuals and associations contemplating the involvement of one with another, such as an individual seeking associations to become a member of, or associations seeking individuals to become members thereof. For example, in an associations membership métier application, métier-relevant numerical input data (5) may be an association parameter match value (110) for an association member aspirant individual and an association parameter match value (110) for a candidate association, may be an association parameter match value (110) for an association member candidate individual and an association parameter match value (110) for a membership aspirant association, and the like. A métier-trait-metric-parameter-specific mathematical calculation (71) may include setting an interim métier-trait-metric parameter value (28) to a numerical value of 1 if the association parameter match values indicate an association match and setting the interim métier-trait-metric parameter value (28) to a numerical value of 0 in all other cases. Association parameter match values may be selected to correspond to any aspect, characteristic, or other quality of an individual or association consistent with the inventive principles described herein. Moreover, an associations membership parameter in embodiments may have a relative parameter weight (31) that may be a numerical value. The numerical value may be any as may be suitable for a given métier or métier application. For example, the relative parameter weight (31) in various embodiments may be the numerical value 1. A métier-applied data valuation framework processing element (8) configured to apply a métier-trait-metric-parameter-specific mathematical calculation (71) in embodiments may include a métier-applied data valuation framework processing element (8) configured to set an interim métier-trait-metric parameter value (28) to a numerical value of 1 if association parameter match values indicate an association match and to set an interim métier-trait-metric parameter value (28) to a numerical value of 0 in all other cases.

At least one métier-trait-metric parameter (26) in embodiments may be an association-subgroup parameter (111). This may be a parameter tending to measure, quantify, or otherwise provide information on matches and disparities among individuals and association subgroups contemplating the involvement of one with another, such as an individual seeking association subgroups to become a member of, or association subgroups seeking individuals to become members thereof. For example, in an association subgroups membership métier application, métier-relevant numerical input data (5) may be an association subgroup parameter match value (112) for an association subgroups member aspirant individual and an association subgroup parameter match value (112) for a candidate association subgroup, may be an association subgroup parameter match value (112) for an association subgroups member candidate individual and an association subgroup parameter match value (112) for a membership aspirant association subgroup, and the like. A métier-trait-metric-parameter-specific mathematical calculation (71) may include setting an interim métier-trait-metric parameter value (28) to a numerical value of 1 if the association subgroup parameter match values indicate an association match and setting the interim métier-trait-metric parameter value (28) to a numerical value of 0 in all other cases. Association subgroup parameter match values may be selected to correspond to any aspect, characteristic, or other quality of an individual or association subgroup consistent with the inventive principles described herein. Moreover, an association subgroups membership parameter in embodiments may have a relative parameter weight (31) that may be a numerical value. The numerical value may be any as may be suitable for a given métier or métier application. For example, the relative parameter weight (31) in various embodiments may be the numerical value 1. A métier-applied data valuation framework processing element (8) configured to apply a métier-trait-metric-parameter-specific mathematical calculation (71) in embodiments may include a métier-applied data valuation framework processing element (8) configured to set an interim métier-trait-metric parameter value (28) to a numerical value of 1 if association parameter match values indicate an association match and to set an interim métier-trait-metric parameter value (28) to a numerical value of 0 in all other cases.

Métier-trait-metric parameters (26) in embodiments may utilize consensus success values (113) for related teams for an individual. A related team for an individual may be a team for which the individual is or was a team member, wherein the team is related to a different métier undertaking with which the individual may be involved. Such a relationship may be any as may be suitable or desirable consistent with the inventive principles discussed herein. In some embodiments, the relationship may be a match value (99) for the team and different métier undertaking that indicates a match, such as for example a field/specialty match value (114) for the team and a field/specialty match value (114) for the different métier undertaking that indicates a match. Examples of such different métier undertakings may be different related teams for which the individual may be a candidate team member, related referrals an individual may seek to make or receive, related mentorship opportunities the individual may be seeking, and the like. A consensus success value (113) for a team may be an average of feedback and/or feedback scores (97) for such team tending to measure, quantify, or otherwise provide information on the success of the team. Such feedback and/or feedback scores (97) may be given by or obtained from any individual or individuals suitable consistent with the inventive principles discussed herein, and in some embodiments may be feedback or feedback scores (97) given by or obtained from the team member individuals of the team in question. Such feedback or feedback scores (97) in embodiments may be a numerical value or values, and in some embodiments may be a numerical value of values between 0 and 1 inclusive. For multiple such feedback or feedback scores (97), embodiments may involve removing or eliminating one or more of such feedback or feedback scores (97), for example by eliminating or removing any feedback or feedback scores (97) given or obtained outside of a window of time for giving or obtaining such feedback or feedback scores (97), or for example by eliminating or removing any such feedback or feedback scores (97) falling outside of a threshold interquartile range value (which in embodiments may be +/−1.5 interquartile range for a given set of feedback or feedback scores (97)), or the like.

Métier-trait-metric parameters (26) in embodiments may be case-success parameters (115). Such parameters may tend to measure, quantify, or otherwise provide information on how likely an individual is to be successful in a métier undertaking. In some embodiments, case-success parameters (115) may utilize consensus success values (113) for related teams to measure, quantify, or otherwise provide information on such likelihood of success. Case-success parameters (115) may be utilized for any kinds of individuals engaged in any kinds of métier undertakings consistent with the inventive principles described herein.

At least one métier-trait-metric parameter (26) in embodiments may be a team-member-candidate-case-success parameter (116). This may be a parameter tending to measure, quantify, or otherwise provide information on how likely an individual is to be successful on a team engaged in a métier undertaking for which the individual is a candidate team member. For example, in a team-building métier application, métier-relevant numerical input data (5) may be one or more consensus success values (113) for related teams for a team-member candidate individual. Where there are a plurality of such consensus success values (113) for related teams, a métier-trait-metric-parameter-specific mathematical operation (98) may include creating an interim numerical data set (27) by eliminating any consensus success value (113) for related teams outside of a threshold interquartile range value for a plurality of such consensus success values (113) for related teams, which in some embodiments may be +/−1.5 interquartile range. A métier-trait-metric-parameter-specific mathematical calculation (71) may include taking the average of the consensus success values (113) for related teams of an interim numerical data set (27). Moreover, a team-member-candidate-case-success parameter (116) in embodiments may have a relative parameter weight (31) that may be a numerical value. The numerical value may be any as may be suitable for a given métier or métier application. For example, the relative parameter weight (31) in various embodiments may be the numerical value 1. A métier-applied data valuation framework processing element (8) configured to perform a métier-trait-metric-parameter-specific mathematical operation (98) in embodiments may include a métier-applied data valuation framework processing element (8) configured to create an interim numerical data set (27) by eliminating any consensus success value (113) for related teams outside of a threshold interquartile range value. A métier-applied data valuation framework processing element (8) configured to apply a métier-trait-metric-parameter-specific mathematical calculation (71) in embodiments may include a métier-applied data valuation framework processing element (8) configured to take the average of consensus success values (113) for related teams of an interim numerical data set (27).

At least one métier-trait-metric parameter (26) in embodiments may be a referral-candidate-case-success parameter (117). This may be a parameter tending to measure, quantify, or otherwise provide information on how likely a referral candidate individual is to be successful with respect to the matter or issue being referred. For example, in a referrals métier application, métier-relevant numerical input data (5) may be one or more consensus success values (113) for related teams for a referral candidate individual. Where there are a plurality of such consensus success values (113) for related teams, a métier-trait-metric-parameter-specific mathematical operation (98) may include creating an interim numerical data set (27) by eliminating any consensus success value (113) for related teams outside of a threshold interquartile range value for a plurality of such consensus success values (113) for related teams, which in some embodiments may be +/−1.5 interquartile range. A métier-trait-metric-parameter-specific mathematical calculation (71) may include taking the average of the consensus success values (113) for related teams of an interim numerical data set (27). Moreover, a referral-candidate-case-success parameter (117) in embodiments may have a relative parameter weight (31) that may be a numerical value. The numerical value may be any as may be suitable for a given métier or métier application. For example, the relative parameter weight (31) in various embodiments may be the numerical value 1. A métier-applied data valuation framework processing element (8) configured to perform a métier-trait-metric-parameter-specific mathematical operation (98) in embodiments may include a métier-applied data valuation framework processing element (8) configured to create an interim numerical data set (27) by eliminating any consensus success value (113) for related teams outside of a threshold interquartile range value. A métier-applied data valuation framework processing element (8) configured to apply a métier-trait-metric-parameter-specific mathematical calculation (71) in embodiments may include a métier-applied data valuation framework processing element (8) configured to take the average of consensus success values (113) for related teams of an interim numerical data set (27).

At least one métier-trait-metric parameter (26) in embodiments may be a mentor-candidate-case-success parameter (118). This may be a parameter tending to measure, quantify, or otherwise provide information on how likely a mentor candidate individual is to be successful with respect to mentoring a mentee aspirant individual. For example, in a mentorship métier application, métier-relevant numerical input data (5) may be one or more consensus success values (113) for related teams for a mentor candidate individual. Where there are a plurality of such consensus success values (113) for related teams, a métier-trait-metric-parameter-specific mathematical operation (98) may include creating an interim numerical data set (27) by eliminating any consensus success value (113) for related teams outside of a threshold interquartile range value for a plurality of such consensus success values (113) for related teams, which in some embodiments may be +/−1.5 interquartile range. A métier-trait-metric-parameter-specific mathematical calculation (71) may include taking the average of the consensus success values (113) for related teams of an interim numerical data set (27). Moreover, a mentor-candidate-case-success parameter (118) in embodiments may have a relative parameter weight (31) that may be a numerical value. The numerical value may be any as may be suitable for a given métier or métier application. For example, the relative parameter weight (31) in various embodiments may be the numerical value 1. A métier-applied data valuation framework processing element (8) configured to perform a métier-trait-metric-parameter-specific mathematical operation (98) in embodiments may include a métier-applied data valuation framework processing element (8) configured to create an interim numerical data set (27) by eliminating any consensus success value (113) for related teams outside of a threshold interquartile range value. A métier-applied data valuation framework processing element (8) configured to apply a métier-trait-metric-parameter-specific mathematical calculation (71) in embodiments may include a métier-applied data valuation framework processing element (8) configured to take the average of said consensus success values (113) for related teams of an interim numerical data set (27).

A métier-trait-metric parameter (26) in embodiments may be utilized for any given or given combination of métiers and métier applications consistent with the inventive principles discussed herein.

For example, in some embodiments a métier application may be networking, and a métier-applied data valuation framework (7) may be a métier-applied networking data valuation framework (7). Métier-trait-metric parameters (26) may be utilized for various individuals who may be involved in such networking, such as one or more networking aspirant individuals (who may be individuals aspiring, seeking, or otherwise investigating networking opportunities or relationships with other individuals in the métier), networking candidate individuals (who may be individuals that are candidates for, available for, or otherwise suitable for networking opportunities or relationships with other individuals in the métier), and the like.

As another example, in some embodiments a métier application may be team-building, and a métier-applied data valuation framework (7) may be a métier-applied team-building data valuation framework (7). Métier-trait-metric parameters (26) may be utilized for various individuals who may be involved in such team-building, such as one or more team-member candidate individuals (who may be individuals who are candidates for, available for, or otherwise suitable for being a member of a team engaged in activities or efforts in or pertaining to the métier), one or more individuals who are members of an existing, past, or prospective, team, and the like.

As another example, in some embodiments a métier application may be referrals, and a métier-applied data valuation framework (7) may be a métier-applied referrals data valuation framework (7). Métier-trait-metric parameters (26) may be utilized for various individuals who may be involved in such referrals, such as one or more referring individuals (who may be individuals aspiring, seeking, or otherwise investigating opportunities or availabilities with other individuals in the métier to whom a matter or issue may be referred), referral candidate individuals (who may be individuals that are candidates for, available for, or otherwise suitable for receiving or handling a matter or issue referred to by another individual in the métier), and the like.

As another example, in some embodiments a métier application may be mentorship, and a métier-applied data valuation framework (7) may be a métier-applied mentorship data valuation framework (7). Métier-trait-metric parameters (26) may be utilized for various individuals who may be involved in such mentorship, such as one or more mentee aspirant individuals (who may be individuals aspiring, seeking, or otherwise investigating opportunities or relationships to receive mentorship from other individuals in the métier), mentor candidate individuals (who may be individuals that are candidates for, available for, or otherwise suitable for providing mentorship to other individuals in the métier), mentor aspirant individuals (who may be individuals aspiring, seeking, or otherwise investigating opportunities or relationships to provide mentorship to other individuals in the métier), mentee candidate individuals (who may be individuals that are candidates for, available for, or otherwise suitable for receiving mentorship from other individuals in the métier), and the like.

As another example, in some embodiments a métier application may be associations membership, and a métier-applied data valuation framework (7) may be a métier-applied associations membership data valuation framework (7). Métier-trait-metric parameters (26) may be utilized for various individuals who may be involved in such associations memberships, such as one or more association member aspirant individuals (who may be individuals aspiring, seeking, or otherwise investigating opportunities or availabilities to join, participate in, or otherwise become associated with an association pertaining to or relevant for the métier), one or more candidate associations (which may be associations of individuals that are candidates for, available for, or otherwise suitable for membership relationships or opportunities with individuals in the métier), association member candidate individuals (who may be individuals that are candidates for, available for, or otherwise suitable for membership relationships or opportunities with an association pertaining to or relevant for the métier), one or more membership aspirant associations (which may be associations aspiring, seeking, or otherwise investigating individuals in the métier to join, participate in, or otherwise become associated with the association), and the like.

As another example, in some embodiments a métier application may be association subgroups membership, and a métier-applied data valuation framework (7) may be a métier-applied association subgroups membership data valuation framework (7). Métier-trait-metric parameters (26) may be utilized for various individuals who may be involved in such association subgroups memberships, such as one or more association subgroups member candidate individuals (who may be individuals that are candidates for, available for, or otherwise suitable for membership relationships or opportunities with an association subgroup pertaining to or relevant for the métier), one or more membership aspirant association subgroups (which may be association subgroups aspiring, seeking, or otherwise investigating individuals in the métier to join, participate in, or otherwise become associated with the association subgroup), and the like.

Another illustrative and non-limiting embodiment for the effectuation and implementation of the methodologies and system elements described herein may involve the following. The illustrative and non-limiting example described as follows may be another example of a practical application and an improvement to the functioning of a computer as being achieved in a way fundamentally different than what a human could or would do as well as improving speed and accuracy of the same in a way that would be unachievable as a practical matter without computer implementation.

A métier may be a métier profession or a métier avocation. The method steps and system elements described herein may utilize at least one manipulable-métier-specification. Such a métier-specification may set forth skills, temperaments, qualifications, or generally characteristics or aspects required for or from an individual to most successfully fulfill a métier undertaking to which the métier-specification may apply. Manipulation of the métier-specification may involve utilizing the specification to evaluate, assess, or otherwise analyze such skills, temperaments, qualifications, or general characteristics or aspects of the individual as they may relate to such a métier undertaking. A manipulable-métier-specification may be a métier-axiom-implementing manipulable-métier-specification. Such an axiom may be a premise, contention, observation, rule, tenet, theorem, principle, or the like that may provide predictive information on whether an individual may be effective or suitable for a given métier undertaking. In this manner, the manipulable-métier-specification may be seen to provide a practical means for testing an individual against an axiom with respect to the métier undertaking. A plurality of métier-axiom-implementing manipulable-métier-specifications may be utilized in an n-dimensional métier specification space. Such an n-dimensional métier specification space may have a plurality of dimensions represented by the number n wherein each dimension may represent a skill, temperament, qualification, or general characteristic or aspect of an individual that may relate to a métier undertaking and having a corresponding métier-axiom-implementing manipulable-métier-specification for the same. In this manner, it may be seen that as many métier-axiom-implementing manipulable-métier-specifications as may be necessary or desirable to fully evaluate, assess, or otherwise analyze skills, temperaments, qualifications, or general characteristics or aspects of an individual may be utilized to an unbounded value of n. A n-dimensional métier specification space may have an aggregate number of independently manipulable métier specification dimensions greater than 10, greater than 20, greater than 50, greater than 75, greater than 100, and encompassing an unbounded number of such dimensions. The capability for independent manipulation of each such métier-axiom-implementing manipulable-métier-specification may be seen to tend to permit the full and complete evaluation, assessment, or other analysis of each individual métier-axiom-implementing manipulable-métier-specification in the métier specification space without overlap or undue influence of other métier-axiom-implementing manipulable-métier-specification in the métier specification space. Independently manipulating each such métier-axiom-implementing manipulable-métier-specification in an n-dimensional métier specification space may be done utilizing métier hypotheses logic specific for the métier specification of each such dimension in the n-dimensional métier specification space. Such métier hypotheses logic may be the bases, principles, reasoning, or other methodologies by which the axiom underlying a métier-axiom-implementing manipulable-métier-specification is implemented in such métier-axiom-implementing manipulable-métier-specification. The capability of utilizing independent hypothesis logic specific for each métier specification may be seen to permit each such métier-axiom-implementing manipulable-métier-specification to be fully customized, dedicated, and specifically applicable to the skills, temperaments, qualifications, characteristics or aspects to which such métier-axiom-implementing manipulable-métier-specification pertains without overlap or undue influence of other métier-axiom-implementing manipulable-métier-specification in the métier specification space. A processing element or elements as described herein may be a processing element or elements configured to utilize at least one manipulable-métier-specification and configured to independently manipulate each métier-axiom-implementing manipulable-métier-specification in an n-dimensional métier specification space utilizing métier hypothesis logic specific for the métier specification of each such dimension in such n-dimensional métier specification space.

Another illustrative and non-limiting embodiment for the effectuation and implementation of the methodologies and system elements described herein may involve the following. The illustrative and non-limiting example described as follows may be another example of a practical application and an improvement to the functioning of a computer as being achieved in a way fundamentally different than what a human could or would do as well as improving speed and accuracy of the same in a way that would be unachievable as a practical matter without computer implementation.

In some embodiments, applicatively revaluing métier-relevant numerical input data (5) for an individual may involve identifying such individual as a métier type. A métier type may be a subset of aspects, qualities, or characteristics individuals may have within and relevant for a given métier that may distinguish them from different subsets of aspects, qualities, or characteristics that other individuals may have within and relevant for a given métier. In system embodiments, a métier-applied data valuation framework processing element (8) may be a métier-applied data valuation framework processing element (8) configured to identify a métier type for an individual. For example, in some embodiments a métier may be the legal profession, and identifying a métier type for an individual may involve identifying a lawyer type for an individual, such as identifying such individual as an advocate lawyer type, identifying such individual as a rainmaker lawyer type, identifying such individual as a litigator lawyer type, identifying such individual as an inspector lawyer type, and identifying such individual as a facilitator lawyer type. In system embodiments, a métier-applied data valuation framework processing element (8) may be configured to identify a lawyer type for an individual, to identify an individual as an advocate lawyer type, to identify an individual as a rainmaker lawyer type, to identify and individual as a litigator lawyer type, to identify an individual as an inspector lawyer type, and to identify an individual as a facilitator lawyer type.

In some embodiments, métier-relevant numerical input data (5) may be métier-relevant numerical input data (5) for métier-relevant psychological data (2) of an individual and may include a numerical assertiveness value between 0 and 1 inclusive, a numerical compassion value between 0 and 1 inclusive, a numerical creativity value between 0 and 1 inclusive, a numerical dependability value between 0 and 1 inclusive, a numerical ethicalness value between 0 and 1 inclusive, a numerical open-mindedness value between 0 and 1 inclusive, a numerical passion value between 0 and 1 inclusive, a numerical perseverance value between 0 and 1 inclusive, a numerical pragmatism value between 0 and 1 inclusive, a numerical resilience value between 0 and 1 inclusive, a numerical trust value between 0 and 1 inclusive, and a numerical wisdom value between 0 and 1 inclusive.

Given lawyer types may have given numerical value metrics in various embodiments. For example, in some embodiments a rainmaker lawyer type may have a numerical assertiveness value, a numerical pragmatism value, a numerical creativity value, and a numerical resilience value, an advocate lawyer type may have a numerical perseverance value, a numerical compassion value, a numerical ethicalness value, a numerical passion value, and a numerical trust value; a litigator lawyer type may have a numerical creativity value, a numerical pragmatism value, a numerical open-mindedness value, and a numerical wisdom value; a facilitator lawyer type may have a numerical pragmatism value, a numerical perseverance value, a numerical dependability value, and a numerical resilience value, an inspector lawyer type may have a numerical open-mindedness value, a numerical perseverance value, a numerical dependability value, and a numerical resilience value.

In some embodiments, identifying a lawyer type for an individual may involve summing the numerical value metrics for each lawyer type and identifying such individual as the lawyer type having the highest such sum. System embodiments may have a métier-applied data valuation framework processing element (8) configured to sum such numerical value metrics for each such lawyer type and identify an individual as such lawyer type having the highest such sum.

While the present inventive technology has been described in connection with some preferred embodiments, it is not intended to limit the scope of the inventive technology to the particular form set forth, but on the contrary, it is intended to cover such alternatives, modifications, and equivalents, as may be included within the spirit and scope of the inventive technology as defined by the statements of inventions. Examples of alternative claims may include:

1. A method for fulfilling a vacant métier role for a particular métier application with a métier-methodized recommended individual comprising the steps of:
prompting said individual for a plurality of métier-specific behavioral tendency data of said individual with a métier-methodized behavioral tendency self-assessment query for said individual;
prompting said individual for a plurality of métier-specific objective data of said individual with a métier-methodized objective data self-assessment query for said individual;
creating a set of métier-specific numerical input data for said individual from said métier-specific behavioral tendency data of said individual and said métier-specific objective data of said individual by assigning a numerical value to each self-assessment query response of said individual to each said self-assessment query for said individual;
numericizing said set of métier-specific numerical input data for said individual in an n-dimensional space wherein each dimension of said n-dimensional space represents a métier trait metric corresponding to each said behavioral tendency of said individual and each said objective datum for said individual inquired of by said self-assessment queries for said individual;
inputting said numericized n-dimensional spaced métier-specific numerical input data for said individual into a computer-implemented métier-applied data valuation framework having a number of computer-implemented métier-trait-metric parameters n corresponding to each dimension n of said n-dimensional space;
performing a computer-implemented métier-trait-metric-parameter-specific mathematical operation with each said computer-implemented métier-trait-metric parameter on at least one numerical value of said numericized n-dimensional spaced métier-specific numerical input data for said computer-implemented métier-trait-metric parameter to create a computer-generated interim numerical data set for said computer-implemented métier-trait-metric parameter;
applying a computer-implemented métier-trait-metric-parameter-specific mathematical calculation with each said computer-implemented métier-trait-metric parameter to said computer-generated interim numerical data set for said computer-implemented métier-trait-metric parameter to create a computer-generated interim métier-trait-metric parameter value for each said computer-implemented métier-trait-metric parameter;
multiplying said computer-generated interim métier-trait-metric parameter value for each said computer-implemented métier-trait-metric parameter by a computer-generated métier-trait-metric parameter weight for said computer-implemented métier-trait-metric parameter to create a computer-generated weighted métier-trait-metric parameter value for each said computer-implemented métier-trait-metric parameter, wherein each said computer-generated métier-trait-metric parameter weight for each said computer-implemented métier-trait-metric parameter is established as a computer-implemented métier-trait-metric-parameter-specific relative parameter weight value for said computer-implemented métier-trait-metric parameter divided by the sum of the computer-implemented métier-trait-metric-parameter-specific relative parameter weight values for all computer-implemented métier-trait-metric parameters of said computer-implemented métier-applied data valuation framework;
taking the sum of the computer-generated weighted métier-trait-metric parameter values for all said computer-implemented métier-trait-metric parameters of said computer-implemented métier-applied data valuation framework divided by the sum of the computer-generated métier-trait-metric parameter weights for all said computer-implemented métier-trait-metric parameters of said computer-implemented métier-applied data valuation framework to create a computer-generated métier-applied individual rank score for said individual;
comparing said computer-generated métier-applied individual rank score for said individual to at least one computer-generated métier-applied individual rank score for another individual to create a computer-generated métier-applied recommendation for said individual relevant to a vacant métier role for a particular métier application;
fulfilling said vacant métier role for a particular métier application with said individual based on said computer-generated métier-applied recommendation for said individual.

2. A method for fulfilling a vacant métier role for a particular métier application with a métier-methodized recommended individual as described in clause 1 or any other clause wherein said métier application comprises a métier application selected from métier networking, métier referrals, métier team-building, métier associations membership, métier leadership development, and métier vendors.

3. A method for fulfilling a vacant métier role for a particular métier application with a métier-methodized recommended individual as described in clause 1 or any other clause wherein said métier-specific behavioral tendency data comprises métier-specific behavioral tendency data selected from data pertaining to the trait of assertiveness, data pertaining to the trait of compassion, data pertaining to the trait of creativity, data pertaining to the trait of dependability, data pertaining to the trait of ethicalness, data pertaining to the trait of open-mindedness, data pertaining to the trait of passion, data pertaining to the trait of perseverance, data pertaining to the trait of pragmatism, data pertaining to the trait of resilience, data pertaining to the trait of trust, data pertaining to the trait of wisdom, and any combination of the foregoing.

4. A method for fulfilling a vacant métier role for a particular métier application with a métier-methodized recommended individual as described in clause 1 or any other clause wherein said métier-specific objective data comprises métier-specific objective data selected from first name data, last name data, nickname data, vocation data, avocation data, location data, personal photo data, pronouns data, birthdate data, race data, ethnicity data, skills data, certifications data, training data, endorsements data, recommendations data, mentorship roles data, and any combination of the foregoing.

5. A method for fulfilling a vacant métier role for a particular métier application with a métier-methodized recommended individual as described in clause 1 or any other clause wherein said métier comprises the legal profession and wherein said métier-specific objective data comprises métier-specific objective data selected from law firm data, field of law data, legal specialty area data, state licensing data, practice geography data, law school data, legal education data, year of bar admission data, desired case type data, recent case overview data, recent case results data, and any combination of the foregoing.

6. A method for fulfilling a vacant métier role for a particular métier application with a métier-methodized recommended individual as described in clause 1 or any other clause wherein said step of performing a computer-implemented métier-trait-metric-parameter-specific mathematical operation comprises the step of performing a computer-implemented métier-trait-metric-parameter-specific mathematical operation selected from the steps of eliminating one or more data pairs of data paired métier-relevant numerical input data, time-based eliminating one or more data pairs of data paired métier-relevant numerical input data, age-of-data eliminating one or more data pairs of data paired métier-relevant numerical input data, individually differentiated data pair weighting of data paired métier-relevant numerical input data, and any combination of the foregoing.

7. A method for fulfilling a vacant métier role for a particular métier application with a métier-methodized recommended individual as described in clause 1 or any other clause wherein said computer-implemented métier-trait-metric-parameter-specific mathematical operation comprises an axiom-implementing computer-implemented métier-trait-metric-parameter-specific mathematical operation.

8. A method for fulfilling a vacant métier role for a particular métier application with a métier-methodized recommended individual as described in clause 1 or any other clause wherein said step of applying a computer-implemented métier-trait-metric-parameter-specific mathematical calculation comprises the step of applying a computer-implemented métier-trait-metric-parameter-specific mathematical calculation selected from the steps of averaging at least some numerical values of data paired métier-relevant numerical input data, averaging at least some measured métier-metric numerical values of data paired métier-relevant numerical input data, finding a maximum of measured métier-metric numerical values of data paired métier-relevant numerical input data, and any combination of the foregoing.

9. A method for fulfilling a vacant métier role for a particular métier application with a métier-methodized recommended individual as described in clause 1 or any other clause wherein said computer-implemented métier-trait-metric-parameter-specific mathematical calculation comprises an axiom-implementing computer-implemented métier-trait-metric-parameter-specific mathematical calculation.

10. A method for fulfilling a vacant métier role for a particular métier application with a métier-methodized recommended individual as described in clause 1 or any other clause wherein said step of comparing said computer-generated métier-applied individual rank score for said individual to at least one computer-generated métier-applied individual rank score for another individual to create a computer-generated métier-applied recommendation for said individual relevant to a vacant métier role for a particular métier application comprises the step of maximizing the aggregate effectiveness of a group of individuals.

11. A method for fulfilling a vacant métier role for a particular métier application with a métier-methodized recommended individual as described in clause 10 or any other clause wherein said step of maximizing the aggregate effectiveness of a group of individuals comprises the step of taking the sum of the highest computer-generated meter-applied individual rank scores for a plurality of individuals.

12. A method for fulfilling a vacant métier role for a particular métier application with a métier-methodized recommended individual as described in clause 1 or any other clause wherein said step of comparing said computer-generated métier-applied individual rank score for said individual to at least one computer-generated métier-applied individual rank score for another individual to create a computer-generated métier-applied recommendation for said individual relevant to a vacant métier role for a particular métier application comprises the step of computer-implemented iteratively recasting said computer-generated métier-applied individual rank score for said individual.

13. A method for fulfilling a vacant métier role for a particular métier application with a métier-methodized recommended individual as described in clause 12 or any other clause wherein said step of computer-implemented iteratively recasting said computer-generated métier-applied individual rank score for said individual comprises a step selected from computer-implemented iteratively recasting said computer-generated métier-applied individual rank score for said individual in response to computer-implemented iteratively developed networking reference data, computer-implemented iteratively recasting said computer-generated métier-applied individual rank score for said individual in response to computer-implemented iteratively developed team-building reference data, computer-implemented iteratively recasting said computer-generated métier-applied individual rank score for said individual in response to computer-implemented iteratively developed referrals reference data, computer-implemented iteratively recasting said computer-generated métier-applied individual rank score for said individual in response to computer-implemented iteratively developed associations membership reference data, and computer-implemented iteratively recasting said computer-generated métier-applied individual rank score for said individual in response to computer-implemented iteratively developed mentorship reference data.

14. A method for fulfilling a vacant métier role for a particular métier application with a métier-methodized recommended individual as described in clause 12 or any other clause wherein said step of computer-implemented iteratively recasting said computer-generated métier-applied individual rank score for said individual comprises the steps of:
computer-generating antecedent iterative reference data;
utilizing said computer-generated antecedent iterative reference data in a step of computer-implemented applicatively revaluing at least some said métier-specific numerical input data for said individual; and
computer-generating subsequent iterative reference data as a result of said step of computer-implemented applicatively revaluing at least some said métier-specific numerical input data for said individual.

15. A method for fulfilling a vacant métier role for a particular métier application with a métier-methodized recommended individual as described in clause 14 or any other clause wherein said computer-generated subsequent iterative reference data comprises computer-generated antecedent iterative reference data for a next succeeding iteration.

16. A method for fulfilling a vacant métier role for a particular métier application with a métier-methodized recommended individual as described in clause 14 or any other clause wherein said step of utilizing said computer-generated antecedent iterative reference data in a step of computer-implemented applicatively revaluing at least some said métier-specific numerical input data for said individual comprises the step of computer-implemented adjusting at least one numerical value of said métier-specific numerical input data in response to said computer-generated antecedent iterative reference data.

17. A method for fulfilling a vacant métier role for a particular métier application with a métier-methodized recommended individual as described in clause 1 or any other clause further comprising the step of utilizing at least one computer-implemented feedback point in connection with any said step.

18. A method for fulfilling a vacant métier role for a particular métier application with a métier-methodized recommended individual as described in clause 17 or any other clause wherein said at least one computer-implemented feedback point comprises multiple computer-implemented feedback points selected from multiple computer-implemented feedback points from multiple users, multiple computer-implemented feedback points from multiple automatic generation, multiple computer-implemented iterative feedback points, and any combination of the foregoing.

19. A method for fulfilling a vacant métier role for a particular métier application with a métier-methodized recommended individual as described in clause 17 or any other clause wherein said feedback comprises computer-implemented feedback reference data and further comprising the step of computer-implemented applicatively revaluing at least some said métier-specific numerical input data for said individual utilizing said computer-implemented feedback reference data.

20. A method for fulfilling a vacant métier role for a particular métier application with a métier-methodized recommended individual as described in clause 19 or any other clause wherein said step of utilizing said computer-implemented feedback reference data comprises the step of computer-implemented adjusting at least one numerical value of said métier-specific numerical input data for said individual in response to said computer-implemented feedback reference data.

21. A method of métier-methodized ranking of individuals for a particular métier application comprising the steps of:
obtaining métier-relevant psychological data of an individual with a métier-methodized capture of individual psychological information of said individual;
obtaining métier-relevant objective data of said individual with a métier-methodized capture of objective information of said individual;
numericizing said métier-relevant psychological data of said individual and said métier-relevant objective data of said individual to create métier-relevant numerical input data for said individual;
applicatively revaluing said métier-relevant numerical input data for said individual by inputting said métier-relevant numerical input data for said individual into a métier-applied data valuation framework to create métier-applied revalued numerical data for said individual;
applicatively ranking said individual by using said métier-applied revalued numerical data for said individual to create a métier-applied individual rank score for said individual;
applying said métier-applied individual rank score for said individual to create a métier-applied recommendation for said individual useful for said particular métier application.

22. A method of métier-methodized ranking of individuals for a particular métier application as described in clause 21 or any other clause wherein said métier application comprises a métier application selected from métier networking, métier referrals, métier team-building, métier associations membership, métier leadership development, and métier vendors.

23. A method of métier-methodized ranking of individuals for a particular métier application as described in clause 21 or any other clause wherein said step of obtaining métier-relevant psychological data comprises the step of obtaining métier-specific psychological data.

24. A method of métier-methodized ranking of individuals for a particular métier application as described in clause 23 wherein said step of obtaining métier-specific psychological data comprises the step of obtaining behavioral tendency data.

25. A method of métier-methodized ranking of individuals for a particular métier application as described in clause 24 or any other clause wherein said métier comprises the legal profession and wherein said step of obtaining behavioral tendency data comprises the step of obtaining behavioral tendency data selected from data pertaining to the trait of assertiveness, data pertaining to the trait of compassion, data pertaining to the trait of creativity, data pertaining to the trait of dependability, data pertaining to the trait of ethicalness, data pertaining to the trait of open-mindedness, data pertaining to the trait of passion, data pertaining to the trait of perseverance, data pertaining to the trait of pragmatism, data pertaining to the trait of resilience, data pertaining to the trait of trust, data pertaining to the trait of wisdom, and any combination of the foregoing.

26. A method of métier-methodized ranking of individuals for a particular métier application as described in clause 21 or any other clause wherein said step of obtaining métier-relevant psychological data of an individual with a métier-methodized capture of individual psychological information of said individual comprises the step of prompting said individual with a métier-methodized self-assessment query.

27. A method of métier-methodized ranking of individuals for a particular métier application as described in clause 26 or any other clause wherein said métier-methodized self-assessment query comprises slider pairs.

28. A method of métier-methodized ranking of individuals for a particular métier application as described in clause 27 or any other clause wherein said slider pairs comprise behavioral tendency metric slider pairs.

29. A method of métier-methodized ranking of individuals for a particular métier application as described in clause 27 or any other clause wherein said métier comprises the legal profession and wherein said slider pairs comprise slider pairs selected from assertiveness versus modesty, compassion versus cruelty, creativity versus unimaginativeness, dependability versus unreliability, ethicalness versus corruption, open-mindedness versus unreceptiveness, passion versus indifference, perseverance versus procrastination, pragmatism versus irrationality, trust versus skepticism, and wisdom versus ignorance.

30. A method of métier-methodized ranking of individuals for a particular métier application as described in clause 26 or any other clause wherein said métier-methodized self-assessment query comprises either/or questions.

31. A method of métier-methodized ranking of individuals for a particular métier application as described in clause 26 or any other clause wherein said either/or questions comprise behavioral tendency metric either/or questions.

32. A method of métier-methodized ranking of individuals for a particular métier application as described in clause 28 or any other clause wherein said métier comprises the legal profession and wherein said either/or questions comprise either/or questions selected from creativity versus pragmatism, trust versus assertiveness, ethics versus perseverance, open-mindedness versus wisdom, passion versus compassion, resilience versus dependability.

33. A method of métier-methodized ranking of individuals for a particular métier application as described in clause 26 or any other clause wherein said métier-methodized self-assessment query comprises ranking questions.

34. A method of métier-methodized ranking of individuals for a particular métier application as described in clause 33 or any other clause wherein said ranking questions comprise behavioral tendency metric ranking questions.

35. A method of métier-methodized ranking of individuals for a particular métier application as described in clause 34 or any other clause wherein said métier comprises the legal profession and wherein said ranking questions comprise ranking questions selected from the group consisting of:
ranking dependability, perseverance, and open-mindedness;
ranking compassion, assertiveness, pragmatism, and trustworthiness; and
ranking resilience, ethics, passion, and wisdom.

36. A method of métier-methodized ranking of individuals for a particular métier application as described in clause 21 or any other clause wherein said step of obtaining métier-relevant objective data comprises the step of obtaining métier-relevant objective data selected from first name data, last name data, nickname data, vocation data, avocation data, location data, personal photo data, pronouns data, birthdate data, race data, ethnicity data, skills data, certifications data, training data, endorsements data, recommendations data, mentorship roles data, and any combination of the foregoing.

37. A method of métier-methodized ranking of individuals for a particular métier application as described in clause 36 or any other clause wherein said métier comprises the legal profession and wherein said step of obtaining métier-relevant objective data comprises the step of obtaining métier-relevant objective data selected from law firm data, field of law data, legal specialty area data, state licensing data, practice geography data, law school data, legal education data, year of bar admission data, desired case type data, recent case overview data, recent case results data, and any combination of the foregoing.

38. A method of métier-methodized ranking of individuals for a particular métier application as described in clause 21 or any other clause wherein said step of obtaining métier-relevant objective data of an individual with a métier-methodized capture of objective information of said individual comprises the step of prompting said individual with a métier-methodized self-assessment query.

39. A method of métier-methodized ranking of individuals for a particular métier application as described in clause 21 or any other clause wherein said step of numericizing comprises the step of assigning a numerical value to at least one métier-methodized self-assessment query response.

40. A method of métier-methodized ranking of individuals for a particular métier application as described in clause 39 or any other clause wherein said at least one métier-methodized self-assessment query response comprises a métier trait metric.

41. A method of métier-methodized ranking of individuals for a particular métier application as described in clause 40 or any other clause further comprising the step of equalizing the number of métier-methodized self-assessment queries for each said métier trait metric.

42. A method of métier-methodized ranking of individuals for a particular métier application as described in clause 40 or any other clause wherein said métier comprises the legal profession and wherein said at least one métier trait metric comprises a behavioral tendency metric.

43. A method of métier-methodized ranking of individuals for a particular métier application as described in clause 40 or any other clause wherein said métier comprises the legal profession and wherein said step of numericizing comprises the step of creating a set of numerical values for behavioral tendencies.

44. A method of métier-methodized ranking of individuals for a particular métier application as described in clause 40 or any other clause wherein said step of assigning a numerical value comprises the step of assigning a numerical value between 0 and 1 inclusive.

45. A method of métier-methodized ranking of individuals for a particular métier application as described in clause 40 or any other clause wherein said step of numericizing said métier-relevant psychological data of said individual and said métier-relevant objective data of said individual to create métier-relevant numerical input data for said individual comprises the step of normalizing said métier-relevant psychological data of said individual and said métier-relevant objective data of said individual to create métier-relevant normalized numerical input data for said individual.

46. A method of métier-methodized ranking of individuals for a particular métier application as described in clause 45 or any other clause wherein said métier-relevant normalized numerical input data for said individual comprises métier-relevant normalized numerical input data for said individual selected from scalable numerical input data for said individual, symmetrical numerical input data for said individual, and any combination of the foregoing.

47. A method of métier-methodized ranking of individuals for a particular métier application as described in clause 40 or any other clause wherein said step of numericizing comprises the step of assigning a plurality of numerical values to an n-dimensional space.

48. A method of métier-methodized ranking of individuals for a particular métier application as described in clause 47 or any other clause wherein each dimension of said n-dimensional space represents a métier trait metric.

49. A method of métier-methodized ranking of individuals for a particular métier application as described in clause 47 or any other clause wherein said métier comprises the legal profession and wherein said n-dimensional space comprises a plurality of behavioral tendency dimensions.

50. A method of métier-methodized ranking of individuals for a particular métier application as described in clause 49 or any other clause wherein said behavioral tendency dimensions comprise behavioral tendency dimensions selected from assertiveness, compassion, creativity, dependability, ethicalness, open-mindedness, passion, perseverance, pragmatism, resilience, trust, wisdom, and any combination of the foregoing.

51. A method of métier-methodized ranking of individuals for a particular métier application as described in clause 39 or any other clause wherein said step of numericizing comprises the step of creating a numerical matrix.

52. A method of métier-methodized ranking of individuals for a particular métier application as described in clause 21 or any other clause wherein said métier-relevant numerical input data for said individual comprises métier-relevant numerical input data for at least one métier trait metric for said individual.

53. A method of métier-methodized ranking of individuals for a particular métier application as described in clause 52 or any other clause wherein said métier comprises the legal profession and wherein said métier trait metric comprises a behavioral tendency metric.

54. A method of métier-methodized ranking of individuals for a particular métier application as described in clause 52 or any other clause wherein said step of applicatively revaluing comprises the step of applicatively revaluing at least one numerical value of said métier-relevant numerical input data from an initial value between 0 and 1 inclusive to an adjusted value between 0 and 1 inclusive.

55. A method of métier-methodized ranking of individuals for a particular métier application as described in clause 52 or any other clause wherein said métier-applied data valuation framework comprises at least one métier-trait-metric parameter, wherein said métier-relevant numerical input data comprises data paired métier-relevant numerical input data, and wherein said step of applicatively revaluing comprises the steps of:
performing a métier-trait-metric-parameter-specific mathematical operation on at least one numerical value of said data paired métier-relevant numerical input data to create an interim numerical data set;
applying a métier-trait-metric-parameter-specific mathematical calculation to said interim numerical data set to create an interim métier-trait-metric parameter value;
multiplying said interim métier-trait-metric parameter value by a métier-trait-metric parameter weight to create a weighted métier-trait-metric parameter value, wherein said métier-trait-metric parameter weight is established as a métier-trait-metric-parameter-specific relative parameter weight value for said métier-trait-metric parameter divided by the sum of the métier-trait-metric-parameter-specific relative parameter weight values for each of all other métier-trait-metric parameters of said métier-applied data valuation framework.

56. A method of métier-methodized ranking of individuals for a particular métier application as described in clause 55 or any other clause:
wherein said métier comprises the legal profession;
wherein said métier application comprises networking;
wherein said métier-applied data valuation framework comprises a métier-applied networking data valuation framework; and
wherein said individual comprises a networking aspirant individual.

57. A method of métier-methodized ranking of individuals for a particular métier application as described in clause 56 or any other clause:
wherein said at least one métier-trait-metric parameter comprises a behavioral-tendency-similarity-for-assertiveness parameter;
wherein said métier-relevant numerical input data for said individual comprises an assertiveness behavioral tendency score for said networking aspirant individual and further comprising an assertiveness behavioral tendency score for a networking candidate individual, each said behavioral tendency score comprising a numerical value between 0 and 1 inclusive;
wherein said métier-trait-metric-parameter-specific mathematical calculation comprises subtracting said assertiveness behavioral tendency score for said networking candidate individual from said assertiveness behavioral tendency score for said networking aspirant individual and taking the absolute value of the result; and
wherein said relative parameter weight comprises the numerical value 1.

58. A method of métier-methodized ranking of individuals for a particular métier application as described in clause 57 or any other clause wherein each said assertiveness behavioral tendency score for each said individual comprises the quotient of a numerical value for all métier-methodized self-assessment query responses of a métier-methodized self-assessment query for said individual pertaining to an assertiveness behavioral tendency divided by a numerical value for all métier-methodized self-assessment query responses for all behavioral tendencies inquired of by said métier-methodized self-assessment query for said individual.

59. A method of métier-methodized ranking of individuals for a particular métier application as described in clause 56 or any other clause:
wherein said at least one métier-trait-metric parameter comprises a behavioral-tendency-similarity-for-compassion parameter;
wherein said métier-relevant numerical input data for said individual comprises a compassion behavioral tendency score for said networking aspirant individual and further comprising a compassion behavioral tendency score for a networking candidate individual, each said behavioral tendency score comprising a numerical value between 0 and 1 inclusive;
wherein said métier-trait-metric-parameter-specific mathematical calculation comprises subtracting said compassion behavioral tendency score for said networking candidate individual from said compassion behavioral tendency score for said networking aspirant individual and taking the absolute value of the result; and wherein said relative parameter weight comprises the numerical value 1.

60. A method of métier-methodized ranking of individuals for a particular métier application as described in clause 59 or any other clause wherein each said compassion behavioral tendency score for each said individual comprises the quotient of a numerical value for all métier-methodized self-assessment query responses of a métier-methodized self-assessment query for said individual pertaining to a compassion behavioral tendency divided by a numerical value for all métier-methodized self-assessment query responses for all behavioral tendencies inquired of by said métier-methodized self-assessment query for said individual.

61. A method of métier-methodized ranking of individuals for a particular métier application as described in clause 56 or any other clause:
wherein said at least one métier-trait-metric parameter comprises a behavioral-tendency-similarity-for-creativity parameter;
wherein said métier-relevant numerical input data for said individual comprises a creativity behavioral tendency score for said networking aspirant individual and further comprising a creativity behavioral tendency score for a networking candidate individual, each said behavioral tendency score comprising a numerical value between 0 and 1 inclusive;
wherein said métier-trait-metric-parameter-specific mathematical calculation comprises subtracting said creativity behavioral tendency score for said networking candidate individual from said creativity behavioral tendency score for said networking aspirant individual and taking the absolute value of the result; and
wherein said relative parameter weight comprises the numerical value 1.

62. A method of métier-methodized ranking of individuals for a particular métier application as described in clause 61 or any other clause wherein each said creativity behavioral tendency score for each said individual comprises the quotient of a numerical value for all métier-methodized self-assessment query responses of a métier-methodized self-assessment query for said individual pertaining to a creativity behavioral tendency divided by a numerical value for all métier-methodized self-assessment query responses for all behavioral tendencies inquired of by said métier-methodized self-assessment query for said individual.

63. A method of métier-methodized ranking of individuals for a particular métier application as described in clause 56 or any other clause:
wherein said at least one métier-trait-metric parameter comprises a behavioral-tendency-similarity-for-deliberation parameter;
wherein said métier-relevant numerical input data for said individual comprises a deliberation behavioral tendency score for said networking aspirant individual and further comprising a deliberation behavioral tendency score for a networking candidate individual, each said behavioral tendency score comprising a numerical value between 0 and 1 inclusive;
wherein said métier-trait-metric-parameter-specific mathematical calculation comprises subtracting said deliberation behavioral tendency score for said networking candidate individual from said deliberation behavioral tendency score for said networking aspirant individual and taking the absolute value of the result; and
wherein said relative parameter weight comprises the numerical value 1.

64. A method of métier-methodized ranking of individuals for a particular métier application as described in clause 63 or any other clause wherein each said deliberation behavioral tendency score for each said individual comprises the quotient of a numerical value for all métier-methodized self-assessment query responses of a métier-methodized self-assessment query for said individual pertaining to a deliberation behavioral tendency divided by a numerical value for all métier-methodized self-assessment query responses for all behavioral tendencies inquired of by said métier-methodized self-assessment query for said individual.

65. A method of métier-methodized ranking of individuals for a particular métier application as described in clause 56 or any other clause:
wherein said at least one métier-trait-metric parameter comprises a behavioral-tendency-similarity-for-ethics parameter;
wherein said métier-relevant numerical input data for said individual comprises an ethics behavioral tendency score for said networking aspirant individual and further comprising an ethics behavioral tendency score for a networking candidate individual, each said behavioral tendency score comprising a numerical value between 0 and 1 inclusive;
wherein said métier-trait-metric-parameter-specific mathematical calculation comprises subtracting said ethics behavioral tendency score for said networking candidate individual from said ethics behavioral tendency score for said networking aspirant individual and taking the absolute value of the result; and
wherein said relative parameter weight comprises the numerical value 1.

66. A method of métier-methodized ranking of individuals for a particular métier application as described in clause 65 or any other clause wherein each said ethics behavioral tendency score for each said individual comprises the quotient of a numerical value for all métier-methodized self-assessment query responses of a métier-methodized self-assessment query for said individual pertaining to an ethics behavioral tendency divided by a numerical value for all métier-methodized self-assessment query responses for all behavioral tendencies inquired of by said métier-methodized self-assessment query for said individual.

67. A method of métier-methodized ranking of individuals for a particular métier application as described in clause 56 or any other clause:
wherein said at least one métier-trait-metric parameter comprises a behavioral-tendency-similarity-for-open-mindedness parameter;
wherein said métier-relevant numerical input data for said individual comprises an open-mindedness behavioral tendency score for said networking aspirant individual and further comprising an open-mindedness behavioral tendency score for a networking candidate individual, each said behavioral tendency score comprising a numerical value between 0 and 1 inclusive;
wherein said métier-trait-metric-parameter-specific mathematical calculation comprises subtracting said open-mindedness behavioral tendency score for said networking candidate individual from said open-mindedness behavioral tendency score for said networking aspirant individual and taking the absolute value of the result; and
wherein said relative parameter weight comprises the numerical value 1.

68. A method of métier-methodized ranking of individuals for a particular métier application as described in clause 67 or any other clause wherein each said open-mindedness behavioral tendency score for each said individual comprises the quotient of a numerical value for all métier-methodized self-assessment query responses of a métier-methodized self-assessment query for said individual pertaining to an open-mindedness behavioral tendency divided by a numerical value for all métier-methodized self-assessment query responses for all behavioral tendencies inquired of by said métier-methodized self-assessment query for said individual.

69. A method of métier-methodized ranking of individuals for a particular métier application as described in clause 56 or any other clause:
wherein said at least one métier-trait-metric parameter comprises a behavioral-tendency-similarity-for-passion parameter;
wherein said métier-relevant numerical input data for said individual comprises a passion behavioral tendency score for said networking aspirant individual and further comprising a passion behavioral tendency score for a networking candidate individual, each said behavioral tendency score comprising a numerical value between 0 and 1 inclusive;
wherein said métier-trait-metric-parameter-specific mathematical calculation comprises subtracting said passion behavioral tendency score for said networking candidate individual from said passion behavioral tendency score for said networking aspirant individual and taking the absolute value of the result; and
wherein said relative parameter weight comprises the numerical value 1.

70. A method of métier-methodized ranking of individuals for a particular métier application as described in clause 69 or any other clause wherein each said passion behavioral tendency score for each said individual comprises the quotient of a numerical value for all métier-methodized self-assessment query responses of a métier-methodized self-assessment query for said individual pertaining to a passion behavioral tendency divided by a numerical value for all métier-methodized self-assessment query responses for all behavioral tendencies inquired of by said métier-methodized self-assessment query for said individual.

71. A method of métier-methodized ranking of individuals for a particular métier application as described in clause 56 or any other clause:
wherein said at least one métier-trait-metric parameter comprises a behavioral-tendency-similarity-for-perseverance parameter;
wherein said métier-relevant numerical input data for said individual comprises a perseverance behavioral tendency score for said networking aspirant individual and further comprising a perseverance behavioral tendency score for a networking candidate individual, each said behavioral tendency score comprising a numerical value between 0 and 1 inclusive;
wherein said métier-trait-metric-parameter-specific mathematical calculation comprises subtracting said perseverance behavioral tendency score for said networking candidate individual from said perseverance behavioral tendency score for said networking aspirant individual and taking the absolute value of the result; and
wherein said relative parameter weight comprises the numerical value 1.

72. A method of métier-methodized ranking of individuals for a particular métier application as described in clause 71 or any other clause wherein each said perseverance behavioral tendency score for each said individual comprises the quotient of a numerical value for all métier-methodized self-assessment query responses of a métier-methodized self-assessment query for said individual pertaining to a perseverance behavioral tendency divided by a numerical value for all métier-methodized self-assessment query responses for all behavioral tendencies inquired of by said métier-methodized self-assessment query for said individual.

73. A method of métier-methodized ranking of individuals for a particular métier application as described in clause 56 or any other clause:
wherein said at least one métier-trait-metric parameter comprises a behavioral-tendency-similarity-for-pragmatism parameter;
wherein said métier-relevant numerical input data for said individual comprises a pragmatism behavioral tendency score for said networking aspirant individual and further comprising a pragmatism behavioral tendency score for a networking candidate individual, each said behavioral tendency score comprising a numerical value between 0 and 1 inclusive;
wherein said métier-trait-metric-parameter-specific mathematical calculation comprises subtracting said pragmatism behavioral tendency score for said networking candidate individual from said pragmatism behavioral tendency score for said networking aspirant individual and taking the absolute value of the result; and
wherein said relative parameter weight comprises the numerical value 1.

74. A method of métier-methodized ranking of individuals for a particular métier application as described in clause 73 or any other clause wherein each said pragmatism behavioral tendency score for each said individual comprises the quotient of a numerical value for all métier-methodized self-assessment query responses of a métier-methodized self-assessment query for said individual pertaining to a pragmatism behavioral tendency divided by a numerical value for all métier-methodized self-assessment query responses for all behavioral tendencies inquired of by said métier-methodized self-assessment query for said individual.

75. A method of métier-methodized ranking of individuals for a particular métier application as described in clause 56 or any other clause:
wherein said at least one métier-trait-metric parameter comprises a behavioral-tendency-similarity-for-skepticism parameter;
wherein said métier-relevant numerical input data for said individual comprises a skepticism behavioral tendency score for said networking aspirant individual and further comprising a skepticism behavioral tendency score for a networking candidate individual, each said behavioral tendency score comprising a numerical value between 0 and 1 inclusive;
wherein said métier-trait-metric-parameter-specific mathematical calculation comprises subtracting said skepticism behavioral tendency score for said networking candidate individual from said skepticism behavioral tendency score for said networking aspirant individual and taking the absolute value of the result; and
wherein said relative parameter weight comprises the numerical value 1.

76. A method of métier-methodized ranking of individuals for a particular métier application as described in clause 75 or any other clause wherein each said skepticism behavioral tendency score for each said individual comprises the quotient of a numerical value for all métier-methodized self-assessment query responses of a métier-methodized self-assessment query for said individual pertaining to a skepticism behavioral tendency divided by a numerical value for all métier-methodized self-assessment query responses for all behavioral tendencies inquired of by said métier-methodized self-assessment query for said individual.

77. A method of métier-methodized ranking of individuals for a particular métier application as described in clause 56 or any other clause:
wherein said at least one métier-trait-metric parameter comprises a behavioral-tendency-similarity-for-urgency parameter;
wherein said métier-relevant numerical input data for said individual comprises an urgency behavioral tendency score for said networking aspirant individual and further comprising an urgency behavioral tendency score for a networking candidate individual, each said behavioral tendency score comprising a numerical value between 0 and 1 inclusive;
wherein said métier-trait-metric-parameter-specific mathematical calculation comprises subtracting said urgency behavioral tendency score for said networking candidate individual from said urgency behavioral tendency score for said networking aspirant individual and taking the absolute value of the result; and
wherein said relative parameter weight comprises the numerical value 1.

78. A method of métier-methodized ranking of individuals for a particular métier application as described in clause 77 or any other clause wherein each said urgency behavioral tendency score for each said individual comprises the quotient of a numerical value for all métier-methodized self-assessment query responses of a métier-methodized self-assessment query for said individual pertaining to an urgency behavioral tendency divided by a numerical value for all métier-methodized self-assessment query responses for all behavioral tendencies inquired of by said métier-methodized self-assessment query for said individual.

79. A method of métier-methodized ranking of individuals for a particular métier application as described in clause 56 or any other clause:
wherein said at least one métier-trait-metric parameter comprises a behavioral-tendency-similarity-for-wisdom parameter;
wherein said métier-relevant numerical input data for said individual comprises a wisdom behavioral tendency score for said networking aspirant individual and further comprising a wisdom behavioral tendency score for a networking candidate individual, each said behavioral tendency score comprising a numerical value between 0 and 1 inclusive;
wherein said métier-trait-metric-parameter-specific mathematical calculation comprises subtracting said wisdom behavioral tendency score for said networking candidate individual from said wisdom behavioral tendency score for said networking aspirant individual and taking the absolute value of the result; and
wherein said relative parameter weight comprises the numerical value 1.

80. A method of métier-methodized ranking of individuals for a particular métier application as described in clause 79 or any other clause wherein each said wisdom behavioral tendency score for each said individual comprises the quotient of a numerical value for all métier-methodized self-assessment query responses of a métier-methodized self-assessment query for said individual pertaining to a wisdom behavioral tendency divided by a numerical value for all métier-methodized self-assessment query responses for all behavioral tendencies inquired of by said métier-methodized self-assessment query for said individual.

81. A method of métier-methodized ranking of individuals for a particular métier application as described in clause 56 or any other clause:
wherein said at least one métier-trait-metric parameter comprises a feedback parameter;
wherein said métier-relevant numerical input data for said individual comprises all feedback scores for a networking candidate individual;
wherein said métier-trait-metric-parameter-specific mathematical operation comprises the step of creating said interim numerical data set by:
   eliminating any feedback score older than a threshold age value; and
   eliminating any feedback score outside of a threshold interquartile range value for said feedback scores;
wherein said métier-trait-metric-parameter-specific mathematical calculation comprises taking the average of said feedback scores of said interim numerical data set; and
wherein said relative parameter weight comprises the numerical value of 1.

82. A method of métier-methodized ranking of individuals for a particular métier application as described in clause 81 or any other clause wherein said threshold age value comprises one year.

83. A method of métier-methodized ranking of individuals for a particular métier application as described in clause 81 or any other clause wherein said threshold interquartile range value comprises +/−1.5 interquartile range.

84. A method of métier-methodized ranking of individuals for a particular métier application as described in clause 56 or any other clause:
wherein said at least one métier-trait-metric parameter comprises a degrees-of-separation parameter;
wherein said métier-relevant numerical input data for said individual comprises a colleague match value for said networking aspirant individual and further comprising a colleague match value for a networking candidate individual;
wherein said métier-trait-metric-parameter-specific mathematical calculation comprises setting said interim métier-trait-metric parameter value to a numerical value of 1 for colleague match values that indicate a colleague match and setting said interim métier-trait-metric parameter value to a numerical value of 0 in all other cases; and
wherein said relative parameter weight comprises the numerical value of 1.

85. A method of métier-methodized ranking of individuals for a particular métier application as described in clause 56 or any other clause:
wherein said at least one métier-trait-metric parameter comprises a networking-aspirant-for-networking-candidate-feedback-scores parameter;
wherein said métier-relevant numerical input data for said individual comprises all feedback scores given by said networking aspirant individual to said networking candidate individual;
wherein said métier-trait-metric-parameter-specific mathematical operation comprises the step of creating said interim numerical data set by:
   eliminating any feedback score older than a threshold age value;
wherein said métier-trait-metric-parameter-specific mathematical calculation comprises taking the average of said feedback scores of said interim numerical data set; and
wherein said relative parameter weight comprises the numerical value of 1.

86. A method of métier-methodized ranking of individuals for a particular métier application as described in clause 85 or any other clause wherein said threshold age value comprises one year.

87. A method of métier-methodized ranking of individuals for a particular métier application as described in clause 56 or any other clause:
wherein said at least one métier-trait-metric parameter comprises a networking-candidate-for-networking-aspirant-feedback-scores parameter;
wherein said métier-relevant numerical input data for said individual comprises all feedback scores given by said networking candidate individual to said networking aspirant individual;
wherein said métier-trait-metric-parameter-specific mathematical operation comprises the step of creating said interim numerical data set by:
   eliminating any feedback score older than a threshold age value;
wherein said métier-trait-metric-parameter-specific mathematical calculation comprises taking the average of said feedback scores of said interim numerical data set; and
wherein said relative parameter weight comprises the numerical value of 1.

88. A method of métier-methodized ranking of individuals for a particular métier application as described in clause 87 or any other clause wherein said threshold age value comprises three months.

89. A method of métier-methodized ranking of individuals for a particular métier application as described in clause 56 or any other clause:
wherein said at least one métier-trait-metric parameter comprises a profession/field/specialty-coverage parameter;
wherein said métier-relevant numerical input data for said individual comprises a colleague profession/field/specialty match value for said networking aspirant individual and further comprising a profession/field/specialty match value for a networking candidate individual;
wherein said métier-trait-metric-parameter-specific mathematical calculation comprises setting said interim métier-trait-metric parameter value to a numerical value of 1 if said profession/field/specialty match values indicate a profession match and a field/specialty disparity and setting said interim métier-trait-metric parameter value to a numerical value of 0 in all other cases; and
wherein said relative parameter weight comprises the numerical value of 1.

90. A method of métier-methodized ranking of individuals for a particular métier application as described in clause 56 or any other clause:
wherein said at least one métier-trait-metric parameter comprises an own-profession-coverage parameter;
wherein said métier-relevant numerical input data for said individual comprises a profession/field/specialty match value for said networking aspirant individual and further comprising a profession/field/specialty match value for a networking candidate individual;
wherein said métier-trait-metric-parameter-specific mathematical calculation comprises setting said interim métier-trait-metric parameter value to a numerical value of 1 if said profession/field/specialty match values indicate a profession/field match and a specialty disparity and setting said interim métier-trait-metric parameter value to a numerical value of 0 in all other cases; and
wherein said relative parameter weight comprises the numerical value of 1.

91. A method of métier-methodized ranking of individuals for a particular métier application as described in clause 56 or any other clause:
wherein said at least one métier-trait-metric parameter comprises a profession/region parameter;
wherein said métier-relevant numerical input data for said individual comprises a profession/region match value for said networking aspirant individual and further comprising a profession/region match value for a networking candidate individual;
wherein said métier-trait-metric-parameter-specific mathematical calculation comprises setting said interim métier-trait-metric parameter value to a numerical value of 1 if said profession/region match values indicate a profession match and a region disparity and setting said interim métier-trait-metric parameter value to a numerical value of 0 in all other cases; and
wherein said relative parameter weight comprises the numerical value of 1.

92. A method of métier-methodized ranking of individuals for a particular métier application as described in clause 56 or any other clause:
wherein said at least one métier-trait-metric parameter comprises a years-of-practice parameter;
wherein said métier-relevant numerical input data for said individual comprises a profession/field/years-of-practice match value for said networking aspirant individual and further comprising a profession/field/years-of-practice match value for a networking candidate individual;
wherein said métier-trait-metric-parameter-specific mathematical calculation comprises setting said interim métier-trait-metric parameter value to a numerical value of 1 if said profession/field/years-of-practice match values indicate a profession/field match and a years-of-practice disparity and setting said interim métier-trait-metric parameter value to a numerical value of 0 in all other cases; and
wherein said relative parameter weight comprises the numerical value of 3.

93. A method of métier-methodized ranking of individuals for a particular métier application as described in clause 56 or any other clause:
wherein said at least one métier-trait-metric parameter comprises a network-identity-composition parameter;
wherein said métier-relevant numerical input data for said individual comprises an identity match value for said networking aspirant individual;
wherein said métier-trait-metric-parameter-specific mathematical calculation comprises setting said interim métier-trait-metric parameter value to the numerical value of the difference obtained by subtracting the percentage of individuals in said networking aspirant's network having the same identity match value from the percentage of individuals in a pool of individuals having the same identity match value if such numerical value of such difference is greater than 0 and setting said interim métier-trait-metric parameter value to a numerical value of 0 in all other cases; and
wherein said relative parameter weight comprises the numerical value of 3.

94. A method of métier-methodized ranking of individuals for a particular métier application as described in clause 93 or any other clause wherein said pool of individuals comprises lawyers in the United States.

95. A method of métier-methodized ranking of individuals for a particular métier application as described in clause 56 or any other clause:
wherein said at least one métier-trait-metric parameter comprises a network-pronouns-composition parameter;
wherein said métier-relevant numerical input data for said individual comprises a pronoun match value for said networking aspirant individual;
wherein said métier-trait-metric-parameter-specific mathematical calculation comprises setting said interim métier-trait-metric parameter value to the numerical value of the difference obtained by subtracting the percentage of individuals in said networking aspirant's network having the same pronoun match value from the percentage of individuals in a pool of individuals having the same pronoun match value if such numerical value of such difference is greater than 0 and setting said interim métier-trait-metric parameter value to a numerical value of 0 in all other cases; and
wherein said relative parameter weight comprises the numerical value of 3.

96. A method of métier-methodized ranking of individuals for a particular métier application as described in clause 95 or any other clause wherein said pool of individuals comprises lawyers in the United States.

97. A method of métier-methodized ranking of individuals for a particular métier application as described in clause 56 or any other clause:
wherein said at least one métier-trait-metric parameter comprises a network-age-composition parameter;
wherein said métier-relevant numerical input data for said individual comprises an age match value for said networking aspirant individual;
wherein said métier-trait-metric-parameter-specific mathematical calculation comprises setting said interim métier-trait-metric parameter value to the numerical value of the difference obtained by subtracting the percentage of individuals in said networking aspirant's network having the same age match value from the percentage of individuals in a pool of individuals having the same age match value if such numerical value of such difference is greater than 0 and setting said interim métier-trait-metric parameter value to a numerical value of 0 in all other cases; and
wherein said relative parameter weight comprises the numerical value of 3.

98. A method of métier-methodized ranking of individuals for a particular métier application as described in clause 97 or any other clause wherein said pool of individuals comprises lawyers in the United States.

99. A method of métier-methodized ranking of individuals for a particular métier application as described in clause 55 or any other clause:
wherein said métier comprises the legal profession;
wherein said métier application comprises team-building;
wherein said métier-applied data valuation framework comprises a métier-applied team-building data valuation framework; and
wherein said individual comprises a team-member candidate individual.

100. A method of métier-methodized ranking of individuals for a particular métier application as described in clause 99 or any other clause:
wherein said at least one métier-trait-metric parameter comprises a team-field/specialty-complementarity parameter;
wherein said métier-relevant numerical input data for said individual comprises a profession/field/specialty match value for said team-member candidate individual and further comprising a profession/field/specialty match value for a team;
wherein said métier-trait-metric-parameter-specific mathematical calculation comprises setting said interim métier-trait-metric parameter value to a numerical value of 1 if said profession/field/specialty match values indicate a field/specialty match and a profession disparity and setting said interim métier-trait-metric parameter value to a numerical value of 0 in all other cases; and
wherein said relative parameter weight comprises the numerical value of 1.

101. A method of métier-methodized ranking of individuals for a particular métier application as described in claim 99:
wherein said at least one métier-trait-metric parameter comprises a personality-harmony parameter;
wherein said métier-relevant numerical input data for said individual comprises a numerical value for each behavioral tendency inquired of by a métier-methodized self-assessment query for said team-member candidate individual and further comprising, for each member individual of a team, a numerical value for each behavioral tendency inquired of by a métier-methodized self-assessment query for said member individual of said team;
wherein said métier-trait-metric-parameter-specific mathematical calculation comprises:
   taking the sum of all said numerical values for each said behavioral tendency for all said individuals to create a first set of numerical value sums for each said behavioral tendency;
   taking the standard deviation of said first set of numerical value sums to obtain a first standard deviation value;
   taking the sum of all said numerical values for each said behavioral tendency for all said member individuals of said team to create a second set of numerical value sums for each said behavioral tendency;
   taking the standard deviation of said second set of numerical value sums to obtain a second standard deviation value;
   setting said interim métier-trait-metric parameter value to a numerical value of 0 if said first standard deviation value is greater than said second standard deviation value;
   setting said interim métier-trait-metric parameter value in all other cases to a numerical value equal to the quotient of said first standard deviation value divided by said second standard deviation value, said quotient subtracted from the numerical value 1; and
wherein said relative parameter weight comprises the numerical value of 1.

102. A method of métier-methodized ranking of individuals for a particular métier application as described in clause 99 or any other clause:
wherein said at least one métier-trait-metric parameter comprises an average-degrees-of-separation parameter;
wherein said métier-relevant numerical input data for said individual comprises a colleague match value for said team-member candidate individual for each individual team member of a team;
wherein said métier-trait-metric-parameter-specific mathematical calculation comprises:
   assigning a numerical value of 1 for colleague match values that indicate a colleague match and assigning a numerical value of 0 for colleague match values that do not indicate a colleague match;
   taking the average of said assigned numerical values; and
wherein said relative parameter weight comprises the numerical value of 1.

103. A method of métier-methodized ranking of individuals for a particular métier application as described in clause 99 or any other clause:
wherein said at least one métier-trait-metric parameter comprises a team-member-candidate-feedback parameter;
wherein said métier-relevant numerical input data for said individual comprises all feedback scores for said team-member candidate individual;
wherein said métier-trait-metric-parameter-specific mathematical operation comprises the step of creating said interim numerical data set by:
   eliminating any feedback score older than a threshold age value; and
   eliminating any feedback score outside of a threshold interquartile range value for said feedback scores;
wherein said métier-trait-metric-parameter-specific mathematical calculation comprises taking the average of said feedback scores of said interim numerical data set; and
wherein said relative parameter weight comprises the numerical value of 1.

104. A method of métier-methodized ranking of individuals for a particular métier application as described in clause 103 or any other clause wherein said threshold age value comprises one year.

105. A method of métier-methodized ranking of individuals for a particular métier application as described in clause 103 or any other clause wherein said threshold interquartile range value comprises +/−1.5 interquartile range.

106. A method of métier-methodized ranking of individuals for a particular métier application as described in clause 99 or any other clause:
wherein said at least one métier-trait-metric parameter comprises a team-years-of-practice parameter;
wherein said métier-relevant numerical input data for said individual comprises a profession/years-of-practice match value for said team-member candidate individual and further comprising a profession/years-of-practice match value for a team;
wherein said métier-trait-metric-parameter-specific mathematical calculation comprises setting said interim métier-trait-metric parameter value to a numerical value of 1 if said profession/years-of-practice match values indicate a profession match and a years-of-practice disparity and setting said interim métier-trait-metric parameter value to a numerical value of 0 in all other cases; and
wherein said relative parameter weight comprises the numerical value of 1.

107. A method of métier-methodized ranking of individuals for a particular métier application as described in clause 99 or any other clause:
wherein said at least one métier-trait-metric parameter comprises a team-identity-composition parameter;
wherein said métier-relevant numerical input data for said individual comprises an identity match value for said team-member candidate individual;
wherein said métier-trait-metric-parameter-specific mathematical calculation comprises setting said interim métier-trait-metric parameter value to the numerical value of the difference obtained by subtracting the percentage of individuals of said team having the same identity match value from the percentage of individuals in a pool of individuals having the same identity match value if such numerical value of such difference is greater than 0 and setting said interim métier-trait-metric parameter value to a numerical value of 0 in all other cases; and
wherein said relative parameter weight comprises the numerical value of 1.

108. A method of métier-methodized ranking of individuals for a particular métier application as described in clause 107 or any other clause wherein said pool of individuals comprises lawyers in the United States.

109. A method of métier-methodized ranking of individuals for a particular métier application as described in clause 99 or any other clause:
wherein said at least one métier-trait-metric parameter comprises a team-pronouns-composition parameter;
wherein said métier-relevant numerical input data for said individual comprises a pronoun match value for said team-member candidate individual;
wherein said métier-trait-metric-parameter-specific mathematical calculation comprises setting said interim métier-trait-metric parameter value to the numerical value of the difference obtained by subtracting the percentage of individuals of said team having the same pronoun match value from the percentage of individuals in a pool of individuals having the same pronoun match value if such numerical value of such difference is greater than 0 and setting said interim métier-trait-metric parameter value to a numerical value of 0 in all other cases; and
wherein said relative parameter weight comprises the numerical value of 1.

110. A method of métier-methodized ranking of individuals for a particular métier application as described in clause 109 or any other clause wherein said pool of individuals comprises lawyers in the United States.

111. A method of métier-methodized ranking of individuals for a particular métier application as described in clause 99 or any other clause:
wherein said at least one métier-trait-metric parameter comprises a team-age-composition parameter;
wherein said métier-relevant numerical input data for said individual comprises an age match value for said team-member candidate individual;
wherein said métier-trait-metric-parameter-specific mathematical calculation comprises setting said interim métier-trait-metric parameter value to the numerical value of the difference obtained by subtracting the percentage of individuals of said team having the same age match value from the percentage of individuals in a pool of individuals having the same age match value if such numerical value of such difference is greater than 0 and setting said interim métier-trait-metric parameter value to a numerical value of 0 in all other cases; and
wherein said relative parameter weight comprises the numerical value of 1.

112. A method of métier-methodized ranking of individuals for a particular métier application as described in clause 111 or any other clause wherein said pool of individuals comprises lawyers in the United States.

113. A method of métier-methodized ranking of individuals for a particular métier application as described in clause 99 or any other clause:
wherein said at least one métier-trait-metric parameter comprises a team-member-candidate-case-success parameter;
wherein said métier-relevant numerical input data for said individual comprises all consensus success values for related teams for said team-member candidate
wherein said métier-trait-metric-parameter-specific mathematical operation comprises the step of creating said interim numerical data set by:
   eliminating any consensus success value for related teams outside of a threshold interquartile range value;
wherein said métier-trait-metric-parameter-specific mathematical calculation comprises taking the average of said consensus success values for related teams of said interim numerical data set; and
wherein said relative parameter weight comprises the numerical value of 1.

114. A method of métier-methodized ranking of individuals for a particular métier application as described in clause 113 or any other clause wherein said threshold interquartile range value comprises +/−1.5 interquartile range.

115. A method of métier-methodized ranking of individuals for a particular métier application as described in clause 55 or any other clause:
wherein said métier comprises the legal profession;
wherein said métier application comprises referrals;
wherein said métier-applied data valuation framework comprises a métier-applied referrals data valuation framework; and
wherein said individual comprises a referring individual.

116. A method of métier-methodized ranking of individuals for a particular métier application as described in clause 115 or any other clause:
wherein said at least one métier-trait-metric parameter comprises a referral-field/specialty-complementarity parameter;
wherein said métier-relevant numerical input data for said individual comprises a profession/field/specialty match value for said referring individual and further comprising a profession/field/specialty match value for a referral candidate
wherein said métier-trait-metric-parameter-specific mathematical calculation comprises setting said interim métier-trait-metric parameter value to a numerical value of 1 if said profession/field/specialty match values indicate a field/specialty match and setting said interim métier-trait-metric parameter value to a numerical value of 0 in all other cases; and
wherein said relative parameter weight comprises the numerical value of 1.

117. A method of métier-methodized ranking of individuals for a particular métier application as described in clause 115 or any other clause:
wherein said at least one métier-trait-metric parameter comprises a feedback parameter;
wherein said métier-relevant numerical input data for said individual comprises all feedback scores for a referral candidate individual;
wherein said métier-trait-metric-parameter-specific mathematical operation comprises the step of creating said interim numerical data set by:
   eliminating any feedback score older than a threshold age value; and
   eliminating any feedback score outside of a threshold interquartile range value for said feedback scores;
wherein said métier-trait-metric-parameter-specific mathematical calculation comprises taking the average of said feedback scores of said interim numerical data set; and
wherein said relative parameter weight comprises the numerical value of 1.

118. A method of métier-methodized ranking of individuals for a particular métier application as described in clause 117 or any other clause wherein said threshold age value comprises one year.

119. A method of métier-methodized ranking of individuals for a particular métier application as described in clause 117 or any other clause wherein said threshold interquartile range value comprises +/−1.5 interquartile range.

120. A method of métier-methodized ranking of individuals for a particular métier application as described in clause 115 or any other clause:
wherein said at least one métier-trait-metric parameter comprises a degrees-of-separation parameter;
wherein said métier-relevant numerical input data for said individual comprises a colleague match value for said referring individual and further comprising a colleague match value for a referral candidate individual;
wherein said métier-trait-metric-parameter-specific mathematical calculation comprises setting said interim métier-trait-metric parameter value to a numerical value of 1 for colleague match values that indicate a colleague match and setting said interim métier-trait-metric parameter value to a numerical value of 0 in all other cases; and
wherein said relative parameter weight comprises the numerical value of 1.

121. A method of métier-methodized ranking of individuals for a particular métier application as described in clause 115 or any other clause:
wherein said at least one métier-trait-metric parameter comprises a referral-candidate-case-success parameter;
wherein said métier-relevant numerical input data for said individual comprises all consensus success values for related teams for said referral candidate individual;
wherein said métier-trait-metric-parameter-specific mathematical operation comprises the step of creating said interim numerical data set by:
   eliminating any consensus success value for related teams outside of a threshold interquartile range value;
wherein said métier-trait-metric-parameter-specific mathematical calculation comprises taking the average of said consensus success values for related teams of said interim numerical data set; and
wherein said relative parameter weight comprises the numerical value of 1.

122. A method of métier-methodized ranking of individuals for a particular métier application as described in clause 121 or any other clause wherein said threshold interquartile range value comprises +/−1.5 interquartile range.

123. A method of métier-methodized ranking of individuals for a particular métier application as described in clause 115 or any other clause:
wherein said at least one métier-trait-metric parameter comprises a referring-individual-for-referral-candidate-feedback-scores parameter;
wherein said métier-relevant numerical input data for said individual comprises all feedback scores given by said referring individual to said referral candidate individual;
wherein said métier-trait-metric-parameter-specific mathematical operation comprises the step of creating said interim numerical data set by:
   eliminating any feedback score older than a threshold age value;
wherein said métier-trait-metric-parameter-specific mathematical calculation comprises taking the average of said feedback scores of said interim numerical data set; and
wherein said relative parameter weight comprises the numerical value of 1.

124. A method of métier-methodized ranking of individuals for a particular métier application as described in clause 123 or any other clause wherein said threshold age value comprises one year.

125. A method of métier-methodized ranking of individuals for a particular métier application as described in clause 115 or any other clause:
wherein said at least one métier-trait-metric parameter comprises a referral-candidate-for-referring-individual-feedback-scores parameter;
wherein said métier-relevant numerical input data for said individual comprises all feedback scores given by said referral candidate individual to said referring
wherein said métier-trait-metric-parameter-specific mathematical operation comprises the step of creating said interim numerical data set by:
   eliminating any feedback score older than a threshold age value;
wherein said métier-trait-metric-parameter-specific mathematical calculation comprises taking the average of said feedback scores of said interim numerical data set; and
wherein said relative parameter weight comprises the numerical value of 1.

126. A method of métier-methodized ranking of individuals for a particular métier application as described in clause 125 or any other clause wherein said threshold age value comprises three months.

127. A method of métier-methodized ranking of individuals for a particular métier application as described in clause 55 or any other clause:
wherein said métier comprises the legal profession;
wherein said métier application comprises mentorship;
wherein said métier-applied data valuation framework comprises a métier-applied mentorship data valuation framework; and
wherein said individual comprises a mentee aspirant individual.

128. A method of métier-methodized ranking of individuals for a particular métier application as described in clause 127 or any other clause:
wherein said at least one métier-trait-metric parameter comprises a behavioral-tendency-similarity-for-assertiveness parameter;
wherein said métier-relevant numerical input data for said individual comprises an assertiveness behavioral tendency score for said mentee aspirant individual and further comprising an assertiveness behavioral tendency score for a mentor candidate individual, each said behavioral tendency score comprising a numerical value between 0 and 1 inclusive;
wherein said métier-trait-metric-parameter-specific mathematical calculation comprises subtracting said assertiveness behavioral tendency score for said mentor candidate individual from said assertiveness behavioral tendency score for said mentee aspirant individual and taking the absolute value of the result; and
wherein said relative parameter weight comprises the numerical value 1.

129. A method of métier-methodized ranking of individuals for a particular métier application as described in clause 128 or any other clause wherein each said assertiveness behavioral tendency score for each said individual comprises the quotient of a numerical value for all métier-methodized self-assessment query responses of a métier-methodized self-assessment query for said individual pertaining to an assertiveness behavioral tendency divided by a numerical value for all métier-methodized self-assessment query responses for all behavioral tendencies inquired of by said métier-methodized self-assessment query for said individual.

130. A method of métier-methodized ranking of individuals for a particular métier application as described in clause 127 or any other clause:
wherein said at least one métier-trait-metric parameter comprises a behavioral-tendency-similarity-for-compassion parameter;
wherein said métier-relevant numerical input data for said individual comprises a compassion behavioral tendency score for said mentee aspirant individual and further comprising a compassion behavioral tendency score for a mentor candidate individual, each said behavioral tendency score comprising a numerical value between 0 and 1 inclusive;
wherein said métier-trait-metric-parameter-specific mathematical calculation comprises subtracting said compassion behavioral tendency score for said mentor candidate individual from said compassion behavioral tendency score for said mentee aspirant individual and taking the absolute value of the result; and
wherein said relative parameter weight comprises the numerical value 1.

131. A method of métier-methodized ranking of individuals for a particular métier application as described in clause 130 or any other clause wherein each said compassion behavioral tendency score for each said individual comprises the quotient of a numerical value for all métier-methodized self-assessment query responses of a métier-methodized self-assessment query for said individual pertaining to a compassion behavioral tendency divided by a numerical value for all métier-methodized self-assessment query responses for all behavioral tendencies inquired of by said métier-methodized self-assessment query for said individual.

132. A method of métier-methodized ranking of individuals for a particular métier application as described in clause 127 or any other clause:
wherein said at least one métier-trait-metric parameter comprises a behavioral-tendency-similarity-for-creativity parameter;
wherein said métier-relevant numerical input data for said individual comprises a creativity behavioral tendency score for said mentee aspirant individual and further comprising a creativity behavioral tendency score for a mentor candidate individual, each said behavioral tendency score comprising a numerical value between 0 and 1 inclusive;
wherein said métier-trait-metric-parameter-specific mathematical calculation comprises subtracting said creativity behavioral tendency score for said mentor candidate individual from said creativity behavioral tendency score for said mentee aspirant individual and taking the absolute value of the result; and
wherein said relative parameter weight comprises the numerical value 1.

133. A method of métier-methodized ranking of individuals for a particular métier application as described in clause 132 or any other clause wherein each said creativity behavioral tendency score for each said individual comprises the quotient of a numerical value for all métier-methodized self-assessment query responses of a métier-methodized self-assessment query for said individual pertaining to a creativity behavioral tendency divided by a numerical value for all métier-methodized self-assessment query responses for all behavioral tendencies inquired of by said métier-methodized self-assessment query for said individual.

134. A method of métier-methodized ranking of individuals for a particular métier application as described in clause 127 or any other clause:
wherein said at least one métier-trait-metric parameter comprises a behavioral-tendency-similarity-for-deliberation parameter;
wherein said métier-relevant numerical input data for said individual comprises a deliberation behavioral tendency score for said mentee aspirant individual and further comprising a deliberation behavioral tendency score for a mentor candidate individual, each said behavioral tendency score comprising a numerical value between 0 and 1 inclusive;
wherein said métier-trait-metric-parameter-specific mathematical calculation comprises subtracting said deliberation behavioral tendency score for said mentor candidate individual from said deliberation behavioral tendency score for said mentee aspirant individual and taking the absolute value of the result; and
wherein said relative parameter weight comprises the numerical value 1.

135. A method of métier-methodized ranking of individuals for a particular métier application as described in clause 134 or any other clause wherein each said deliberation behavioral tendency score for each said individual comprises the quotient of a numerical value for all métier-methodized self-assessment query responses of a métier-methodized self-assessment query for said individual pertaining to a deliberation behavioral tendency divided by a numerical value for all métier-methodized self-assessment query responses for all behavioral tendencies inquired of by said métier-methodized self-assessment query for said individual.

136. A method of métier-methodized ranking of individuals for a particular métier application as described in clause 127 or any other clause:
wherein said at least one métier-trait-metric parameter comprises a behavioral-tendency-similarity-for-ethics parameter;
wherein said métier-relevant numerical input data for said individual comprises an ethics behavioral tendency score for said mentee aspirant individual and further comprising an ethics behavioral tendency score for a mentor candidate individual, each said behavioral tendency score comprising a numerical value between 0 and 1 inclusive;
wherein said métier-trait-metric-parameter-specific mathematical calculation comprises subtracting said ethics behavioral tendency score for said mentor candidate individual from said ethics behavioral tendency score for said mentee aspirant individual and taking the absolute value of the result; and
wherein said relative parameter weight comprises the numerical value 1.

137. A method of métier-methodized ranking of individuals for a particular métier application as described in clause 136 or any other clause wherein each said ethics behavioral tendency score for each said individual comprises the quotient of a numerical value for all métier-methodized self-assessment query responses of a métier-methodized self-assessment query for said individual pertaining to an ethics behavioral tendency divided by a numerical value for all métier-methodized self-assessment query responses for all behavioral tendencies inquired of by said métier-methodized self-assessment query for said individual.

138. A method of métier-methodized ranking of individuals for a particular métier application as described in clause 127 or any other clause:
wherein said at least one métier-trait-metric parameter comprises a behavioral-tendency-similarity-for-open-mindedness parameter;
wherein said métier-relevant numerical input data for said individual comprises an open-mindedness behavioral tendency score for said mentee aspirant individual and further comprising an open-mindedness behavioral tendency score for a mentor candidate individual, each said behavioral tendency score comprising a numerical value between 0 and 1 inclusive;
wherein said métier-trait-metric-parameter-specific mathematical calculation comprises subtracting said open-mindedness behavioral tendency score for said mentor candidate individual from said ethics behavioral tendency score for said mentee aspirant individual and taking the absolute value of the result; and
wherein said relative parameter weight comprises the numerical value 1.

139. A method of métier-methodized ranking of individuals for a particular métier application as described in clause 138 or any other clause wherein each said open-mindedness behavioral tendency score for each said individual comprises the quotient of a numerical value for all métier-methodized self-assessment query responses of a métier-methodized self-assessment query for said individual pertaining to an open-mindedness behavioral tendency divided by a numerical value for all métier-methodized self-assessment query responses for all behavioral tendencies inquired of by said métier-methodized self-assessment query for said individual.

140. A method of métier-methodized ranking of individuals for a particular métier application as described in clause 127 or any other clause:
wherein said at least one métier-trait-metric parameter comprises a behavioral-tendency-similarity-for-passion parameter;
wherein said métier-relevant numerical input data for said individual comprises a passion behavioral tendency score for said mentee aspirant individual and further comprising a passion behavioral tendency score for a mentor candidate individual, each said behavioral tendency score comprising a numerical value between 0 and 1 inclusive;
wherein said métier-trait-metric-parameter-specific mathematical calculation comprises subtracting said passion behavioral tendency score for said mentor candidate individual from said passion behavioral tendency score for said mentee aspirant individual and taking the absolute value of the result; and
wherein said relative parameter weight comprises the numerical value 1.

141. A method of métier-methodized ranking of individuals for a particular métier application as described in clause 140 or any other clause wherein each said passion behavioral tendency score for each said individual comprises the quotient of a numerical value for all métier-methodized self-assessment query responses of a métier-methodized self-assessment query for said individual pertaining to a passion behavioral tendency divided by a numerical value for all métier-methodized self-assessment query responses for all behavioral tendencies inquired of by said métier-methodized self-assessment query for said individual.

142. A method of métier-methodized ranking of individuals for a particular métier application as described in clause 127 or any other clause:
wherein said at least one métier-trait-metric parameter comprises a behavioral-tendency-similarity-for-perseverance parameter;
wherein said métier-relevant numerical input data for said individual comprises a perseverance behavioral tendency score for said mentee aspirant individual and further comprising a perseverance behavioral tendency score for a mentor candidate individual, each said behavioral tendency score comprising a numerical value between 0 and 1 inclusive;
wherein said métier-trait-metric-parameter-specific mathematical calculation comprises subtracting said perseverance behavioral tendency score for said mentor candidate individual from said perseverance behavioral tendency score for said mentee aspirant individual and taking the absolute value of the result; and
wherein said relative parameter weight comprises the numerical value 1.

143. A method of métier-methodized ranking of individuals for a particular métier application as described in clause 142 or any other clause wherein each said perseverance behavioral tendency score for each said individual comprises the quotient of a numerical value for all métier-methodized self-assessment query responses of a métier-methodized self-assessment query for said individual pertaining to a perseverance behavioral tendency divided by a numerical value for all métier-methodized self-assessment query responses for all behavioral tendencies inquired of by said métier-methodized self-assessment query for said individual.

144. A method of métier-methodized ranking of individuals for a particular métier application as described in clause 127 or any other clause:
wherein said at least one métier-trait-metric parameter comprises a behavioral-tendency-similarity-for-pragmatism parameter;
wherein said métier-relevant numerical input data for said individual comprises a pragmatism behavioral tendency score for said mentee aspirant individual and further comprising a pragmatism behavioral tendency score for a mentor candidate individual, each said behavioral tendency score comprising a numerical value between 0 and 1 inclusive;
wherein said métier-trait-metric-parameter-specific mathematical calculation comprises subtracting said pragmatism behavioral tendency score for said mentor candidate individual from said pragmatism behavioral tendency score for said mentee aspirant individual and taking the absolute value of the result; and
wherein said relative parameter weight comprises the numerical value 1.

145. A method of métier-methodized ranking of individuals for a particular métier application as described in clause 144 or any other clause wherein each said pragmatism behavioral tendency score for each said individual comprises the quotient of a numerical value for all métier-methodized self-assessment query responses of a métier-methodized self-assessment query for said individual pertaining to a pragmatism behavioral tendency divided by a numerical value for all métier-methodized self-assessment query responses for all behavioral tendencies inquired of by said métier-methodized self-assessment query for said individual.

146. A method of métier-methodized ranking of individuals for a particular métier application as described in clause 127 or any other clause:
wherein said at least one métier-trait-metric parameter comprises a behavioral-tendency-similarity-for-skepticism parameter;
wherein said métier-relevant numerical input data for said individual comprises a skepticism behavioral tendency score for said mentee aspirant individual and further comprising a skepticism behavioral tendency score for a mentor candidate individual, each said behavioral tendency score comprising a numerical value between 0 and 1 inclusive;
wherein said métier-trait-metric-parameter-specific mathematical calculation comprises subtracting said skepticism behavioral tendency score for said mentor candidate individual from said skepticism behavioral tendency score for said mentee aspirant individual and taking the absolute value of the result; and
wherein said relative parameter weight comprises the numerical value 1.

147. A method of métier-methodized ranking of individuals for a particular métier application as described in clause 146 or any other clause wherein each said skepticism behavioral tendency score for each said individual comprises the quotient of a numerical value for all métier-methodized self-assessment query responses of a métier-methodized self-assessment query for said individual pertaining to a skepticism behavioral tendency divided by a numerical value for all métier-methodized self-assessment query responses for all behavioral tendencies inquired of by said métier-methodized self-assessment query for said individual.

148. A method of métier-methodized ranking of individuals for a particular métier application as described in clause 127 or any other clause:
wherein said at least one métier-trait-metric parameter comprises a behavioral-tendency-similarity-for-urgency parameter;
wherein said métier-relevant numerical input data for said individual comprises an urgency behavioral tendency score for said mentee aspirant individual and further comprising an urgency tendency score for a mentor candidate individual, each said behavioral tendency score comprising a numerical value between 0 and 1 inclusive;
wherein said métier-trait-metric-parameter-specific mathematical calculation comprises subtracting said urgency behavioral tendency score for said mentor candidate individual from said urgency behavioral tendency score for said mentee aspirant individual and taking the absolute value of the result; and
wherein said relative parameter weight comprises the numerical value 1.

149. A method of métier-methodized ranking of individuals for a particular métier application as described in clause 148 or any other clause wherein each said urgency behavioral tendency score for each said individual comprises the quotient of a numerical value for all métier-methodized self-assessment query responses of a métier-methodized self-assessment query for said individual pertaining to an urgency behavioral tendency divided by a numerical value for all métier-methodized self-assessment query responses for all behavioral tendencies inquired of by said métier-methodized self-assessment query for said individual.

150. A method of métier-methodized ranking of individuals for a particular métier application as described in clause 127 or any other clause:
wherein said at least one métier-trait-metric parameter comprises a behavioral-tendency-similarity-for-wisdom parameter;
wherein said métier-relevant numerical input data for said individual comprises a wisdom behavioral tendency score for said mentee aspirant individual and further comprising a wisdom behavioral tendency score for a mentor candidate individual, each said behavioral tendency score comprising a numerical value between 0 and 1 inclusive;
wherein said métier-trait-metric-parameter-specific mathematical calculation comprises subtracting said wisdom behavioral tendency score for said mentor candidate individual from said wisdom behavioral tendency score for said mentee aspirant individual and taking the absolute value of the result; and
wherein said relative parameter weight comprises the numerical value 1.

151. A method of métier-methodized ranking of individuals for a particular métier application as described in clause 150 or any other clause wherein each said wisdom behavioral tendency score for each said individual comprises the quotient of a numerical value for all métier-methodized self-assessment query responses of a métier-methodized self-assessment query for said individual pertaining to a wisdom behavioral tendency divided by a numerical value for all métier-methodized self-assessment query responses for all behavioral tendencies inquired of by said métier-methodized self-assessment query for said individual.

152. A method of métier-methodized ranking of individuals for a particular métier application as described in clause 127 or any other clause:
wherein said at least one métier-trait-metric parameter comprises a feedback parameter;
wherein said métier-relevant numerical input data for said individual comprises all feedback scores for a mentor candidate individual;
wherein said métier-trait-metric-parameter-specific mathematical operation comprises the step of creating said interim numerical data set by or any other clause:
   eliminating any feedback score older than a threshold age value; and
   eliminating any feedback score outside of a threshold interquartile range value for said feedback scores;
wherein said métier-trait-metric-parameter-specific mathematical calculation comprises taking the average of said feedback scores of said interim numerical data set; and
wherein said relative parameter weight comprises the numerical value of 1.

153. A method of métier-methodized ranking of individuals for a particular métier application as described in clause 152 or any other clause wherein said threshold age value comprises one year.

154. A method of métier-methodized ranking of individuals for a particular métier application as described in clause 152 or any other clause wherein said threshold interquartile range value comprises +/−1.5 interquartile range.

155. A method of métier-methodized ranking of individuals for a particular métier application as described in clause 127 or any other clause:
wherein said at least one métier-trait-metric parameter comprises a degrees-of-separation parameter;
wherein said métier-relevant numerical input data for said individual comprises a colleague match value for said mentee aspirant individual and further comprising a colleague match value for a mentor candidate individual;
wherein said métier-trait-metric-parameter-specific mathematical calculation comprises setting said interim métier-trait-metric parameter value to a numerical value of 1 for colleague match values that indicate a colleague match and setting said interim métier-trait-metric parameter value to a numerical value of 0 in all other cases; and
wherein said relative parameter weight comprises the numerical value of 1.

156. A method of métier-methodized ranking of individuals for a particular métier application as described in clause 127 or any other clause:
wherein said at least one métier-trait-metric parameter comprises a mentee-aspirant-for-mentor-candidate-feedback-scores parameter;
wherein said métier-relevant numerical input data for said individual comprises all feedback scores given by said mentee aspirant individual to said mentor candidate individual;
wherein said métier-trait-metric-parameter-specific mathematical operation comprises the step of creating said interim numerical data set by:
   eliminating any feedback score older than a threshold age value;
wherein said métier-trait-metric-parameter-specific mathematical calculation comprises taking the average of said feedback scores of said interim numerical data set; and
wherein said relative parameter weight comprises the numerical value of 1.

157. A method of métier-methodized ranking of individuals for a particular métier application as described in clause 156 or any other clause wherein said threshold age value comprises one year.

158. A method of métier-methodized ranking of individuals for a particular métier application as described in clause 127 or any other clause:
wherein said at least one métier-trait-metric parameter comprises a mentor-candidate-for-mentee-aspirant-feedback-scores parameter;
wherein said métier-relevant numerical input data for said individual comprises all feedback scores given by said mentor candidate individual to said mentee aspirant individual;
wherein said métier-trait-metric-parameter-specific mathematical operation comprises the step of creating said interim numerical data set by:
   eliminating any feedback score older than a threshold age value;
wherein said métier-trait-metric-parameter-specific mathematical calculation comprises taking the average of said feedback scores of said interim numerical data set; and
wherein said relative parameter weight comprises the numerical value of 1.

159. A method of métier-methodized ranking of individuals for a particular métier application as described in clause 158 or any other clause wherein said threshold age value comprises three months.

160. A method of métier-methodized ranking of individuals for a particular métier application as described in clause 127 or any other clause:
wherein said at least one métier-trait-metric parameter comprises a mentor-candidate-case-success parameter;
wherein said métier-relevant numerical input data for said individual comprises all consensus success values for related teams for said mentor candidate individual;
wherein said métier-trait-metric-parameter-specific mathematical operation comprises the step of creating said interim numerical data set by:
   eliminating any consensus success value for related teams outside of a threshold interquartile range value;
wherein said métier-trait-metric-parameter-specific mathematical calculation comprises taking the average of said consensus success values for related teams of said interim numerical data set; and
wherein said relative parameter weight comprises the numerical value of 1.

161. A method of métier-methodized ranking of individuals for a particular métier application as described in clause 160 or any other clause wherein said threshold interquartile range value comprises +/−1.5 interquartile range.

162. A method of métier-methodized ranking of individuals for a particular métier application as described in clause 55 or any other clause:
wherein said métier comprises the legal profession;
wherein said métier application comprises mentorship;
wherein said métier-applied data valuation framework comprises a métier-applied mentorship data valuation framework; and
wherein said individual comprises a mentor aspirant individual.

163. A method of métier-methodized ranking of individuals for a particular métier application as described in clause 162 or any other clause:
wherein said at least one métier-trait-metric parameter comprises a behavioral-tendency-similarity-for-assertiveness parameter;
wherein said métier-relevant numerical input data for said individual comprises an assertiveness behavioral tendency score for said mentor aspirant individual and further comprising an assertiveness behavioral tendency score for a mentee candidate individual, each said behavioral tendency score comprising a numerical value between 0 and 1 inclusive;
wherein said métier-trait-metric-parameter-specific mathematical calculation comprises subtracting said assertiveness behavioral tendency score for said mentee candidate individual from said assertiveness behavioral tendency score for said mentor aspirant individual and taking the absolute value of the result; and
wherein said relative parameter weight comprises the numerical value 1.

164. A method of métier-methodized ranking of individuals for a particular métier application as described in clause 163 or any other clause wherein each said assertiveness behavioral tendency score for each said individual comprises the quotient of a numerical value for all métier-methodized self-assessment query responses of a métier-methodized self-assessment query for said individual pertaining to an assertiveness behavioral tendency divided by a numerical value for all métier-methodized self-assessment query responses for all behavioral tendencies inquired of by said métier-methodized self-assessment query for said individual.

165. A method of métier-methodized ranking of individuals for a particular métier application as described in clause 162 or any other clause:
wherein said at least one métier-trait-metric parameter comprises a behavioral-tendency-similarity-for-compassion parameter;
wherein said métier-relevant numerical input data for said individual comprises a compassion behavioral tendency score for said mentor aspirant individual and further comprising a compassion behavioral tendency score for a mentee candidate individual, each said behavioral tendency score comprising a numerical value between 0 and 1 inclusive;
wherein said métier-trait-metric-parameter-specific mathematical calculation comprises subtracting said compassion behavioral tendency score for said mentee candidate individual from said compassion behavioral tendency score for said mentor aspirant individual and taking the absolute value of the result; and
wherein said relative parameter weight comprises the numerical value 1.

166. A method of métier-methodized ranking of individuals for a particular métier application as described in clause 165 or any other clause wherein each said compassion behavioral tendency score for each said individual comprises the quotient of a numerical value for all métier-methodized self-assessment query responses of a métier-methodized self-assessment query for said individual pertaining to a compassion behavioral tendency divided by a numerical value for all métier-methodized self-assessment query responses for all behavioral tendencies inquired of by said métier-methodized self-assessment query for said individual.

167. A method of métier-methodized ranking of individuals for a particular métier application as described in clause 162 or any other clause:
wherein said at least one métier-trait-metric parameter comprises a behavioral-tendency-similarity-for-creativity parameter;
wherein said métier-relevant numerical input data for said individual comprises a creativity behavioral tendency score for said mentor aspirant individual and further comprising a creativity behavioral tendency score for a mentee candidate individual, each said behavioral tendency score comprising a numerical value between 0 and 1 inclusive;
wherein said métier-trait-metric-parameter-specific mathematical calculation comprises subtracting said creativity behavioral tendency score for said mentee candidate individual from said creativity behavioral tendency score for said mentor aspirant individual and taking the absolute value of the result; and
wherein said relative parameter weight comprises the numerical value 1.

168. A method of métier-methodized ranking of individuals for a particular métier application as described in clause 167 or any other clause wherein each said creativity behavioral tendency score for each said individual comprises the quotient of a numerical value for all métier-methodized self-assessment query responses of a métier-methodized self-assessment query for said individual pertaining to a creativity behavioral tendency divided by a numerical value for all métier-methodized self-assessment query responses for all behavioral tendencies inquired of by said métier-methodized self-assessment query for said individual.

169. A method of métier-methodized ranking of individuals for a particular métier application as described in clause 162 or any other clause:
wherein said at least one métier-trait-metric parameter comprises a behavioral-tendency-similarity-for-deliberation parameter;
wherein said métier-relevant numerical input data for said individual comprises a deliberation behavioral tendency score for said mentor aspirant individual and further comprising a deliberation behavioral tendency score for a mentee candidate individual, each said behavioral tendency score comprising a numerical value between 0 and 1 inclusive;
wherein said métier-trait-metric-parameter-specific mathematical calculation comprises subtracting said deliberation behavioral tendency score for said mentee candidate individual from said deliberation behavioral tendency score for said mentor aspirant individual and taking the absolute value of the result; and
wherein said relative parameter weight comprises the numerical value 1.

170. A method of métier-methodized ranking of individuals for a particular métier application as described in clause 169 or any other clause wherein each said deliberation behavioral tendency score for each said individual comprises the quotient of a numerical value for all métier-methodized self-assessment query responses of a métier-methodized self-assessment query for said individual pertaining to a deliberation behavioral tendency divided by a numerical value for all métier-methodized self-assessment query responses for all behavioral tendencies inquired of by said métier-methodized self-assessment query for said individual.

171. A method of métier-methodized ranking of individuals for a particular métier application as described in clause 162 or any other clause:
wherein said at least one métier-trait-metric parameter comprises a behavioral-tendency-similarity-for-ethics parameter;
wherein said métier-relevant numerical input data for said individual comprises an ethics behavioral tendency score for said mentor aspirant individual and further comprising an ethics behavioral tendency score for a mentee candidate individual, each said behavioral tendency score comprising a numerical value between 0 and 1 inclusive;
wherein said métier-trait-metric-parameter-specific mathematical calculation comprises subtracting said ethics behavioral tendency score for said mentee candidate individual from said ethics behavioral tendency score for said mentor aspirant individual and taking the absolute value of the result; and
wherein said relative parameter weight comprises the numerical value 1.

172. A method of métier-methodized ranking of individuals for a particular métier application as described in clause 171 or any other clause wherein each said ethics behavioral tendency score for each said individual comprises the quotient of a numerical value for all métier-methodized self-assessment query responses of a métier-methodized self-assessment query for said individual pertaining to an ethics behavioral tendency divided by a numerical value for all métier-methodized self-assessment query responses for all behavioral tendencies inquired of by said métier-methodized self-assessment query for said individual.

173. A method of métier-methodized ranking of individuals for a particular métier application as described in clause 162 or any other clause:
wherein said at least one métier-trait-metric parameter comprises a behavioral-tendency-similarity-for-open-mindedness parameter;
wherein said métier-relevant numerical input data for said individual comprises an open-mindedness behavioral tendency score for said mentor aspirant individual and further comprising an open-mindedness behavioral tendency score for a mentee candidate individual, each said behavioral tendency score comprising a numerical value between 0 and 1 inclusive;
wherein said métier-trait-metric-parameter-specific mathematical calculation comprises subtracting said open-mindedness behavioral tendency score for said mentee candidate individual from said open-mindedness behavioral tendency score for said mentor aspirant individual and taking the absolute value of the result; and
wherein said relative parameter weight comprises the numerical value 1.

174. A method of métier-methodized ranking of individuals for a particular métier application as described in clause 176 or any other clause wherein each said open-mindedness behavioral tendency score for each said individual comprises the quotient of a numerical value for all métier-methodized self-assessment query responses of a métier-methodized self-assessment query for said individual pertaining to an open-mindedness behavioral tendency divided by a numerical value for all métier-methodized self-assessment query responses for all behavioral tendencies inquired of by said métier-methodized self-assessment query for said individual.

175. A method of métier-methodized ranking of individuals for a particular métier application as described in clause 162 or any other clause:
wherein said at least one métier-trait-metric parameter comprises a behavioral-tendency-similarity-for-passion parameter;
wherein said métier-relevant numerical input data for said individual comprises a passion behavioral tendency score for said mentor aspirant individual and further comprising a passion behavioral tendency score for a mentee candidate individual, each said behavioral tendency score comprising a numerical value between 0 and 1 inclusive;
wherein said métier-trait-metric-parameter-specific mathematical calculation comprises subtracting said passion behavioral tendency score for said mentee candidate individual from said passion behavioral tendency score for said mentor aspirant individual and taking the absolute value of the result; and
wherein said relative parameter weight comprises the numerical value 1.

176. A method of métier-methodized ranking of individuals for a particular métier application as described in clause 175 or any other clause wherein each said passion behavioral tendency score for each said individual comprises the quotient of a numerical value for all métier-methodized self-assessment query responses of a métier-methodized self-assessment query for said individual pertaining to a passion behavioral tendency divided by a numerical value for all métier-methodized self-assessment query responses for all behavioral tendencies inquired of by said métier-methodized self-assessment query for said individual.

177. A method of métier-methodized ranking of individuals for a particular métier application as described in clause 162 or any other clause:
wherein said at least one métier-trait-metric parameter comprises a behavioral-tendency-similarity-for-perseverance parameter;
wherein said métier-relevant numerical input data for said individual comprises a perseverance behavioral tendency score for said mentor aspirant individual and further comprising a perseverance behavioral tendency score for a mentee candidate individual, each said behavioral tendency score comprising a numerical value between 0 and 1 inclusive;
wherein said métier-trait-metric-parameter-specific mathematical calculation comprises subtracting said perseverance behavioral tendency score for said mentee candidate individual from said perseverance behavioral tendency score for said mentor aspirant individual and taking the absolute value of the result; and
wherein said relative parameter weight comprises the numerical value 1.

178. A method of métier-methodized ranking of individuals for a particular métier application as described in clause 177 or any other clause wherein each said perseverance behavioral tendency score for each said individual comprises the quotient of a numerical value for all métier-methodized self-assessment query responses of a métier-methodized self-assessment query for said individual pertaining to a perseverance behavioral tendency divided by a numerical value for all métier-methodized self-assessment query responses for all behavioral tendencies inquired of by said métier-methodized self-assessment query for said individual.

179. A method of métier-methodized ranking of individuals for a particular métier application as described in clause 162 or any other clause:
wherein said at least one métier-trait-metric parameter comprises a behavioral-tendency-similarity-for-pragmatism parameter;
wherein said métier-relevant numerical input data for said individual comprises a pragmatism behavioral tendency score for said mentor aspirant individual and further comprising a pragmatism behavioral tendency score for a mentee candidate individual, each said behavioral tendency score comprising a numerical value between 0 and 1 inclusive;
wherein said métier-trait-metric-parameter-specific mathematical calculation comprises subtracting said pragmatism behavioral tendency score for said mentee candidate individual from said pragmatism behavioral tendency score for said mentor aspirant individual and taking the absolute value of the result; and
wherein said relative parameter weight comprises the numerical value 1.

180. A method of métier-methodized ranking of individuals for a particular métier application as described in clause 179 or any other clause wherein each said pragmatism behavioral tendency score for each said individual comprises the quotient of a numerical value for all métier-methodized self-assessment query responses of a métier-methodized self-assessment query for said individual pertaining to a pragmatism behavioral tendency divided by a numerical value for all métier-methodized self-assessment query responses for all behavioral tendencies inquired of by said métier-methodized self-assessment query for said individual.

181. A method of métier-methodized ranking of individuals for a particular métier application as described in clause 162 or any other clause:
wherein said at least one métier-trait-metric parameter comprises a behavioral-tendency-similarity-for-skepticism parameter;
wherein said métier-relevant numerical input data for said individual comprises a skepticism behavioral tendency score for said mentor aspirant individual and further comprising a skepticism behavioral tendency score for a mentee candidate individual, each said behavioral tendency score comprising a numerical value between 0 and 1 inclusive;
wherein said métier-trait-metric-parameter-specific mathematical calculation comprises subtracting said skepticism behavioral tendency score for said mentee candidate individual from said skepticism behavioral tendency score for said mentor aspirant individual and taking the absolute value of the result; and
wherein said relative parameter weight comprises the numerical value 1.

182. A method of métier-methodized ranking of individuals for a particular métier application as described in clause 181 or any other clause wherein each said skepticism behavioral tendency score for each said individual comprises the quotient of a numerical value for all métier-methodized self-assessment query responses of a métier-methodized self-assessment query for said individual pertaining to a skepticism behavioral tendency divided by a numerical value for all métier-methodized self-assessment query responses for all behavioral tendencies inquired of by said métier-methodized self-assessment query for said individual.

183. A method of métier-methodized ranking of individuals for a particular métier application as described in clause 162 or any other clause:
wherein said at least one métier-trait-metric parameter comprises a behavioral-tendency-similarity-for-urgency parameter;
wherein said métier-relevant numerical input data for said individual comprises an urgency behavioral tendency score for said mentor aspirant individual and further comprising an urgency behavioral tendency score for a mentee candidate individual, each said behavioral tendency score comprising a numerical value between 0 and 1 inclusive;
wherein said métier-trait-metric-parameter-specific mathematical calculation comprises subtracting said urgency behavioral tendency score for said mentee candidate individual from said urgency behavioral tendency score for said mentor aspirant individual and taking the absolute value of the result; and
wherein said relative parameter weight comprises the numerical value 1.

184. A method of métier-methodized ranking of individuals for a particular métier application as described in clause 183 or any other clause wherein each said urgency behavioral tendency score for each said individual comprises the quotient of a numerical value for all métier-methodized self-assessment query responses of a métier-methodized self-assessment query for said individual pertaining to an urgency behavioral tendency divided by a numerical value for all métier-methodized self-assessment query responses for all behavioral tendencies inquired of by said métier-methodized self-assessment query for said individual.

185. A method of métier-methodized ranking of individuals for a particular métier application as described in clause 162 or any other clause:
wherein said at least one métier-trait-metric parameter comprises a behavioral-tendency-similarity-for-wisdom parameter;
wherein said métier-relevant numerical input data for said individual comprises a wisdom behavioral tendency score for said mentor aspirant individual and further comprising a wisdom behavioral tendency score for a mentee candidate individual, each said behavioral tendency score comprising a numerical value between 0 and 1 inclusive;
wherein said métier-trait-metric-parameter-specific mathematical calculation comprises subtracting said wisdom behavioral tendency score for said mentee candidate individual from said wisdom behavioral tendency score for said mentor aspirant individual and taking the absolute value of the result; and
wherein said relative parameter weight comprises the numerical value 1.

186. A method of métier-methodized ranking of individuals for a particular métier application as described in clause 184 or any other clause wherein each said wisdom behavioral tendency score for each said individual comprises the quotient of a numerical value for all métier-methodized self-assessment query responses of a métier-methodized self-assessment query for said individual pertaining to a wisdom behavioral tendency divided by a numerical value for all métier-methodized self-assessment query responses for all behavioral tendencies inquired of by said métier-methodized self-assessment query for said individual.

187. A method of métier-methodized ranking of individuals for a particular métier application as described in clause 162 or any other clause:
wherein said at least one métier-trait-metric parameter comprises a feedback parameter;
wherein said métier-relevant numerical input data for said individual comprises all feedback scores for a mentee candidate individual;
wherein said métier-trait-metric-parameter-specific mathematical operation comprises the step of creating said interim numerical data set by:
   eliminating any feedback score older than a threshold age value; and
   eliminating any feedback score outside of a threshold interquartile range value for said feedback scores;
wherein said métier-trait-metric-parameter-specific mathematical calculation comprises taking the average of said feedback scores of said interim numerical data set; and
wherein said relative parameter weight comprises the numerical value of 1.

188. A method of métier-methodized ranking of individuals for a particular métier application as described in clause 187 or any other clause wherein said threshold age value comprises one year.

189. A method of métier-methodized ranking of individuals for a particular métier application as described in clause 187 or any other clause wherein said threshold interquartile range value comprises +/−1.5 interquartile range.

190. A method of métier-methodized ranking of individuals for a particular métier application as described in clause 162 or any other clause:
wherein said at least one métier-trait-metric parameter comprises a degrees-of-separation parameter;
wherein said métier-relevant numerical input data for said individual comprises a colleague match value for said mentor aspirant individual and further comprising a colleague match value for a mentee candidate individual;
wherein said métier-trait-metric-parameter-specific mathematical calculation comprises setting said interim métier-trait-metric parameter value to a numerical value of 1 for colleague match values that indicate a colleague match and setting said interim métier-trait-metric parameter value to a numerical value of 0 in all other cases; and
wherein said relative parameter weight comprises the numerical value of 1.

191. A method of métier-methodized ranking of individuals for a particular métier application as described in clause 162 or any other clause:
wherein said at least one métier-trait-metric parameter comprises a mentor-aspirant-for-mentee-candidate-feedback-scores parameter;
wherein said métier-relevant numerical input data for said individual comprises all feedback scores given by said mentor aspirant individual to said mentee candidate individual;
wherein said métier-trait-metric-parameter-specific mathematical operation comprises the step of creating said interim numerical data set by:
   eliminating any feedback score older than a threshold age value;
wherein said métier-trait-metric-parameter-specific mathematical calculation comprises taking the average of said feedback scores of said interim numerical data set; and
wherein said relative parameter weight comprises the numerical value of 1.

192. A method of métier-methodized ranking of individuals for a particular métier application as described in clause 191 or any other clause wherein said threshold age value comprises one year.

193. A method of métier-methodized ranking of individuals for a particular métier application as described in clause 162 or any other clause:
wherein said at least one métier-trait-metric parameter comprises a mentee-candidate-for-mentor-aspirant-feedback-scores parameter;
wherein said métier-relevant numerical input data for said individual comprises all feedback scores given by said mentee candidate individual to said mentor aspirant individual;
wherein said métier-trait-metric-parameter-specific mathematical operation comprises the step of creating said interim numerical data set by:
   eliminating any feedback score older than a threshold age value;
wherein said métier-trait-metric-parameter-specific mathematical calculation comprises taking the average of said feedback scores of said interim numerical data set; and
wherein said relative parameter weight comprises the numerical value of 1.

194. A method of métier-methodized ranking of individuals for a particular métier application as described in clause 193 or any other clause wherein said threshold age value comprises three months.

195. A method of métier-methodized ranking of individuals for a particular métier application as described in clause 55 or any other clause:
wherein said métier comprises the legal profession;
wherein said métier application comprises associations membership;
wherein said métier-applied data valuation framework comprises a métier-applied associations membership data valuation framework; and
wherein said individual comprises an association member aspirant individual.

196. A method of métier-methodized ranking of individuals for a particular métier application as described in clause 195 or any other clause:
wherein said at least one métier-trait-metric parameter comprises an association parameter;
wherein said métier-relevant numerical input data for said individual comprises an association parameter match value for said association member aspirant individual and further comprising an association parameter match value for a candidate association;
wherein said métier-trait-metric-parameter-specific mathematical calculation comprises setting said interim métier-trait-metric parameter value to a numerical value of 1 if said association parameter match values indicate an association match and setting said interim métier-trait-metric parameter value to a numerical value of 0 in all other cases; and
wherein said relative parameter weight comprises the numerical value of 1.

197. A method of métier-methodized ranking of individuals for a particular métier application as described in clause 55 or any other clause:
wherein said métier comprises the legal profession;
wherein said métier application comprises associations membership;
wherein said métier-applied data valuation framework comprises a métier-applied associations membership data valuation framework; and
wherein said individual comprises an association member candidate individual.

198. A method of métier-methodized ranking of individuals for a particular métier application as described in clause 197 or any other clause:
wherein said at least one métier-trait-metric parameter comprises an association parameter;
wherein said métier-relevant numerical input data for said individual comprises an association parameter match value for said association member candidate individual and further comprising an association parameter match value for a membership aspirant association;
wherein said métier-trait-metric-parameter-specific mathematical calculation comprises setting said interim métier-trait-metric parameter value to a numerical value of 1 if said association parameter match values indicate an association match and setting said interim métier-trait-metric parameter value to a numerical value of 0 in all other cases; and
wherein said relative parameter weight comprises the numerical value of 1.

199. A method of métier-methodized ranking of individuals for a particular métier application as described in clause 55 or any other clause:
wherein said métier comprises the legal profession;
wherein said métier application comprises association subgroups membership;
wherein said métier-applied data valuation framework comprises a métier-applied association subgroups membership data valuation framework; and
wherein said individual comprises an association subgroups member candidate individual.

200. A method of métier-methodized ranking of individuals for a particular métier application as described in clause 199 or any other clause:
wherein said at least one métier-trait-metric parameter comprises an association-subgroup parameter;
wherein said métier-relevant numerical input data for said individual comprises an association subgroup parameter match value for said association subgroups member candidate individual and further comprising an association subgroup parameter match value for a membership aspirant association subgroup;
wherein said métier-trait-metric-parameter-specific mathematical calculation comprises setting said interim métier-trait-metric parameter value to a numerical value of 1 if said association subgroup parameter match values indicate an association subgroup match and setting said interim métier-trait-metric parameter value to a numerical value of 0 in all other cases; and
wherein said relative parameter weight comprises the numerical value of 1.

201. A method of métier-methodized ranking of individuals for a particular métier application as described in clause 55 or any other clause wherein said step of performing a métier-trait-metric-parameter-specific mathematical operation comprises the step of performing a métier-trait-metric-parameter-specific mathematical operation selected from the steps of eliminating one or more data pairs of said data paired métier-relevant numerical input data, time-based eliminating one or more data pairs of said data paired métier-relevant numerical input data, age-of-data eliminating one or more data pairs of said data paired métier-relevant numerical input data, individually differentiated data pair weighting of said data paired métier-relevant numerical input data, and any combination of the foregoing.

202. A method of métier-methodized ranking of individuals for a particular métier application as described in clause 201 or any other clause wherein said métier-trait-metric-parameter-specific mathematical operation comprises an axiom-implementing métier-trait-metric-parameter-specific mathematical operation.

203. A method of métier-methodized ranking of individuals for a particular métier application as described in clause 201 or any other clause further comprising the step of updating said métier-trait-metric-parameter-specific mathematical operation using self-generated métier-methodized data.

204. A method of métier-methodized ranking of individuals for a particular métier application as described in clause 201 or any other clause further comprising the step of updating said métier-trait-metric-parameter-specific mathematical calculation using self-generated métier-methodized data.

205. A method of métier-methodized ranking of individuals for a particular métier application as described in clause 55 or any other clause wherein said data paired métier-relevant numerical input data comprises one or more data pairs, each said data pair having a measured métier-metric numerical value and a corresponding time stamp numerical value.

206. A method of métier-methodized ranking of individuals for a particular métier application as described in clause 55 or any other clause wherein said step of applying a métier-metric-parameter-specific mathematical calculation comprises the step of applying a métier-metric-parameter-specific mathematical calculation selected from the steps of averaging at least some numerical values of said data paired métier-relevant numerical input data, averaging at least some measured métier-metric numerical values of said data paired métier-relevant numerical input data, finding a maximum of said measured métier-metric numerical values of said data paired métier-relevant numerical input data, and any combination of the foregoing.

207. A method of métier-methodized ranking of individuals for a particular métier application as described in clause 55 or any other clause wherein each said weighted métier-trait-metric parameter value for each of all said métier-trait-metric parameters of said métier-applied data valuation framework and each said métier-trait-metric parameter weights for each of all said métier-trait-metric parameters of said métier-applied data valuation framework comprise said métier-applied revalued numerical data for said individual, and wherein said step of applicatively ranking comprises the step of taking the sum of the weighted métier-trait-metric parameter values for all said métier-trait-metric parameters of said métier-applied data valuation framework divided by the sum of the métier-trait-metric parameter weights for all said métier-trait-metric parameters of said métier-applied data valuation framework to create said métier-applied individual rank score for said individual.

208. A method of métier-methodized ranking of individuals for a particular métier application as described in clause 207 or any other clause wherein said step of applicatively revaluing comprises the step of applicatively revaluing for a plurality of said individuals, wherein said step of applicatively ranking comprises the step of applicatively ranking for a plurality of said individuals, and further comprising the step of métier-applied ordering a plurality of métier-applied individual rank scores for a plurality of said individuals.

209. A method of métier-methodized ranking of individuals for a particular métier application as described in clause 207 or any other clause further comprising métier-relevant numerical input networking reference data for said particular métier application, and wherein said step of applicatively revaluing further comprises the step of performing a métier-trait-metric-parameter-specific mathematical operation on at least one numerical value of said métier-relevant numerical input networking reference data to create said interim numerical data set.

210. A method of métier-methodized ranking of individuals for a particular métier application as described in clause 207 or any other clause further comprising métier-relevant numerical input team-building reference data for said particular métier application, and wherein said step of applicatively revaluing further comprises the step of performing a métier-trait-metric-parameter-specific mathematical operation on at least one numerical value of said métier-relevant numerical input team-building reference data to create said interim numerical data set.

211. A method of métier-methodized ranking of individuals for a particular métier application as described in clause 207 or any other clause further comprising métier-relevant numerical input referrals reference data for said particular métier application, and wherein said step of applicatively revaluing further comprises the step of performing a métier-trait-metric-parameter-specific mathematical operation on at least one numerical value of said métier-relevant numerical input referrals reference data to create said interim numerical data set.

212. A method of métier-methodized ranking of individuals for a particular métier application as described in clause 55 or any other clause further comprising métier-relevant numerical input associations membership reference data for said particular métier application, and wherein said step of applicatively revaluing further comprises the step of performing a métier-trait-metric-parameter-specific mathematical operation on at least one numerical value of said métier-relevant numerical input associations membership reference data to create said interim numerical data set.

213. A method of métier-methodized ranking of individuals for a particular métier application as described in clause 55 or any other clause further comprising métier-relevant numerical input mentorship reference data for said particular métier application, and wherein said step of applicatively revaluing further comprises the step of performing a métier-trait-metric-parameter-specific mathematical operation on at least one numerical value of said métier-relevant numerical input mentorship reference data to create said interim numerical data set.

214. A method of métier-methodized ranking of individuals for a particular métier application as described in clause 55 or any other clause further comprising métier-relevant numerical input feedback reference data for said particular métier application, and wherein said step of applicatively revaluing further comprises the step of performing a métier-trait-metric-parameter-specific mathematical operation on at least one numerical value of said métier-relevant numerical input feedback reference data to create said interim numerical data set.

215. A method of métier-methodized ranking of individuals for a particular métier application as described in clause 55 or any other clause further comprising métier-relevant numerical input historical reference data for said particular métier application, and wherein said step of applicatively revaluing further comprises the step of performing a métier-trait-metric-parameter-specific mathematical operation on at least one numerical value of said métier-relevant numerical input historical reference data to create said interim numerical data set.

216. A method of métier-methodized ranking of individuals for a particular métier application as described in clause 55 or any other clause further comprising métier-relevant numerical input group reference data for said particular métier application, and wherein said step of applicatively revaluing further comprises the step of performing a métier-trait-metric-parameter-specific mathematical operation on at least one numerical value of said métier-relevant numerical input group reference data to create said interim numerical data set.

217. A method of métier-methodized ranking of individuals for a particular métier application as described in clause 55 or any other clause further comprising métier-relevant numerical input iteratively-developed reference data for said particular métier application, and wherein said step of applicatively revaluing further comprises the step of performing a métier-trait-metric-parameter-specific mathematical operation on at least one numerical value of said métier-relevant numerical input iteratively-developed reference data to create said interim numerical data set.

218. A method of métier-methodized ranking of individuals for a particular métier application as described in clause 21 or any other clause wherein said step of applicatively revaluing comprises the step of utilizing historical reference data.

219. A method of métier-methodized ranking of individuals for a particular métier application as described in clause 218 or any other clause wherein said step of utilizing historical reference data comprises the step of adjusting at least one numerical value of said métier-relevant numerical input data in response to said historical reference data.

220. A method of métier-methodized ranking of individuals for a particular métier application as described in clause 219 or any other clause wherein said step of adjusting comprises the step of adjusting selected from increasing a value of a historically effective variable, decreasing a value of a historically ineffective variable, or any combination of the foregoing.

221. A method of métier-methodized ranking of individuals for a particular métier application as described in clause 218 or any other clause wherein said historical reference data comprises user feedback data.

222. A method of métier-methodized ranking of individuals for a particular métier application as described in clause 218 or any other clause further comprising the step of discounting aged historical reference data.

223. A method of métier-methodized ranking of individuals for a particular métier application as described in clause 21 or any other clause wherein said métier-applied data valuation framework comprises a métier-applied data valuation framework selected from a métier-applied weighting data valuation framework, a métier-applied function data valuation framework, a métier-applied computation data valuation framework, a métier-applied data rule valuation framework, and a métier-applied data matrix valuation framework.

224. A method of métier-methodized ranking of individuals for a particular métier application as described in clause 21 or any other clause wherein said step of applicatively revaluing comprises the step of applicatively revaluing in n-dimensional space.

225. A method of métier-methodized ranking of individuals for a particular métier application as described in clause 224 or any other clause wherein each dimension of said n-dimensional space represents a métier trait metric.

226. A method of métier-methodized ranking of individuals for a particular métier application as described in clause 225 or any other clause wherein said métier comprises the legal profession and wherein said n-dimensional space comprises a plurality of behavioral tendency dimensions.

227. A method of métier-methodized ranking of individuals for a particular métier application as described in clause 226 or any other clause wherein said behavioral tendency dimensions comprise behavioral tendency dimensions selected from assertiveness, compassion, creativity, dependability, ethicalness, open-mindedness, passion, perseverance, pragmatism, resilience, trust, wisdom, and any combination of the foregoing.

228. A method of métier-methodized ranking of individuals for a particular métier application as described in clause 21 or any other clause wherein said métier comprises the legal profession and wherein said step of applicatively revaluing comprises the step of identifying a lawyer type for said individual.

229. A method of métier-methodized ranking of individuals for a particular métier application as described in clause 228 or any other clause wherein said step of identifying a lawyer type for said individual comprises the step of identifying said individual selected from identifying said individual as an advocate lawyer type, identifying said individual as a rainmaker lawyer type, identifying said individual as a litigator lawyer type, identifying said individual as an inspector lawyer type, and identifying said individual as a facilitator lawyer type.

230. A method of métier-methodized ranking of individuals for a particular métier application as described in clause 229 or any other clause:
wherein said métier-relevant numerical input data comprises métier-relevant numerical input data for said métier-relevant psychological data of said individual and comprises a numerical assertiveness value between 0 and 1 inclusive, a numerical compassion value between 0 and 1 inclusive, a numerical creativity value between 0 and 1 inclusive, a numerical dependability value between 0 and 1 inclusive, a numerical ethicalness value between 0 and 1 inclusive, a numerical open-mindedness value between 0 and 1 inclusive, a numerical passion value between 0 and 1 inclusive, a numerical perseverance value between 0 and 1 inclusive, a numerical pragmatism value between 0 and 1 inclusive, a numerical resilience value between 0 and 1 inclusive, a numerical trust value between 0 and 1 inclusive, and a numerical wisdom value between 0 and 1 inclusive;
wherein each said lawyer type has four numerical value metrics comprising:
   a numerical assertiveness value, a numerical pragmatism value, a numerical creativity value, and a numerical resilience value for a rainmaker lawyer type;
   a numerical perseverance value, a numerical compassion value, a numerical ethicalness value, a numerical passion value, and a numerical trust value for an advocate lawyer type;
   a numerical creativity value, a numerical pragmatism value, a numerical open-mindedness value, and a numerical wisdom value for a litigator lawyer type;
   a numerical pragmatism value, a numerical perseverance value, a numerical dependability value, and a numerical resilience value for a facilitator lawyer type;
   a numerical open-mindedness value, a numerical perseverance value, a numerical dependability value, and a numerical resilience value for an inspector lawyer type;
and wherein said step of identifying a lawyer type for said individual comprises the steps of summing said four numerical value metrics for each said lawyer type and identifying said individual as said lawyer type having the highest said sum.

231. A method of métier-methodized ranking of individuals for a particular métier application as described in clause 21 or any other clause wherein said métier comprises the legal profession and wherein said métier-applied data valuation framework comprises a métier-applied networking data valuation framework.

232. A method of métier-methodized ranking of individuals for a particular métier application as described in clause 231 or any other clause wherein said métier-applied networking data valuation framework comprises at least one networking axiom.

233. A method of métier-methodized ranking of individuals for a particular métier application as described in clause 231 or any other clause further comprising the step of providing a métier-applied networking user interface.

234. A method of métier-methodized ranking of individuals for a particular métier application as described in clause 233 or any other clause wherein said métier-applied networking user interface comprises a métier-applied networking user interface selected from a map of fields of law, a referrals sorting interface, a feedback sorting interface, a profession sorting interface, and any combination of the foregoing.

235. A method of métier-methodized ranking of individuals for a particular métier application as described in clause 21 or any other clause wherein said métier comprises the legal profession and wherein said métier-applied data valuation framework comprises a métier-applied team-building data valuation framework.

236. A method of métier-methodized ranking of individuals for a particular métier application as described in clause 235 or any other clause wherein said métier-applied team-building data valuation framework comprises at least one team-building axiom.

237. A method of métier-methodized ranking of individuals for a particular métier application as described in clause 236 or any other clause wherein said at least one team-building axiom comprises a team-building axiom selected from a local practice area axiom, a fields of law axiom, a specialty area axiom, a trial threat axiom, a complementary personalities axiom, a case outcomes axiom, a diversity axiom, a feedback axiom, a degrees of separation axiom, a case example axiom, and a skills and certifications axiom.

238. A method of métier-methodized ranking of individuals for a particular métier application as described in clause 235 or any other clause further comprising the step of providing a métier-applied team-building user interface.

239. A method of métier-methodized ranking of individuals for a particular métier application as described in clause 21 or any other clause wherein said wherein said métier comprises the legal profession and wherein said métier-applied data valuation framework comprises a métier-applied referrals data valuation framework.

240. A method of métier-methodized ranking of individuals for a particular métier application as described in clause 239 or any other clause wherein said métier-applied referrals data valuation framework comprises at least one referrals axiom.

241. A method of métier-methodized ranking of individuals for a particular métier application as described in clause 239 or any other clause further comprising the step of providing a métier-applied referrals user interface.

242. A method of métier-methodized ranking of individuals for a particular métier application as described in clause 241 or any other clause wherein said métier-applied referrals user interface comprises a métier-applied referrals user interface selected from a referrals sending interface, a referrals receiving interface, a referrals tracking interface, a reciprocity tracking interface, and any combination of the foregoing.

243. A method of métier-methodized ranking of individuals for a particular métier application as described in clause 241 or any other clause wherein said métier-applied referrals user interface comprises a referrals filter.

244. A method of métier-methodized ranking of individuals for a particular métier application as described in clause 243 or any other clause wherein said referrals filter comprises a referrals filter selected from a geographic filter, a field of law filter, and any combination of the foregoing.

245. A method of métier-methodized ranking of individuals for a particular métier application as described in clause 21 or any other clause wherein said métier comprises the legal profession and wherein said métier-applied data valuation framework comprises a métier-applied associations membership data valuation framework.

246. A method of métier-methodized ranking of individuals for a particular métier application as described in clause 245 or any other clause wherein said métier-applied associations membership data valuation framework comprises at least one associations membership axiom.

247. A method of métier-methodized ranking of individuals for a particular métier application as described in clause 245 or any other clause further comprising the step of providing a métier-applied associations membership user interface.

248. A method of métier-methodized ranking of individuals for a particular métier application as described in clause 247 or any other clause wherein said métier-applied associations membership user interface comprises a métier-applied associations membership user interface selected from a chat interface, a dues interface, a purchasing interface, and any combination of the foregoing.

249. A method of métier-methodized ranking of individuals for a particular métier application as described in clause 21 or any other clause wherein said métier comprises the legal profession and wherein said métier-applied data valuation framework comprises a métier-applied mentorship data valuation framework.

250. A method of métier-methodized ranking of individuals for a particular métier application as described in clause 249 or any other clause wherein said métier-applied mentorship data valuation framework comprises at least one mentorship axiom.

251. A method of métier-methodized ranking of individuals for a particular métier application as described in clause 249 or any other clause further comprising the step of providing a métier-applied mentorship user interface.

252. A method of métier-methodized ranking of individuals for a particular métier application as described in clause 21 or any other clause wherein said métier-applied individual rank score comprises a numerical value rank score.

253. A method of métier-methodized ranking of individuals for a particular métier application as described in clause 252 or any other clause wherein said métier-applied revalued numerical data comprises a plurality of revalued numerical values, and wherein said step of applicatively ranking comprises the step of transforming said plurality of revalued numerical values into said numerical value rank score.

254. A method of métier-methodized ranking of individuals for a particular métier application as described in clause 253 or any other clause wherein said plurality of revalued numerical values comprises a plurality of revalued numerical values in an n-dimensional space.

255. A method of métier-methodized ranking of individuals for a particular métier application as described in clause 254 or any other clause wherein each dimension of said n-dimensional space represents a métier trait metric.

256. A method of métier-methodized ranking of individuals for a particular métier application as described in clause 255 or any other clause wherein said métier comprises the legal profession and wherein said n-dimensional space comprises a plurality of behavioral tendency dimensions.

257. A method of métier-methodized ranking of individuals for a particular métier application as described in clause 256 or any other clause wherein said behavioral tendency dimensions comprise behavioral tendency dimensions selected from assertiveness, compassion, creativity, dependability, ethicalness, open-mindedness, passion, perseverance, pragmatism, resilience, trust, wisdom, and any combination of the foregoing.

258. A method of métier-methodized ranking of individuals for a particular métier application as described in clause 21 or any other clause wherein said step of applicatively ranking comprises the step of comparing said métier-applied individual rank score for said individual to at least one métier-applied individual rank score for another individual.

259. A method of métier-methodized ranking of individuals for a particular métier application as described in clause 21 or any other clause wherein said step of applicatively ranking said individual comprises the step of maximizing the aggregate effectiveness of a group of individuals.

260. A method of métier-methodized ranking of individuals for a particular métier application as described in clause 259 or any other clause wherein said group of individuals comprises a group of individuals selected from a team and a network.

261. A method of métier-methodized ranking of individuals for a particular métier application as described in clause 259 or any other clause wherein said step of applicatively revaluing comprises the step of utilizing group reference data.

262. A method of métier-methodized ranking of individuals for a particular métier application as described in clause 259 or any other clause wherein said step of maximizing the aggregate effectiveness of said group of individuals comprises the step of prompting a user to maximize the aggregate effectiveness of said group of individuals.

263. A method of métier-methodized ranking of individuals for a particular métier application as described in clause 259 or any other clause wherein said step of maximizing the aggregate effectiveness of said group of individuals comprises the step of taking the sum of the highest meter-applied individual rank scores for a plurality of individuals.

264. A method of métier-methodized ranking of individuals for a particular métier application as described in clause 259 or any other clause wherein said step of applicatively ranking said individual comprises the step of iteratively recasting said métier-applied individual rank score for said individual to create a métier-applied iteratively recast individual rank score for said individual.

265. A method of métier-methodized ranking of individuals for a particular métier application as described in clause 264 or any other clause wherein said step of maximizing the aggregate effectiveness of said group of individuals comprises the step of utilizing the highest métier-applied iteratively recast individual rank score among a plurality of individuals.

266. A method of métier-methodized ranking of individuals for a particular métier application as described in clause 21 or any other clause wherein said step of applicatively ranking comprises the step of iteratively recasting said métier-applied individual rank score for said individual.

267. A method of métier-methodized ranking of individuals for a particular métier application as described in clause 266 or any other clause wherein said step of iteratively recasting comprises the step of iteratively recasting said métier-applied individual rank score for said individual in response to iteratively developed networking reference data.

268. A method of métier-methodized ranking of individuals for a particular métier application as described in clause 266 or any other clause wherein said step of iteratively recasting comprises the step of iteratively recasting said métier-applied individual rank score for said individual in response to iteratively developed team-building reference data.

269. A method of métier-methodized ranking of individuals for a particular métier application as described in clause 266 or any other clause wherein said step of iteratively recasting comprises the step of iteratively recasting said métier-applied individual rank score for said individual in response to iteratively developed referrals reference data.

270. A method of métier-methodized ranking of individuals for a particular métier application as described in clause 266 or any other clause wherein said step of iteratively recasting comprises the step of iteratively recasting said métier-applied individual rank score for said individual in response to iteratively developed associations membership reference data.

271. A method of métier-methodized ranking of individuals for a particular métier application as described in clause 266 or any other clause wherein said step of iteratively recasting comprises the step of iteratively recasting said métier-applied individual rank score for said individual in response to iteratively developed mentorship reference data.

272. A method of métier-methodized ranking of individuals for a particular métier application as described in clause 266 or any other clause wherein said step of iteratively recasting comprises the steps of:
generating antecedent iterative reference data;
utilizing said antecedent iterative reference data in said step of applicatively revaluing; and
generating subsequent iterative reference data as a result of said step of applicatively revaluing.

273. A method of métier-methodized ranking of individuals for a particular métier application as described in clause 272 or any other clause wherein said subsequent iterative reference data comprises antecedent iterative reference data for a next succeeding iteration.

274. A method of métier-methodized ranking of individuals for a particular métier application as described in clause 272 or any other clause wherein said step of utilizing said antecedent iterative reference data in said step of applicatively revaluing comprises the step of adjusting at least one numerical value of said métier-relevant numerical input data in response to said antecedent iterative reference data.

275. A method of métier-methodized ranking of individuals for a particular métier application as described in clause 21 or any other clause wherein said métier-applied recommendation for said individual useful for said particular métier application comprises a métier-applied networking recommendation for said individual useful for a métier networking application.

276. A method of métier-methodized ranking of individuals for a particular métier application as described in clause 21 or any other clause wherein said métier-applied recommendation for said individual useful for said particular métier application comprises a métier-applied team-building recommendation for said individual useful for a métier team-building application.

277. A method of métier-methodized ranking of individuals for a particular métier application as described in clause 21 or any other clause wherein said métier-applied recommendation for said individual useful for said particular métier application comprises a métier-applied mentorship recommendation for said individual useful for a métier mentorship application.

278. A method of métier-methodized ranking of individuals for a particular métier application as described in clause 21 or any other clause wherein said métier-applied recommendation for said individual useful for said particular métier application comprises a métier-applied referral recommendation for said individual useful for a métier referral application.

279. A method of métier-methodized ranking of individuals for a particular métier application as described in clause 21 or any other clause wherein said métier-applied recommendation for said individual useful for said particular métier application comprises a métier-applied associations membership recommendation for said individual useful for a métier associations membership application.

280. A method of métier-methodized ranking of individuals for a particular métier application as described in clause 21 or any other clause wherein said métier-applied recommendation for said individual useful for said particular métier application comprises a métier-applied leadership recommendation for said individual useful for a métier leadership application.

281. A method of métier-methodized ranking of individuals for a particular métier application as described in clause 21 or any other clause wherein said métier-applied recommendation for said individual useful for said particular métier application comprises a métier-applied vendor recommendation for said individual useful for a métier vendor application.

282. A method of métier-methodized ranking of individuals for a particular métier application as described in clause 21 or any other clause wherein said step of applying comprises the step of applying the highest métier-applied individual rank score among a plurality of individuals.

283. A method of métier-methodized ranking of individuals for a particular métier application as described in clause 21 or any other clause further comprising the step of utilizing at least one feedback point in connection with any said step.

284. A method of métier-methodized ranking of individuals for a particular métier application as described in clause 283 or any other clause wherein said at least one feedback point comprises multiple feedback points selected from multiple feedback points from multiple users, multiple feedback points from multiple automatic generation, multiple iterative feedback points, and any combination of the foregoing.

285. A method of métier-methodized ranking of individuals for a particular métier application as described in clause 284 or any other clause further comprising the step of discounting aged feedback.

286. A method of métier-methodized ranking of individuals for a particular métier application as described in clause 283 or any other clause wherein said feedback comprises user generated feedback.

287. A method of métier-methodized ranking of individuals for a particular métier application as described in clause 283 or any other clause wherein said métier comprises the legal profession and wherein said user generated feedback comprises user generated feedback selected from at least one relationship statement, at least one user reported interaction outcome, at least one user reported behavioral tendency evaluation, at least one user reported peer value added evaluation, and any combination of the foregoing.

288. A method of métier-methodized ranking of individuals for a particular métier application as described in clause 283 or any other clause wherein said feedback comprises automatically generated feedback.

289. A method of métier-methodized ranking of individuals for a particular métier application as described in clause 288 or any other clause wherein said métier comprises the legal profession and wherein said automatically generated feedback comprises automatically generated feedback selected from historical data feedback, data trend feedback, and any combination of the foregoing.

290. A method of métier-methodized ranking of individuals for a particular métier application as described in clause 283 or any other clause wherein said feedback comprises milestone feedback.

291. A method of métier-methodized ranking of individuals for a particular métier application as described in clause 290 or any other clause wherein said métier comprises the legal profession and wherein said milestone feedback comprises milestone feedback selected from periodic interval feedback, event milestone feedback, case milestone feedback, outcome feedback, and any combination of the foregoing.

292. A method of métier-methodized ranking of individuals for a particular métier application as described in clause 283 or any other clause wherein said feedback comprises feedback reference data and wherein said step of applicatively revaluing comprises the step of utilizing said feedback reference data.

293. A method of métier-methodized ranking of individuals for a particular métier application as described in clause 292 or any other clause wherein said step of utilizing said feedback reference data comprises the step of adjusting at least one numerical value of said métier-relevant numerical input data in response to said feedback reference data.

294. A method of métier-methodized ranking of individuals for a particular métier application as described in clause 292 or any other clause wherein said at least one feedback point comprises multiple feedback points and wherein said feedback reference data comprises a plurality of said feedback reference data.

295. A method of métier-methodized ranking of individuals for a particular métier application as described in clause 294 or any other clause further comprising the step of discounting aged feedback reference data.

296. A method of métier-methodized ranking of individuals for a particular métier application as described in clause 294 or any other clause wherein said plurality of feedback reference data comprises iterative feedback reference data, and wherein said step of applicatively revaluing comprises the step of iteratively applicatively revaluing to create métier-applied iteratively revalued numerical data for said individual.

297. A method of métier-methodized ranking of individuals for a particular métier application as described in clause 296 or any other clause wherein said step of iteratively applicatively revaluing comprises the steps of:
generating antecedent iterative feedback reference data;
utilizing said antecedent iterative feedback reference data in said step of applicatively revaluing; and
generating subsequent iterative feedback reference data as a result of said step of applicatively revaluing.

298. A method of métier-methodized ranking of individuals for a particular métier application as described in clause 297 or any other clause wherein said subsequent iterative feedback reference data comprises antecedent iterative feedback reference data for a next succeeding iteration.

299. A method of métier-methodized ranking of individuals for a particular métier application as described in clause 298 or any other clause further comprising the step of discounting aged feedback reference data.

300. A method of métier-methodized ranking of individuals for a particular métier application as described in clause 283 or any other clause wherein said feedback comprises a two-axis score.

301. A method of métier-methodized ranking of individuals for a particular métier application as described in clause 300 or any other clause wherein said métier comprises the legal profession and wherein said two-axis score comprises a user-generated outcome score axis and a user-generated difficulty score axis.

302. A method of métier-methodized ranking of individuals for a particular métier application as described in clause 301 or any other clause wherein said feedback comprises a two-axis score for a case outcome.

303. A method of métier-methodized ranking of individuals for a particular métier application as described in clause 303 or any other clause further comprising the step of displaying at least one said two-axis score as a data point on a two-axis plot.

304. A method of métier-methodized ranking of individuals for a particular métier application as described in clause 303 or any other clause wherein said data point on said two-axis plot comprises a data point selected from a two-axis score provided by a user, a two-axis score averaged from multiple users, a two-axis score averaged from multiple users that comprise a team, a two-axis score averaged from multiple users that comprise multiple teams, and any combination of the foregoing.

305. A method of métier-methodized ranking of individuals for a particular métier application as described in clause 303 or any other clause wherein said data point comprises a data point selectable to view underlying constituent information of said data point.

306. A method of métier-methodized ranking of individuals for a particular métier application as described in clause 303 or any other clause wherein said step of displaying comprises the step of displaying a plurality of two-axis scores as a plurality of data points on a two-axis plot wherein said plurality of data points comprise a plurality of data points selected from a plurality of data points organized by attorney, a plurality of data points organized by case, and any combination of the foregoing.

307. A method of métier-methodized ranking of individuals for a particular métier application as described in clause 303 or any other clause further comprising the step of data analyzing said plurality of data points.

308. A method of métier-methodized ranking of individuals for a particular métier application as described in clause 307 or any other clause wherein said step of data analyzing comprises a step of data analyzing selected from analyzing a data trend, discounting aged data, temporally sorting data, and any combination of the foregoing.

309. A method of métier-methodized ranking of individuals for a particular métier application as described in clause 21 or any other clause further comprising the step of automatically updating at least one said step using self-generated métier-methodized data.

310. A method of métier-methodized ranking of individuals for a particular métier application as described in clause 309 or any other clause wherein said self-generated métier-methodized data comprises self-generated métier-methodized data selected from historical reference data, feedback reference data, and any combination of the foregoing.

311. A method of métier-methodized ranking of individuals for a particular métier application as described in clause 21 or any other clause wherein said métier comprises a métier selected from a métier profession and a métier avocation.

312. A method of métier-methodized ranking of individuals for a particular métier application as described in clause 21 or any other clause wherein each said métier-methodized step comprises the step of utilizing at least one manipulable-métier-specification.

313. A method of métier-methodized ranking of individuals for a particular métier application as described in clause 312 or any other clause wherein each said manipulable-métier-specification comprises a métier-axiom-implementing manipulable-métier-specification.

314. A method of métier-methodized ranking of individuals for a particular métier application as described in clause 313 or any other clause further comprising a plurality of said métier-axiom-implementing manipulable-métier-specification in an n-dimensional métier specification space.

315. A method of métier-methodized ranking of individuals for a particular métier application as described in clause 314 or any other clause wherein said n-dimensional métier specification space comprises a n-dimensional métier specification space having an aggregate number of independently manipulable métier specification dimensions greater than a number of dimensions selected from 10, 20, 50, 75, and 100.

316. A method of métier-methodized ranking of individuals for a particular métier application as described in clause 315 or any other clause further comprising the step of independently manipulating each said métier-axiom-implementing manipulable-métier-specification in said n-dimensional métier specification space utilizing métier hypotheses logic specific for the métier specification of each said dimension in said n-dimensional métier specification space.

317. A métier-methodized ranking system of individuals for a particular métier application comprising:
a métier-methodized individual psychological information capture element configured to obtain métier-relevant psychological data of said individual;
a métier-methodized individual objective information capture element configured to obtain métier-relevant objective data of said individual;
a data numeration processing element configured to create métier-relevant numerical input data for said individual from said métier-relevant psychological data of said individual and said métier-relevant objective data of said individual;
a métier-applied data valuation framework processing element configured to create métier-applied revalued numerical data for said individual by applicatively revaluing said métier-relevant numerical input data for said individual with a métier-applied data valuation framework;
an applicative data rank processing element configured to create a métier-applied individual rank score for said individual using said métier-applied revalued numerical data for said individual;
an individual rank score data application processing element configured to apply said métier-applied individual rank score for said individual to create a métier-applied recommendation for said individual useful for said particular métier application.

318. A métier-methodized ranking system of individuals for a particular métier application as described in clause 317 or any other clause wherein said métier application comprises a métier application selected from métier networking, métier referrals, métier team-building, métier associations membership, métier leadership development, and métier vendors.

319. A métier-methodized ranking system of individuals for a particular métier application as described in clause 317 or any other clause wherein said capture element configured to obtain métier-relevant psychological data comprises a capture element configured to obtain métier-specific psychological data.

320. A métier-methodized ranking system of individuals for a particular métier application as described in clause 319 or any other clause wherein said métier-specific psychological data comprises behavioral tendency data.

321. A métier-methodized ranking system of individuals for a particular métier application as described in clause 320 or any other clause wherein said métier comprises the legal profession and wherein said behavioral tendency data comprises behavioral tendency data selected from data pertaining to the trait of assertiveness, data pertaining to the trait of compassion, data pertaining to the trait of creativity, data pertaining to the trait of dependability, data pertaining to the trait of ethicalness, data pertaining to the trait of open-mindedness, data pertaining to the trait of passion, data pertaining to the trait of perseverance, data pertaining to the trait of pragmatism, data pertaining to the trait of resilience, data pertaining to the trait of trust, data pertaining to the trait of wisdom, and any combination of the foregoing.

322. A métier-methodized ranking system of individuals for a particular métier application as described in clause 317 or any other clause wherein said métier-methodized individual psychological information capture element comprises a métier-methodized self-assessment query prompt.

323. A métier-methodized ranking system of individuals for a particular métier application as described in clause 322 or any other clause wherein said métier-methodized self-assessment query prompt comprises slider pairs.

324. A métier-methodized ranking system of individuals for a particular métier application as described in clause 323 or any other clause wherein said slider pairs comprise behavioral tendency metric slider pairs.

325. A métier-methodized ranking system of individuals for a particular métier application as described in clause 323 or any other clause wherein said métier comprises the legal profession and wherein said slider pairs comprise slider pairs selected from assertiveness versus modesty, compassion versus cruelty, creativity versus unimaginativeness, dependability versus unreliability, ethicalness versus corruption, open-mindedness versus unreceptiveness, passion versus indifference, perseverance versus procrastination, pragmatism versus irrationality, trust versus skepticism, and wisdom versus ignorance.

326. A métier-methodized ranking system of individuals for a particular métier application as described in clause 322 or any other clause wherein said métier-methodized self-assessment query prompt comprises either/or questions.

327. A métier-methodized ranking system of individuals for a particular métier application as described in clause 326 or any other clause wherein said either/or questions comprise behavioral tendency metric either/or questions.

328. A métier-methodized ranking system of individuals for a particular métier application as described in clause 327 or any other clause wherein said métier comprises the legal profession and wherein said either/or questions comprise either/or questions selected from creativity versus pragmatism, trust versus assertiveness, ethics versus perseverance, open-mindedness versus wisdom, passion versus compassion, resilience versus dependability.

329. A métier-methodized ranking system of individuals for a particular métier application as described in clause 329 or any other clause wherein said métier-methodized self-assessment query prompt comprises ranking questions.

330. A métier-methodized ranking system of individuals for a particular métier application as described in clause 329 or any other clause wherein said ranking questions comprise behavioral tendency metric ranking questions.

331. A métier-methodized ranking system of individuals for a particular métier application as described in clause 330 or any other clause wherein said métier comprises the legal profession and wherein said ranking questions comprise ranking questions selected from the group consisting of:
ranking dependability, perseverance, and open-mindedness;
ranking compassion, assertiveness, pragmatism, and trustworthiness; and
ranking resilience, ethics, passion, and wisdom.

332. A métier-methodized ranking system of individuals for a particular métier application as described in clause 317 or any other clause wherein said métier-relevant objective data of said individual comprises objective data selected from first name data, last name data, nickname data, vocation data, avocation data, location data, personal photo data, pronouns data, birthdate data, race data, ethnicity data, skills data, certifications data, training data, endorsements data, recommendations data, mentorship roles data, and any combination of the foregoing.

333. A métier-methodized ranking system of individuals for a particular métier application as described in clause 332 or any other clause wherein said métier comprises the legal profession and wherein said métier-relevant objective data of said individual comprises objective data selected from law firm data, field of law data, legal specialty area data, state licensing data, practice geography data, law school data, legal education data, year of bar admission data, desired case type data, recent case overview data, recent case results data, and any combination of the foregoing.

334. A métier-methodized ranking system of individuals for a particular métier application as described in clause 317 or any other clause wherein said métier-methodized individual objective information capture element comprises a métier-methodized self-assessment query prompt.

335. A métier-methodized ranking system of individuals for a particular métier application as described in clause 317 or any other clause wherein said data numeration processing element comprises a data numeration processing element configured to assign a numerical value to at least one métier-methodized self-assessment query response.

336. A métier-methodized ranking system of individuals for a particular métier application as described in clause 335 or any other clause wherein said at least one métier-methodized self-assessment query response comprises a métier trait metric.

337. A métier-methodized ranking system of individuals for a particular métier application as described in clause 336 or any other clause further comprising an equal number of métier-methodized self-assessment queries for each said métier trait metric.

338. A métier-methodized ranking system of individuals for a particular métier application as described in clause 336 or any other clause wherein said métier comprises the legal profession and wherein said at least one métier trait metric comprises a behavioral tendency metric.

339. A métier-methodized ranking system of individuals for a particular métier application as described in clause 336 or any other clause wherein said métier comprises the legal profession and wherein said data numeration processing element comprises a data numeration processing element configured to create a set of numerical values for behavioral tendencies.

340. A métier-methodized ranking system of individuals for a particular métier application as described in clause 336 or any other clause wherein said data numeration processing element configured to assign a numerical value comprises a data numeration processing element configured to assign a numerical value between 0 and 1 inclusive.

341. A métier-methodized ranking system of individuals for a particular métier application as described in clause 336 or any other clause wherein said data numeration processing element configured to create métier-relevant numerical input data for said individual from said métier-relevant psychological data of said individual and said métier-relevant objective data of said individual comprises a data numeration processing element configured to create métier-relevant normalized numerical input data for said individual from said métier-relevant psychological data of said individual and said métier-relevant objective data of said individual.

342. A métier-methodized ranking system of individuals for a particular métier application as described in clause 341 or any other clause wherein said métier-relevant normalized numerical input data for said individual comprises métier-relevant normalized numerical input data for said individual selected from scalable numerical input data for said individual, symmetrical numerical input data for said individual, and any combination of the foregoing.

343. A métier-methodized ranking system of individuals for a particular métier application as described in clause 336 or any other clause wherein said data numeration processing element comprises a data numeration processing element configured to assign a plurality of numerical values to an n-dimensional space.

344. A métier-methodized ranking system of individuals for a particular métier application as described in clause 343 or any other clause wherein each dimension of said n-dimensional space represents a métier trait metric.

345. A métier-methodized ranking system of individuals for a particular métier application as described in clause 343 or any other clause wherein said métier comprises the legal profession and wherein said n-dimensional space comprises a plurality of behavioral tendency dimensions.

346. A métier-methodized ranking system of individuals for a particular métier application as described in clause 345 or any other clause wherein said behavioral tendency dimensions comprise behavioral tendency dimensions selected from assertiveness, compassion, creativity, dependability, ethicalness, open-mindedness, passion, perseverance, pragmatism, resilience, trust, wisdom, and any combination of the foregoing.

347. A métier-methodized ranking system of individuals for a particular métier application as described in clause 335 or any other clause wherein said data numeration processing element comprises a data numeration processing element configured to create a numerical matrix.

348. A métier-methodized ranking system of individuals for a particular métier application as described in clause 317 or any other clause wherein said métier-relevant numerical input data for said individual comprises métier-relevant numerical input data for at least one métier trait metric for said individual.

349. A métier-methodized ranking system of individuals for a particular métier application as described in clause 348 or any other clause wherein said métier comprises the legal profession and wherein said métier trait metric comprises a behavioral tendency metric.

350. A métier-methodized ranking system of individuals for a particular métier application as described in clause 348 or any other clause wherein said métier-applied data valuation framework processing element comprises a métier-applied data valuation framework processing element configured to create métier-applied revalued numerical data for said individual by applicatively revaluing at least one numerical value of said métier-relevant numerical input data from an initial value between 0 and 1 inclusive to an adjusted value between 0 and 1 inclusive.

351. A métier-methodized ranking system of individuals for a particular métier application as described in clause 348 or any other clause wherein said métier-applied data valuation framework comprises at least one métier-trait-metric parameter, wherein said métier-relevant numerical input data comprises data paired métier-relevant numerical input data, and wherein said métier-applied data valuation framework processing element comprises a métier-applied data valuation framework processing element configured to:
perform a métier-trait-metric-parameter-specific mathematical operation on at least one numerical value of said data paired métier-relevant numerical input data to create an interim numerical data set;
apply a métier-trait-metric-parameter-specific mathematical calculation to said interim numerical data set to create an interim métier-trait-metric parameter value;
multiply said interim métier-trait-metric parameter value by a métier-trait-metric parameter weight to create a weighted métier-trait-metric parameter value, wherein said métier-trait-metric parameter weight is established as a métier-trait-metric-parameter-specific relative parameter weight value for said métier-trait-metric parameter divided by the sum of the métier-trait-metric-parameter-specific relative parameter weight values for each of all other métier-trait-metric parameters of said métier-applied data valuation framework.

352. A métier-methodized ranking system of individuals for a particular métier application as described in clause 351 or any other clause:
wherein said métier comprises the legal profession;
wherein said métier application comprises networking;
wherein said métier-applied data valuation framework comprises a métier-applied networking data valuation framework; and
wherein said individual comprises a networking aspirant individual.

353. A métier-methodized ranking system of individuals for a particular métier application as described in clause 352 or any other clause:
wherein said at least one métier-trait-metric parameter comprises a behavioral-tendency-similarity-for-assertiveness parameter;
wherein said métier-relevant numerical input data for said individual comprises an assertiveness behavioral tendency score for said networking aspirant individual and further comprising an assertiveness behavioral tendency score for a networking candidate individual, each said behavioral tendency score comprising a numerical value between 0 and 1 inclusive;
wherein said métier-applied data valuation framework processing element configured to apply a métier-trait-metric-parameter-specific mathematical calculation comprises a métier-applied data valuation framework processing element configured to subtract said assertiveness behavioral tendency score for said networking candidate individual from said assertiveness behavioral tendency score for said networking aspirant individual and take the absolute value of the result; and
wherein said relative parameter weight comprises the numerical value 1.

354. A métier-methodized ranking system of individuals for a particular métier application as described in clause 353 or any other clause wherein each said assertiveness behavioral tendency score for each said individual comprises the quotient of a numerical value for all métier-methodized self-assessment query responses of a métier-methodized self-assessment query for said individual pertaining to an assertiveness behavioral tendency divided by a numerical value for all métier-methodized self-assessment query responses for all behavioral tendencies inquired of by said métier-methodized self-assessment query for said individual.

355. A métier-methodized ranking system of individuals for a particular métier application as described in clause 352 or any other clause:
wherein said at least one métier-trait-metric parameter comprises a behavioral-tendency-similarity-for-compassion parameter;
wherein said métier-relevant numerical input data for said individual comprises a compassion behavioral tendency score for said networking aspirant individual and further comprising a compassion behavioral tendency score for a networking candidate individual, each said behavioral tendency score comprising a numerical value between 0 and 1 inclusive;
wherein said métier-applied data valuation framework processing element configured to apply a métier-trait-metric-parameter-specific mathematical calculation comprises a métier-applied data valuation framework processing element configured to subtract said compassion behavioral tendency score for said networking candidate individual from said compassion behavioral tendency score for said networking aspirant individual and take the absolute value of the result; and
wherein said relative parameter weight comprises the numerical value 1.

356. A métier-methodized ranking system of individuals for a particular métier application as described in clause 355 or any other clause wherein each said compassion behavioral tendency score for each said individual comprises the quotient of a numerical value for all métier-methodized self-assessment query responses of a métier-methodized self-assessment query for said individual pertaining to a compassion behavioral tendency divided by a numerical value for all métier-methodized self-assessment query responses for all behavioral tendencies inquired of by said métier-methodized self-assessment query for said individual.

357. A métier-methodized ranking system of individuals for a particular métier application as described in clause 352 or any other clause:
wherein said at least one métier-trait-metric parameter comprises a behavioral-tendency-similarity-for-creativity parameter;
wherein said métier-relevant numerical input data for said individual comprises a creativity behavioral tendency score for said networking aspirant individual and further comprising a creativity behavioral tendency score for a networking candidate individual, each said behavioral tendency score comprising a numerical value between 0 and 1 inclusive;
wherein said métier-applied data valuation framework processing element configured to apply a métier-trait-metric-parameter-specific mathematical calculation comprises a métier-applied data valuation framework processing element configured to subtract said creativity behavioral tendency score for said networking candidate individual from said creativity behavioral tendency score for said networking aspirant individual and take the absolute value of the result; and
wherein said relative parameter weight comprises the numerical value 1.

358. A métier-methodized ranking system of individuals for a particular métier application as described in clause 357 or any other clause wherein each said creativity behavioral tendency score for each said individual comprises the quotient of a numerical value for all métier-methodized self-assessment query responses of a métier-methodized self-assessment query for said individual pertaining to a creativity behavioral tendency divided by a numerical value for all métier-methodized self-assessment query responses for all behavioral tendencies inquired of by said métier-methodized self-assessment query for said individual.

359. A métier-methodized ranking system of individuals for a particular métier application as described in clause 352 or any other clause:
wherein said at least one métier-trait-metric parameter comprises a behavioral-tendency-similarity-for-deliberation parameter;
wherein said métier-relevant numerical input data for said individual comprises a deliberation behavioral tendency score for said networking aspirant individual and further comprising a deliberation behavioral tendency score for a networking candidate individual, each said behavioral tendency score comprising a numerical value between 0 and 1 inclusive;
wherein said métier-applied data valuation framework processing element configured to apply a métier-trait-metric-parameter-specific mathematical calculation comprises a métier-applied data valuation framework processing element configured to subtract said deliberation behavioral tendency score for said networking candidate individual from said deliberation behavioral tendency score for said networking aspirant individual and take the absolute value of the result; and
wherein said relative parameter weight comprises the numerical value 1.

360. A métier-methodized ranking system of individuals for a particular métier application as described in clause 63 or any other clause wherein each said deliberation behavioral tendency score for each said individual comprises the quotient of a numerical value for all métier-methodized self-assessment query responses of a métier-methodized self-assessment query for said individual pertaining to a deliberation behavioral tendency divided by a numerical value for all métier-methodized self-assessment query responses for all behavioral tendencies inquired of by said métier-methodized self-assessment query for said individual.

361. A métier-methodized ranking system of individuals for a particular métier application as described in clause 352 or any other clause:
wherein said at least one métier-trait-metric parameter comprises a behavioral-tendency-similarity-for-ethics parameter;
wherein said métier-relevant numerical input data for said individual comprises an ethics behavioral tendency score for said networking aspirant individual and further comprising an ethics behavioral tendency score for a networking candidate individual, each said behavioral tendency score comprising a numerical value between 0 and 1 inclusive;
wherein said métier-applied data valuation framework processing element configured to apply a métier-trait-metric-parameter-specific mathematical calculation comprises a métier-applied data valuation framework processing element configured to subtract said ethics behavioral tendency score for said networking candidate individual from said ethics behavioral tendency score for said networking aspirant individual and take the absolute value of the result; and
wherein said relative parameter weight comprises the numerical value 1.

362. A métier-methodized ranking system of individuals for a particular métier application as described in clause 361 or any other clause wherein each said ethics behavioral tendency score for each said individual comprises the quotient of a numerical value for all métier-methodized self-assessment query responses of a métier-methodized self-assessment query for said individual pertaining to an ethics behavioral tendency divided by a numerical value for all métier-methodized self-assessment query responses for all behavioral tendencies inquired of by said métier-methodized self-assessment query for said individual.

363. A métier-methodized ranking system of individuals for a particular métier application as described in clause 352 or any other clause:
wherein said at least one métier-trait-metric parameter comprises a behavioral-tendency-similarity-for-open-mindedness parameter;
wherein said métier-relevant numerical input data for said individual comprises an open-mindedness behavioral tendency score for said networking aspirant individual and further comprising an open-mindedness behavioral tendency score for a networking candidate individual, each said behavioral tendency score comprising a numerical value between 0 and 1 inclusive;
wherein said métier-applied data valuation framework processing element configured to apply a métier-trait-metric-parameter-specific mathematical calculation comprises a métier-applied data valuation framework processing element configured to subtract said open-mindedness behavioral tendency score for said networking candidate individual from said open-mindedness behavioral tendency score for said networking aspirant individual and take the absolute value of the result; and
wherein said relative parameter weight comprises the numerical value 1.

364. A métier-methodized ranking system of individuals for a particular métier application as described in clause 363 or any other clause wherein each said open-mindedness behavioral tendency score for each said individual comprises the quotient of a numerical value for all métier-methodized self-assessment query responses of a métier-methodized self-assessment query for said individual pertaining to an open-mindedness behavioral tendency divided by a numerical value for all métier-methodized self-assessment query responses for all behavioral tendencies inquired of by said métier-methodized self-assessment query for said individual.

365. A métier-methodized ranking system of individuals for a particular métier application as described in clause 352 or any other clause:
wherein said at least one métier-trait-metric parameter comprises a behavioral-tendency-similarity-for-passion parameter;
wherein said métier-relevant numerical input data for said individual comprises a passion behavioral tendency score for said networking aspirant individual and further comprising a passion behavioral tendency score for a networking candidate individual, each said behavioral tendency score comprising a numerical value between 0 and 1 inclusive;
wherein said métier-applied data valuation framework processing element configured to apply a métier-trait-metric-parameter-specific mathematical calculation comprises a métier-applied data valuation framework processing element configured to subtract said passion behavioral tendency score for said networking candidate individual from said passion behavioral tendency score for said networking aspirant individual and take the absolute value of the result; and
wherein said relative parameter weight comprises the numerical value 1.

366. A métier-methodized ranking system of individuals for a particular métier application as described in clause 365 or any other clause wherein each said passion behavioral tendency score for each said individual comprises the quotient of a numerical value for all métier-methodized self-assessment query responses of a métier-methodized self-assessment query for said individual pertaining to a passion behavioral tendency divided by a numerical value for all métier-methodized self-assessment query responses for all behavioral tendencies inquired of by said métier-methodized self-assessment query for said individual.

367. A métier-methodized ranking system of individuals for a particular métier application as described in clause 352 or any other clause:
wherein said at least one métier-trait-metric parameter comprises a behavioral-tendency-similarity-for-perseverance parameter;
wherein said métier-relevant numerical input data for said individual comprises a perseverance behavioral tendency score for said networking aspirant individual and further comprising a perseverance behavioral tendency score for a networking candidate individual, each said behavioral tendency score comprising a numerical value between 0 and 1 inclusive;
wherein said métier-applied data valuation framework processing element configured to apply a métier-trait-metric-parameter-specific mathematical calculation comprises a métier-applied data valuation framework processing element configured to subtract said perseverance behavioral tendency score for said networking candidate individual from said perseverance behavioral tendency score for said networking aspirant individual and take the absolute value of the result; and
wherein said relative parameter weight comprises the numerical value 1.

368. A métier-methodized ranking system of individuals for a particular métier application as described in clause 367 or any other clause wherein each said perseverance behavioral tendency score for each said individual comprises the quotient of a numerical value for all métier-methodized self-assessment query responses of a métier-methodized self-assessment query for said individual pertaining to a perseverance behavioral tendency divided by a numerical value for all métier-methodized self-assessment query responses for all behavioral tendencies inquired of by said métier-methodized self-assessment query for said individual.

369. A métier-methodized ranking system of individuals for a particular métier application as described in clause 352 or any other clause:
wherein said at least one métier-trait-metric parameter comprises a behavioral-tendency-similarity-for-pragmatism parameter;
wherein said métier-relevant numerical input data for said individual comprises a pragmatism behavioral tendency score for said networking aspirant individual and further comprising a pragmatism behavioral tendency score for a networking candidate individual, each said behavioral tendency score comprising a numerical value between 0 and 1 inclusive;
wherein said métier-applied data valuation framework processing element configured to apply a métier-trait-metric-parameter-specific mathematical calculation comprises a métier-applied data valuation framework processing element configured to subtract said pragmatism behavioral tendency score for said networking candidate individual from said pragmatism behavioral tendency score for said networking aspirant individual and take the absolute value of the result; and
wherein said relative parameter weight comprises the numerical value 1.

370. A métier-methodized ranking system of individuals for a particular métier application as described in clause 369 or any other clause wherein each said pragmatism behavioral tendency score for each said individual comprises the quotient of a numerical value for all métier-methodized self-assessment query responses of a métier-methodized self-assessment query for said individual pertaining to a pragmatism behavioral tendency divided by a numerical value for all métier-methodized self-assessment query responses for all behavioral tendencies inquired of by said métier-methodized self-assessment query for said individual.

371. A métier-methodized ranking system of individuals for a particular métier application as described in clause 352 or any other clause:
wherein said at least one métier-trait-metric parameter comprises a behavioral-tendency-similarity-for-skepticism parameter;
wherein said métier-relevant numerical input data for said individual comprises a skepticism behavioral tendency score for said networking aspirant individual and further comprising a skepticism behavioral tendency score for a networking candidate individual, each said behavioral tendency score comprising a numerical value between 0 and 1 inclusive;
wherein said métier-applied data valuation framework processing element configured to apply a métier-trait-metric-parameter-specific mathematical calculation comprises a métier-applied data valuation framework processing element configured to subtract said skepticism behavioral tendency score for said networking candidate individual from said skepticism behavioral tendency score for said networking aspirant individual and take the absolute value of the result; and
wherein said relative parameter weight comprises the numerical value 1.

372. A métier-methodized ranking system of individuals for a particular métier application as described in clause 371 or any other clause wherein each said skepticism behavioral tendency score for each said individual comprises the quotient of a numerical value for all métier-methodized self-assessment query responses of a métier-methodized self-assessment query for said individual pertaining to a skepticism behavioral tendency divided by a numerical value for all métier-methodized self-assessment query responses for all behavioral tendencies inquired of by said métier-methodized self-assessment query for said individual.

373. A métier-methodized ranking system of individuals for a particular métier application as described in clause 352 or any other clause:
wherein said at least one métier-trait-metric parameter comprises a behavioral-tendency-similarity-for-urgency parameter;
wherein said métier-relevant numerical input data for said individual comprises an urgency behavioral tendency score for said networking aspirant individual and further comprising an urgency behavioral tendency score for a networking candidate individual, each said behavioral tendency score comprising a numerical value between 0 and 1 inclusive;
wherein said métier-applied data valuation framework processing element configured to apply a métier-trait-metric-parameter-specific mathematical calculation comprises a métier-applied data valuation framework processing element configured to subtract said urgency behavioral tendency score for said networking candidate individual from said urgency behavioral tendency score for said networking aspirant individual and take the absolute value of the result; and
wherein said relative parameter weight comprises the numerical value 1.

374. A métier-methodized ranking system of individuals for a particular métier application as described in clause 373 or any other clause wherein each said urgency behavioral tendency score for each said individual comprises the quotient of a numerical value for all métier-methodized self-assessment query responses of a métier-methodized self-assessment query for said individual pertaining to an urgency behavioral tendency divided by a numerical value for all métier-methodized self-assessment query responses for all behavioral tendencies inquired of by said métier-methodized self-assessment query for said individual.

375. A métier-methodized ranking system of individuals for a particular métier application as described in clause 352 or any other clause:
wherein said at least one métier-trait-metric parameter comprises a behavioral-tendency-similarity-for-wisdom parameter;
wherein said métier-relevant numerical input data for said individual comprises a wisdom behavioral tendency score for said networking aspirant individual and further comprising a wisdom behavioral tendency score for a networking candidate individual, each said behavioral tendency score comprising a numerical value between 0 and 1 inclusive;
wherein said métier-applied data valuation framework processing element configured to apply a métier-trait-metric-parameter-specific mathematical calculation comprises a métier-applied data valuation framework processing element configured to subtract said wisdom behavioral tendency score for said networking candidate individual from said wisdom behavioral tendency score for said networking aspirant individual and take the absolute value of the result; and
wherein said relative parameter weight comprises the numerical value 1.

376. A métier-methodized ranking system of individuals for a particular métier application as described in clause 375 or any other clause wherein each said wisdom behavioral tendency score for each said individual comprises the quotient of a numerical value for all métier-methodized self-assessment query responses of a métier-methodized self-assessment query for said individual pertaining to a wisdom behavioral tendency divided by a numerical value for all métier-methodized self-assessment query responses for all behavioral tendencies inquired of by said métier-methodized self-assessment query for said individual.

377. A métier-methodized ranking system of individuals for a particular métier application as described in clause 352 or any other clause:
wherein said at least one métier-trait-metric parameter comprises a feedback parameter;
wherein said métier-relevant numerical input data for said individual comprises all feedback scores for a networking candidate individual;
wherein said métier-applied data valuation framework processing element configured to perform a métier-trait-metric-parameter-specific mathematical operation comprises a métier-applied data valuation framework processing element configured to create said interim numerical data set by:
   eliminating any feedback score older than a threshold age value; and
   eliminating any feedback score outside of a threshold interquartile range value for said feedback scores;
wherein said métier-applied data valuation framework processing element configured to apply a métier-trait-metric-parameter-specific mathematical calculation comprises a métier-applied data valuation framework processing element configured to take the average of said feedback scores of said interim numerical data set; and
wherein said relative parameter weight comprises the numerical value of 1.

378. A métier-methodized ranking system of individuals for a particular métier application as described in clause 377 or any other clause wherein said threshold age value comprises one year.

379. A métier-methodized ranking system of individuals for a particular métier application as described in clause 377 or any other clause wherein said threshold interquartile range value comprises +/−1.5 interquartile range.

380. A métier-methodized ranking system of individuals for a particular métier application as described in clause 352 or any other clause:
wherein said at least one métier-trait-metric parameter comprises a degrees-of-separation parameter;
wherein said métier-relevant numerical input data for said individual comprises a colleague match value for said networking aspirant individual and further comprising a colleague match value for a networking candidate individual;
wherein said métier-applied data valuation framework processing element configured to apply a métier-trait-metric-parameter-specific mathematical calculation comprises a métier-applied data valuation framework processing element configured to set said interim métier-trait-metric parameter value to a numerical value of 1 for colleague match values that indicate a colleague match and to set said interim métier-trait-metric parameter value to a numerical value of 0 in all other cases; and
wherein said relative parameter weight comprises the numerical value of 1.

381. A métier-methodized ranking system of individuals for a particular métier application as described in clause 352 or any other clause:
wherein said at least one métier-trait-metric parameter comprises a networking-aspirant-for-networking-candidate-feedback-scores parameter;
wherein said métier-relevant numerical input data for said individual comprises all feedback scores given by said networking aspirant individual to said networking candidate individual;
wherein said métier-applied data valuation framework processing element configured to perform a métier-trait-metric-parameter-specific mathematical operation comprises a métier-applied data valuation framework processing element configured to create said interim numerical data set by:
   eliminating any feedback score older than a threshold age value;
wherein said métier-applied data valuation framework processing element configured to apply a métier-trait-metric-parameter-specific mathematical calculation comprises a métier-applied data valuation framework processing element configured to take the average of said feedback scores of said interim numerical data set; and
wherein said relative parameter weight comprises the numerical value of 1.

382. A métier-methodized ranking system of individuals for a particular métier application as described in clause 381 or any other clause wherein said threshold age value comprises one year.

383. A métier-methodized ranking system of individuals for a particular métier application as described in clause 352 or any other clause:
wherein said at least one métier-trait-metric parameter comprises a networking-candidate-for-networking-aspirant-feedback-scores parameter;
wherein said métier-relevant numerical input data for said individual comprises all feedback scores given by said networking candidate individual to said networking aspirant individual;
wherein said métier-applied data valuation framework processing element configured to perform a métier-trait-metric-parameter-specific mathematical operation comprises a métier-applied data valuation framework processing element configured to create said interim numerical data set by:
   eliminating any feedback score older than a threshold age value;
wherein said métier-applied data valuation framework processing element configured to apply a métier-trait-metric-parameter-specific mathematical calculation comprises a métier-applied data valuation framework processing element configured to take the average of said feedback scores of said interim numerical data set; and
wherein said relative parameter weight comprises the numerical value of 1.

384. A métier-methodized ranking system of individuals for a particular métier application as described in clause 383 or any other clause wherein said threshold age value comprises three months.

385. A métier-methodized ranking system of individuals for a particular métier application as described in clause 352 or any other clause:
wherein said at least one métier-trait-metric parameter comprises a profession/field/specialty-coverage parameter;
wherein said métier-relevant numerical input data for said individual comprises a colleague profession/field/specialty match value for said networking aspirant individual and further comprising a profession/field/specialty match value for a networking candidate individual;
wherein said métier-applied data valuation framework processing element configured to apply a métier-trait-metric-parameter-specific mathematical calculation comprises a métier-applied data valuation framework processing element configured to set said interim métier-trait-metric parameter value to a numerical value of 1 if said profession/field/specialty match values indicate a profession match and a field/specialty disparity and to set said interim métier-trait-metric parameter value to a numerical value of 0 in all other cases; and
wherein said relative parameter weight comprises the numerical value of 1.

386. A métier-methodized ranking system of individuals for a particular métier application as described in clause 352 or any other clause:
wherein said at least one métier-trait-metric parameter comprises an own-profession-coverage parameter;
wherein said métier-relevant numerical input data for said individual comprises a profession/field/specialty match value for said networking aspirant individual and further comprising a profession/field/specialty match value for a networking candidate individual;
wherein said métier-applied data valuation framework processing element configured to apply a métier-trait-metric-parameter-specific mathematical calculation comprises a métier-applied data valuation framework processing element configured to set said interim métier-trait-metric parameter value to a numerical value of 1 if said profession/field/specialty match values indicate a profession/field match and a specialty disparity and to set said interim métier-trait-metric parameter value to a numerical value of 0 in all other cases; and
wherein said relative parameter weight comprises the numerical value of 1.

387. A métier-methodized ranking system of individuals for a particular métier application as described in clause 352 or any other clause:
wherein said at least one métier-trait-metric parameter comprises a profession/region parameter;
wherein said métier-relevant numerical input data for said individual comprises a profession/region match value for said networking aspirant individual and further comprising a profession/region match value for a networking candidate
wherein said métier-applied data valuation framework processing element configured to apply a métier-trait-metric-parameter-specific mathematical calculation comprises a métier-applied data valuation framework processing element configured to set said interim métier-trait-metric parameter value to a numerical value of 1 if said profession/region match values indicate a profession match and a region disparity and to set said interim métier-trait-metric parameter value to a numerical value of 0 in all other cases; and
wherein said relative parameter weight comprises the numerical value of 1.

388. A métier-methodized ranking system of individuals for a particular métier application as described in clause 352 or any other clause:
wherein said at least one métier-trait-metric parameter comprises a years-of-practice parameter;
wherein said métier-relevant numerical input data for said individual comprises a profession/field/years-of-practice match value for said networking aspirant individual and further comprising a profession/field/years-of-practice match value for a networking candidate individual;
wherein said métier-applied data valuation framework processing element configured to apply a métier-trait-metric-parameter-specific mathematical calculation comprises a métier-applied data valuation framework processing element configured to set said interim métier-trait-metric parameter value to a numerical value of 1 if said profession/field/years-of-practice match values indicate a profession/field match and a years-of-practice disparity and to set said interim métier-trait-metric parameter value to a numerical value of 0 in all other cases; and
wherein said relative parameter weight comprises the numerical value of 3.

389. A métier-methodized ranking system of individuals for a particular métier application as described in clause 352 or any other clause:
wherein said at least one métier-trait-metric parameter comprises a network-identity-composition parameter;
wherein said métier-relevant numerical input data for said individual comprises an identity match value for said networking aspirant individual;
wherein said métier-applied data valuation framework processing element configured to apply a métier-trait-metric-parameter-specific mathematical calculation comprises a métier-applied data valuation framework processing element configured to set said interim métier-trait-metric parameter value to the numerical value of the difference obtained by subtracting the percentage of individuals in said networking aspirant's network having the same identity match value from the percentage of individuals in a pool of individuals having the same identity match value if such numerical value of such difference is greater than 0 and to set said interim métier-trait-metric parameter value to a numerical value of 0 in all other cases; and
wherein said relative parameter weight comprises the numerical value of 3.

390. A métier-methodized ranking system of individuals for a particular métier application as described in clause 389 or any other clause wherein said pool of individuals comprises lawyers in the United States.

391. A métier-methodized ranking system of individuals for a particular métier application as described in clause 352 or any other clause:
wherein said at least one métier-trait-metric parameter comprises a network-pronouns-composition parameter;
wherein said métier-relevant numerical input data for said individual comprises a pronoun match value for said networking aspirant individual;
wherein said métier-applied data valuation framework processing element configured to apply a métier-trait-metric-parameter-specific mathematical calculation comprises a métier-applied data valuation framework processing element configured to set said interim métier-trait-metric parameter value to the numerical value of the difference obtained by subtracting the percentage of individuals in said networking aspirant's network having the same pronoun match value from the percentage of individuals in a pool of individuals having the same pronoun match value if such numerical value of such difference is greater than 0 and setting said interim métier-trait-metric parameter value to a numerical value of 0 in all other cases; and
wherein said relative parameter weight comprises the numerical value of 3.

392. A métier-methodized ranking system of individuals for a particular métier application as described in clause 391 or any other clause wherein said pool of individuals comprises lawyers in the United States.

393. A métier-methodized ranking system of individuals for a particular métier application as described in clause 352 or any other clause:
wherein said at least one métier-trait-metric parameter comprises a network-age-composition parameter;
wherein said métier-relevant numerical input data for said individual comprises an age match value for said networking aspirant individual;
wherein said métier-applied data valuation framework processing element configured to apply a métier-trait-metric-parameter-specific mathematical calculation comprises a métier-applied data valuation framework processing element configured to set said interim métier-trait-metric parameter value to the numerical value of the difference obtained by subtracting the percentage of individuals in said networking aspirant's network having the same age match value from the percentage of individuals in a pool of individuals having the same age match value if such numerical value of such difference is greater than 0 and to set said interim métier-trait-metric parameter value to a numerical value of 0 in all other cases; and
wherein said relative parameter weight comprises the numerical value of 3.

394. A métier-methodized ranking system of individuals for a particular métier application as described in clause 393 or any other clause wherein said pool of individuals comprises lawyers in the United States.

395. A métier-methodized ranking system of individuals for a particular métier application as described in clause 351 or any other clause:
wherein said métier comprises the legal profession;
wherein said métier application comprises team-building;
wherein said métier-applied data valuation framework comprises a métier-applied team-building data valuation framework; and
wherein said individual comprises a team-member candidate individual.

396. A métier-methodized ranking system of individuals for a particular métier application as described in clause 395 or any other clause:
wherein said at least one métier-trait-metric parameter comprises a team-field/specialty-complementarity parameter;
wherein said métier-relevant numerical input data for said individual comprises a profession/field/specialty match value for said team-member candidate individual and further comprising a profession/field/specialty match value for a team;
wherein said métier-applied data valuation framework processing element configured to apply a métier-trait-metric-parameter-specific mathematical calculation comprises a métier-applied data valuation framework processing element configured to set said interim métier-trait-metric parameter value to a numerical value of 1 if said profession/field/specialty match values indicate a field/specialty match and a profession disparity and to set said interim métier-trait-metric parameter value to a numerical value of 0 in all other cases; and
wherein said relative parameter weight comprises the numerical value of 1.

397. A métier-methodized ranking system of individuals for a particular métier application as described in claim 395:
wherein said at least one métier-trait-metric parameter comprises a personality-harmony parameter;
wherein said métier-relevant numerical input data for said individual comprises a numerical value for each behavioral tendency inquired of by a métier-methodized self-assessment query for said team-member candidate individual and further comprising, for each member individual of a team, a numerical value for each behavioral tendency inquired of by a métier-methodized self-assessment query for said member individual of said team;
wherein said métier-applied data valuation framework processing element configured to apply a métier-trait-metric-parameter-specific mathematical calculation comprises a métier-applied data valuation framework processing element configured to:
   take the sum of all said numerical values for each said behavioral tendency for all said individuals to create a first set of numerical value sums for each said behavioral tendency;
   take the standard deviation of said first set of numerical value sums to obtain a first standard deviation value;
   take the sum of all said numerical values for each said behavioral tendency for all said member individuals of said team to create a second set of numerical value sums for each said behavioral tendency;
   take the standard deviation of said second set of numerical value sums to obtain a second standard deviation value;
   set said interim métier-trait-metric parameter value to a numerical value of 0 if said first standard deviation value is greater than said second standard deviation value;
   set said interim métier-trait-metric parameter value in all other cases to a numerical value equal to the quotient of said first standard deviation value divided by said second standard deviation value, said quotient subtracted from the numerical value 1; and
wherein said relative parameter weight comprises the numerical value of 1.

398. A métier-methodized ranking system of individuals for a particular métier application as described in clause 395 or any other clause:
wherein said at least one métier-trait-metric parameter comprises an average-degrees-of-separation parameter;
wherein said métier-relevant numerical input data for said individual comprises a colleague match value for said team-member candidate individual for each individual team member of a team;
wherein said métier-applied data valuation framework processing element configured to apply a métier-trait-metric-parameter-specific mathematical calculation comprises a métier-applied data valuation framework processing element configured to:
   assign a numerical value of 1 for colleague match values that indicate a colleague match and assign a numerical value of 0 for colleague match values that do not indicate a colleague match;
   take the average of said assigned numerical values; and
wherein said relative parameter weight comprises the numerical value of 1.

399. A métier-methodized ranking system of individuals for a particular métier application as described in clause 395 or any other clause:
wherein said at least one métier-trait-metric parameter comprises a team-member-candidate-feedback parameter;
wherein said métier-relevant numerical input data for said individual comprises all feedback scores for said team-member candidate individual;
wherein said métier-applied data valuation framework processing element configured to perform a métier-trait-metric-parameter-specific mathematical operation comprises a métier-applied data valuation framework processing element configured to create said interim numerical data set by:
   eliminating any feedback score older than a threshold age value; and
   eliminating any feedback score outside of a threshold interquartile range value for said feedback scores;
wherein said métier-applied data valuation framework processing element configured to apply a métier-trait-metric-parameter-specific mathematical calculation comprises a métier-applied data valuation framework processing element configured to take the average of said feedback scores of said interim numerical data set; and
wherein said relative parameter weight comprises the numerical value of 1.

400. A métier-methodized ranking system of individuals for a particular métier application as described in clause 399 or any other clause wherein said threshold age value comprises one year.

401. A métier-methodized ranking system of individuals for a particular métier application as described in clause 399 or any other clause wherein said threshold interquartile range value comprises +/−1.5 interquartile range.

402. A métier-methodized ranking system of individuals for a particular métier application as described in clause 395 or any other clause:
wherein said at least one métier-trait-metric parameter comprises a team-years-of-practice parameter;
wherein said métier-relevant numerical input data for said individual comprises a profession/years-of-practice match value for said team-member candidate individual and further comprising a profession/years-of-practice match value for a team;
wherein said métier-applied data valuation framework processing element configured to apply a métier-trait-metric-parameter-specific mathematical calculation comprises a métier-applied data valuation framework processing element configured to set said interim métier-trait-metric parameter value to a numerical value of 1 if said profession/years-of-practice match values indicate a profession match and a years-of-practice disparity and to set said interim métier-trait-metric parameter value to a numerical value of 0 in all other cases; and
wherein said relative parameter weight comprises the numerical value of 1.

403. A métier-methodized ranking system of individuals for a particular métier application as described in clause 395 or any other clause:
wherein said at least one métier-trait-metric parameter comprises a team-identity-composition parameter;
wherein said métier-relevant numerical input data for said individual comprises an identity match value for said team-member candidate individual;
wherein said métier-applied data valuation framework processing element configured to apply a métier-trait-metric-parameter-specific mathematical calculation comprises a métier-applied data valuation framework processing element configured to set said interim métier-trait-metric parameter value to the numerical value of the difference obtained by subtracting the percentage of individuals of said team having the same identity match value from the percentage of individuals in a pool of individuals having the same identity match value if such numerical value of such difference is greater than 0 and setting said interim métier-trait-metric parameter value to a numerical value of 0 in all other cases; and
wherein said relative parameter weight comprises the numerical value of 1.

404. A métier-methodized ranking system of individuals for a particular métier application as described in clause 403 or any other clause wherein said pool of individuals comprises lawyers in the United States.

405. A métier-methodized ranking system of individuals for a particular métier application as described in clause 395 or any other clause:
wherein said at least one métier-trait-metric parameter comprises a team-pronouns-composition parameter;
wherein said métier-relevant numerical input data for said individual comprises a pronoun match value for said team-member candidate individual;
wherein said métier-applied data valuation framework processing element configured to apply a métier-trait-metric-parameter-specific mathematical calculation comprises a métier-applied data valuation framework processing element configured to set said interim métier-trait-metric parameter value to the numerical value of the difference obtained by subtracting the percentage of individuals of said team having the same pronoun match value from the percentage of individuals in a pool of individuals having the same pronoun match value if such numerical value of such difference is greater than 0 and to set said interim métier-trait-metric parameter value to a numerical value of 0 in all other cases; and
wherein said relative parameter weight comprises the numerical value of 1.

406. A métier-methodized ranking system of individuals for a particular métier application as described in clause 405 or any other clause wherein said pool of individuals comprises lawyers in the United States.

407. A métier-methodized ranking system of individuals for a particular métier application as described in clause 395 or any other clause:
wherein said at least one métier-trait-metric parameter comprises a team-age-composition parameter;
wherein said métier-relevant numerical input data for said individual comprises an age match value for said team-member candidate individual;
wherein said métier-applied data valuation framework processing element configured to apply a métier-trait-metric-parameter-specific mathematical calculation comprises a métier-applied data valuation framework processing element configured to set said interim métier-trait-metric parameter value to the numerical value of the difference obtained by subtracting the percentage of individuals of said team having the same age match value from the percentage of individuals in a pool of individuals having the same age match value if such numerical value of such difference is greater than 0 and to set said interim métier-trait-metric parameter value to a numerical value of 0 in all other cases; and
wherein said relative parameter weight comprises the numerical value of 1.

408. A métier-methodized ranking system of individuals for a particular métier application as described in clause 407 or any other clause wherein said pool of individuals comprises lawyers in the United States.

409. A métier-methodized ranking system of individuals for a particular métier application as described in clause 395 or any other clause:
wherein said at least one métier-trait-metric parameter comprises a team-member-candidate-case-success parameter;
wherein said métier-relevant numerical input data for said individual comprises all consensus success values for related teams for said team-member candidate individual;
wherein said métier-applied data valuation framework processing element configured to perform a métier-trait-metric-parameter-specific mathematical operation comprises a métier-applied data valuation framework processing element configured to create said interim numerical data set by:
   eliminating any consensus success value for related teams outside of a threshold interquartile range value;
wherein said métier-applied data valuation framework processing element configured to apply a métier-trait-metric-parameter-specific mathematical calculation comprises a métier-applied data valuation framework processing element configured to take the average of said consensus success values for related teams of said interim numerical data set; and
wherein said relative parameter weight comprises the numerical value of 1.

410. A métier-methodized ranking system of individuals for a particular métier application as described in clause 409 or any other clause wherein said threshold interquartile range value comprises +/−1.5 interquartile range.

411. A métier-methodized ranking system of individuals for a particular métier application as described in clause 351 or any other clause:
wherein said métier comprises the legal profession;
wherein said métier application comprises referrals;
wherein said métier-applied data valuation framework comprises a métier-applied referrals data valuation framework; and
wherein said individual comprises a referring individual.

412. A métier-methodized ranking system of individuals for a particular métier application as described in clause 411 or any other clause:
wherein said at least one métier-trait-metric parameter comprises a referral-field/specialty-complementarity parameter;
wherein said métier-relevant numerical input data for said individual comprises a profession/field/specialty match value for said referring individual and further comprising a profession/field/specialty match value for a referral candidate
wherein said métier-applied data valuation framework processing element configured to apply a métier-trait-metric-parameter-specific mathematical calculation comprises a métier-applied data valuation framework processing element configured to set said interim métier-trait-metric parameter value to a numerical value of 1 if said profession/field/specialty match values indicate a field/specialty match and to set said interim métier-trait-metric parameter value to a numerical value of 0 in all other cases; and
wherein said relative parameter weight comprises the numerical value of 1.

413. A métier-methodized ranking system of individuals for a particular métier application as described in clause 411 or any other clause:
wherein said at least one métier-trait-metric parameter comprises a feedback parameter;
wherein said métier-relevant numerical input data for said individual comprises all feedback scores for a referral candidate individual;
wherein said métier-applied data valuation framework processing element configured to perform a métier-trait-metric-parameter-specific mathematical operation comprises a métier-applied data valuation framework processing element configured to create said interim numerical data set by:
   eliminating any feedback score older than a threshold age value; and
   eliminating any feedback score outside of a threshold interquartile range value for said feedback scores;
wherein said métier-applied data valuation framework processing element configured to apply a métier-trait-metric-parameter-specific mathematical calculation comprises a métier-applied data valuation framework processing element configured to take the average of said feedback scores of said interim numerical data set; and
wherein said relative parameter weight comprises the numerical value of 1.

414. A métier-methodized ranking system of individuals for a particular métier application as described in clause 413 or any other clause wherein said threshold age value comprises one year.

415. A métier-methodized ranking system of individuals for a particular métier application as described in clause 413 or any other clause wherein said threshold interquartile range value comprises +/−1.5 interquartile range.

416. A métier-methodized ranking system of individuals for a particular métier application as described in clause 411 or any other clause:
wherein said at least one métier-trait-metric parameter comprises a degrees-of-separation parameter;
wherein said métier-relevant numerical input data for said individual comprises a colleague match value for said referring individual and further comprising a colleague match value for a referral candidate individual;
wherein said métier-applied data valuation framework processing element configured to apply a métier-trait-metric-parameter-specific mathematical calculation comprises a métier-applied data valuation framework processing element configured to set said interim métier-trait-metric parameter value to a numerical value of 1 for colleague match values that indicate a colleague match and to set said interim métier-trait-metric parameter value to a numerical value of 0 in all other cases; and
wherein said relative parameter weight comprises the numerical value of 1.

417. A métier-methodized ranking system of individuals for a particular métier application as described in clause 411 or any other clause:
wherein said at least one métier-trait-metric parameter comprises a referral-candidate-case-success parameter;
wherein said métier-relevant numerical input data for said individual comprises all consensus success values for related teams for said referral candidate
wherein said métier-applied data valuation framework processing element configured to perform a métier-trait-metric-parameter-specific mathematical operation comprises a métier-applied data valuation framework processing element configured to create said interim numerical data set by:
   eliminating any consensus success value for related teams outside of a threshold interquartile range value;
wherein said métier-applied data valuation framework processing element configured to apply a métier-trait-metric-parameter-specific mathematical calculation comprises a métier-applied data valuation framework processing element configured to take the average of said consensus success values for related teams of said interim numerical data set; and
wherein said relative parameter weight comprises the numerical value of 1.

418. A métier-methodized ranking system of individuals for a particular métier application as described in clause 417 or any other clause wherein said threshold interquartile range value comprises +/−1.5 interquartile range.

419. A métier-methodized ranking system of individuals for a particular métier application as described in clause 411 or any other clause:
wherein said at least one métier-trait-metric parameter comprises a referring-individual-for-referral-candidate-feedback-scores parameter;
wherein said métier-relevant numerical input data for said individual comprises all feedback scores given by said referring individual to said referral candidate individual;
wherein said métier-applied data valuation framework processing element configured to perform a métier-trait-metric-parameter-specific mathematical operation comprises a métier-applied data valuation framework processing element configured to create said interim numerical data set by:
   eliminating any feedback score older than a threshold age value;
wherein said métier-applied data valuation framework processing element configured to apply a métier-trait-metric-parameter-specific mathematical calculation comprises a métier-applied data valuation framework processing element configured to take the average of said feedback scores of said interim numerical data set; and
wherein said relative parameter weight comprises the numerical value of 1.

420. A métier-methodized ranking system of individuals for a particular métier application as described in clause 419 or any other clause wherein said threshold age value comprises one year.

421. A métier-methodized ranking system of individuals for a particular métier application as described in clause 411 or any other clause:
wherein said at least one métier-trait-metric parameter comprises a referral-candidate-for-referring-individual-feedback-scores parameter;
wherein said métier-relevant numerical input data for said individual comprises all feedback scores given by said referral candidate individual to said referring individual;
wherein said métier-applied data valuation framework processing element configured to perform a métier-trait-metric-parameter-specific mathematical operation comprises a métier-applied data valuation framework processing element configured to create said interim numerical data set by:
   eliminating any feedback score older than a threshold age value;
wherein said métier-applied data valuation framework processing element configured to apply a métier-trait-metric-parameter-specific mathematical calculation comprises a métier-applied data valuation framework processing element configured to take the average of said feedback scores of said interim numerical data set; and
wherein said relative parameter weight comprises the numerical value of 1.

422. A métier-methodized ranking system of individuals for a particular métier application as described in clause 421 or any other clause wherein said threshold age value comprises three months.

423. A métier-methodized ranking system of individuals for a particular métier application as described in clause 351 or any other clause:
wherein said métier comprises the legal profession;
wherein said métier application comprises mentorship;
wherein said métier-applied data valuation framework comprises a métier-applied mentorship data valuation framework; and
wherein said individual comprises a mentee aspirant individual.

424. A métier-methodized ranking system of individuals for a particular métier application as described in clause 423 or any other clause:
wherein said at least one métier-trait-metric parameter comprises a behavioral-tendency-similarity-for-assertiveness parameter;
wherein said métier-relevant numerical input data for said individual comprises an assertiveness behavioral tendency score for said mentee aspirant individual and further comprising an assertiveness behavioral tendency score for a mentor candidate individual, each said behavioral tendency score comprising a numerical value between 0 and 1 inclusive;
wherein said métier-applied data valuation framework processing element configured to apply a métier-trait-metric-parameter-specific mathematical calculation comprises a métier-applied data valuation framework processing element configured to subtract said assertiveness behavioral tendency score for said mentor candidate individual from said assertiveness behavioral tendency score for said mentee aspirant individual and take the absolute value of the result; and
wherein said relative parameter weight comprises the numerical value 1.

425. A métier-methodized ranking system of individuals for a particular métier application as described in clause 424 or any other clause wherein each said assertiveness behavioral tendency score for each said individual comprises the quotient of a numerical value for all métier-methodized self-assessment query responses of a métier-methodized self-assessment query for said individual pertaining to an assertiveness behavioral tendency divided by a numerical value for all métier-methodized self-assessment query responses for all behavioral tendencies inquired of by said métier-methodized self-assessment query for said individual.

426. A métier-methodized ranking system of individuals for a particular métier application as described in clause 423 or any other clause:
wherein said at least one métier-trait-metric parameter comprises a behavioral-tendency-similarity-for-compassion parameter;
wherein said métier-relevant numerical input data for said individual comprises a compassion behavioral tendency score for said mentee aspirant individual and further comprising a compassion behavioral tendency score for a mentor candidate individual, each said behavioral tendency score comprising a numerical value between 0 and 1 inclusive;
wherein said métier-applied data valuation framework processing element configured to apply a métier-trait-metric-parameter-specific mathematical calculation comprises a métier-applied data valuation framework processing element configured to subtract said compassion behavioral tendency score for said mentor candidate individual from said compassion behavioral tendency score for said mentee aspirant individual and take the absolute value of the result; and
wherein said relative parameter weight comprises the numerical value 1.

427. A métier-methodized ranking system of individuals for a particular métier application as described in clause 426 or any other clause wherein each said compassion behavioral tendency score for each said individual comprises the quotient of a numerical value for all métier-methodized self-assessment query responses of a métier-methodized self-assessment query for said individual pertaining to a compassion behavioral tendency divided by a numerical value for all métier-methodized self-assessment query responses for all behavioral tendencies inquired of by said métier-methodized self-assessment query for said individual.

428. A métier-methodized ranking system of individuals for a particular métier application as described in clause 423 or any other clause:
wherein said at least one métier-trait-metric parameter comprises a behavioral-tendency-similarity-for-creativity parameter;
wherein said métier-relevant numerical input data for said individual comprises a creativity behavioral tendency score for said mentee aspirant individual and further comprising a creativity behavioral tendency score for a mentor candidate individual, each said behavioral tendency score comprising a numerical value between 0 and 1 inclusive;
wherein said métier-applied data valuation framework processing element configured to apply a métier-trait-metric-parameter-specific mathematical calculation comprises a métier-applied data valuation framework processing element configured to subtract said creativity behavioral tendency score for said mentor candidate individual from said creativity behavioral tendency score for said mentee aspirant individual and take the absolute value of the result; and
wherein said relative parameter weight comprises the numerical value 1.

429. A métier-methodized ranking system of individuals for a particular métier application as described in clause 428 or any other clause wherein each said creativity behavioral tendency score for each said individual comprises the quotient of a numerical value for all métier-methodized self-assessment query responses of a métier-methodized self-assessment query for said individual pertaining to a creativity behavioral tendency divided by a numerical value for all métier-methodized self-assessment query responses for all behavioral tendencies inquired of by said métier-methodized self-assessment query for said individual.

430. A métier-methodized ranking system of individuals for a particular métier application as described in clause 423 or any other clause:
wherein said at least one métier-trait-metric parameter comprises a behavioral-tendency-similarity-for-deliberation parameter;
wherein said métier-relevant numerical input data for said individual comprises a deliberation behavioral tendency score for said mentee aspirant individual and further comprising a deliberation behavioral tendency score for a mentor candidate individual, each said behavioral tendency score comprising a numerical value between 0 and 1 inclusive;
wherein said métier-applied data valuation framework processing element configured to apply a métier-trait-metric-parameter-specific mathematical calculation comprises a métier-applied data valuation framework processing element configured to subtract said deliberation behavioral tendency score for said mentor candidate individual from said deliberation behavioral tendency score for said mentee aspirant individual and take the absolute value of the result; and
wherein said relative parameter weight comprises the numerical value 1.

431. A métier-methodized ranking system of individuals for a particular métier application as described in clause 430 or any other clause wherein each said deliberation behavioral tendency score for each said individual comprises the quotient of a numerical value for all métier-methodized self-assessment query responses of a métier-methodized self-assessment query for said individual pertaining to a deliberation behavioral tendency divided by a numerical value for all métier-methodized self-assessment query responses for all behavioral tendencies inquired of by said métier-methodized self-assessment query for said individual.

432. A métier-methodized ranking system of individuals for a particular métier application as described in clause 423 or any other clause:
wherein said at least one métier-trait-metric parameter comprises a behavioral-tendency-similarity-for-ethics parameter;
wherein said métier-relevant numerical input data for said individual comprises an ethics behavioral tendency score for said mentee aspirant individual and further comprising an ethics behavioral tendency score for a mentor candidate individual, each said behavioral tendency score comprising a numerical value between 0 and 1 inclusive;
wherein said métier-applied data valuation framework processing element configured to apply a métier-trait-metric-parameter-specific mathematical calculation comprises a métier-applied data valuation framework processing element configured to subtract said ethics behavioral tendency score for said mentor candidate individual from said ethics behavioral tendency score for said mentee aspirant individual and take the absolute value of the result; and
wherein said relative parameter weight comprises the numerical value 1.

433. A métier-methodized ranking system of individuals for a particular métier application as described in clause 432 or any other clause wherein each said ethics behavioral tendency score for each said individual comprises the quotient of a numerical value for all métier-methodized self-assessment query responses of a métier-methodized self-assessment query for said individual pertaining to an ethics behavioral tendency divided by a numerical value for all métier-methodized self-assessment query responses for all behavioral tendencies inquired of by said métier-methodized self-assessment query for said individual.

434. A métier-methodized ranking system of individuals for a particular métier application as described in clause 423 or any other clause:
wherein said at least one métier-trait-metric parameter comprises a behavioral-tendency-similarity-for-open-mindedness parameter;
wherein said métier-relevant numerical input data for said individual comprises an open-mindedness behavioral tendency score for said mentee aspirant individual and further comprising an open-mindedness behavioral tendency score for a mentor candidate individual, each said behavioral tendency score comprising a numerical value between 0 and 1 inclusive;
wherein said métier-applied data valuation framework processing element configured to apply a métier-trait-metric-parameter-specific mathematical calculation comprises a métier-applied data valuation framework processing element configured to subtract said open-mindedness behavioral tendency score for said mentor candidate individual from said open-mindedness behavioral tendency score for said mentee aspirant individual and take the absolute value of the result; and
wherein said relative parameter weight comprises the numerical value 1.

435. A métier-methodized ranking system of individuals for a particular métier application as described in clause 434 or any other clause wherein each said open-mindedness behavioral tendency score for each said individual comprises the quotient of a numerical value for all métier-methodized self-assessment query responses of a métier-methodized self-assessment query for said individual pertaining to an open-mindedness behavioral tendency divided by a numerical value for all métier-methodized self-assessment query responses for all behavioral tendencies inquired of by said métier-methodized self-assessment query for said individual.

436. A métier-methodized ranking system of individuals for a particular métier application as described in clause 423 or any other clause:
wherein said at least one métier-trait-metric parameter comprises a behavioral-tendency-similarity-for-passion parameter;
wherein said métier-relevant numerical input data for said individual comprises a passion behavioral tendency score for said mentee aspirant individual and further comprising a passion behavioral tendency score for a mentor candidate individual, each said behavioral tendency score comprising a numerical value between 0 and 1 inclusive;
wherein said métier-applied data valuation framework processing element configured to apply a métier-trait-metric-parameter-specific mathematical calculation comprises a métier-applied data valuation framework processing element configured to subtract said passion behavioral tendency score for said mentor candidate individual from said passion behavioral tendency score for said mentee aspirant individual and take the absolute value of the result; and
wherein said relative parameter weight comprises the numerical value 1.

437. A métier-methodized ranking system of individuals for a particular métier application as described in clause 436 or any other clause wherein each said passion behavioral tendency score for each said individual comprises the quotient of a numerical value for all métier-methodized self-assessment query responses of a métier-methodized self-assessment query for said individual pertaining to a passion behavioral tendency divided by a numerical value for all métier-methodized self-assessment query responses for all behavioral tendencies inquired of by said métier-methodized self-assessment query for said individual.

438. A métier-methodized ranking system of individuals for a particular métier application as described in clause 423 or any other clause:
wherein said at least one métier-trait-metric parameter comprises a behavioral-tendency-similarity-for-perseverance parameter;
wherein said métier-relevant numerical input data for said individual comprises a perseverance behavioral tendency score for said mentee aspirant individual and further comprising a perseverance behavioral tendency score for a mentor candidate individual, each said behavioral tendency score comprising a numerical value between 0 and 1 inclusive;
wherein said métier-applied data valuation framework processing element configured to apply a métier-trait-metric-parameter-specific mathematical calculation comprises a métier-applied data valuation framework processing element configured to subtract said perseverance behavioral tendency score for said mentor candidate individual from said perseverance behavioral tendency score for said mentee aspirant individual and take the absolute value of the result; and
wherein said relative parameter weight comprises the numerical value 1.

439. A métier-methodized ranking system of individuals for a particular métier application as described in clause 438 or any other clause wherein each said perseverance behavioral tendency score for each said individual comprises the quotient of a numerical value for all métier-methodized self-assessment query responses of a métier-methodized self-assessment query for said individual pertaining to a perseverance behavioral tendency divided by a numerical value for all métier-methodized self-assessment query responses for all behavioral tendencies inquired of by said métier-methodized self-assessment query for said individual.

440. A métier-methodized ranking system of individuals for a particular métier application as described in clause 423 or any other clause:
wherein said at least one métier-trait-metric parameter comprises a behavioral-tendency-similarity-for-pragmatism parameter;
wherein said métier-relevant numerical input data for said individual comprises a pragmatism behavioral tendency score for said mentee aspirant individual and further comprising a pragmatism behavioral tendency score for a mentor candidate individual, each said behavioral tendency score comprising a numerical value between 0 and 1 inclusive;
wherein said métier-applied data valuation framework processing element configured to apply a métier-trait-metric-parameter-specific mathematical calculation comprises a métier-applied data valuation framework processing element configured to subtract said pragmatism behavioral tendency score for said mentor candidate individual from said pragmatism behavioral tendency score for said mentee aspirant individual and take the absolute value of the result; and
wherein said relative parameter weight comprises the numerical value 1.

441. A métier-methodized ranking system of individuals for a particular métier application as described in clause 440 or any other clause wherein each said pragmatism behavioral tendency score for each said individual comprises the quotient of a numerical value for all métier-methodized self-assessment query responses of a métier-methodized self-assessment query for said individual pertaining to a pragmatism behavioral tendency divided by a numerical value for all métier-methodized self-assessment query responses for all behavioral tendencies inquired of by said métier-methodized self-assessment query for said individual.

442. A métier-methodized ranking system of individuals for a particular métier application as described in clause 423 or any other clause:
wherein said at least one métier-trait-metric parameter comprises a behavioral-tendency-similarity-for-skepticism parameter;
wherein said métier-relevant numerical input data for said individual comprises a skepticism behavioral tendency score for said mentee aspirant individual and further comprising a skepticism behavioral tendency score for a mentor candidate individual, each said behavioral tendency score comprising a numerical value between 0 and 1 inclusive;
wherein said métier-applied data valuation framework processing element configured to apply a métier-trait-metric-parameter-specific mathematical calculation comprises a métier-applied data valuation framework processing element configured to subtract said skepticism behavioral tendency score for said mentor candidate individual from said skepticism behavioral tendency score for said mentee aspirant individual and take the absolute value of the result; and
wherein said relative parameter weight comprises the numerical value 1.

443. A métier-methodized ranking system of individuals for a particular métier application as described in clause 442 or any other clause wherein each said skepticism behavioral tendency score for each said individual comprises the quotient of a numerical value for all métier-methodized self-assessment query responses of a métier-methodized self-assessment query for said individual pertaining to a skepticism behavioral tendency divided by a numerical value for all métier-methodized self-assessment query responses for all behavioral tendencies inquired of by said métier-methodized self-assessment query for said individual.

444. A métier-methodized ranking system of individuals for a particular métier application as described in clause 423 or any other clause:
wherein said at least one métier-trait-metric parameter comprises a behavioral-tendency-similarity-for-urgency parameter;
wherein said métier-relevant numerical input data for said individual comprises an urgency behavioral tendency score for said mentee aspirant individual and further comprising an urgency behavioral tendency score for a mentor candidate individual, each said behavioral tendency score comprising a numerical value between 0 and 1 inclusive;
wherein said métier-applied data valuation framework processing element configured to apply a métier-trait-metric-parameter-specific mathematical calculation comprises a métier-applied data valuation framework processing element configured to subtract said urgency behavioral tendency score for said mentor candidate individual from said urgency behavioral tendency score for said mentee aspirant individual and take the absolute value of the result; and
wherein said relative parameter weight comprises the numerical value 1.

445. A métier-methodized ranking system of individuals for a particular métier application as described in clause 444 or any other clause wherein each said urgency behavioral tendency score for each said individual comprises the quotient of a numerical value for all métier-methodized self-assessment query responses of a métier-methodized self-assessment query for said individual pertaining to an urgency behavioral tendency divided by a numerical value for all métier-methodized self-assessment query responses for all behavioral tendencies inquired of by said métier-methodized self-assessment query for said individual.

446. A métier-methodized ranking system of individuals for a particular métier application as described in clause 423 or any other clause:
wherein said at least one métier-trait-metric parameter comprises a behavioral-tendency-similarity-for-wisdom parameter;
wherein said métier-relevant numerical input data for said individual comprises a wisdom behavioral tendency score for said mentee aspirant individual and further comprising a wisdom behavioral tendency score for a mentor candidate individual, each said behavioral tendency score comprising a numerical value between 0 and 1 inclusive;
wherein said métier-applied data valuation framework processing element configured to apply a métier-trait-metric-parameter-specific mathematical calculation comprises a métier-applied data valuation framework processing element configured to subtract said wisdom behavioral tendency score for said mentor candidate individual from said wisdom behavioral tendency score for said mentee aspirant individual and take the absolute value of the result; and
wherein said relative parameter weight comprises the numerical value 1.

447. A métier-methodized ranking system of individuals for a particular métier application as described in clause 446 or any other clause wherein each said wisdom behavioral tendency score for each said individual comprises the quotient of a numerical value for all métier-methodized self-assessment query responses of a métier-methodized self-assessment query for said individual pertaining to a wisdom behavioral tendency divided by a numerical value for all métier-methodized self-assessment query responses for all behavioral tendencies inquired of by said métier-methodized self-assessment query for said individual.

448. A métier-methodized ranking system of individuals for a particular métier application as described in clause 423 or any other clause:
wherein said at least one métier-trait-metric parameter comprises a feedback parameter;
wherein said métier-relevant numerical input data for said individual comprises all feedback scores for a mentor candidate individual;
wherein said métier-applied data valuation framework processing element configured to perform a métier-trait-metric-parameter-specific mathematical operation comprises a métier-applied data valuation framework processing element configured to create said interim numerical data set by:
   eliminating any feedback score older than a threshold age value; and
   eliminating any feedback score outside of a threshold interquartile range value for said feedback scores;
wherein said métier-applied data valuation framework processing element configured to apply a métier-trait-metric-parameter-specific mathematical calculation comprises a métier-applied data valuation framework processing element configured to take the average of said feedback scores of said interim numerical data set; and
wherein said relative parameter weight comprises the numerical value of 1.

449. A métier-methodized ranking system of individuals for a particular métier application as described in clause 448 or any other clause wherein said threshold age value comprises one year.

450. A métier-methodized ranking system of individuals for a particular métier application as described in clause 448 or any other clause wherein said threshold interquartile range value comprises +/−1.5 interquartile range.

451. A métier-methodized ranking system of individuals for a particular métier application as described in clause 423 or any other clause:
wherein said at least one métier-trait-metric parameter comprises a degrees-of-separation parameter;
wherein said métier-relevant numerical input data for said individual comprises a colleague match value for said mentee aspirant individual and further comprising a colleague match value for a mentor candidate individual;
wherein said métier-applied data valuation framework processing element configured to apply a métier-trait-metric-parameter-specific mathematical calculation comprises a métier-applied data valuation framework processing element configured to set said interim métier-trait-metric parameter value to a numerical value of 1 for colleague match values that indicate a colleague match and to set said interim métier-trait-metric parameter value to a numerical value of 0 in all other cases; and
wherein said relative parameter weight comprises the numerical value of 1.

452. A métier-methodized ranking system of individuals for a particular métier application as described in clause 423 or any other clause:
wherein said at least one métier-trait-metric parameter comprises a mentee-aspirant-for-mentor-candidate-feedback-scores parameter;
wherein said métier-relevant numerical input data for said individual comprises all feedback scores given by said mentee aspirant individual to said mentor candidate individual;
wherein said métier-applied data valuation framework processing element configured to perform a métier-trait-metric-parameter-specific mathematical operation comprises a métier-applied data valuation framework processing element configured to create said interim numerical data set by:
   eliminating any feedback score older than a threshold age value;
wherein said métier-applied data valuation framework processing element configured to apply a métier-trait-metric-parameter-specific mathematical calculation comprises a métier-applied data valuation framework processing element configured to take the average of said feedback scores of said interim numerical data set; and
wherein said relative parameter weight comprises the numerical value of 1.

453. A métier-methodized ranking system of individuals for a particular métier application as described in clause 452 or any other clause wherein said threshold age value comprises one year.

454. A métier-methodized ranking system of individuals for a particular métier application as described in clause 423 or any other clause:
wherein said at least one métier-trait-metric parameter comprises a mentor-candidate-for-mentee-aspirant-feedback-scores parameter;
wherein said métier-relevant numerical input data for said individual comprises all feedback scores given by said mentor candidate individual to said mentee aspirant individual;
wherein said métier-applied data valuation framework processing element configured to perform a métier-trait-metric-parameter-specific mathematical operation comprises a métier-applied data valuation framework processing element configured to create said interim numerical data set by:
   eliminating any feedback score older than a threshold age value;
wherein said métier-applied data valuation framework processing element configured to apply a métier-trait-metric-parameter-specific mathematical calculation comprises a métier-applied data valuation framework processing element configured to take the average of said feedback scores of said interim numerical data set; and
wherein said relative parameter weight comprises the numerical value of 1.

455. A métier-methodized ranking system of individuals for a particular métier application as described in clause 454 or any other clause wherein said threshold age value comprises three months.

456. A métier-methodized ranking system of individuals for a particular métier application as described in clause 423 or any other clause:
wherein said at least one métier-trait-metric parameter comprises a mentor-candidate-case-success parameter;
wherein said métier-relevant numerical input data for said individual comprises all consensus success values for related teams for said mentor candidate individual;
wherein said métier-applied data valuation framework processing element configured to perform a métier-trait-metric-parameter-specific mathematical operation comprises a métier-applied data valuation framework processing element configured to create said interim numerical data set by:
   eliminating any consensus success value for related teams outside of a threshold interquartile range value;
wherein said métier-applied data valuation framework processing element configured to apply a métier-trait-metric-parameter-specific mathematical calculation comprises a métier-applied data valuation framework processing element configured to take the average of said consensus success values for related teams of said interim numerical data set; and
wherein said relative parameter weight comprises the numerical value of 1.

457. A métier-methodized ranking system of individuals for a particular métier application as described in clause 456 or any other clause wherein said threshold interquartile range value comprises +/−1.5 interquartile range.

458. A métier-methodized ranking system of individuals for a particular métier application as described in clause 351 or any other clause:
wherein said métier comprises the legal profession;
wherein said métier application comprises mentorship;
wherein said métier-applied data valuation framework comprises a métier-applied mentorship data valuation framework; and
wherein said individual comprises a mentor aspirant individual.

459. A métier-methodized ranking system of individuals for a particular métier application as described in clause 458 or any other clause:
wherein said at least one métier-trait-metric parameter comprises a behavioral-tendency-similarity-for-assertiveness parameter;
wherein said métier-relevant numerical input data for said individual comprises an assertiveness behavioral tendency score for said mentor aspirant individual and further comprising an assertiveness behavioral tendency score for a mentee candidate individual, each said behavioral tendency score comprising a numerical value between 0 and 1 inclusive;
wherein said métier-applied data valuation framework processing element configured to apply a métier-trait-metric-parameter-specific mathematical calculation comprises a métier-applied data valuation framework processing element configured to subtract said assertiveness behavioral tendency score for said mentee candidate individual from said assertiveness behavioral tendency score for said mentor aspirant individual and take the absolute value of the result; and
wherein said relative parameter weight comprises the numerical value 1.

460. A métier-methodized ranking system of individuals for a particular métier application as described in clause 459 or any other clause wherein each said assertiveness behavioral tendency score for each said individual comprises the quotient of a numerical value for all métier-methodized self-assessment query responses of a métier-methodized self-assessment query for said individual pertaining to an assertiveness behavioral tendency divided by a numerical value for all métier-methodized self-assessment query responses for all behavioral tendencies inquired of by said métier-methodized self-assessment query for said individual.

461. A métier-methodized ranking system of individuals for a particular métier application as described in clause 458 or any other clause:
wherein said at least one métier-trait-metric parameter comprises a behavioral-tendency-similarity-for-compassion parameter;
wherein said métier-relevant numerical input data for said individual comprises a compassion behavioral tendency score for said mentor aspirant individual and further comprising a compassion behavioral tendency score for a mentee candidate individual, each said behavioral tendency score comprising a numerical value between 0 and 1 inclusive;
wherein said métier-applied data valuation framework processing element configured to apply a métier-trait-metric-parameter-specific mathematical calculation comprises a métier-applied data valuation framework processing element configured to subtract said compassion behavioral tendency score for said mentee candidate individual from said compassion behavioral tendency score for said mentor aspirant individual and take the absolute value of the result; and
wherein said relative parameter weight comprises the numerical value 1.

462. A métier-methodized ranking system of individuals for a particular métier application as described in clause 461 or any other clause wherein each said compassion behavioral tendency score for each said individual comprises the quotient of a numerical value for all métier-methodized self-assessment query responses of a métier-methodized self-assessment query for said individual pertaining to a compassion behavioral tendency divided by a numerical value for all métier-methodized self-assessment query responses for all behavioral tendencies inquired of by said métier-methodized self-assessment query for said individual.

463. A métier-methodized ranking system of individuals for a particular métier application as described in clause 458 or any other clause:
wherein said at least one métier-trait-metric parameter comprises a behavioral-tendency-similarity-for-creativity parameter;
wherein said métier-relevant numerical input data for said individual comprises a creativity behavioral tendency score for said mentor aspirant individual and further comprising a creativity behavioral tendency score for a mentee candidate individual, each said behavioral tendency score comprising a numerical value between 0 and 1 inclusive;
wherein said métier-applied data valuation framework processing element configured to apply a métier-trait-metric-parameter-specific mathematical calculation comprises a métier-applied data valuation framework processing element configured to subtract said creativity behavioral tendency score for said mentee candidate individual from said creativity behavioral tendency score for said mentor aspirant individual and take the absolute value of the result; and
wherein said relative parameter weight comprises the numerical value 1.

464. A métier-methodized ranking system of individuals for a particular métier application as described in clause 463 or any other clause wherein each said creativity behavioral tendency score for each said individual comprises the quotient of a numerical value for all métier-methodized self-assessment query responses of a métier-methodized self-assessment query for said individual pertaining to a creativity behavioral tendency divided by a numerical value for all métier-methodized self-assessment query responses for all behavioral tendencies inquired of by said métier-methodized self-assessment query for said individual.

465. A métier-methodized ranking system of individuals for a particular métier application as described in clause 458 or any other clause:
wherein said at least one métier-trait-metric parameter comprises a behavioral-tendency-similarity-for-deliberation parameter;
wherein said métier-relevant numerical input data for said individual comprises a deliberation behavioral tendency score for said mentor aspirant individual and further comprising a deliberation behavioral tendency score for a mentee candidate individual, each said behavioral tendency score comprising a numerical value between 0 and 1 inclusive;
wherein said métier-applied data valuation framework processing element configured to apply a métier-trait-metric-parameter-specific mathematical calculation comprises a métier-applied data valuation framework processing element configured to subtract said deliberation behavioral tendency score for said mentee candidate individual from said deliberation behavioral tendency score for said mentor aspirant individual and take the absolute value of the result; and
wherein said relative parameter weight comprises the numerical value 1.

466. A métier-methodized ranking system of individuals for a particular métier application as described in clause 465 or any other clause wherein each said deliberation behavioral tendency score for each said individual comprises the quotient of a numerical value for all métier-methodized self-assessment query responses of a métier-methodized self-assessment query for said individual pertaining to a deliberation behavioral tendency divided by a numerical value for all métier-methodized self-assessment query responses for all behavioral tendencies inquired of by said métier-methodized self-assessment query for said individual.

467. A métier-methodized ranking system of individuals for a particular métier application as described in clause 458 or any other clause:
wherein said at least one métier-trait-metric parameter comprises a behavioral-tendency-similarity-for-ethics parameter;
wherein said métier-relevant numerical input data for said individual comprises an ethics behavioral tendency score for said mentor aspirant individual and further comprising an ethics behavioral tendency score for a mentee candidate individual, each said behavioral tendency score comprising a numerical value between 0 and 1 inclusive;
wherein said métier-applied data valuation framework processing element configured to apply a métier-trait-metric-parameter-specific mathematical calculation comprises a métier-applied data valuation framework processing element configured to subtract said ethics behavioral tendency score for said mentee candidate individual from said ethics behavioral tendency score for said mentor aspirant individual and take the absolute value of the result; and
wherein said relative parameter weight comprises the numerical value 1.

468. A métier-methodized ranking system of individuals for a particular métier application as described in clause 467 or any other clause wherein each said ethics behavioral tendency score for each said individual comprises the quotient of a numerical value for all métier-methodized self-assessment query responses of a métier-methodized self-assessment query for said individual pertaining to an ethics behavioral tendency divided by a numerical value for all métier-methodized self-assessment query responses for all behavioral tendencies inquired of by said métier-methodized self-assessment query for said individual.

469. A métier-methodized ranking system of individuals for a particular métier application as described in clause 458 or any other clause:
wherein said at least one métier-trait-metric parameter comprises a behavioral-tendency-similarity-for-open-mindedness parameter;
wherein said métier-relevant numerical input data for said individual comprises an open-mindedness behavioral tendency score for said mentor aspirant individual and further comprising an open-mindedness behavioral tendency score for a mentee candidate individual, each said behavioral tendency score comprising a numerical value between 0 and 1 inclusive;
wherein said métier-applied data valuation framework processing element configured to apply a métier-trait-metric-parameter-specific mathematical calculation comprises a métier-applied data valuation framework processing element configured to subtract said open-mindedness behavioral tendency score for said mentee candidate individual from said open-mindedness behavioral tendency score for said mentor aspirant individual and take the absolute value of the result; and
wherein said relative parameter weight comprises the numerical value 1.

470. A métier-methodized ranking system of individuals for a particular métier application as described in clause 469 or any other clause wherein each said open-mindedness behavioral tendency score for each said individual comprises the quotient of a numerical value for all métier-methodized self-assessment query responses of a métier-methodized self-assessment query for said individual pertaining to an open-mindedness behavioral tendency divided by a numerical value for all métier-methodized self-assessment query responses for all behavioral tendencies inquired of by said métier-methodized self-assessment query for said individual.

471. A métier-methodized ranking system of individuals for a particular métier application as described in clause 458 or any other clause:
wherein said at least one métier-trait-metric parameter comprises a behavioral-tendency-similarity-for-passion parameter;
wherein said métier-relevant numerical input data for said individual comprises a passion behavioral tendency score for said mentor aspirant individual and further comprising a passion behavioral tendency score for a mentee candidate individual, each said behavioral tendency score comprising a numerical value between 0 and 1 inclusive;
wherein said métier-applied data valuation framework processing element configured to apply a métier-trait-metric-parameter-specific mathematical calculation comprises a métier-applied data valuation framework processing element configured to subtract said passion behavioral tendency score for said mentee candidate individual from said passion behavioral tendency score for said mentor aspirant individual and take the absolute value of the result; and
wherein said relative parameter weight comprises the numerical value 1.

472. A métier-methodized ranking system of individuals for a particular métier application as described in clause 471 or any other clause wherein each said passion behavioral tendency score for each said individual comprises the quotient of a numerical value for all métier-methodized self-assessment query responses of a métier-methodized self-assessment query for said individual pertaining to a passion behavioral tendency divided by a numerical value for all métier-methodized self-assessment query responses for all behavioral tendencies inquired of by said métier-methodized self-assessment query for said individual.

473. A métier-methodized ranking system of individuals for a particular métier application as described in clause 458 or any other clause:
wherein said at least one métier-trait-metric parameter comprises a behavioral-tendency-similarity-for-perseverance parameter;
wherein said métier-relevant numerical input data for said individual comprises a perseverance behavioral tendency score for said mentor aspirant individual and further comprising a perseverance behavioral tendency score for a mentee candidate individual, each said behavioral tendency score comprising a numerical value between 0 and 1 inclusive;
wherein said métier-applied data valuation framework processing element configured to apply a métier-trait-metric-parameter-specific mathematical calculation comprises a métier-applied data valuation framework processing element configured to subtract said perseverance behavioral tendency score for said mentee candidate individual from said perseverance behavioral tendency score for said mentor aspirant individual and take the absolute value of the result; and
wherein said relative parameter weight comprises the numerical value 1.

474. A métier-methodized ranking system of individuals for a particular métier application as described in clause 473 or any other clause wherein each said perseverance behavioral tendency score for each said individual comprises the quotient of a numerical value for all métier-methodized self-assessment query responses of a métier-methodized self-assessment query for said individual pertaining to a perseverance behavioral tendency divided by a numerical value for all métier-methodized self-assessment query responses for all behavioral tendencies inquired of by said métier-methodized self-assessment query for said individual.

475. A métier-methodized ranking system of individuals for a particular métier application as described in clause 458 or any other clause:
wherein said at least one métier-trait-metric parameter comprises a behavioral-tendency-similarity-for-pragmatism parameter;
wherein said métier-relevant numerical input data for said individual comprises a pragmatism behavioral tendency score for said mentor aspirant individual and further comprising a pragmatism behavioral tendency score for a mentee candidate individual, each said behavioral tendency score comprising a numerical value between 0 and 1 inclusive;
wherein said métier-applied data valuation framework processing element configured to apply a métier-trait-metric-parameter-specific mathematical calculation comprises a métier-applied data valuation framework processing element configured to subtract said pragmatism behavioral tendency score for said mentee candidate individual from said pragmatism behavioral tendency score for said mentor aspirant individual and take the absolute value of the result; and
wherein said relative parameter weight comprises the numerical value 1.

476. A métier-methodized ranking system of individuals for a particular métier application as described in clause 475 or any other clause wherein each said pragmatism behavioral tendency score for each said individual comprises the quotient of a numerical value for all métier-methodized self-assessment query responses of a métier-methodized self-assessment query for said individual pertaining to a pragmatism behavioral tendency divided by a numerical value for all métier-methodized self-assessment query responses for all behavioral tendencies inquired of by said métier-methodized self-assessment query for said individual.

477. A métier-methodized ranking system of individuals for a particular métier application as described in clause 458 or any other clause:
wherein said at least one métier-trait-metric parameter comprises a behavioral-tendency-similarity-for-skepticism parameter;
wherein said métier-relevant numerical input data for said individual comprises a skepticism behavioral tendency score for said mentor aspirant individual and further comprising a skepticism behavioral tendency score for a mentee candidate individual, each said behavioral tendency score comprising a numerical value between 0 and 1 inclusive;
wherein said métier-applied data valuation framework processing element configured to apply a métier-trait-metric-parameter-specific mathematical calculation comprises a métier-applied data valuation framework processing element configured to subtract said skepticism behavioral tendency score for said mentee candidate individual from said skepticism behavioral tendency score for said mentor aspirant individual and take the absolute value of the result; and
wherein said relative parameter weight comprises the numerical value 1.

478. A métier-methodized ranking system of individuals for a particular métier application as described in clause 477 or any other clause wherein each said skepticism behavioral tendency score for each said individual comprises the quotient of a numerical value for all métier-methodized self-assessment query responses of a métier-methodized self-assessment query for said individual pertaining to a skepticism behavioral tendency divided by a numerical value for all métier-methodized self-assessment query responses for all behavioral tendencies inquired of by said métier-methodized self-assessment query for said individual.

479. A métier-methodized ranking system of individuals for a particular métier application as described in clause 458 or any other clause:
wherein said at least one métier-trait-metric parameter comprises a behavioral-tendency-similarity-for-urgency parameter;
wherein said métier-relevant numerical input data for said individual comprises an urgency behavioral tendency score for said mentor aspirant individual and further comprising an urgency behavioral tendency score for a mentee candidate individual, each said behavioral tendency score comprising a numerical value between 0 and 1 inclusive;
wherein said métier-applied data valuation framework processing element configured to apply a métier-trait-metric-parameter-specific mathematical calculation comprises a métier-applied data valuation framework processing element configured to subtract said urgency behavioral tendency score for said mentee candidate individual from said urgency behavioral tendency score for said mentor aspirant individual and take the absolute value of the result; and
wherein said relative parameter weight comprises the numerical value 1.

480. A métier-methodized ranking system of individuals for a particular métier application as described in clause 479 or any other clause wherein each said urgency behavioral tendency score for each said individual comprises the quotient of a numerical value for all métier-methodized self-assessment query responses of a métier-methodized self-assessment query for said individual pertaining to an urgency behavioral tendency divided by a numerical value for all métier-methodized self-assessment query responses for all behavioral tendencies inquired of by said métier-methodized self-assessment query for said individual.

481. A métier-methodized ranking system of individuals for a particular métier application as described in clause 458 or any other clause:
wherein said at least one métier-trait-metric parameter comprises a behavioral-tendency-similarity-for-wisdom parameter;
wherein said métier-relevant numerical input data for said individual comprises a wisdom behavioral tendency score for said mentor aspirant individual and further comprising a wisdom behavioral tendency score for a mentee candidate individual, each said behavioral tendency score comprising a numerical value between 0 and 1 inclusive;
wherein said métier-applied data valuation framework processing element configured to apply a métier-trait-metric-parameter-specific mathematical calculation comprises a métier-applied data valuation framework processing element configured to subtract said wisdom behavioral tendency score for said mentee candidate individual from said wisdom behavioral tendency score for said mentor aspirant individual and take the absolute value of the result; and
wherein said relative parameter weight comprises the numerical value 1.

482. A métier-methodized ranking system of individuals for a particular métier application as described in clause 481 or any other clause wherein each said wisdom behavioral tendency score for each said individual comprises the quotient of a numerical value for all métier-methodized self-assessment query responses of a métier-methodized self-assessment query for said individual pertaining to a wisdom behavioral tendency divided by a numerical value for all métier-methodized self-assessment query responses for all behavioral tendencies inquired of by said métier-methodized self-assessment query for said individual.

483. A métier-methodized ranking system of individuals for a particular métier application as described in clause 458 or any other clause:
wherein said at least one métier-trait-metric parameter comprises a feedback parameter;
wherein said métier-relevant numerical input data for said individual comprises all feedback scores for a mentee candidate individual;
wherein said métier-applied data valuation framework processing element configured to perform a métier-trait-metric-parameter-specific mathematical operation comprises a métier-applied data valuation framework processing element configured to create said interim numerical data set by:
   eliminating any feedback score older than a threshold age value; and
   eliminating any feedback score outside of a threshold interquartile range value for said feedback scores;
wherein said métier-applied data valuation framework processing element configured to apply a métier-trait-metric-parameter-specific mathematical calculation comprises a métier-applied data valuation framework processing element configured to take the average of said feedback scores of said interim numerical data set; and
wherein said relative parameter weight comprises the numerical value of 1.

484. A métier-methodized ranking system of individuals for a particular métier application as described in clause 483 or any other clause wherein said threshold age value comprises one year.

485. A métier-methodized ranking system of individuals for a particular métier application as described in clause 483 or any other clause wherein said threshold interquartile range value comprises +/−1.5 interquartile range.

486. A métier-methodized ranking system of individuals for a particular métier application as described in clause 458 or any other clause:
wherein said at least one métier-trait-metric parameter comprises a degrees-of-separation parameter;
wherein said métier-relevant numerical input data for said individual comprises a colleague match value for said mentor aspirant individual and further comprising a colleague match value for a mentee candidate individual;
wherein said métier-applied data valuation framework processing element configured to apply a métier-trait-metric-parameter-specific mathematical calculation comprises a métier-applied data valuation framework processing element configured to set said interim métier-trait-metric parameter value to a numerical value of 1 for colleague match values that indicate a colleague match and to set said interim métier-trait-metric parameter value to a numerical value of 0 in all other cases; and
wherein said relative parameter weight comprises the numerical value of 1.

487. A métier-methodized ranking system of individuals for a particular métier application as described in clause 458 or any other clause:
wherein said at least one métier-trait-metric parameter comprises a mentor-aspirant-for-mentee-candidate-feedback-scores parameter;
wherein said métier-relevant numerical input data for said individual comprises all feedback scores given by said mentor aspirant individual to said mentee candidate individual;
wherein said métier-applied data valuation framework processing element configured to perform a métier-trait-metric-parameter-specific mathematical operation comprises a métier-applied data valuation framework processing element configured to create said interim numerical data set by:
   eliminating any feedback score older than a threshold age value;
wherein said métier-applied data valuation framework processing element configured to apply a métier-trait-metric-parameter-specific mathematical calculation comprises a métier-applied data valuation framework processing element configured to take the average of said feedback scores of said interim numerical data set; and
wherein said relative parameter weight comprises the numerical value of 1.

488. A métier-methodized ranking system of individuals for a particular métier application as described in clause 487 or any other clause wherein said threshold age value comprises one year.

489. A métier-methodized ranking system of individuals for a particular métier application as described in clause 458 or any other clause:
wherein said at least one métier-trait-metric parameter comprises a mentee-candidate-for-mentor-aspirant-feedback-scores parameter;
wherein said métier-relevant numerical input data for said individual comprises all feedback scores given by said mentee candidate individual to said mentor aspirant individual;
wherein said métier-applied data valuation framework processing element configured to perform a métier-trait-metric-parameter-specific mathematical operation comprises a métier-applied data valuation framework processing element configured to create said interim numerical data set by:
   eliminating any feedback score older than a threshold age value;
wherein said métier-applied data valuation framework processing element configured to apply a métier-trait-metric-parameter-specific mathematical calculation comprises a métier-applied data valuation framework processing element configured to take the average of said feedback scores of said interim numerical data set; and
wherein said relative parameter weight comprises the numerical value of 1.

490. A métier-methodized ranking system of individuals for a particular métier application as described in clause 489 or any other clause wherein said threshold age value comprises three months.

491. A métier-methodized ranking system of individuals for a particular métier application as described in clause 351 or any other clause:
wherein said métier comprises the legal profession;
wherein said métier application comprises associations membership;
wherein said métier-applied data valuation framework comprises a métier-applied associations membership data valuation framework; and
wherein said individual comprises an association member aspirant individual.

492. A métier-methodized ranking system of individuals for a particular métier application as described in clause 491 or any other clause:
wherein said at least one métier-trait-metric parameter comprises an association parameter;
wherein said métier-relevant numerical input data for said individual comprises an association parameter match value for said association member aspirant individual and further comprising an association parameter match value for a candidate association;
wherein said métier-applied data valuation framework processing element configured to apply a métier-trait-metric-parameter-specific mathematical calculation comprises a métier-applied data valuation framework processing element configured to set said interim métier-trait-metric parameter value to a numerical value of 1 if said association parameter match values indicate an association match and to set said interim métier-trait-metric parameter value to a numerical value of 0 in all other cases; and
wherein said relative parameter weight comprises the numerical value of 1.

493. A métier-methodized ranking system of individuals for a particular métier application as described in clause 351 or any other clause:
wherein said métier comprises the legal profession;
wherein said métier application comprises associations membership;
wherein said métier-applied data valuation framework comprises a métier-applied associations membership data valuation framework; and
wherein said individual comprises an association member candidate individual.

494. A métier-methodized ranking system of individuals for a particular métier application as described in clause 493 or any other clause:
wherein said at least one métier-trait-metric parameter comprises an association parameter;
wherein said métier-relevant numerical input data for said individual comprises an association parameter match value for said association member candidate individual and further comprising an association parameter match value for a membership aspirant association;
wherein said métier-applied data valuation framework processing element configured to apply a métier-trait-metric-parameter-specific mathematical calculation comprises a métier-applied data valuation framework processing element configured to set said interim métier-trait-metric parameter value to a numerical value of 1 if said association parameter match values indicate an association match and to set said interim métier-trait-metric parameter value to a numerical value of 0 in all other cases; and
wherein said relative parameter weight comprises the numerical value of 1.

495. A métier-methodized ranking system of individuals for a particular métier application as described in clause 351 or any other clause:
wherein said métier comprises the legal profession;
wherein said métier application comprises association subgroups membership;
wherein said métier-applied data valuation framework comprises a métier-applied association subgroups membership data valuation framework; and
wherein said individual comprises an association subgroups member candidate individual.

496. A métier-methodized ranking system of individuals for a particular métier application as described in clause 495 or any other clause:
wherein said at least one métier-trait-metric parameter comprises an association-subgroup parameter;
wherein said métier-relevant numerical input data for said individual comprises an association subgroup parameter match value for said association subgroups member candidate individual and further comprising an association subgroup parameter match value for a membership aspirant association subgroup;
wherein said métier-applied data valuation framework processing element configured to apply a métier-trait-metric-parameter-specific mathematical calculation comprises a métier-applied data valuation framework processing element configured to set said interim métier-trait-metric parameter value to a numerical value of 1 if said association subgroup parameter match values indicate an association subgroup match and to set said interim métier-trait-metric parameter value to a numerical value of 0 in all other cases; and
wherein said relative parameter weight comprises the numerical value of 1.

497. A métier-methodized ranking system of individuals for a particular métier application as described in clause 351 or any other clause wherein said métier-applied data valuation framework processing element configured to perform a métier-trait-metric-parameter-specific mathematical operation comprises a métier-applied data valuation framework processing element configured to perform a métier-trait-metric-parameter-specific mathematical operation selected from eliminating one or more data pairs of said data paired métier-relevant numerical input data, time-based eliminating one or more data pairs of said data paired métier-relevant numerical input data, age-of-data eliminating one or more data pairs of said data paired métier-relevant numerical input data, individually differentiated data pair weighting of said data paired métier-relevant numerical input data, and any combination of the foregoing.

498. A métier-methodized ranking system of individuals for a particular métier application as described in clause 497 or any other clause wherein said métier-trait-metric-parameter-specific mathematical operation comprises an axiom-implementing métier-trait-metric-parameter-specific mathematical operation.

499. A métier-methodized ranking system of individuals for a particular métier application as described in clause 497 or any other clause further comprising a métier-trait-metric-parameter-specific mathematical operation update data processing element configured to update said métier-trait-metric-parameter-specific mathematical operation using self-generated métier-methodized data.

500. A métier-methodized ranking system of individuals for a particular métier application as described in clause 497 or any other clause further comprising a métier-trait-metric-parameter-specific mathematical calculation update data processing element configured to update said métier-trait-metric-parameter-specific mathematical calculation using self-generated métier-methodized data.

501. A métier-methodized ranking system of individuals for a particular métier application as described in clause 351 or any other clause wherein said data paired métier-relevant numerical input data comprises one or more data pairs, each said data pair having a measured métier-metric numerical value and a corresponding time stamp numerical value.

502. A métier-methodized ranking system of individuals for a particular métier application as described in clause 351 or any other clause wherein said métier-applied data valuation framework processing element configured to apply a métier-trait-metric-parameter-specific mathematical calculation comprises a métier-applied data valuation framework processing element configured to apply a métier-trait-metric-parameter-specific mathematical calculation selected from averaging at least some numerical values of said data paired métier-relevant numerical input data, averaging at least some measured métier-metric numerical values of said data paired métier-relevant numerical input data, finding a maximum of said measured métier-metric numerical values of said data paired métier-relevant numerical input data, and any combination of the foregoing.

503. A métier-methodized ranking system of individuals for a particular métier application as described in clause 351 or any other clause wherein each said weighted métier-trait-metric parameter value for each of all said métier-trait-metric parameters of said métier-applied data valuation framework and each said métier-trait-metric parameter weights for each of all said métier-trait-metric parameters of said métier-applied data valuation framework comprise said métier-applied revalued numerical data for said individual, and wherein said applicative data rank processing element comprises an applicative data rank processing element configured to take the sum of the weighted métier-trait-metric parameter values for all said métier-trait-metric parameters of said métier-applied data valuation framework divided by the sum of the métier-trait-metric parameter weights for all said métier-trait-metric parameters of said métier-applied data valuation framework to create said métier-applied individual rank score for said individual.

504. A métier-methodized ranking system of individuals for a particular métier application as described in clause 503 or any other clause wherein said métier-applied data valuation framework processing element comprises a métier-applied data valuation framework processing element configured to create métier-applied revalued numerical data for a plurality of said individuals by applicatively revaluing said métier-relevant numerical input data for said plurality of said individuals with said métier-applied data valuation framework, wherein said applicative data rank processing element comprises an applicative data rank processing element configured to create a plurality of métier-applied individual rank scores for a plurality of said individuals using a plurality of said métier-applied revalued numerical data for said plurality of said individuals, and further comprising a métier-applied data ordering processing element configured to order a plurality of métier-applied individual rank scores for said plurality of said individuals.

505. A métier-methodized ranking system of individuals for a particular métier application as described in clause 503 or any other clause further comprising métier-relevant numerical input networking reference data for said particular métier application, and wherein said métier-applied data valuation framework processing element further comprises a métier-applied data valuation framework processing element configured to perform métier-trait-metric-parameter-specific mathematical operation on at least one numerical value of said métier-relevant numerical input networking reference data to create said interim numerical data set.

506. A métier-methodized ranking system of individuals for a particular métier application as described in clause 503 or any other clause further comprising métier-relevant numerical input team-building reference data for said particular métier application, and wherein said métier-applied data valuation framework processing element further comprises a métier-applied data valuation framework processing element configured to perform a métier-trait-metric-parameter-specific mathematical operation on at least one numerical value of said métier-relevant numerical input team-building reference data to create said interim numerical data set.

507. A métier-methodized ranking system of individuals for a particular métier application as described in clause 503 or any other clause further comprising métier-relevant numerical input referrals reference data for said particular métier application, and wherein said métier-applied data valuation framework processing element further comprises a métier-applied data valuation framework processing element configured to perform a métier-trait-metric-parameter-specific mathematical operation on at least one numerical value of said métier-relevant numerical input referrals reference data to create said interim numerical data set.

508. A métier-methodized ranking system of individuals for a particular métier application as described in clause 503 or any other clause further comprising métier-relevant numerical input associations membership reference data for said particular métier application, and wherein said métier-applied data valuation framework processing element further comprises a métier-applied data valuation framework processing element configured to perform a métier-trait-metric-parameter-specific mathematical operation on at least one numerical value of said métier-relevant numerical input associations membership reference data to create said interim numerical data set.

509. A métier-methodized ranking system of individuals for a particular métier application as described in clause 503 or any other clause further comprising métier-relevant numerical input mentorship reference data for said particular métier application, and wherein said métier-applied data valuation framework processing element further comprises a métier-applied data valuation framework processing element configured to perform a métier-trait-metric-parameter-specific mathematical operation on at least one numerical value of said métier-relevant numerical input mentorship reference data to create said interim numerical data set.

510. A métier-methodized ranking system of individuals for a particular métier application as described in clause 503 or any other clause further comprising métier-relevant numerical input feedback reference data for said particular métier application, and wherein said métier-applied data valuation framework processing element further comprises a métier-applied data valuation framework processing element configured to perform a métier-trait-metric-parameter-specific mathematical operation on at least one numerical value of said métier-relevant numerical input feedback reference data to create said interim numerical data set.

511. A métier-methodized ranking system of individuals for a particular métier application as described in clause 503 or any other clause further comprising métier-relevant numerical input historical reference data for said particular métier application, and wherein said métier-applied data valuation framework processing element further comprises a métier-applied data valuation framework processing element configured to perform a métier-trait-metric-parameter-specific mathematical operation on at least one numerical value of said métier-relevant numerical input historical reference data to create said interim numerical data set.

512. A métier-methodized ranking system of individuals for a particular métier application as described in clause 503 or any other clause further comprising métier-relevant numerical input group reference data for said particular métier application, and wherein said métier-applied data valuation framework processing element further comprises a métier-applied data valuation framework processing element configured to perform a métier-trait-metric-parameter-specific mathematical operation on at least one numerical value of said métier-relevant numerical input group reference data to create said interim numerical data set.

513. A métier-methodized ranking system of individuals for a particular métier application as described in clause 503 or any other clause further comprising métier-relevant numerical input iteratively-developed reference data for said particular métier application, and wherein said métier-applied data valuation framework processing element further comprises a métier-applied data valuation framework processing element configured to perform a métier-trait-metric-parameter-specific mathematical operation on at least one numerical value of said métier-relevant numerical input iteratively-developed reference data to create said interim numerical data set.

514. A métier-methodized ranking system of individuals for a particular métier application as described in clause 317 or any other clause wherein said métier-applied data valuation framework processing element comprises a métier-applied data valuation framework processing element configured to utilize historical reference data.

515. A métier-methodized ranking system of individuals for a particular métier application as described in clause 514 or any other clause wherein said métier-applied data valuation framework processing element configured to utilize historical reference data comprises a métier-applied data valuation framework processing element configured to adjust at least one numerical value of said métier-relevant numerical input data in response to said historical reference data.

516. A métier-methodized ranking system of individuals for a particular métier application as described in clause 515 or any other clause wherein said métier-applied data valuation framework processing element configured to adjust comprises a métier-applied data valuation framework processing element selected from configured to increase a value of a historically effective variable, configured to decrease a value of a historically ineffective variable, or any combination of the foregoing.

517. A métier-methodized ranking system of individuals for a particular métier application as described in clause 514 or any other clause wherein said historical reference data comprises user feedback data.

518. A métier-methodized ranking system of individuals for a particular métier application as described in clause 514 or any other clause further comprising an age-of-data historical reference data discount processing element.

519. A métier-methodized ranking system of individuals for a particular métier application as described in clause 514 or any other clause wherein said métier-applied data valuation framework comprises a métier-applied data valuation framework selected from a métier-applied weighting data valuation framework, a métier-applied function data valuation framework, a métier-applied computation data valuation framework, a métier-applied data rule valuation framework, and a métier-applied data matrix valuation framework.

520. A métier-methodized ranking system of individuals for a particular métier application as described in clause 317 or any other clause wherein said métier-applied data valuation framework processing element comprises an n-dimensional space métier-applied data valuation framework processing element.

521. A métier-methodized ranking system of individuals for a particular métier application as described in clause 520 or any other clause wherein each dimension of said n-dimensional space represents a métier trait metric.

522. A métier-methodized ranking system of individuals for a particular métier application as described in clause 521 or any other clause wherein said métier comprises the legal profession and wherein said n-dimensional space comprises a plurality of behavioral tendency dimensions.

523. A métier-methodized ranking system of individuals for a particular métier application as described in clause 522 or any other clause wherein said behavioral tendency dimensions comprise behavioral tendency dimensions selected from assertiveness, compassion, creativity, dependability, ethicalness, open-mindedness, passion, perseverance, pragmatism, resilience, trust, wisdom, and any combination of the foregoing.

524. A métier-methodized ranking system of individuals for a particular métier application as described in clause 317 or any other clause wherein said métier comprises the legal profession and wherein said métier-applied data valuation framework processing element comprises a métier-applied data valuation framework processing element configured to identify a lawyer type for said individual.

525. A métier-methodized ranking system of individuals for a particular métier application as described in clause 524 or any other clause wherein said métier-applied data valuation framework processing element configured to identify a lawyer type for said individual comprises a métier-applied data valuation framework processing element configured to identify an individual selected from an advocate lawyer type, a rainmaker lawyer type, a litigator lawyer type, an inspector lawyer type, and a facilitator lawyer type.

526. A métier-methodized ranking system of individuals for a particular métier application as described in clause 525 or any other clause:
wherein said métier-relevant numerical input data comprises métier-relevant numerical input data for said métier-relevant psychological data of said individual and comprises a numerical assertiveness value between 0 and 1 inclusive, a numerical compassion value between 0 and 1 inclusive, a numerical creativity value between 0 and 1 inclusive, a numerical dependability value between 0 and 1 inclusive, a numerical ethicalness value between 0 and 1 inclusive, a numerical open-mindedness value between 0 and 1 inclusive, a numerical passion value between 0 and 1 inclusive, a numerical perseverance value between 0 and 1 inclusive, a numerical pragmatism value between 0 and 1 inclusive, a numerical resilience value between 0 and 1 inclusive, a numerical trust value between 0 and 1 inclusive, and a numerical wisdom value between 0 and 1 inclusive;
wherein each said lawyer type has four numerical value metrics comprising:
   a numerical assertiveness value, a numerical pragmatism value, a numerical creativity value, and a numerical resilience value for a rainmaker lawyer type;
   a numerical perseverance value, a numerical compassion value, a numerical ethicalness value, a numerical passion value, and a numerical trust value for an advocate lawyer type;
   a numerical creativity value, a numerical pragmatism value, a numerical open-mindedness value, and a numerical wisdom value for a litigator lawyer type;
   a numerical pragmatism value, a numerical perseverance value, a numerical dependability value, and a numerical resilience value for a facilitator lawyer type;
   a numerical open-mindedness value, a numerical perseverance value, a numerical dependability value, and a numerical resilience value for an inspector lawyer type;
and wherein said métier-applied data valuation framework processing element configured to identify a lawyer type for said individual comprises a métier-applied data valuation framework processing element configured to sum said four numerical value metrics for each said lawyer type and identify said individual as said lawyer type having the highest said sum.

527. A métier-methodized ranking system of individuals for a particular métier application as described in clause 317 or any other clause wherein said métier comprises the legal profession and wherein said métier-applied data valuation framework comprises a métier-applied networking data valuation framework.

528. A métier-methodized ranking system of individuals for a particular métier application as described in clause 527 or any other clause wherein said métier-applied networking data valuation framework comprises at least one networking axiom.

529. A métier-methodized ranking system of individuals for a particular métier application as described in clause 527 or any other clause further comprising a métier-applied networking user interface responsive to at least one said processing element.

530. A métier-methodized ranking system of individuals for a particular métier application as described in clause 529 or any other clause wherein said métier-applied networking user interface comprises a métier-applied networking user interface selected from a map of fields of law, a referrals sorting interface, a feedback sorting interface, a profession sorting interface, and any combination of the foregoing.

531. A métier-methodized ranking system of individuals for a particular métier application as described in clause 317 or any other clause wherein said métier comprises the legal profession and wherein said métier-applied data valuation framework comprises a métier-applied team-building data valuation framework.

532. A métier-methodized ranking system of individuals for a particular métier application as described in clause 531 or any other clause wherein said métier-applied team-building data valuation framework comprises at least one team-building axiom.

533. A métier-methodized ranking system of individuals for a particular métier application as described in clause 532 or any other clause wherein said at least one team-building axiom comprises a team-building axiom selected from a local practice area axiom, a fields of law axiom, a specialty area axiom, a trial threat axiom, a complementary personalities axiom, a case outcomes axiom, a diversity axiom, a feedback axiom, a degrees of separation axiom, a case example axiom, and a skills and certifications axiom.

534. A métier-methodized ranking system of individuals for a particular métier application as described in clause 531 or any other clause further comprising a métier-applied team-building user interface responsive to at least one said processing element.

535. A métier-methodized ranking system of individuals for a particular métier application as described in clause 317 or any other clause wherein said métier comprises the legal profession and wherein said métier-applied data valuation framework comprises a métier-applied referrals data valuation framework.

536. A métier-methodized ranking system of individuals for a particular métier application as described in clause 535 or any other clause wherein said métier-applied referrals data valuation framework comprises at least one referrals axiom.

537. A métier-methodized ranking system of individuals for a particular métier application as described in clause 535 or any other clause further comprising a métier-applied referrals user interface responsive to at least one said processing element.

538. A métier-methodized ranking system of individuals for a particular métier application as described in clause 537 or any other clause wherein said métier-applied referrals user interface comprises a métier-applied referrals user interface selected from a referrals sending interface, a referrals receiving interface, a referrals tracking interface, a reciprocity tracking interface, and any combination of the foregoing.

539. A métier-methodized ranking system of individuals for a particular métier application as described in clause 537 or any other clause wherein said métier-applied referrals user interface comprises a referrals filter.

540. A métier-methodized ranking system of individuals for a particular métier application as described in clause 539 or any other clause wherein said referrals filter comprises a referrals filter selected from a geographic filter, a field of law filter, and any combination of the foregoing.

541. A métier-methodized ranking system of individuals for a particular métier application as described in clause 317 or any other clause wherein said métier comprises the legal profession and wherein said métier-applied data valuation framework comprises a métier-applied associations membership data valuation framework.

542. A métier-methodized ranking system of individuals for a particular métier application as described in clause 541 or any other clause wherein said métier-applied associations membership data valuation framework comprises at least one associations membership axiom.

543. A métier-methodized ranking system of individuals for a particular métier application as described in clause 541 or any other clause further comprising a métier-applied associations membership user interface responsive to at least one said processing element.

544 A métier-methodized ranking system of individuals for a particular métier application as described in clause 543 or any other clause wherein said métier-applied associations membership user interface comprises a métier-applied associations membership user interface selected from a chat interface, a dues interface, a purchasing interface, and any combination of the foregoing.

545. A métier-methodized ranking system of individuals for a particular métier application as described in clause 317 or any other clause wherein said métier comprises the legal profession and wherein said métier-applied data valuation framework comprises a métier-applied mentorship data valuation framework.

546. A métier-methodized ranking system of individuals for a particular métier application as described in clause 545 or any other clause wherein said métier-applied mentorship data valuation framework comprises at least one mentorship axiom.

547. A métier-methodized ranking system of individuals for a particular métier application as described in clause 545 or any other clause further comprising a métier-applied mentorship user interface responsive to at least one said processing element.

548. A métier-methodized ranking system of individuals for a particular métier application as described in clause 317 or any other clause wherein said wherein said métier-applied individual rank score comprises a numerical value rank score.

549. A métier-methodized ranking system of individuals for a particular métier application as described in clause 548 or any other clause wherein said métier-applied revalued numerical data comprises a plurality of revalued numerical values, and wherein said métier-applied data valuation framework processing element comprises a métier-applied data valuation framework processing element configured to transform said plurality of revalued numerical values into said numerical value rank score.

550. A métier-methodized ranking system of individuals for a particular métier application as described in clause 549 or any other clause wherein said plurality of revalued numerical values comprises a plurality of revalued numerical values in an n-dimensional space.

551. A métier-methodized ranking system of individuals for a particular métier application as described in clause 550 or any other clause wherein each dimension of said n-dimensional space represents a métier trait metric.

552. A métier-methodized ranking system of individuals for a particular métier application as described in clause 551 or any other clause wherein said métier comprises the legal profession and wherein said n-dimensional space comprises a plurality of behavioral tendency dimensions.

553. A métier-methodized ranking system of individuals for a particular métier application as described in clause 552 or any other clause wherein said behavioral tendency dimensions comprise behavioral tendency dimensions selected from assertiveness, compassion, creativity, dependability, ethicalness, open-mindedness, passion, perseverance, pragmatism, resilience, trust, wisdom, and any combination of the foregoing.

554. A métier-methodized ranking system of individuals for a particular métier application as described in clause 317 or any other clause wherein said applicative data rank processing element comprises an applicative data rank processing element configured to compare said métier-applied individual rank score for said individual to at least one métier-applied individual rank score for another individual.

555. A métier-methodized ranking system of individuals for a particular métier application as described in clause 317 or any other clause wherein said applicative data rank processing element comprises an applicative data rank processing element configured to maximize the aggregate effectiveness of a group of individuals.

556. A métier-methodized ranking system of individuals for a particular métier application as described in clause 555 or any other clause wherein said group of individuals comprises a group of individuals selected from a team and a network.

557. A métier-methodized ranking system of individuals for a particular métier application as described in clause 555 or any other clause wherein said métier-applied data valuation framework processing element comprises a métier-applied data valuation framework processing element configured to utilize group reference data.

558. A métier-methodized ranking system of individuals for a particular métier application as described in clause 556 or any other clause wherein said métier-applied data valuation framework processing element configured to utilize group reference data comprises a métier-applied data valuation framework processing element responsive to a user prompt.

559. A métier-methodized ranking system of individuals for a particular métier application as described in clause 556 or any other clause wherein said métier-applied data valuation framework processing element configured to utilize group reference data comprises a métier-applied data valuation framework processing element configured to take the sum of the highest meter-applied individual rank scores for a plurality of individuals.

560. A métier-methodized ranking system of individuals for a particular métier application as described in clause 556 or any other clause wherein said applicative data rank processing element comprises an applicative data rank processing element configured to iteratively recast said métier-applied individual rank score for said individual to create a métier-applied iteratively recast individual rank score for said individual.

561. A métier-methodized ranking system of individuals for a particular métier application as described in clause 560 or any other clause wherein said applicative data rank processing element configured to maximize the aggregate effectiveness of a group of individuals comprises an applicative data rank processing element configured to utilize the highest métier-applied iteratively recast individual rank score among a plurality of individuals.

562. A métier-methodized ranking system of individuals for a particular métier application as described in clause 317 or any other clause wherein said métier-applied data valuation framework processing element comprises a métier-applied data valuation framework processing element configured to iteratively recast said métier-applied individual rank score for said individual.

563. A métier-methodized ranking system of individuals for a particular métier application as described in clause 562 or any other clause wherein said métier-applied data valuation framework processing element configured to iteratively recast said métier-applied individual rank score for said individual comprises a métier-applied data valuation framework processing element configured to utilize iteratively developed networking reference data.

564. A métier-methodized ranking system of individuals for a particular métier application as described in clause 562 or any other clause wherein said métier-applied data valuation framework processing element configured to iteratively recast said métier-applied individual rank score for said individual comprises a métier-applied data valuation framework processing element configured to utilize iteratively developed team-building reference data.

565. A métier-methodized ranking system of individuals for a particular métier application as described in clause 562 or any other clause wherein said métier-applied data valuation framework processing element configured to iteratively recast said métier-applied individual rank score for said individual comprises a métier-applied data valuation framework processing element configured to utilize iteratively developed referrals reference data.

566. A métier-methodized ranking system of individuals for a particular métier application as described in clause 562 or any other clause wherein said métier-applied data valuation framework processing element configured to iteratively recast said métier-applied individual rank score for said individual comprises a métier-applied data valuation framework processing element configured to utilize iteratively developed associations membership reference data.

567. A métier-methodized ranking system of individuals for a particular métier application as described in clause 562 or any other clause wherein said métier-applied data valuation framework processing element configured to iteratively recast said métier-applied individual rank score for said individual comprises a métier-applied data valuation framework processing element configured to utilize iteratively developed mentorship reference data.

568. A métier-methodized ranking system of individuals for a particular métier application as described in clause 562 or any other clause wherein said métier-applied data valuation framework processing element configured to iteratively recast said métier-applied individual rank score for said individual comprises a métier-applied data valuation framework processing element configured to:
generate antecedent iterative reference data;
utilize said antecedent iterative reference data with said métier-applied data valuation framework; and
generate subsequent iterative reference data with said métier-applied data valuation framework.

569. A métier-methodized ranking system of individuals for a particular métier application as described in clause 568 or any other clause wherein said wherein said subsequent iterative reference data comprises antecedent iterative reference data for a next succeeding iteration.

570. A métier-methodized ranking system of individuals for a particular métier application as described in clause 568 or any other clause wherein said métier-applied data valuation framework processing element configured to utilize said antecedent iterative reference data with said métier-applied data valuation framework comprises a métier-applied data valuation framework processing element configured to adjust at least one numerical value of said métier-relevant numerical input data in response to said antecedent iterative reference data.

571. A métier-methodized ranking system of individuals for a particular métier application as described in clause 317 or any other clause wherein said métier-applied recommendation for said individual useful for said particular métier application comprises a métier-applied networking recommendation for said individual useful for a métier networking application.

572. A métier-methodized ranking system of individuals for a particular métier application as described in clause 317 or any other clause wherein said métier-applied recommendation for said individual useful for said particular métier application comprises a métier-applied team-building recommendation for said individual useful for a métier team-building application.

573. A métier-methodized ranking system of individuals for a particular métier application as described in clause 317 or any other clause wherein said métier-applied recommendation for said individual useful for said particular métier application comprises a métier-applied mentorship recommendation for said individual useful for a métier mentorship application.

574. A métier-methodized ranking system of individuals for a particular métier application as described in clause 317 or any other clause wherein said métier-applied recommendation for said individual useful for said particular métier application comprises a métier-applied referral recommendation for said individual useful for a métier referral application.

575. A métier-methodized ranking system of individuals for a particular métier application as described in clause 317 or any other clause wherein said métier-applied recommendation for said individual useful for said particular métier application comprises a métier-applied associations membership recommendation for said individual useful for a métier associations membership application.

576. A métier-methodized ranking system of individuals for a particular métier application as described in clause 317 or any other clause wherein said métier-applied recommendation for said individual useful for said particular métier application comprises a métier-applied leadership recommendation for said individual useful for a métier leadership application.

577. A métier-methodized ranking system of individuals for a particular métier application as described in clause 317 or any other clause wherein said métier-applied recommendation for said individual useful for said particular métier application comprises a métier-applied vendor recommendation for said individual useful for a métier vendor application.

578. A métier-methodized ranking system of individuals for a particular métier application as described in clause 317 or any other clause wherein said métier-applied recommendation for said individual useful for said particular métier application comprises the highest métier-applied individual rank score among a plurality of individuals.

579. A métier-methodized ranking system of individuals for a particular métier application as described in clause 317 or any other clause further comprising a feedback point configured for utilization by at least one said processing element.

580. A métier-methodized ranking system of individuals for a particular métier application as described in clause 579 or any other clause wherein said at least one feedback point comprises multiple feedback points selected from multiple feedback points from multiple users, multiple feedback points from multiple automatic generation, multiple iterative feedback points, and any combination of the foregoing.

581. A métier-methodized ranking system of individuals for a particular métier application as described in clause 580 or any other clause further comprising an age-of-data feedback discount processing element responsive to at least one said feedback point.

582. A métier-methodized ranking system of individuals for a particular métier application as described in clause 579 or any other clause wherein said feedback comprises user generated feedback.

583. A métier-methodized ranking system of individuals for a particular métier application as described in clause 579 or any other clause wherein said métier comprises the legal profession and wherein said user generated feedback comprises user generated feedback selected from at least one relationship statement, at least one user reported interaction outcome, at least one user reported behavioral tendency evaluation, at least one user reported peer value added evaluation, and any combination of the foregoing.

584. A métier-methodized ranking system of individuals for a particular métier application as described in clause 579 or any other clause wherein said feedback comprises automatically generated feedback.

585. A métier-methodized ranking system of individuals for a particular métier application as described in clause 584 or any other clause wherein said métier comprises the legal profession and wherein said automatically generated feedback comprises automatically generated feedback selected from historical data feedback, data trend feedback, and any combination of the foregoing.

586. A métier-methodized ranking system of individuals for a particular métier application as described in clause 579 or any other clause wherein said feedback comprises milestone feedback.

587. A métier-methodized ranking system of individuals for a particular métier application as described in clause 586 or any other clause wherein said métier comprises the legal profession and wherein said milestone feedback comprises milestone feedback selected from periodic interval feedback, event milestone feedback, case milestone feedback, outcome feedback, and any combination of the foregoing.

588. A métier-methodized ranking system of individuals for a particular métier application as described in clause 579 or any other clause wherein said feedback comprises feedback reference data and wherein said métier-applied data valuation framework processing element comprises a métier-applied data valuation framework processing element configured to utilize said feedback reference data.

589. A métier-methodized ranking system of individuals for a particular métier application as described in clause 588 or any other clause wherein said métier-applied data valuation framework processing element configured to utilize said feedback reference data comprises a métier-applied data valuation framework processing element configured to adjust at least one numerical value of said métier-relevant numerical input data in response to said feedback reference data.

590. A métier-methodized ranking system of individuals for a particular métier application as described in clause 588 or any other clause wherein said at least one feedback point comprises multiple feedback points and wherein said feedback reference data comprises a plurality of said feedback reference data.

591. A métier-methodized ranking system of individuals for a particular métier application as described in clause 590 or any other clause further comprising an age-of-data feedback reference data discount processing element responsive to at least one said feedback point.

592. A métier-methodized ranking system of individuals for a particular métier application as described in clause 590 or any other clause wherein said plurality of feedback reference data comprises a plurality of iterative feedback reference data, and wherein said métier-applied data valuation framework processing element comprises a métier-applied data valuation framework processing element configured to iteratively create métier-applied revalued numerical data for said individual by applicatively revaluing said métier-relevant numerical input data for said individual with a métier-applied data valuation framework utilizing said plurality of iterative feedback reference data.

593. A métier-methodized ranking system of individuals for a particular métier application as described in clause 592 or any other clause wherein said métier-applied data valuation framework processing element configured to iteratively create métier-applied revalued numerical data for said individual by applicatively revaluing said métier-relevant numerical input data for said individual with a métier-applied data valuation framework utilizing said plurality of iterative feedback reference data comprises a métier-applied data valuation framework processing element configured to:
generate antecedent iterative feedback reference data;
utilize said antecedent iterative feedback reference data with said métier-applied data valuation framework; and
generate subsequent iterative feedback reference data with said métier-applied data valuation framework.

594. A métier-methodized ranking system of individuals for a particular métier application as described in clause 593 or any other clause wherein said subsequent iterative feedback reference data comprises antecedent iterative feedback reference data for a next succeeding iteration.

595. A métier-methodized ranking system of individuals for a particular métier application as described in clause 594 or any other clause further comprising an age-of-data feedback reference data discount processing element responsive to at least one said feedback point.

596. A métier-methodized ranking system of individuals for a particular métier application as described in clause 579 or any other clause wherein said feedback comprises a two-axis score.

597. A métier-methodized ranking system of individuals for a particular métier application as described in clause 596 or any other clause wherein said métier comprises the legal profession and wherein said two-axis score comprises a user-generated outcome score axis and a user-generated difficulty score axis.

598. A métier-methodized ranking system of individuals for a particular métier application as described in clause 597 or any other clause wherein said feedback comprises a two-axis score for a case outcome.

599. A métier-methodized ranking system of individuals for a particular métier application as described in clause 598 or any other clause or any other clause further comprising a display processing element configured to display at least one said two-axis score as a data point on a two-axis plot.

600. A métier-methodized ranking system of individuals for a particular métier application as described in clause 599 or any other clause wherein said data point on said two-axis plot comprises a data point selected from a two-axis score provided by a user, a two-axis score averaged from multiple users, a two-axis score averaged from multiple users that comprise a team, a two-axis score averaged from multiple users that comprise multiple teams, and any combination of the foregoing.

601. A métier-methodized ranking system of individuals for a particular métier application as described in clause 599 or any other clause wherein said data point comprises a data point selectable to view underlying constituent information of said data point.

602. A métier-methodized ranking system of individuals for a particular métier application as described in clause 599 or any other clause wherein said display processing element comprises a display processing element configured to display a plurality of two-axis scores as a plurality of data points on a two-axis plot wherein said plurality of data points comprise a plurality of data points selected from a plurality of data points organized by attorney, a plurality of data points organized by case, and any combination of the foregoing.

603. A métier-methodized ranking system of individuals for a particular métier application as described in clause 599 or any other clause further comprising a data analysis processing element configured to data analyze said plurality of data points.

604. A métier-methodized ranking system of individuals for a particular métier application as described in clause 603 or any other clause wherein said data analysis processing element configured to data analyze said plurality of data points comprises a data analysis processing element configured to analyze a data trend, discount aged data, temporally sort data, and any combination of the foregoing.

605. A métier-methodized ranking system of individuals for a particular métier application as described in clause 317 or any other clause further comprising an automated processing element configuration data update processing element configured to use self-generated métier-methodized data to update the configuration of at least one said processing element.

606. A métier-methodized ranking system of individuals for a particular métier application as described in clause 605 or any other clause wherein said self-generated métier-methodized data comprises self-generated métier-methodized data selected from historical reference data, feedback reference data, and any combination of the foregoing.

607. A métier-methodized ranking system of individuals for a particular métier application as described in clause 317 or any other clause wherein said métier comprises a métier selected from a métier profession and a métier avocation 608. A métier-methodized ranking system of individuals for a particular métier application as described in clause 607 or any other clause wherein each said processing element comprises a processing element configured to utilize at least one manipulable-métier-specification.

609. A métier-methodized ranking system of individuals for a particular métier application as described in clause 608 or any other clause wherein each said manipulable-métier-specification comprises a métier-axiom-implementing manipulable-métier-specification.

610. A métier-methodized ranking system of individuals for a particular métier application as described in clause 609 or any other clause further comprising a plurality of said métier-axiom-implementing manipulable-métier-specification in an n-dimensional métier specification space.

611. A métier-methodized ranking system of individuals for a particular métier application as described in clause 610 or any other clause wherein said n-dimensional métier specification space comprises a n-dimensional métier specification space having an aggregate number of independently manipulable métier specification dimensions greater than a number of dimensions selected from 10, 20, 50, 75, and 100.

612. A métier-methodized ranking system of individuals for a particular métier application as described in clause 611 or any other clause wherein at least one said processing element comprises a processing element configured to independently manipulate each said métier-axiom-implementing manipulable-métier-specification in said n-dimensional métier specification space utilizing métier hypotheses logic specific for the métier specification of each said dimension in said n-dimensional métier specification space.

613. A system substantially as herein described with reference to any one or more of the Figures and Description.

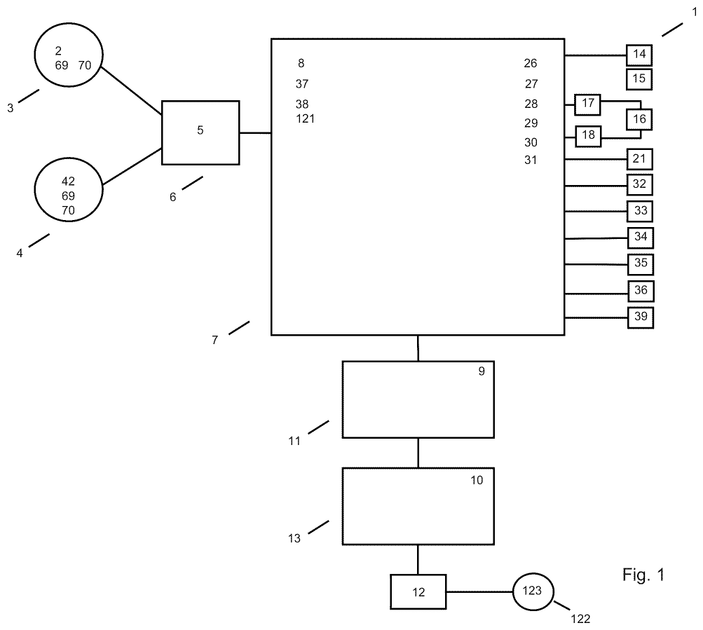

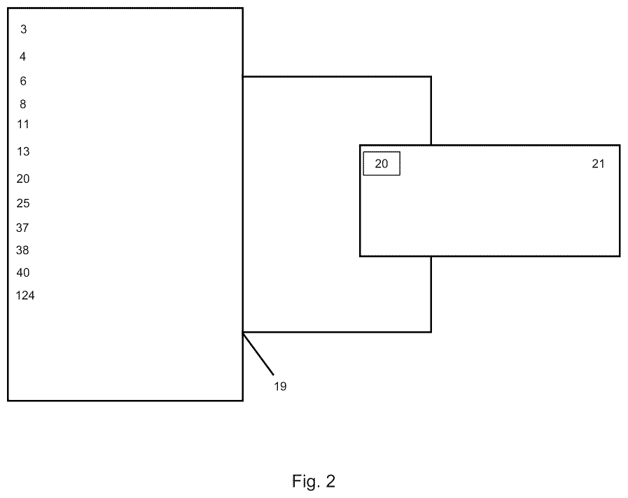

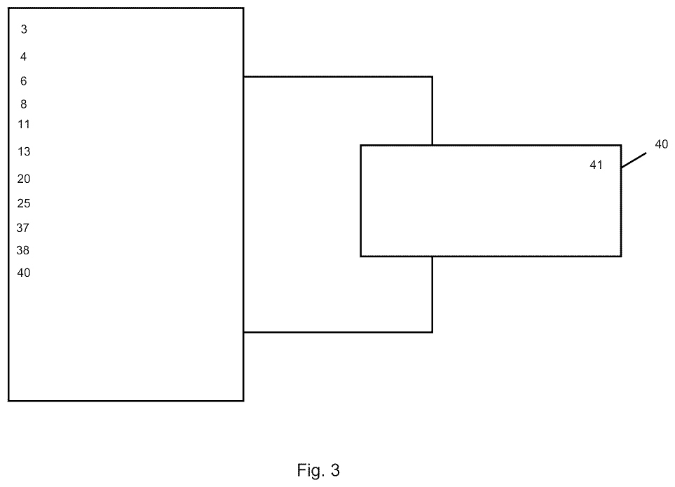

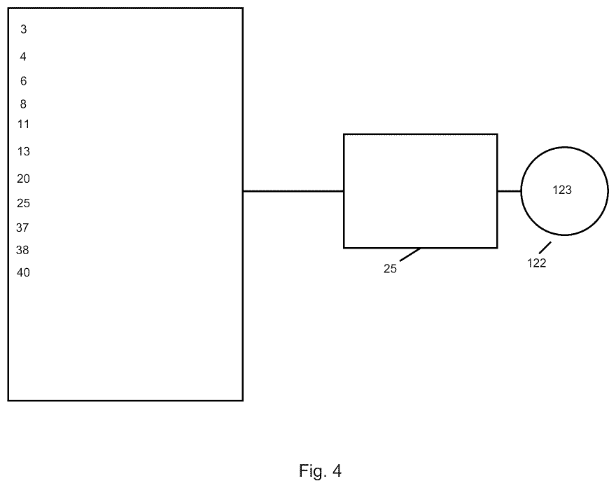

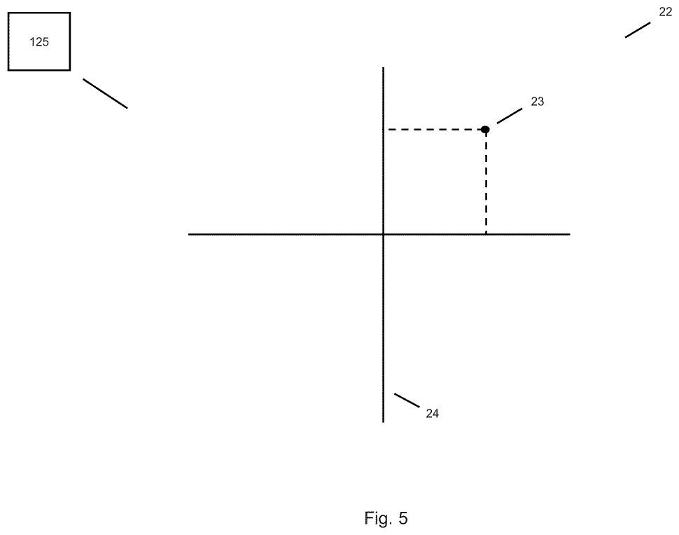

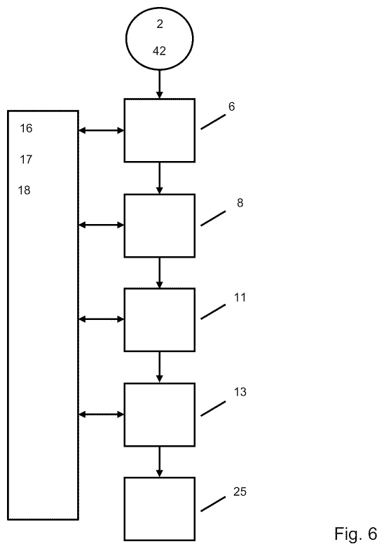

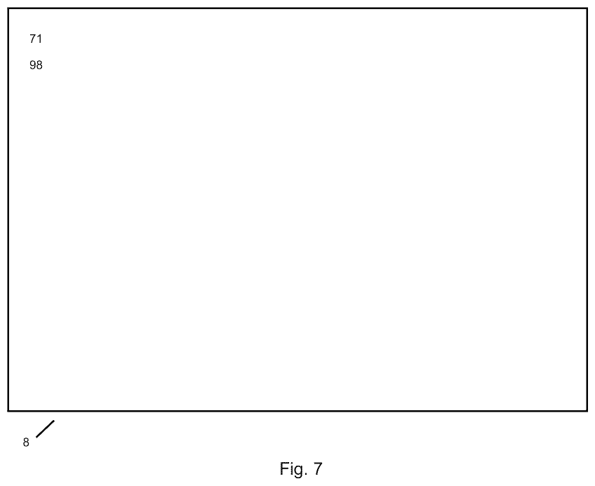

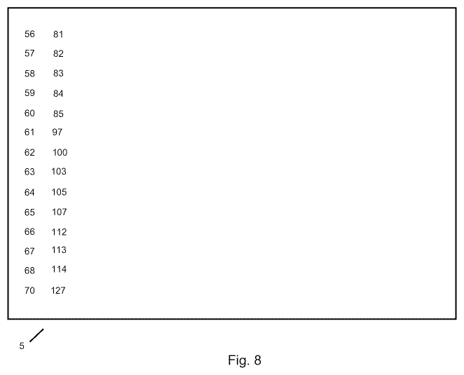

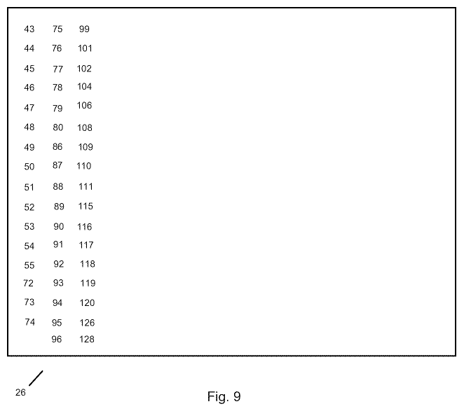

614. The process according to clause 1, clause 21, clause 317, or any other clause and further comprising any of the steps as shown in FIGS. 1-9, separately, in any combination or permutation.

As can be easily understood from the foregoing, the basic concepts of the various embodiments of the present invention(s) may be embodied in a variety of ways. It involves both métier-methodized techniques as well as devices to accomplish the appropriate métier methodization. In this application, the métier-methodized techniques are disclosed as part of the results shown to be achieved by the various devices described and as steps which are inherent to utilization. They are simply the natural result of utilizing the devices as intended and described. In addition, while some devices are disclosed, it should be understood that these not only accomplish certain methods but also can be varied in a number of ways. Importantly, as to all of the foregoing, all of these facets should be understood to be encompassed by this disclosure.

The discussion included in this patent application is intended to serve as a basic description. The reader should be aware that the specific discussion may not explicitly describe all embodiments possible; many alternatives are implicit. It also may not fully explain the generic nature of the various embodiments of the invention(s) and may not explicitly show how each feature or element can actually be representative of a broader function or of a great variety of alternative or equivalent elements. As one example, terms of degree, terms of approximation, and/or relative terms may be used. These may include terms such as the words: substantially, about, only, and the like. These words and types of words are to be understood in a dictionary sense as terms that encompass an ample or considerable amount, quantity, size, etc. as well as terms that encompass largely but not wholly that which is specified. Further, for this application if or when used, terms of degree, terms of approximation, and/or relative terms should be understood as also encompassing more precise and even quantitative values that include various levels of precision and the possibility of claims that address a number of quantitative options and alternatives. For example, to the extent ultimately used, the existence or non-existence of a substance or condition in a particular input, output, or at a particular stage can be specified as substantially only x or substantially free of x, as a value of about x, or such other similar language. Using percentage values as one example, these types of terms should be understood as encompassing the options of percentage values that include 99.5%, 99%, 97%, 95%, 92% or even 90% of the specified value or relative condition; correspondingly for values at the other end of the spectrum (e.g., substantially free of x, these should be understood as encompassing the options of percentage values that include not more than 0.5%, 1%, 3%, 5%, 8% or even 10% of the specified value or relative condition, all whether by volume or by weight as either may be specified). In context, these should be understood by a person of ordinary skill as being disclosed and included whether in an absolute value sense or in valuing one set of or substance as compared to the value of a second set of or substance. Again, these are implicitly included in this disclosure and should (and, it is believed, would) be understood to a person of ordinary skill in this field. Where the application is described in device-oriented terminology, each element of the device implicitly performs a function. Apparatus claims may not only be included for the device described, but also method or process claims may be included to address the functions of the embodiments and that each element performs. Neither the description nor the terminology is intended to limit the scope of the claims that will be included in any subsequent patent application.

It should also be understood that a variety of changes may be made without departing from the essence of the various embodiments of the invention(s). Such changes are also implicitly included in the description. They still fall within the scope of the various embodiments of the invention(s). A broad disclosure encompassing the explicit embodiment(s) shown, the great variety of implicit alternative embodiments, and the broad methods or processes and the like are encompassed by this disclosure and may be relied upon when drafting the claims for any subsequent patent application. It should be understood that such language changes and broader or more detailed claiming may be accomplished at a later date (such as by any required deadline) or in the event the applicant subsequently seeks a patent filing based on this filing. With this understanding, the reader should be aware that this disclosure is to be understood to support any subsequently filed patent application that may seek examination of as broad a base of claims as deemed within the applicant's right and may be designed to yield a patent covering numerous aspects of embodiments of the invention(s) both independently and as an overall system.

Further, each of the various elements of the embodiments of the invention(s) and claims may also be achieved in a variety of manners. Additionally, when used or implied, an element is to be understood as encompassing individual as well as plural structures that may or may not be physically connected. This disclosure should be understood to encompass each such variation, be it a variation of an embodiment of any apparatus embodiment, a method or process embodiment, or even merely a variation of any element of these. Particularly, it should be understood that as the disclosure relates to elements of the various embodiments of the invention(s), the words for each element may be expressed by equivalent apparatus terms or method terms—even if only the function or result is the same. Such equivalent, broader, or even more generic terms should be considered to be encompassed in the description of each element or action. Such terms can be substituted where desired to make explicit the implicitly broad coverage to which embodiments of the invention(s) is entitled. As but one example, it should be understood that all actions may be expressed as a means for taking that action or as an element which causes that action. Similarly, each physical element disclosed should be understood to encompass a disclosure of the action which that physical element facilitates. Regarding this last aspect, as but one example, the disclosure of a “rank” should be understood to encompass disclosure of the act of “ranking”—whether explicitly discussed or not—and, conversely, were there effectively disclosure of the act of “ranking”, such a disclosure should be understood to encompass disclosure of a “rank” and even a “means for ranking.” Such changes and alternative terms are to be understood to be explicitly included in the description. Further, each such means (whether explicitly so described or not) should be understood as encompassing all elements that can perform the given function, and all descriptions of elements that perform a described function should be understood as a non-limiting example of means for performing that function. As other non-limiting examples, it should be understood that claim elements can also be expressed as any of: components, programming, subroutines, logic, or elements that are configured to, or configured and arranged to, provide or even achieve a particular result, use, purpose, situation, function, or operation, or as components that are capable of achieving a particular activity, result, use, purpose, situation, function, or operation. All should be understood as within the scope of this disclosure and written description.

Any patents, publications, or other references mentioned in this application for patent are hereby incorporated by reference. Any priority case(s) claimed by this application is hereby appended and hereby incorporated by reference. In addition, as to each term used it should be understood that unless its utilization in this application is inconsistent with a broadly supporting interpretation, common dictionary definitions should be understood as incorporated for each term and all definitions, alternative terms, and synonyms such as contained in the Random House Webster's Unabridged Dictionary, second edition are hereby incorporated by reference. Finally, all references listed in the list of References To Be Incorporated By Reference In Accordance With The Provisional Patent Application or other information statement filed with the application are hereby appended and hereby incorporated by reference, however, as to each of the above, to the extent that such information or statements incorporated by reference might be considered inconsistent with the patenting of the various embodiments of invention(s) such statements are expressly not to be considered as made by the applicant(s).

Thus, the applicant(s) should be understood to have support to claim and make claims to embodiments including at least: i) each of the métier-methodized devices as herein disclosed and described, ii) the related methods disclosed and described, iii) similar, equivalent, and even implicit variations of each of these devices and methods, iv) those alternative designs which accomplish each of the functions shown as are disclosed and described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such processes, methods, systems or components, ix) each system, method, and element shown or described as now applied to any specific field or devices mentioned, x) methods and apparatuses substantially as described hereinbefore and with reference to any of the accompanying examples, xi) an apparatus for performing the methods described herein comprising means for performing the steps, xii) the various combinations and permutations of each of the elements disclosed, xiii) each potentially dependent claim or concept as a dependency on each and every one of the independent claims or concepts presented, and xiv) all inventions described herein.

In addition and as to computer aspects and each aspect amenable to programming or other electronic automation, it should be understood that in characterizing these and all other aspects of the various embodiments of the invention(s)—whether characterized as a device, a capability, an element, or otherwise, because all of these can be implemented via software, hardware, or even firmware structures as set up for a general purpose computer, a programmed chip or chipset, an ASIC, application specific controller, subroutine, logic, or other known programmable or circuit specific structure-—it should be understood that all such aspects are at least defined by structures including, as person of ordinary skill in the art would well recognize: hardware circuitry, firmware, programmed application specific components, and even a general purpose computer programmed to accomplish the identified aspect. For such items implemented by programmable features, the applicant(s) should be understood to have support to claim and make a statement of invention to at least: xv) processes performed with the aid of or on a computer, machine, or computing machine as described throughout the above discussion, xvi) a programmable apparatus as described throughout the above discussion, xvii) a computer readable memory encoded with data to direct a computer comprising means or elements which function as described throughout the above discussion, xviii) a computer, machine, or computing machine configured as herein disclosed and described, xix) individual or combined subroutines, processor logic, and/or programs as herein disclosed and described, xx) a carrier medium carrying computer readable code for control of a computer to carry out separately each and every individual and combined method described herein or in any claim, xxi) a computer program to perform separately each and every individual and combined method disclosed, xxii) a computer program containing all and each combination of means for performing each and every individual and combined step disclosed, xxiii) a storage medium storing each computer program disclosed, xxiv) a signal carrying a computer program disclosed, xxv) a processor executing instructions that act to achieve the steps and activities detailed, xxvi) circuitry configurations (including configurations of transistors, gates, and the like) that act to sequence and/or cause actions as detailed, xxvii) computer readable medium(s) storing instructions to execute the steps and cause activities detailed, xxviii) the related methods disclosed and described, xxix) similar, equivalent, and even implicit variations of each of these systems and methods, xxx) those alternative designs which accomplish each of the functions shown as are disclosed and described, xxxi) those alternative designs and methods which accomplish each of the functions shown as are implicit to accomplish that which is disclosed and described, xxxii) each feature, component, and step shown as separate and independent inventions, and xxxiii) the various combinations of each of the above and of any aspect, all without limiting other aspects in addition.

With regard to claims whether now or later presented for examination, it should be understood that for practical reasons and so as to avoid great expansion of the examination burden, the applicant may at any time present only initial claims or perhaps only initial claims with only initial dependencies. The office and any third persons interested in potential scope of this or subsequent applications should understand that broader claims may be presented at a later date in this case, in a case claiming the benefit of this case, or in any continuation in spite of any preliminary amendments, other amendments, claim language, or arguments presented, thus throughout the pendency of any case there is no intention to disclaim or surrender any potential subject matter. It should be understood that if or when broader claims are presented, such may require that any relevant prior art that may have been considered at any prior time may need to be re-visited since it is possible that to the extent any amendments, claim language, or arguments presented in this or any subsequent application are considered as made to avoid such prior art, such reasons may be eliminated by later presented claims or the like. Both the examiner and any person otherwise interested in existing or later potential coverage, or considering if there has at any time been any possibility of an indication of disclaimer or surrender of potential coverage, should be aware that no such surrender or disclaimer is ever intended or ever exists in this or any subsequent application. Limitations such as arose in Hakim v. Cannon Avent Group, PLC, 479 F.3d 1313 (Fed. Cir 2007), or the like are expressly not intended in this or any subsequent related matter. In addition, support should be understood to exist to the degree required under new matter laws—including but not limited to European Patent Convention Article 123(2) and United States Patent Law 35 USC 132 or other such laws—to permit the addition of any of the various dependencies or other elements presented under one independent claim or concept as dependencies or elements under any other independent claim or concept. In drafting any claims at any time whether in this application or in any subsequent application, it should also be understood that the applicant has intended to capture as full and broad a scope of coverage as legally available. To the extent that insubstantial substitutes are made, to the extent that the applicant did not in fact draft any claim so as to literally encompass any particular embodiment, and to the extent otherwise applicable, the applicant should not be understood to have in any way intended to or actually relinquished such coverage as the applicant simply may not have been able to anticipate all eventualities; one skilled in the art, should not be reasonably expected to have drafted a claim that would have literally encompassed such alternative embodiments.

Further, if or when used, the use of the transitional phrases “comprising”, “including”, “containing”, “characterized by” and “having” are used to maintain the “open-end” claims herein, according to traditional claim interpretation including that discussed in MPEP § 2111.03. Thus, unless the context requires otherwise, it should be understood that the terms “comprise” or variations such as “comprises” or “comprising”, “include” or variations such as “includes” or “including”, “contain” or variations such as “contains” and “containing”, “characterized by” or variations such as “characterizing by”, “have” or variations such as “has” or “having”, are intended to imply the inclusion of a stated element or step or group of elements or steps but not the exclusion of any other element or step or group of elements or steps. Such terms should be interpreted in their most expansive form so as to afford the applicant the broadest coverage legally permissible.

The use of the phrase, “or any other claim” is used to provide support for any claim to be dependent on any other claim, such as another dependent claim, another independent claim, a previously listed claim, a subsequently listed claim, and the like. As one clarifying example, if a claim were dependent “on claim 9 or any other claim” or the like, it could be re-drafted as dependent on claim 1, claim 8, or even claim 11 (if such were to exist) if desired and still fall with the disclosure. It should be understood that this phrase also provides support for any combination of elements in the claims and even incorporates any desired proper antecedent basis for certain claim combinations such as with combinations of method, apparatus, process, and the like claims.

With respect to the drawings, it should be understood that these present only initial views, mirror views such as left, right, top, bottom, front, and back should be understood as within the realm of this disclosure as may be appropriate for design or industrial design protections. Furthermore, any aspect and any portion of such drawings should be understood as potentially not within the scope of any then-made claim such as by then dashing any portion desired. And such drawings should be understood as including drawing elements such as rectangles, circles, ellipses, ovals, squares, and the like as particular side or other views as well understood from the existing drawings.

Finally, any claims set forth at any time are hereby incorporated by reference as part of this description of the various embodiments of the application, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

1. (canceled)

2. A method for computer-generating métier-applied recommendation data utilizing a computer-implemented métier-applied complementary-personalities data valuation framework having at least one computer-implemented behavioral-tendency-similarity parameter comprising the steps of:
prompting an individual for a plurality of métier-specific behavioral tendency data of said individual comprising at least one of data selected from the group consisting of:
data pertaining to the trait of assertiveness;
data pertaining to the trait of compassion;
data pertaining to the trait of creativity;
data pertaining to the trait of deliberation;
data pertaining to the trait of ethicalness;
data pertaining to the trait of open-mindedness;
data pertaining to the trait of passion;
data pertaining to the trait of perseverance;
data pertaining to the trait of pragmatism;
data pertaining to the trait of skepticism;
data pertaining to the trait of urgency; and
data pertaining to the trait of wisdom;
with a métier-methodized behavioral tendency self-assessment query for said individual;
prompting said individual for a plurality of métier-specific objective data of said individual with a métier-methodized objective data self-assessment query for said individual;
creating a set of métier-specific numerical input data for said individual from said métier-specific behavioral tendency data of said individual and said métier-specific objective data of said individual by assigning a numerical value to each self-assessment query response of said individual to each said self-assessment query for said individual, wherein said métier-specific numerical input data for said individual comprises at least one behavioral tendency score for said individual selected from the group consisting of:
an assertiveness behavioral tendency score;
a compassion behavioral tendency score;
a creativity behavioral tendency score;
a deliberation behavioral tendency score;
an ethicalness behavioral tendency score;
an open-mindedness behavioral tendency score;
a passion behavioral tendency score;
a perseverance behavioral tendency score;
a pragmatism behavioral tendency score;
a skepticism behavioral tendency score;
an urgency behavioral tendency score; and
a wisdom behavioral tendency score;
numericizing said set of métier-specific numerical input data for said individual in an n-dimensional space wherein each dimension of said n-dimensional space represents a métier trait metric corresponding to each said behavioral tendency of said individual and each said objective datum for said individual inquired of by said self-assessment queries for said individual;
inputting said numericized n-dimensional spaced métier-specific numerical input data for said individual into a computer-implemented métier-applied complementary-personalities data valuation framework having a number of computer-implemented métier-trait-metric complementary personality parameters n corresponding to each dimension n of said n-dimensional;
space, wherein at least one said computer-implemented métier-trait-metric complementary personality parameter n comprises a parameter selected from the group consisting of:
a behavioral-tendency-similarity-for-assertiveness parameter;
a behavioral-tendency-similarity-for-compassion parameter;
a behavioral-tendency-similarity-for-creativity parameter;
a behavioral-tendency-similarity-for-deliberation parameter;
a behavioral-tendency-similarity-for-ethicalness parameter;
a behavioral-tendency-similarity-for-open-mindedness parameter;
a behavioral-tendency-similarity-for-passion parameter;
a behavioral-tendency-similarity-for-perseverance parameter;
a behavioral-tendency-similarity-for-pragmatism parameter;
a behavioral-tendency-similarity-for-skepticism parameter;
a behavioral-tendency-similarity-for-urgency parameter;
a behavioral-tendency-similarity-for-wisdom parameter;
performing a computer-implemented métier-trait-metric-parameter-specific mathematical operation with each said computer-implemented métier-trait-metric complementary personality parameter on at least one numerical value of said numericized n-dimensional spaced métier-specific numerical input data for said computer-implemented métier-trait-metric complementary personality parameter to create a computer-generated interim numerical data set for said computer-implemented métier-trait-metric complementary personality parameter;
applying a computer-implemented métier-trait-metric-parameter-specific mathematical calculation with each said computer-implemented métier-trait-metric complementary personality parameter to said computer-generated interim numerical data set for said computer-implemented métier-trait-metric complementary personality parameter to create a computer-generated interim métier-trait-metric parameter value for each said computer-implemented métier-trait-metric complementary personality parameter, wherein said métier-trait-metric-parameter-specific mathematical calculation comprises at least one calculation selected from the group consisting of:
for said behavioral-tendency-similarity-for-assertiveness parameter, subtracting said assertiveness behavioral tendency score for said individual from an assertiveness behavioral tendency score for another individual and taking the absolute value of the result;
for said behavioral-tendency-similarity-for-compassion parameter, subtracting said compassion behavioral tendency score for said individual from a compassion behavioral tendency score for another individual and taking the absolute value of the result;
for said behavioral-tendency-similarity-for-creativity parameter, subtracting said creativity behavioral tendency score for said individual from a creativity behavioral tendency score for another individual and taking the absolute value of the result;
for said behavioral-tendency-similarity-for-deliberation parameter, subtracting said deliberation behavioral tendency score for said individual from a deliberation behavioral tendency score for another individual and taking the absolute value of the result;
for said behavioral-tendency-similarity-for-ethicalness parameter, subtracting said ethicalness behavioral tendency score for said individual from an ethicalness behavioral tendency score for another individual and taking the absolute value of the result;
for said behavioral-tendency-similarity-for-open-mindedness parameter, subtracting said open-mindedness behavioral tendency score for said individual from an open-mindedness behavioral tendency score for another individual and taking the absolute value of the result;
for said behavioral-tendency-similarity-for-passion parameter, subtracting said passion behavioral tendency score for said individual from a passion behavioral tendency score for another individual and taking the absolute value of the result;
for said behavioral-tendency-similarity-for-perseverance parameter, subtracting said perseverance behavioral tendency score for said individual from a perseverance behavioral tendency score for another individual and taking the absolute value of the result;
for said behavioral-tendency-similarity-for-pragmatism parameter, subtracting said pragmatism behavioral tendency score for said individual from a pragmatism behavioral tendency score for another individual and taking the absolute value of the result;
for said behavioral-tendency-similarity-for-skepticism parameter, subtracting said skepticism behavioral tendency score for said individual from a skepticism behavioral tendency score for another individual and taking the absolute value of the result;
for said behavioral-tendency-similarity-for-urgency parameter, subtracting said urgency behavioral tendency score for said individual from an urgency behavioral tendency score for another individual and taking the absolute value of the result; and
for said behavioral-tendency-similarity-for-wisdom parameter, subtracting said wisdom behavioral tendency score for said individual from a wisdom behavioral tendency score for another individual and taking the absolute value of the result;
multiplying said computer-generated interim métier-trait-metric parameter value for each said computer-implemented métier-trait-metric complementary personality parameter by a computer-generated métier-trait-metric parameter weight for said computer-implemented métier-trait-metric complementary personality parameter to create a computer-generated weighted métier-trait-metric parameter value for each said computer-implemented métier-trait-metric complementary personality parameter, wherein each said computer-generated métier-trait-metric parameter weight for each said computer-implemented métier-trait-metric complementary personality parameter is established as a computer-implemented métier-trait-metric-parameter-specific relative parameter weight value for said computer-implemented métier-trait-metric complementary personality parameter divided by the sum of the computer-implemented métier-trait-metric-parameter-specific relative parameter weight values for all computer-implemented métier-trait-metric complementary personality parameters of said computer-implemented métier-applied complementary-personalities data valuation framework;
taking the sum of the computer-generated weighted métier-trait-metric parameter values for all said computer-implemented métier-trait-metric complementary personality parameters of said computer-implemented métier-applied complementary-personalities data valuation framework divided by the sum of the computer-generated métier-trait-metric parameter weights for all said computer-implemented métier-trait-metric complementary personality parameters of said computer-implemented métier-applied complementary-personalities data valuation framework to create a computer-generated métier-applied individual rank score for said individual;
comparing said computer-generated métier-applied individual rank score for said individual to at least one computer-generated métier-applied individual rank score for another individual to create a computer-generated métier-applied recommendation for said individual.

3. A method for computer-generating métier-applied recommendation data utilizing a computer-implemented métier-applied complementary-personalities data valuation framework having at least one computer-implemented behavioral-tendency-similarity parameter as described in claim 2 further comprising the step of fulfilling a vacant métier role for a particular métier application utilizing said computer-generated métier-applied recommendation, wherein said métier application comprises a métier application selected from métier networking, métier referrals, métier team-building, métier associations membership, métier leadership development, and métier vendors.

4. (canceled)

5. A method for computer-generating métier-applied recommendation data utilizing a computer-implemented métier-applied complementary-personalities data valuation framework having at least one computer-implemented behavioral-tendency-similarity parameter as described in claim 2 wherein said métier-specific objective data comprises métier-specific objective data selected from first name data, last name data, nickname data, vocation data, avocation data, location data, personal photo data, pronouns data, birthdate data, race data, ethnicity data, skills data, certifications data, training data, endorsements data, recommendations data, mentorship roles data, and any combination of the foregoing.

6. A method for computer-generating métier-applied recommendation data utilizing a computer-implemented métier-applied complementary-personalities data valuation framework having at least one computer-implemented behavioral-tendency-similarity parameter as described in claim 2 wherein said métier comprises the legal profession and wherein said métier-specific objective data comprises métier-specific objective data selected from law firm data, field of law data, legal specialty area data, state licensing data, practice geography data, law school data, legal education data, year of bar admission data, desired case type data, recent case overview data, recent case results data, and any combination of the foregoing.

7. A method for computer-generating métier-applied recommendation data utilizing a computer-implemented métier-applied complementary-personalities data valuation framework having at least one computer-implemented behavioral-tendency-similarity parameter as described in claim 2 wherein said step of performing a computer-implemented métier-trait-metric-parameter-specific mathematical operation comprises the step of performing a computer-implemented métier-trait-metric-parameter-specific mathematical operation selected from the steps of eliminating one or more data pairs of data paired métier-relevant numerical input data, time-based eliminating one or more data pairs of data paired métier-relevant numerical input data, age-of-data eliminating one or more data pairs of data paired métier-relevant numerical input data, individually differentiated data pair weighting of data paired métier-relevant numerical input data, and any combination of the foregoing.

8. A method for computer-generating métier-applied recommendation data utilizing a computer-implemented métier-applied complementary-personalities data valuation framework having at least one computer-implemented behavioral-tendency-similarity parameter as described in claim 2 wherein said computer-implemented métier-trait-metric-parameter-specific mathematical operation comprises an axiom-implementing computer-implemented métier-trait-metric-parameter-specific mathematical operation.

9. A method for computer-generating métier-applied recommendation data utilizing a computer-implemented métier-applied complementary-personalities data valuation framework having at least one computer-implemented behavioral-tendency-similarity parameter as described in claim 2 wherein said step of applying a computer-implemented métier-trait-metric-parameter-specific mathematical calculation comprises the step of applying a computer-implemented métier-trait-metric-parameter-specific mathematical calculation selected from the steps of averaging at least some numerical values of data paired métier-relevant numerical input data, averaging at least some measured métier-metric numerical values of data paired métier-relevant numerical input data, finding a maximum of measured métier-metric numerical values of data paired métier-relevant numerical input data, and any combination of the foregoing.

10. A method for computer-generating métier-applied recommendation data utilizing a computer-implemented métier-applied complementary-personalities data valuation framework having at least one computer-implemented behavioral-tendency-similarity parameter as described in claim 2 wherein said computer-implemented métier-trait-metric-parameter-specific mathematical calculation comprises an axiom-implementing computer-implemented métier-trait-metric-parameter-specific mathematical calculation.

11. A method for computer-generating métier-applied recommendation data utilizing a computer-implemented métier-applied complementary-personalities data valuation framework having at least one computer-implemented behavioral-tendency-similarity parameter as described in claim 2 wherein said step of comparing said computer-generated métier-applied individual rank score for said individual to at least one computer-generated métier-applied individual rank score for another individual to create a computer-generated métier-applied recommendation for said individual comprises the step of maximizing the aggregate effectiveness of a group of individuals.

12. A method for computer-generating métier-applied recommendation data utilizing a computer-implemented métier-applied complementary-personalities data valuation framework having at least one computer-implemented behavioral-tendency-similarity parameter as described in claim 11 wherein said step of maximizing the aggregate effectiveness of a group of individuals comprises the step of taking the sum of the highest computer-generated meter-applied individual rank scores for a plurality of individuals.

13. A method for computer-generating métier-applied recommendation data utilizing a computer-implemented métier-applied complementary-personalities data valuation framework having at least one computer-implemented behavioral-tendency-similarity parameter as described in claim 2 wherein said step of comparing said computer-generated métier-applied individual rank score for said individual to at least one computer-generated métier-applied individual rank score for another individual to create a computer-generated métier-applied recommendation for said individual comprises the step of computer-implemented iteratively recasting said computer-generated métier-applied individual rank score for said individual.

14. A method for computer-generating métier-applied recommendation data utilizing a computer-implemented métier-applied complementary-personalities data valuation framework having at least one computer-implemented behavioral-tendency-similarity parameter as described in claim 13 wherein said step of computer-implemented iteratively recasting said computer-generated métier-applied individual rank score for said individual comprises a step selected from computer-implemented iteratively recasting said computer-generated métier-applied individual rank score for said individual in response to computer-implemented iteratively developed networking reference data, computer-implemented iteratively recasting said computer-generated métier-applied individual rank score for said individual in response to computer-implemented iteratively developed team-building reference data, computer-implemented iteratively recasting said computer-generated métier-applied individual rank score for said individual in response to computer-implemented iteratively developed referrals reference data, computer-implemented iteratively recasting said computer-generated métier-applied individual rank score for said individual in response to computer-implemented iteratively developed associations membership reference data, and computer-implemented iteratively recasting said computer-generated métier-applied individual rank score for said individual in response to computer-implemented iteratively developed mentorship reference data.

15. A method for computer-generating métier-applied recommendation data utilizing a computer-implemented métier-applied complementary-personalities data valuation framework having at least one computer-implemented behavioral-tendency-similarity parameter as described in claim 13 wherein said step of computer-implemented iteratively recasting said computer-generated métier-applied individual rank score for said individual comprises the steps of:
computer-generating antecedent iterative reference data;
utilizing said computer-generated antecedent iterative reference data in a step of computer-implemented applicatively revaluing at least some said métier-specific numerical input data for said individual; and
computer-generating subsequent iterative reference data as a result of said step of computer-implemented applicatively revaluing at least some said métier-specific numerical input data for said individual.

16. A method for computer-generating métier-applied recommendation data utilizing a computer-implemented métier-applied complementary-personalities data valuation framework having at least one computer-implemented behavioral-tendency-similarity parameter as described in claim 15 wherein said computer-generated subsequent iterative reference data comprises computer-generated antecedent iterative reference data for a next succeeding iteration.

17. A method for computer-generating métier-applied recommendation data utilizing a computer-implemented métier-applied complementary-personalities data valuation framework having at least one computer-implemented behavioral-tendency-similarity parameter as described in claim 15 wherein said step of utilizing said computer-generated antecedent iterative reference data in a step of computer-implemented applicatively revaluing at least some said métier-specific numerical input data for said individual comprises the step of computer-implemented adjusting at least one numerical value of said métier-specific numerical input data in response to said computer-generated antecedent iterative reference data.

18. A method for computer-generating métier-applied recommendation data utilizing a computer-implemented métier-applied complementary-personalities data valuation framework having at least one computer-implemented behavioral-tendency-similarity parameter as described in claim 2 further comprising the step of utilizing at least one computer-implemented feedback point in connection with any said step.

19. A method for computer-generating métier-applied recommendation data utilizing a computer-implemented métier-applied complementary-personalities data valuation framework having at least one computer-implemented behavioral-tendency-similarity parameter as described in claim 18 wherein said at least one computer-implemented feedback point comprises multiple computer-implemented feedback points selected from multiple computer-implemented feedback points from multiple users, multiple computer-implemented feedback points from multiple automatic generation, multiple computer-implemented iterative feedback points, and any combination of the foregoing.

20. A method for computer-generating métier-applied recommendation data utilizing a computer-implemented métier-applied complementary-personalities data valuation framework having at least one computer-implemented behavioral-tendency-similarity parameter as described in claim 18 wherein said feedback comprises computer-implemented feedback reference data and further comprising the step of computer-implemented applicatively revaluing at least some said métier-specific numerical input data for said individual utilizing said computer-implemented feedback reference data.

21. A method for computer-generating métier-applied recommendation data utilizing a computer-implemented métier-applied complementary-personalities data valuation framework having at least one computer-implemented behavioral-tendency-similarity parameter as described in claim 20 wherein said step of utilizing said computer-implemented feedback reference data comprises the step of computer-implemented adjusting at least one numerical value of said métier-specific numerical input data for said individual in response to said computer-implemented feedback reference data.

22-26. (canceled)
